(19) United States
(12) Patent Application Publication
(10) Pub. No.: US 2003/0091947 A1
(43) Pub. Date: May 15, 2003

(54) Heat-developable image recording material

(75) Inventors: Yoshihisa Tsukada, Kanagawa (JP); Hajime Nakagawa, Kanagawa (JP); Seiji Hatano, Kanagawa (JP); tomokazu Yasuda, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/115,894

(22) Filed: Apr. 5, 2002

(30) Foreign Application Priority Data
Apr. 6, 2001 (JP) P.2001-109332
May 8, 2001 (JP) P.2001-137470
Jul. 27, 2001 (JP) P.2001-227816
Aug. 22, 2001 (JP) P.2001-251247
Sep. 14, 2001 (JP) P.2001-279851

(51) Int. Cl. G03C 1/04; G03C 1/498

(52) U.S. Cl. 430/620; 430/627; 430/350; 430/907

(57) ABSTRACT

A heat-developable image recording material having excellent image preservability, comprises a support having thereon a photosensitive silver halide, a non-photosensitive organic silver salt, a reducing agent for silver ion and a specific binder.

### FIELD OF THE INVENTION

The present invention relates to a heat-developable image recording material suitable for use in the fields of medical diagnostic film and photomechanical film.

### BACKGROUND OF THE INVENTION

In recent years, it is being eagerly demanded to reduce waste processing solution in the fields of medical diagnostic film and photomechanical film from the standpoint of environmental conservation and space saving. To satisfy this, development of techniques relating to heat-developable image recording materials suitable for medical diagnostic film and photomechanical film, which can be efficiently exposed using a laser image-setter or a laser imager and can provide a clear black image having high resolution and sharpness, is being required. By the use of such a heat-developable image recording material, a heat development processing system capable of dispensing with solution-type processing chemicals and being simpler and free of any adverse effect on the environment can be provided to customers.

These requirements are also raised in the field of general image recording materials, however, particularly in the field of medical diagnosis, a high-quality image excellent in sharpness and graininess and capable of performing fine description is necessary. Moreover, since the diagnosis is easy, an image of blue black tone is preferred. At present, various hard copy systems using a pigment or a dye, such as ink jet printer and electro-photography, are popularized as a system for forming a general image. However, these systems are unsatisfactory as a system for outputting an image for medical use.

On the other hand, a thermal image-forming system utilizing an organic silver salt is described, for example, in U.S. Pat. Nos. 3,152,904 and 3,457,075, J. Sturge, V. Walworth and A. Shepp (compilers), Imaging Processes and Materials: Neblette's, 8th Ed., Chap. 9, “Thermally Processed Silver Systems” (D. Klosterboer), page 279 (1989). In particular, a heat-developable image recording material generally has a photosensitive layer comprising a binder matrix having dispersed therein a catalytically active amount of photocatalyst (e.g., silver halide), a reducing agent, a silver salt capable of being reduced (e.g., organic silver salt) and if desired, a toning agent for controlling the color tone of silver image. The heat-developable image recording material is imagewise exposed and then heated at a high temperature (e.g., 80° C. or more), whereby an oxidation reduction reaction proceeds between the silver salt capable of being reduced (the silver salt acts as an oxidizing agent) and the reducing agent to form a black silver image. The oxidation reduction reaction is accelerated by the catalytic action of a latent image of silver halide generated upon image exposure. Therefore, the black silver image is formed in the exposed area.

Heat-developable image recording materials of this type have been conventionally known, however, in most of these recording materials, the solvent used for forming the photosensitive layer is an organic solvent (e.g., toluene, methyl ethyl ketone, methanol). Use of an organic solvent is disadvantageous not only in its adverse effect on human body in the process of production but also in view of the cost due to necessity for recovery of the solvent and other factors.

Therefore, a method for forming a photosensitive layer by applying a coating solution using an aqueous medium free from the above-described problems (hereinafter this photosensitive layer is sometimes referred to as a “water-based photosensitive layer”) is disclosed. For example, a technique of using gelatin as a binder is disclosed in JP-A-49-52626 (the term “JP-A” as used herein means an “unexamined published Japanese patent application”) and JP-A-53-116114, and a technique of using polyvinyl alcohol as a binder is disclosed in JP-A-50-151138.

However, these techniques are below the level of practical use, because severe fog occurs and the image formed has very poor color tone. A technique of using a polymer as a binder and forming a photosensitive layer using an aqueous medium is disclosed in JP-A-10-10669 and JP-A-10-62899. This technique opens the way for the production of a heat-developable image recording material which is satisfied in regard to fog and color tone of the image and preferred in view of environmental conservation, safety, cost and the like.

However, this technique is still insufficient in view of photographic characteristics, in particular, so-called image preservability, for example, the density in the unexposed area increases or the color tone of silver changes after the formation of image. Thus, a technique of providing a heat-developable image recording material improved in the image preservability is demanded.

In synthesizing the above-described polymer latex using an aqueous medium, its polymerization suitability greatly depends on the pH of the water medium at the synthesis of latex, the strength of salt, the kind and the amount added of additives such as polymerization initiator and surface active agent. In particular, at the time of synthesizing a polymer latex of high concentration while adding a surface active agent in a small amount, aggregates are produced at the reaction. Furthermore, in the production of a heat-developable image recording material, the coating property is disadvantageously worsened due to the aggregates generated. Accordingly, establishment of a technique for producing a polymer latex of causing no precipitation or aggregation at the polymerization and capable of presenting a good dispersion state, in other words, a polymer latex having excellent polymerization suitability, is demanded, so that a heat-developable image recording material having both good coating property of forming a homogeneous coating film and high image preservability of enabling practical use can be provided.

In the production of a heat developable photo-sensitive material, a high-speed coating-drying step using an aqueous medium is provided. For realizing a homogeneous surface state, it is indispensable to strictly control the viscosity of the coating solution. The viscosity of the coating solution is very readily affected particularly by the particle size and the distribution thereof and is often elevated to cause a failed surface state such as crawling or streaks. Therefore, a technique for suitably controlling the viscosity of the coating solution and providing a heat-developable image recording material having good surface state is being demanded.

With respect to the production suitability of the heat-developable image recording material, improvement of the working brittleness and in turn elevation of the productivity are demanded.

### SUMMARY OF THE INVENTION

The object of the present invention is to solve the above-described problems in conventional techniques.

More specifically, a first object of the present invention is to provide a heat-developable image recording material having excellent image preservability.

A second object of the present invention is to provide a heat-developable image recording material having both excellent image preservability and improved working brittleness.

A third object of the present invention is to provide a heat-developable image recording material excellent in both the image preservability and the coating property.

A fourth object of the present invention is to establish a method for producing a polymer latex having excellent polymerization suitability and, based thereon, provide a heat-developable image recording material excellent in both the coating property and the image preservability.

A fifth object of the present invention is to provide a heat-developable image recording material excellent in the homogeneity of the coated surface state.

Other objects of the present invention will become apparent from the following description.

The above-described objects are attained by the following constructions.

(1) A heat-developable image recording material (a first embodiment) comprising:

a support;

a photosensitive silver halide;

a non-photosensitive organic silver salt;

a reducing agent for silver ion; and

a binder including a polymer,

wherein said polymer has:

a sol formation ratio of 5 to 55 wt %; and

the sol moiety having a weight average molecular weight of 10,000 to 200,000 and having a glass transition temperature of −30 to 50° C.

(2) The heat-developable image recording material as described in the item (1), wherein said binder contains a polymer having:

a sol formation ratio of 15 to 45 wt %; and

the sol moiety having a weight average molecular weight of 30,000 to 150,000 and having a glass transition temperature of 0 to 30° C.

(3) The heat-developable image recording material as described in the item (1), wherein said polymer contains a repeating unit corresponding to a crosslinkable monomer.

(4) The heat-developable image recording material as described in the item (1), wherein said polymer contains a repeating unit corresponding to a conjugated diene monomer.

(5) The heat-developable image recording material as described in the item (4), wherein said polymer is a styrene-butadiene copolymer.

(6) The heat-developable image recording material as described in the item (1), wherein the reducing agent contains:

a phenol compound; and

a compound that satisfies at least one of the conditions A and B:

A: the compound having a hydrogen bond-forming rate constant (Kf) of from 20 to 4,000,

B: the compound having one of a phosphoryl group in its molecule, and a structure represented by the following formula (II), (III), (IV) or (V):

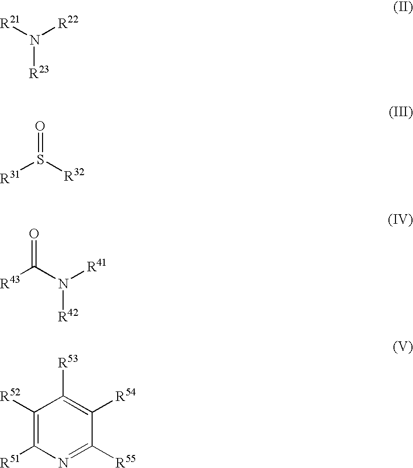

wherein R²¹ and R²² each independently represents an alkyl group; R²³ represents an alkyl group, an aryl group or a heterocyclic group; at least two of R²¹, R²² and R²³ may combine with each other to form a ring; R³¹ and R³² each independently represents an alkyl group, an aryl group or a heterocyclic group; R³¹ and R³² may combine with each other to form a ring; R⁴¹ and R⁴² each independently represents an alkyl group, an aryl group or a heterocyclic group; R²³ represents an alkyl group, an aryl group, a heterocyclic group or —N(R⁴⁴) (R⁴⁵); R⁴⁴ and R⁴² each independently represents an alkyl group, an aryl group or a heterocyclic group; at least two of R⁴¹, R⁴², R⁴³, R⁴⁴ and R⁴⁵ may combine with each other to form a ring; R⁵¹, R⁵², R⁵³, R⁵⁴ and R⁵⁵ each independently represents a hydrogen atom or a substituent; at least two of R⁵¹, R⁵², R³, R⁵⁴ and R⁵⁵ may combine with each other to form a ring.

(7) The heat-developable image recording material as described in the item (6), wherein said phenol compound is an o-polyphenol compound.

(8) The heat-developable image recording material as described in the item (7), wherein said o-polyphenol compound is a compound represented by the following formula (I):

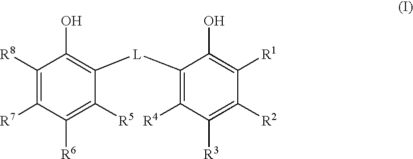

wherein R¹, R², R³, R⁴, R⁵, R⁶, R⁷ and R⁸ each independently represents a hydrogen atom or a group capable of being substituted on the benzene ring; L represents —S— or —CHR⁹—; R⁹ represents a hydrogen atom or an alkyl group.

(9) The heat-developable image recording material as described in the item (8), wherein said compound represented by formula (I) is a compound where R², R⁴, R⁵ and R⁷ each is a hydrogen atom, R¹ and R⁸ each is independently an alkyl group, R³ and R⁶ each is independently an alkyl group, and L is —CHR⁹—.

(10) The heat-developable image recording material as described in the item (9), wherein R¹ and R⁸ each is independently a secondary or tertiary alkyl group.

(11) The heat-developable image recording material as described in the item (6), wherein said hydrogen bond-forming rate constant (Kf) is from 70 to 4,000.

(12) The heat-developable image recording material as described in the item (6), wherein said phenol compound is an o-polyphenol compound, and the compound that satisfies at least one of the conditions A and B is the compound having a phosphoryl group in its molecule.

(13) The heat-developable image recording material as described in the item (6), wherein said compound having a phosphoryl group in its molecule is a compound represented by the following formula (VI):

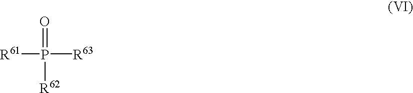

wherein R⁶¹, R⁶² and R⁶³ each independently represents an alkyl group, an aryl group, an aralkyl group, an alkoxy group, an aryloxy group, an amino group or a heterocyclic group.

(14) A heat-developable image recording material (a second embodiment) comprising:

a support;

a photosensitive silver halide;

a non-photosensitive organic silver salt;

a reducing agent for silver ion; and

a binder including a polymer latex,

wherein the polymer latex contains a chelate compound in an amount of 20 to 900 ppm based on the polymer latex solution.

(15) The heat-developable image recording material as described in the item (14), wherein said polymer latex contains the chelate compound in an amount of from 40 to 600 ppm based on the polymer latex solution.

(16) The heat-developable image recording material as described in the item (14), wherein said chelate compound is an aminopolycarboxylic acid derivative.

(17) The heat-developable image recording material as described in the item (14), wherein said binder has a glass transition temperature of −20 to 80° C.

(18) The heat-developable image recording material as described in the item (14), wherein said binder contains a copolymer having a repeating unit corresponding to a conjugated diene monomer.

(19) The heat-developable image recording material as described in the item (14), wherein the reducing agent contains:

a phenol compound; and

a compound that satisfies at least one of the conditions A and B:

A: the compound having a hydrogen bond-forming rate constant (Kf) of from 20 to 4,000,

B: the compound having one of a phosphoryl group in its molecule, and a structure represented by the following formula (II), (III), (IV) or (V):

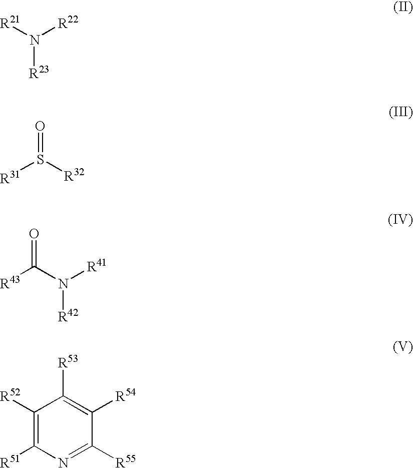

wherein R²¹ and R²² each independently represents an alkyl group; R²³ represents an alkyl group, an aryl group or a heterocyclic group; at least two of R², R²² and R²³ may combine with each other to form a ring; R³¹ and R³² each independently represents an alkyl group, an aryl group or a heterocyclic group; R³¹ and R³² may combine with each other to form a ring; R⁴¹ and R⁴² each independently represents an alkyl group, an aryl group or a heterocyclic group; R⁴³ represents an alkyl group, an aryl group, a heterocyclic group or —N(R⁴⁴) (R⁴⁵); R⁴⁴ and R⁴⁵ each independently represents an alkyl group, an aryl group or a heterocyclic group; at least two of R⁴¹, R⁴², R⁴³, R⁴⁴ and R₄₅ may combine with each other to form a ring; R⁵, R⁵², R⁵³, R⁵⁴ and R⁵⁵ each independently represents a hydrogen atom or a substituent; at least two of R⁵, R⁵², R⁵³, R⁵⁴ and R⁵⁵ may combine with each other to form a ring.

(20) The heat-developable image recording material as described in the item (19), wherein said phenol compound is an o-polyphenol compound.

(21) The heat-developable image recording material as described in the item (20), wherein said o-polyphenol compound is a compound represented by the following formula (I):

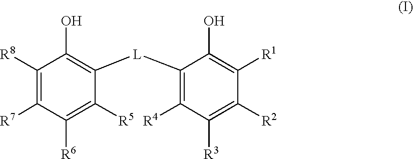

wherein R¹, R², R³, R⁴, R⁵ , R⁶, R⁷ and R⁸ each independently represents a hydrogen atom or a group capable of being substituted on the benzene ring; L represents —S— or —CHR⁹—; R⁹ represents a hydrogen atom or an alkyl group.

(22) The heat-developable image recording material as described in the item (21), wherein said compound represented by formula (I) is a compound where R², R⁴, R⁵ and R⁷ each is a hydrogen atom, R¹ and R⁸ each is independently an alkyl group, R³ and R⁶ each is independently an alkyl group, and L is —CHR⁹—.

(23) The heat-developable image recording material as described in the item (22), wherein R¹ and R⁸ each is independently a secondary or tertiary alkyl group.

(24) The heat-developable image recording material as described in the item (19), wherein said hydrogen bond-forming rate constant (Kf) is from 70 to 4,000.

(25) The heat-developable image recording material as described in the item (19), wherein said phenol compound is an o-polyphenol compound, and the compound that satisfies at least one of the conditions A and B is the compound having a phosphoryl group in its molecule.

(26) The heat-developable image recording material as described in the item (19), wherein said compound having a phosphoryl group in its molecule is a compound represented by the following formula (VI):

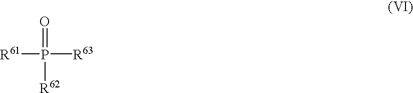

wherein R⁶¹, R⁶² and R⁶³ each independently represents an alkyl group, an aryl group, an aralkyl group, an alkoxy group, an aryloxy group, an amino group or a heterocyclic group.

(27) A latex solution for an organic silver-containing heat-developable image recording material, which comprises:

a polymer latex; and

a chelate compound in an amount of from 20 to 900 ppm.

(28) A heat-developable image recording material (a third embodiment) comprising:

a support;

a photosensitive silver halide;

a non-photosensitive organic silver salt;

a reducing agent capable of reducing silver ion; and

a binder,

wherein a layer containing the binder is provided by applying a coating solution containing:

the photosensitive silver halide;

the non-photosensitive organic silver salt; and

a polymer latex obtained by the emulsion polymerization in the presence of a basic compound.

(29) The heat-developable image recording material as described in the item (28), wherein the basic compound is used in an amount of 1.0×10⁻⁵ mmol or more per g as a solid content of the polymer latex. (30) The heat-developable image recording material as described in the item (28), wherein said binder contains a polymer latex obtained by the copolymerization of a monomer having a carboxyl group.

(31) The heat-developable image recording material as described in the item (28), wherein the polymer latex is obtained by the emulsion polymerization in the presence of a surface active agent in an amount of 10 wt % or less based on the solid content of the polymer latex.

(32) The heat-developable image recording material as described in the item (28), wherein said binder has a glass transition temperature of −20 to 80° C.

(33) The heat-developable image recording material as described in the item (28), wherein said polymer latex is a polymer latex obtained by the copolymerization of at least a conjugated diene monomer.

(34) The heat-developable image recording material as described in the item (28), wherein the reducing agent contains:

a phenol compound; and

a compound that satisfies at least one of the conditions A and B:

A: the compound having a hydrogen bond-forming rate constant (Kf) of from 20 to 4,000,

B: the compound having one of a phosphoryl group in its molecule, and a structure represented by the following formula (II), (III), (IV) or (V):

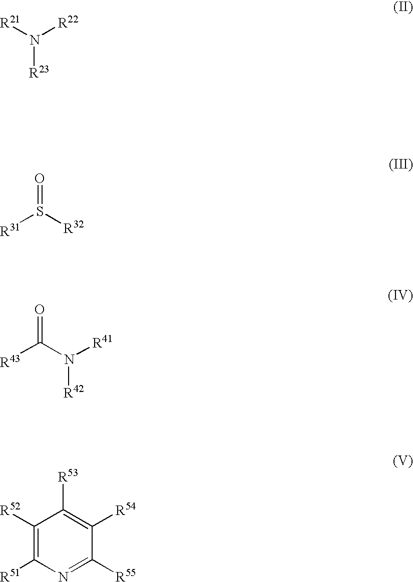

wherein R²¹ and R²² each independently represents an alkyl group; R²³ represents an alkyl group, an aryl group or a heterocyclic group; at least two of R²¹, R²² and R²³ may combine with each other to form a ring; R³¹ and R³² each independently represents an alkyl group, an aryl group or a heterocyclic group; R³¹ and R³² may combine with each other to form a ring; R⁴¹ and R⁴² each independently represents an alkyl group, an aryl group or a heterocyclic group; R⁴³ represents an alkyl group, an aryl group, a heterocyclic group or —N(R⁴⁴) (R⁴⁵); R⁴⁴ and R⁴⁵ each independently represents an alkyl group, an aryl group or a heterocyclic group; at least two of R⁴¹, R⁴², R⁴³, R⁴⁴ and R⁴⁵ may combine with each other to form a ring; R⁵¹, R⁵², R⁵³, R⁵⁴ and R⁵⁵ each independently represents a hydrogen atom or a substituent; at least two of R⁵¹, R⁵², R⁵³, R¹⁴ and R⁵⁵ may combine with each other to form a ring.

(35) The heat-developable image recording material as described in the item (34), wherein said phenol compound is an o-polyphenol compound.

(36) The heat-developable image recording material as described in the item (35), wherein said o-polyphenol compound is a compound represented by the following formula (I):

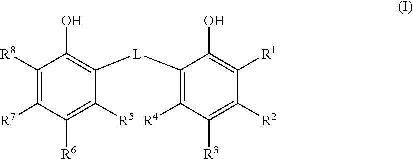

wherein R¹, R², R³, R⁴, R⁵, R¹, R⁷ and R⁸ each independently represents a hydrogen atom or a group capable of being substituted on the benzene ring; L represents —S— or —CHR⁹—; R⁹ represents a hydrogen atom or an alkyl group.

(37) The heat-developable image recording material as described in the item (36), wherein said compound represented by formula (I) is a compound where R², R⁴, R⁵ and R⁷ each is a hydrogen atom, R¹ and R⁸ each is independently an alkyl group, R³ and R⁶ each is independently an alkyl group, and L is —CHR⁹—.

(38) The heat-developable image recording material as described in the item (37), wherein R¹ and R⁸ each is independently a secondary or tertiary alkyl group.

(39) The heat-developable image recording material as described in the item (34), wherein said hydrogen bond-forming rate constant (Kf) is from 70 to 4,000.

(40) The heat-developable image recording material as described in the item (34), wherein said phenol compound is an o-polyphenol compound, and the compound that satisfies at least one of the conditions A and B is the compound having a phosphoryl group in its molecule.

(41) The heat-developable image recording material as described in the item (34), wherein said compound having a phosphoryl group in its molecule is a compound represented by the following formula (VI):

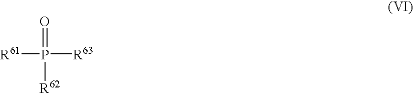

wherein R⁶¹, R⁶² and R⁶³ each independently represents an alkyl group, an aryl group, an aralkyl group, an alkoxy group, an aryloxy group, an amino group or a heterocyclic group.

(42) A heat-developable image recording material (a fourth embodiment) comprising:

a support;

a photosensitive silver halide;

a non-photosensitive organic silver salt;

a reducing agent for silver ion; and

a binder including a polymer latex,

wherein said polymer latex has a heavy metal content of 1 ppm or less based on the polymer latex.

(43) The heat-developable image recording material as described in the item (42), wherein said heavy metal content is 0.5 ppm or less based on the polymer latex.

(44) The heat-developable image recording material as described in the item (42), wherein said heavy metal is at least one selected from the group consisting of iron, chromium, nickel, molybdenum or titanium.

(45) The heat-developable image recording material as described in the item (42), wherein said binder has a glass transition temperature of −20 to 80° C.

(46) The heat-developable image recording material as described in the item (42), wherein the polymer has a repeating unit corresponding to a conjugated diene monomer.

(47) The heat-developable image recording material as described in the item (42), wherein the reducing agent contains:

a phenol compound; and

a compound that satisfies at least one of the conditions A and B:

A: the compound having a hydrogen bond-forming rate constant (Kf) of from 20 to 4,000,

B: the compound having one of a phosphoryl group in its molecule, and a structure represented by the following formula (II), (III), (IV) or (V):

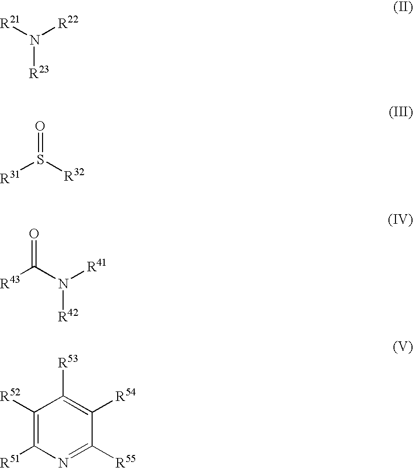

wherein R²¹ and R²² each independently represents an alkyl group; R²³ represents an alkyl group, an aryl group or a heterocyclic group; at least two of R²¹, R²² and R²³ may combine with each other to form a ring; R³¹ and R³² each independently represents an alkyl group, an aryl group or a heterocyclic group; R³¹ and R³² may combine with each other to form a ring; R⁴¹ and R⁴² each independently represents an alkyl group, an aryl group or a heterocyclic group; R⁴³ represents an alkyl group, an aryl group, a heterocyclic group or —N(R⁴⁴) (R⁴⁵); R⁴⁴ and R⁴⁵ each independently represents an alkyl group, an aryl group or a heterocyclic group; at least two of R⁴¹, R⁴², R⁴³ , R⁴³ and R⁴⁵ may combine with each other to form a ring; R⁵¹, R⁵², R⁵³, R⁵⁴ and R⁵⁵ each independently represents a hydrogen atom or a substituent; at least two of R⁵¹, R⁵² , R⁵³ , R⁴³ and R⁵⁵ may combine with each other to form a ring.

(48) The heat-developable image recording material as described in the item (47), wherein said phenol compound is an o-polyphenol compound.

(49) The heat-developable image recording material as described in the item (48), wherein said o-polyphenol compound is a compound represented by the following formula (I):

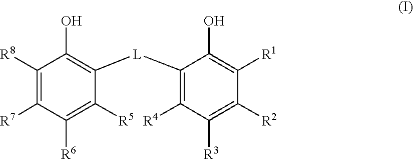

wherein R¹, R², R¹, R¹, R⁵, R⁶, R⁷ and R⁸ each independently represents a hydrogen atom or a group capable of being substituted on the benzene ring; L represents —S— or —CHR⁹—; R⁹ represents a hydrogen atom or an alkyl group.

(50) The heat-developable image recording material as described in the item (49), wherein said compound represented by formula (I) is a compound where R², R⁴, R⁵ and R⁷ each is a hydrogen atom, R¹ and R⁸ each is independently an alkyl group, R³ and R⁶ each is independently an alkyl group, and L is —CHR⁹—.

(51) The heat-developable image recording material as described in the item (50), wherein R¹ and R⁸ each is independently a secondary or tertiary alkyl group.

(52) The heat-developable image recording material as described in the item (47), wherein said hydrogen bond-forming rate constant (Kf) is from 70 to 4,000.

(53) The heat-developable image recording material as described in the item (47), wherein said phenol compound is an o-polyphenol compound, and the compound that satisfies at least one of the conditions A and B is the compound having a phosphoryl group in its molecule.

(54) The heat-developable image recording material as described in the item (47), wherein said compound having a phosphoryl group within the molecule is a compound represented by the following formula (VI):

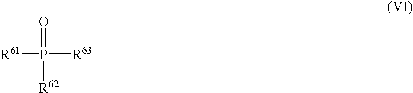

wherein R⁶¹, R⁶² and R⁶³ each independently represents an alkyl group, an aryl group, an aralkyl group, an alkoxy group, an aryloxy group, an amino group or a heterocyclic group.

(55) A heat-developable image recording material (a fifth embodiment) comprising:

a support;

a photosensitive silver halide;

a non-photosensitive organic silver salt;

a reducing agent for silver ion; and

a binder including a latex,

wherein the latex contains dispersed particles, and the dispersed particles has the ratio (dv/dn) of the volume weighted mean diameter (dv) to the number average diameter (dn) of from 1.0 to 1.10.

(56) The heat-developable image recording material as described in the item (55), wherein the number average diameter (dn) of the dispersed particles of the latex is from 30 to 300 nm.

(57) The heat-developable image recording material as described in the item (55), wherein the latex is a dispersion of a polymer having a repeating unit corresponding to a conjugated diene monomer.

(58) The heat-developable image recording material as described in the item (57), wherein said polymer is a styrene-butadiene copolymer.

(59) The heat-developable image recording material as described in the item (55), wherein the reducing agent contains:

a phenol compound; and

a compound that satisfies at least one of the conditions A and B:

A: the compound having a hydrogen bond-forming rate constant (Kf) of from 20 to 4,000,

B: the compound having one of a phosphoryl group in its molecule, and a structure represented by the following formula (II), (III), (IV) or (V):

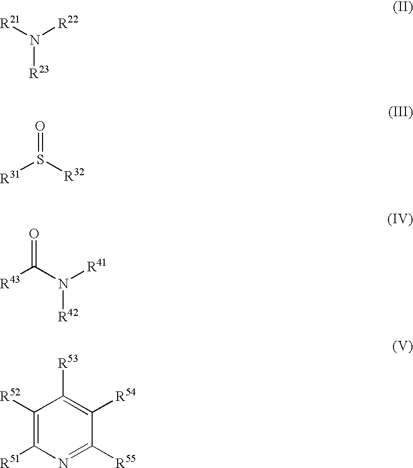

wherein R²¹ and R²² each independently represents an alkyl group; R²³ represents an alkyl group, an aryl group or a heterocyclic group; at least two of R²¹, R²² and R²³ may combine with each other to form a ring; R³¹ and R³² each independently represents an alkyl group, an aryl group or a heterocyclic group; R³¹ and R³² may combine with each other to form a ring; R⁴¹ and R⁴² each independently represents an alkyl group, an aryl group or a heterocyclic group; R⁴³ represents an alkyl group, an aryl group, a heterocyclic group or —N(R⁴⁴) (R⁴⁵); R⁴⁴ and R⁴⁵ each independently represents an alkyl group, an aryl group or a heterocyclic group; at least two of R⁴¹, R⁴², R⁴³, R⁴⁴ and R⁴⁵ may combine with each other to form a ring; R⁵¹′, R⁵², R⁵³, R⁵⁴ and R⁵⁵ each independently represents a hydrogen atom or a substituent; at least two of R⁵¹, R⁵², R⁵³, R⁵⁴ and R⁵⁵ may combine with each other to form a ring.

(60) The heat-developable image recording material as described in the item (59), wherein said phenol compound is an o-polyphenol compound.

(61) The heat-developable image recording material as described in the item (60), wherein said o-polyphenol compound is a compound represented by the following formula (I):

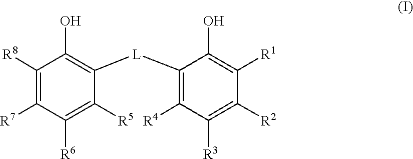

wherein R¹, R², R³, R⁴, R⁵, R⁶, R⁷ and R⁸ each independently represents a hydrogen atom or a group capable of being substituted on the benzene ring; L represents —S— or —CHR⁹—; R⁹ represents a hydrogen atom or an alkyl group.

(62) The heat-developable image recording material as described in the item (61), wherein said compound represented by formula (I) is a compound where R², R⁴, R⁵ and R⁷ each is a hydrogen atom, R¹, R³, R⁶ and R⁸ each is independently an alkyl group, L is —CHR⁹—, and R⁹ is a hydrogen atom or an alkyl group.

(63) The heat-developable image recording material as described in the item (62), wherein R¹ and R⁸ each is independently a secondary or tertiary alkyl group.

(64) The heat-developable image recording material as described in the item (59), wherein said hydrogen bond-forming rate constant (Kf) is from 70 to 4,000.

(65) The heat-developable image recording material as described in the item (59), wherein said phenol compound is an o-polyphenol compound, and the compound that satisfies at least one of the conditions A and B is the compound having a phosphoryl group in its molecule.

(66) The heat-developable image recording material as described in the item (59), wherein said compound having a phosphoryl group within the molecule is a compound represented by the following formula (VI):

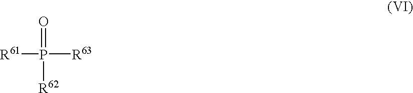

wherein R⁶¹, R⁶² and R⁶³ each independently represents an alkyl group, an aryl group, an aralkyl group, an alkoxy group, an aryloxy group, an amino group or a heterocyclic group.

(67) A heat-developable image recording material (a fifth embodiment) comprising:

a support;

a photosensitive silver halide;

a non-photosensitive organic silver salt;

a reducing agent for silver ion; and

a binder including a latex,

wherein the latex has the ratio (N_{U80}/Nₐₗₗ) of 0.1 or less between the number (N_{U80}) of small-size particles having a diameter of less than 80% of the number average diameter (dn) and the number (Nₐₗₗ) of all particles.

(68) The heat-developable image recording material as described in the item (67), wherein the number average diameter (dn) of said latex is from 30 to 300 nm.

(69) The heat-developable image recording material as described in the item (67), wherein the latex is a dispersion of a polymer having a repeating unit corresponding to a conjugated diene monomer.

(70) The heat-developable image recording material as described in the item (69), wherein said polymer is a styrene-butadiene copolymer.

(71) The heat-developable image recording material as described in the item (67), wherein the reducing agent contains:

a phenol compound; and

a compound that satisfies at least one of the conditions A and B:

A: the compound having a hydrogen bond-forming rate constant (Kf) of from 20 to 4,000,

B: the compound having one of a phosphoryl group in its molecule, and a structure represented by the following formula (II), (III), (IV) or (V):

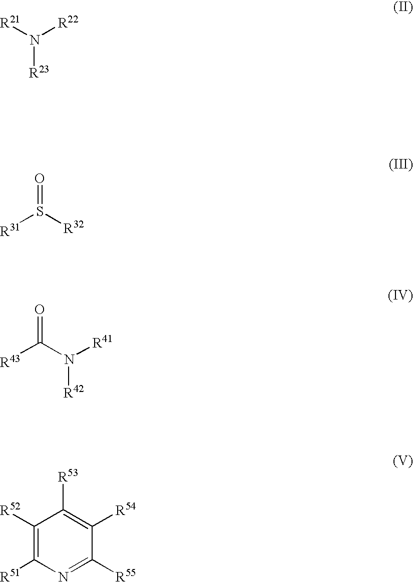

wherein R²¹ and R²² each independently represents an alkyl group; R²³ represents an alkyl group, an aryl group or a heterocyclic group; at least two of R²¹, R²² and R²³ may combine with each other to form a ring; R³¹ and R³² each independently represents an alkyl group, an aryl group or a heterocyclic group; R³¹ and R³² may combine with each other to form a ring; R⁴¹ and R⁴² each independently represents an alkyl group, an aryl group or a heterocyclic group; R⁴³ represents an alkyl group, an aryl group, a heterocyclic group or —N(R⁴⁴) (R⁴⁵); R⁴⁴ and R⁴⁵ each independently represents an alkyl group, an aryl group or a heterocyclic group; at least two of R⁴¹, R⁴², R⁴³, R⁴⁴ and R⁴⁵ may combine with each other to form a ring; R⁵¹, R⁵², R⁵³, R⁵⁴ and R⁵⁵ each independently represents a hydrogen atom or a substituent; at least two of R⁵¹, R⁵², R⁵³, R⁵⁴ and R⁵⁵ may combine with each other to form a ring.

(72) The heat-developable image recording material as described in the item (71), wherein said phenol compound is an o-polyphenol compound.

(73) The heat-developable image recording material as described in the item (72), wherein said o-polyphenol compound is a compound represented by the following formula (I):

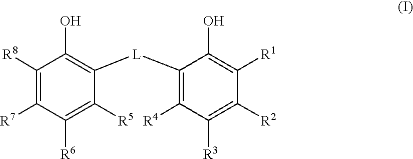

wherein R¹, R², R³, R⁴, R⁵, R⁶, R⁷ and R⁸ each independently represents a hydrogen atom or a group capable of being substituted on the benzene ring; L represents —S— or —CHR⁹—, and R⁹ represents a hydrogen atom or an alkyl group.

(74) The heat-developable image recording material as described in the item (73), wherein said compound represented by formula (I) is a compound where R², R⁴, R⁵ and R⁷ each is a hydrogen atom, R¹, R³, R⁶ and R³ each is independently an alkyl group, L is —CHR⁹—, and R⁹ is a hydrogen atom or an alkyl group.

(75) The heat-developable image recording material as described in the item (74), wherein R¹ and R⁸ each is independently a secondary or tertiary alkyl group.

(76) The heat-developable image recording material as described in the item (71), wherein said hydrogen bond-forming rate constant (Kf) is from 70 to 4,000.

(77) The heat-developable image recording material as described in the item (71), wherein said phenol compound is an o-polyphenol compound, and the compound that satisfies at least one of the conditions A and B is the compound having a phosphoryl group in its molecule.

(78) The heat-developable image recording material as described in the item (71), wherein said compound having a phosphoryl group in its molecule is a compound represented by the following formula (VI):

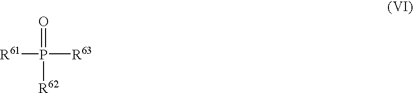

wherein R⁶¹, R⁶² and R⁶³ each independently represents an alkyl group, an aryl group, an aralkyl group, an alkoxy group, an aryloxy group, an amino group or a heterocyclic group.

### BRIEF DESCRIPTION OF THE DRAWING

FIG. 1 is a side view showing a construction of a heat developing machine used in Examples.

### Explanation of Numerical References

10: Heat-developable image recording material

11: Carrying-in roller

12: Carrying-out roller

13: Roller

14: Smooth surface

15: Heater

16: Guide plate

A: Pre-heating part

B: Heat development processing part

C: Slow cooling part

### DETAILED DESCRIPTION OF THE INVENTION

The present invention is described in detail below.

The heat-developable image recording material according to the first embodiment of the present invention comprises a support having on one surface thereof at least one photosensitive silver halide, a photo-insensitive organic silver salt (a non-photosensitive organic silver salt), a reducing agent for silver ion and a binder, wherein the binder contains a polymer having a sol formation ratio of 5 to 55 mass % with the sol moiety having a mass average molecular weight of 10,000 to 200,000 and a glass transition temperature of −30 to 50° C.

By virtue of the polymer specified in the sol formation ratio and in the mass average molecular weight and glass transition temperature of the sol, which is contained in the binder, the heat-developable image recording material according to the first embodiment of the present invention have both excellent image preservability and improved working brittleness.

<Binder>

The polymer as the binder is described in detail below.

The polymer for use in the present invention has a sol formation ratio of 5 to 55 mass %, preferably from 15 to 45 mass %, more preferably from 20 to 40 mass %. If the sol formation ratio is less than 5 mass %, the fusing component in the binder is increased and the binder is elevated in the maneuverability, giving rise to reduction in the image preservability.

The “sol formation ratio” as used herein means a value calculated as follows. In an aluminum foil Petri dish, 25 g of a polymer sample is weighed and dried at 60° C. for 2 hours using a blast drier. The obtained dry film is further dried at 120° C. for 0.5 hours and cut into a size of about 2×2 cm. This film was placed in a wire gauze cage (300 mesh) and left standing in 60 ml of tetrahydrofuran (THF) for 16 hours or more. The cage is taken out from THF and dried at 110° C. for 1 hour, the amount of sample (gel portion) remained in the cage is weighed and therefrom, a sol formation ratio (ratio of components other than gel portion) and a gelling ratio (ratio of gel portion) are calculated.

The sol formation ratio is preferably controlled by adjusting the amount added of a chain transfer agent which is described later. Specifically, the amount of the chain transfer agent added to the monomer is preferably from 0.01 to 5 mass %, more preferably from 0.1 to 3 mass %, based on the total mass of monomers.

In the polymer for use in the present invention, the sol moiety has a mass average molecular weight of 10,000 to 200,000, preferably from 30,000 to 150,000, more preferably from 40,000 to 100,000. If the mass average molecular weight of the sol is less than 10,000, the maneuverability of the binder is elevated and the image preservability decreases, whereas if it exceeds 200,000, the fusibility of the binder decreases and the work brittleness is worsened.

The mass average molecular weight in the sol moiety of the polymer for use in the present invention is determined by gel permeation chromatography.

In the polymer for use in the present invention, the sol moiety has a glass transition temperature of −30 to 50° C., preferably from 0 to 30° C., more preferably from 10 to 25° C. If the glass transition temperature of the sol is less than −30° C., the maneuverability of the binder is elevated and therefore, the image preservability decreases, whereas it exceeds 50° C., the fusibility of the binder decreases and the work brittleness is worsened.

This glass transition temperature (Tg) can be calculated by the following formula:

1/Tg=Σ(Xi/Tgi)

wherein assuming that the binder is obtained by the copolymerization of n monomers from i=1 to i=n, Xi is a mass partial ratio of the i-th monomer (ΣXi=1), Tgi is a glass transition temperature (absolute temperature) of a homopolymer of the i-th monomer, and Σ is the sum total of from i=1 to i=n. As for the glass transition temperature value (Tgi) of a homopolymer of each monomer, the values described in J. Brandrup and E. H. Immergut, Polymer Handbook, 3rd Ed., Wiley-Interscience (1989) are adopted.

The polymer for use in the present invention preferably has a particle size of 500 nm or less, more preferably 300 nm or less, still more preferably 200 nm or less. The kind of the polymer is not particularly limited and examples of the polymer which can be used include hydrophobic polymers such as acrylic resin, polyester resin, rubber-based resin (e.g., conjugated diene copolymer), polyurethane resin, vinyl chloride resin, vinyl acetate resin, vinylidene chloride resin and polyolefin resin, and copolymers thereof. Among these, preferred are acrylic resin, polyester resin, rubber-based resin (e.g., conjugated diene copolymer) and polyurethane resin, and more preferred are acrylic resin and rubber-based resin (e.g., conjugated diene copolymer).

In view of the photographic properties and film quality, the polymer for use in the heat-developable image recording material according to the first embodiment of the present invention preferably has at least a repeating unit corresponding to a crosslinkable monomer. Examples of the crosslinkable monomer include the following compounds.

Crosslinkable Monomer:

1,4-divinylbenzene, ethylene glycol diacrylate, ethylene glycol dimethacrylate, 1,4-cyclohexane diacrylate, pentaerythritol tetramethacrylate, pentaerythritol triacrylate, trimethylolpropane triacrylate, trimethylolethane triacrylate, dipentaerythritol pentamethacrylate, pentaerythritol hexaacrylate, 1,2,4-cyclohexane tetramethacrylate, methylenebisacrylamide and divinylsulfone.

Preferred examples of the polymer obtained by the copolymerization of at least a crosslinkable monomer include 1,4-divinylbenzene copolymer, ethylene glycol, diacrylate copolymer, ethylene glycol methacrylate copolymer and methylenebisacrylamide copolymer.

The heat-developable image recording material according to the second embodiment of the present invention comprises a support having on one surface thereof at least one photosensitive silver halide, a photo-insensitive organic silver salt, a reducing agent for silver ion and a binder, wherein the binder contains a polymer latex containing a chelate compound in an amount of 20 to 900 ppm based on the latex solution.

By virtue of the polymer specified in the chelate compound content, which is contained in the binder, the heat-developable image recording material according to the second embodiment of the present invention is excellent in both the image preservability and the coating property.

<Binder>

The polymer latex as the binder is described in detail below. The chelate compound contained in the polymer latex for use in the present invention is a compound capable of coordinating (chelating) a polyvalent ion such as metal ion (e.g., iron ion) or alkaline earth metal ion (e.g., calcium ion) and examples of the chelate compound which can be used include the compounds described in JP-B-6-8956 (the term “JP-B” as used herein means an “examined Japanese patent publication”), U.S. Pat. No. 5,053,322, JP-A-4-73645, JP-A-4-127145, JP-A-4-247073, JP-A-4-305572, JP-A-6-11805, JP-A-5-173312, JP-A-5-66527, JP-A-5-158195, JP-A-6-118580, JP-A-6-110168, JP-A-6-161054, JP-A-6-175299, JP-A-6-214352, JP-A-7-114161, JP-A-7-114154, JP-A-7-120894, JP-A-7-199433, JP-A-7-306504, JP-A-9-43792, JP-A-8-314090, JP-A-10-182571, JP-A-10-182570 and JP-A-11-190892.

Preferred examples of the chelate compound for use in the present invention include inorganic chelate compounds (e.g., sodium tripolyphosphate, sodium hexametaphosphate, sodium tetrapolyphosphsate), aminopolycarboxylic acid-based chelate compounds (e.g., nitrilotriacetate, ethylenediaminetetraacetate), organic phosphonic acid-based chelate compounds (e.g., compounds described in Research Disclosure, No. 18170, JP-A-52-102726, JP-A-53-42730, JP-A-56-97347, JP-A-54-121127, JP-A-55-4024, JP-A-55-4025, JP-A-55-29883, JP-A-55-126241, JP-A-55-65955, JP-A-55-65956, JP-A-57-179843, JP-A-54-61125 and West German Patent 1045373), polyphenol-based chelating agents and polyamine-based chelate compounds, with aminopolycarboxylic acid derivatives being more preferred.

Preferred examples of the aminopolycarboxylic acid derivative for use in the present invention include the compounds shown in the Table attached to EDTA (-Complexane no Kagaku (Chemistry of Complexane)-), Nankodo (1977). In these compounds, a part of the carboxyl groups may be substituted by an alkali metal salt such as sodium or potassium or by an ammonium salt. More preferred examples of the aminopolycarboxylic acid derivative include iminodiacetic acid, N-methyliminodiacetic acid, N-(2-aminoethyl)iminodiacetic acid, N-(carbamoylmethyl)iminodiacetic acid, nitrilotriacetic acid, ethylenediamine-N,N′-diacetic acid, ethylenediamine-N,N′-di-α-propionic acid, ethylenediamine-N,N′-di-β-propionic acid, N,N′-ethylene-bis(α-o-hydroxyphenyl)glycine, N,N′-di(2-hydroxybenzyl)ethylenediamine-N,N′-diacetic acid, ethylenediamine-N,N′-diacetic acid-N,N′-diacetohydroxamic acid, N-hydroxyethylethylenediamine-N,N′,N′-triacetic acid, ethylenediamine-N,N,N′,N′-tetraacetic acid, 1,2-propylenediamine-N,N,N′,N′-tetraacetic acid, d,1-2,3-diaminobutane-N,N,N′,N′-tetraacetic acid, meso-2,3-diaminobutane-N,N,N′,N′-tetraacetic acid, 1-phenylethylenediamine-N,N,N′,N′-tetraacetic acid, d,1-1,2-diphenylethylenediamine-N,N,N′,N′-tetraacetic acid, 1,4-diaminobutane-N,N,N′,N′-tetraacetic acid, trans-cyclobutane-1,2-diamine-N,N,N′,N′-tetraacetic acid, trans-cyclopentane-1,2-diamine-N,N,N′,N′-tetraactic acid, trans-cyclopentane-1,2-diamine-N,N,N′,N′-tetraacetic acid, trans-cyclohexane-1,2-diamine-N,N,N′,N′-tetraacetic acid, cis-cyclohexane-1,2-diamine-N,N,N′,N′-tetraacetic acid, cyclohexane-1,3-diamine-N,N,N′,N′-tetraacetic acid, cyclohexane-1,4-diamine-N,N,N′,N′-tetraacetic acid, O-phenylenediamine-N,N,N′,N′-tetraacetic acid, cis-1,4-diaminobutene-N,N,N′,N′-tetraacetic acid, trans-1,4-diaminobutene-N,N,N′,N′-tetraacetic acid, α,α′-diamino-o-xylene-N,N,N′,N′-tetraacetic acid, 2-hydroxy-1,3-propanediamine-N,N,N′,N′-tetraacetic acid, 2,2′-oxy-bis(ethyliminodiacetic acid), 2,2′-ethylenedioxy-bis(ethyliminodiacetic acid), ethylenediamine-N,N′-diacetic acid-N,N′-di-α-propionic acid, ethylenediamine-N,N′-diacetic acid-N,N′-di-β-propionic acid, ethylenediamine-N,N,N′,N′-tetrapropionic acid, diethylenetriamine-N,N,N′,N″,N′″-pentaacetic acid, triethylenetetramine-N,N,N′,N″,N′″,N′″-hexaacetic acid and 1,2,3-triaminopropane-N,N,N′,N″,N′″,N′″-hexaacetic acid. In these compounds, a part of the carboxyl groups may be substituted by an alkali metal salt such as sodium or potassium or by an ammonium salt.

The content of the chelate compound contained in the polymer latex for use in the present invention is from 20 to 900 ppm, preferably from 40 to 600 ppm, more preferably from 90 to 450 ppm, based on the polymer latex (including the chelate compound).

If the chelate compound concentration is less than 20 ppm, the metal ion mingling in the process of producing the polymer latex is insufficiently captured, as a result, the latex is reduced in the stability against aggregation and worsened in the coating property, whereas if it exceeds 900 ppm, the viscosity of the latex increases and this gives rise to deterioration in the coating property and further in the image preservability.

The chelate compound content is from 50 to 2,000 ppm, preferably from 100 to 1,500 ppm, more preferably from 200 to 1,000 ppm, based on the solid content of the polymer latex.

The chelate compound content as used hereinafter means a chelate compound content based on the polymer latex.

The glass transition temperature (Tg) can be calculated by the following formula:

1/Tg=Σ(Xi/Tgi)

wherein assuming that the binder is obtained by the copolymerization of n monomers from i=1 to i=n, Xi is a mass partial ratio of the i-th monomer (ΣXi=1), Tgi is a glass transition temperature (absolute temperature) of a homopolymer of the i-th monomer, and Σ is the sum total of from i=1 to i=n. As for the glass transition temperature value (Tgi) of a homopolymer of each monomer, the values described in J. Brandrup and E. H. Immergut, Polymer Handbook, 3rd Ed., Wiley-Interscience (1989) are adopted.

In view of the work brittleness and the image preservability, the binder for use in the present invention preferably has a glass transition temperature (Tg) of −20 to 80° C., more preferably from 0 to 70° C., still more preferably from 10 to 60° C. For the binder, a blend of two or more polymers may also be used and in this case, the weighted mean of Tg by taking account of the composition preferably falls within the above-described range. In the case where phase separation takes place or a core-shell structure is formed, each phase preferably has a Tg falling within the above-described range.

The polymer for use in the present invention preferably has a particle size of 500 nm or less, more preferably 300 nm or less, still more preferably 200 nm or less. The kind of the polymer is not particularly limited and examples of the polymer which can be used include hydrophobic polymers such as acrylic resin, polyester resin, rubber-based resin (e.g., conjugated diene copolymer), polyurethane resin, vinyl chloride resin, vinyl acetate resin, vinylidene chloride resin and polyolefin resin, and copolymers thereof.

Among these, preferred are acrylic resin, polyester resin, rubber-based resin (e.g., conjugated diene copolymer) and polyurethane resin, and more preferred are acrylic resin and rubber-based resin (e.g., conjugated diene copolymer).

The heat-developable image recording material according to the third embodiment of the present invention comprises a support having on one surface thereof at least one photosensitive silver halide, a photo-insensitive organic silver salt, a reducing agent capable of reducing silver ion, and a binder, wherein the layer containing the binder contains a polymer latex synthesized by adding a basic compound at the synthesis.

More specifically, the polymer latex for use in the heat-developable image recording material according to the third embodiment of the present invention is synthesized by the emulsion polymerization where a basic compound is allowed to be present. By this synthesis method, a polymer latex having excellent polymerization suitability, namely, having no precipitate or aggregate and having excellent dispersibility can be obtained. The heat-developable photosensitive material of the present invention using this polymer latex as the binder is excellent in both the coating property and the image preservability and can satisfy the object of the present invention.

<Binder>

The polymer latex constituting the binder is described in detail below.

The polymer latex for use in the present invention is characterized in that the emulsion polymerization for obtaining the polymer latex is performed in the presence of a basic compound. Therefore, the basic compound is first described and the polymer constituting the polymer latex is then described.

The basic compound for use in the emulsion polymerization may be an inorganic basic compound, an organic basic compound or an inorganic-organic mixed basic compound. Examples of the inorganic basic compound include hydroxides of alkali metal or alkaline earth metal except for beryllium in the periodic table. Among these, preferred are lithium hydroxide, sodium hydroxide, potassium hydroxide, calcium hydroxide, strontium hydroxide and barium hydroxide, and more preferred are lithium hydroxide, sodium hydroxide and potassium hydroxide.

Examples of the organic basic compound include ammonia, aliphatic amines (e.g., methylamine, ethylamine, diethylamine, triethylamine), aromatic amines (e.g., aniline, p-methoxyaniline), nitrogen-containing cyclic compounds (e.g., pyrrole, imidazole, pyridine, pyrazine, pyridazine, derivatives thereof). Among these, preferred are ammonia, methylamine, ethylamine, triethylamine and pyridine, and more preferred are ammonia, methylamine and triethylamine.

These basic compounds may be used individually or in combination of two or more thereof.

The basic compound for use in the present invention is used in an amount of 1.0 ×10⁻⁵ mmol or more, preferably 1.0×10⁻³ mmol or more, more preferably from 5.0×10⁻³ to 1.0 mmol, per g as the solid content of the polymer latex.

The polymer for use in the present invention preferably has a particle size of 500 nm or less, more preferably 300 nm or less, still more preferably 200 nm or less. The kind of the polymer is not particularly limited and examples of the polymer which can be used include hydrophobic polymers such as acrylic resin, polyester resin, rubber-based resin (e.g., conjugated diene copolymer), polyurethane resin, vinyl chloride resin, vinyl acetate resin, vinylidene chloride resin and polyolefin resin, and copolymers thereof. Among these, preferred are acrylic resin, polyester resin, rubber-based resin (e.g., conjugated diene copolymer) and polyurethane resin, and more preferred are acrylic resin and rubber-based resin (e.g., conjugated diene copolymer).

The heat-developable image recording material according to the fourth embodiment of the present invention comprises a support having on one surface thereof at least one photosensitive silver halide, a photo-insensitive organic silver salt, a reducing agent for silver ion and a binder, wherein the binder contains a polymer latex containing a heavy metal in an amount of 1 ppm or less based on the latex.

By virtue of the latex reduced in the heavy metal content to a specific amount or less, the heat-developable image recording material according to the fourth embodiment of the present invention has excellent image preservability.

<Binder>

The polymer latex used as the binder is described in detail below.

The heavy metal contained in the polymer latex for use in the present invention is an element having a density of 4×10⁻³ g/liter or more. The heavy metal is preferably an element belonging to Groups 3 to 12 of the periodic table of elements and more preferably iron, chromium, nickel, molybdenum, titanium, copper or zinc. The iron, chromium, nickel, molybdenum and titanium are particularly preferred because these are contained in a stainless steel generally used for the latex production equipment and have high possibility of mingling into the latex as compared with other heavy metals.

The content of heavy metal contained in the polymer latex for use in the present invention is 1 ppm or less, preferably 0.5 ppm or less, more preferably 0.1 ppm or less, based on the latex. If the heavy metal content based on the latex exceeds 1 ppm, the image preservability is worsened.

Also, the heavy metal content is preferably 2.2 ppm or less, more preferably 1.1 ppm or less, still more preferably 0.2 ppm or less, based on the solid content of the polymer latex.

Hereinafter, the heavy metal content is a heavy metal content based on the polymer latex.

The content of heavy metal contained in the polymer latex for use in the present invention can be measured by atomic absorption method. A representative example of the measurement conditions is shown below.

Measurement Conditions:

Measuring Apparatus:

HITACHI Z-8000, AAS-GFA method (standard addition method)

Concentration of Sample:

1/20 dilution (1 g is sampled and made to 20 g by the addition of water)

Amount Injected:

| | |
|---|---|
| Sample diluted solution | 10 μl |
| Standard solution (diluted with water) | 10 μl |

Cuvette:

Pyro B-Type Cuvette

The glass transition temperature (Tg) can be calculated by the following formula:

1/Tg=Σ(Xi/Tgi)

wherein assuming that the binder is obtained by the copolymerization of n monomers from i=1 to i=n, Xi is a mass partial ratio of the i-th monomer (ΣXi=1), Tgi is a glass transition temperature (absolute temperature) of a homopolymer of the i-th monomer, and Σ is the sum total of from i=1 to i=n. As for the glass transition temperature value (Tgi) of a homopolymer of each monomer, the values described in J. Brandrup and E. H. Immergut, Polymer Handbook, 3rd Ed., Wiley-Interscience (1989) are adopted.

In view of the work brittleness and the image preservability, the binder for use in the present invention preferably has a glass transition temperature (Tg) of −20 to 80° C., more preferably from 0 to 70° C., still more preferably from 10 to 60° C. For the binder, a blend of two or more polymers may also be used and in this case, the weighted mean of Tg by taking account of the composition preferably falls within the above-described range. In the case where phase separation takes place or a core-shell structure is formed, each phase preferably has a Tg falling within the above-described range.

The polymer for use in the present invention preferably has a particle size of 500 nm or less, more preferably 300 nm or less, still more preferably 200 nm or less. The kind of the polymer is not particularly limited and examples of the polymer which can be used include hydrophobic polymers such as acrylic resin, polyester resin, rubber-based resin (e.g., conjugated diene copolymer), polyurethane resin, vinyl chloride resin, vinyl acetate resin, vinylidene chloride resin and polyolefin resin, and copolymers thereof.

Among these, preferred are acrylic resin, polyester resin, rubber-based resin (e.g., conjugated diene copolymer) and polyurethane resin, and more preferred are acrylic resin and rubber-based resin (e.g., conjugated diene copolymer).

The heat-developable image recording material according to the fifth embodiment of the present invention comprises a support having on one surface thereof at least one photosensitive silver halide, a photo-insensitive organic silver salt, a reducing agent for silver ion and a binder, wherein the binder contains a latex and in the dispersed particles of the latex, the ratio (dv/dn) of the volume weighted mean diameter (dv) to the number average diameter (dn) is from 1.0 to 1.10, and/or wherein the binder contains a latex and in the latex, the ratio (N_{U80}/Nₐₗₗ) between the number of small-size particles having a diameter less than 80% of the number average diameter (dn) and the number of all particles is 0.1 or less.

By containing the binder latex specified in the average particle diameter or in the distribution in the number of particles (dv/dn or N_{U80}/Nₐₗₗ), the heat-developable image recording material according to the fifth embodiment of the present invention has excellent homogeneity of the coated surface.

<Binder>

The latex used as the binder is described in detail below.

In the dispersed particles of the latex for use in the present invention, the ratio (dv/dn) of the volume weighted mean diameter (dv) to the number average diameter (dn) is from 1.0 to 1.10, preferably from 1.0 to 1.05, more preferably from 1.0 to 1.02. The dv/dn cannot be theoretically less than 1.0 and if it exceeds 1.10, the viscosity greatly departs from the viscosity range estimated from the average particle size and a homogeneous surface state cannot be obtained.

In the latex for use in the present invention, the ratio (N_{U80}/Nₐₗₗ) between the number of small-size particles having a diameter less than 80% of the number average diameter (dn) and the number of all particles is 0.1 or less, preferably 0.08 or less, more preferably 0.05 or less. If N_{U80}/Nₐₗₗ exceeds 0.1, the viscosity greatly departs from the viscosity range estimated from the average particle size and a homogeneous surface state cannot be obtained.

The number average diameter (dn), the volume weighted mean diameter (dv) and the ratio (N_{U80}/Nₐₗₗ) between the number of small-size particles having a diameter less than 80% of the number average diameter (dn) and the number of all particles each is a value determined as follows.

The particle size of the latex (the particle diameter of dispersed particles) can be analyzed by a direct observation method using a low-temperature transmission-type electron microscope. In the direct observation of the latex particle size using a transmission-type electron microscope, a latex dispersion solution 20-fold diluted with water is placed on a mesh for the observation with an electron microscope, frozen by dipping the solution in liquid nitrogen and observed through an electron microscope at a liquid nitrogen temperature. The obtained photograph of particles is data-processed by an image processing soft (Win ROOF, produced by Mitsuya Shoji) and from the calculated number average particle size and volume average particle size, the ratio dv/dn is determined by an arithmetic operation. Also, from the number accumulating totals with respect to the particle size obtained at the data processing, the number accumulating total value at the particle size corresponding to 80% of the number average molecular weight (dn) is determined, Using these values, the ratio N_{U80}/Nₐₗₗ is obtained.

The particle size distribution is preferably controlled by adjusting the amount of a surface active agent (which is described later) added at the synthesis of a polymer which works out to dispersion particles of the latex, or at the formation of a latex by dispersing the polymer in a solvent. More specifically, the amount of the surface active agent added to the monomer is preferably from 0.05 to 10 mass %, more preferably from 0.1 to 5 mass %, based on the total amount of monomers.

The latex for use in the present invention has a number average particle size of 30 to 300 nm, preferably from 40 to 250 nm, more preferably from 50 to 200 nm. If the number average particle size is less than 30 nm, the viscosity of the coating solution extremely increases and homogeneous coating cannot be obtained, whereas if the number average particle size exceeds 300 nm, the coating solution suffers from bad stability and causes aggregation or precipitation and a homogeneous film cannot be obtained.

In the polymer of the latex for use in the present invention, the sol moiety preferably has a glass transition temperature of −30 to 50° C., more preferably from 0 to 30° C., still more preferably from 10 to 25° C. If the glass transition temperature of the sol moiety is less than −30° C., the maneuverability of the binder is elevated and therefore, the image preservability decreases, whereas the glass transition temperature of the sol moiety exceeds 50° C., the fusibility of the binder decreases and the work brittleness is worsened.

This glass transition temperature (Tg) can be calculated by the following formula:

1/Tg=Σ(Xi/Tgi)

wherein assuming that the binder is a latex comprising a dispersion medium having dispersed therein a copolymer of n monomers from i=1 to i=n, Xi is a mass partial ratio of the i-th monomer (ΣXi=1), Tgi is a glass transition temperature (absolute temperature) of a homopolymer of the i-th monomer, and Σ is the sum total of from i=1 to i=n. As for the glass transition temperature value (Tgi) of a homopolymer of each monomer, the values described in J. Brandrup and E. H. Immergut, Polymer Handbook, 3rd Ed., Wiley-Interscience (1989) are adopted.

The latex for use in the present invention is not particularly limited and examples of the latex which can be used include hydrophobic polymers such as acrylic resin, polyester resin, rubber-based resin (e.g., conjugated diene copolymer), polyurethane resin, vinyl chloride resin, vinyl acetate resin, vinylidene chloride resin and polyolefin resin, and copolymers thereof. Among these, acrylic resin, polyester resin, rubber-based resin (e.g., conjugated diene copolymer) and polyurethane resin are preferred as the polymer which becomes dispersed particles of the latex, with acrylic resin and rubber-based resin (e.g., conjugated diene copolymer) being more preferred.

In particular, the polymer for use in the heat-developable image recording materials according to the first to fifth embodiments of the present invention is preferably a homopolymer or a copolymer of a monomer selected from the following monomer groups (a) to (j) and these monomers may be used individually or may be freely combined. In view of the photographic properties and film quality, the polymer is more preferably a polymer obtained by the copolymerization of a conjugated diene. The monomer unit which can be used is not particularly limited and any monomer unit may be used insofar as it can be polymerized by a normal radical polymerization or ion polymerization method.

Monomer Groups (a) to (j)

(a) Conjugated Diene:

1,3-Butadiene, isoprene, 1,3-pentadiene, 2-ethyl-1,3-butadiene, 2-n-propyl-1,3-butadiene, 2,3-dimethyl-1,3-butadiene, 2-methyl-1,3-butadiene, 1-phenyl-1,3-butadiene, 1-α-naphthyl-1,3-butadiene, 1-β-naphthyl-1,3-butadiene, 2-chloro-1,3-butadiene, 1-bromo-1,3-butadiene, 1-chloro-1,3-butadiene, 2-fluoro-1,3-butadiene, 2,3-dichloro-1,3-butadiene, 1,1,2-trichloro-1,3-butadiene, 2-cyano-1,3-butadiene, cyclopentadiene, etc.

(b) Olefin:

Ethylene, propylene, vinyl chloride, vinylidene chloride, 6-hydroxy-1-hexene, 4-pentenoic acid, methyl 8-nonenoate, vinylsulfonic acid, trimethylvinylsilane, trimethoxyvinylsilane, 1,4-divinylcyclohexane, 1,2,5-trivinylcyclohexane, etc.

(c)α,β-Unsaturated Carboxylic Acid and Salts thereof:

Acrylic acid, methacrylic acid, itaconic acid, maleic acid, sodium acrylate, ammonium methacrylate, potassium itaconate, etc.

(d) α,β-Unsaturated Carboxylic Acid Esters:

Alkyl acrylate (e.g., methyl acrylate, ethyl acrylate, butyl acrylate, cyclohexyl acrylate, 2-ethylhexyl acrylate, dodecyl acrylate), substituted alkyl acrylate (e.g., 2-chloroethyl acrylate, benzyl acrylate, 2-cyanoethyl acrylate), alkyl methacrylate (e.g., methyl methacrylate, butyl methacrylate, 2-ethylhexyl methacrylate, dodecyl methacrylate), substituted alkyl methacrylate (e.g., 2-hydroxyethyl methacrylate, glycidyl methacrylate, glycerol monomethacrylate, 2-acetoxyethyl methacrylate, tetra-hydrofurfuryl methacrylate, 2-methoxyethyl methacrylate, polypropylene glycol monomethacrylate (where the addition molar number of polyoxypropylene is from 2 to 100), 3-N,N-dimethylaminopropyl methacrylate, chloro-3-N,N,N-trimethylammoniopropyl methacrylate, 2-carboxyethyl methacrylate, 3-sulfopropyl methacrylate, 4-oxysulfobutyl methacrylate, 3-trimethoxysilylpropyl methacrylate, allyl methacrylate, 2-isocyanatoethyl methacrylate), unsaturated dicarboxylic acid derivative (e.g., monobutyl maleate, dimethyl maleate, monomethyl itaconate, dibutyl itaconate), polyfunctional esters (e.g., ethylene glycol diacrylate, ethylene glycol dimethacrylate, 1,4-cyclohexane diacrylate, pentaerythritol tetramethacrylate, pentaerythritol triacrylate, trimethylolpropane triacrylate, trimethylolethane triacrylate, dipentaerythritol pentamethacrylate, pentaerythritol hexaacrylate, 1,2,4-cyclohexane tetramethacrylate), etc.

(e) β-Unsaturated Carboxylic Acid Amides:

Acrylamide, methacrylamide, N-methylacrylamide, N,N-dimethylacrylamide, N-methyl-N-hydroxyethylacrylamide, N-tert-butylacrylamide, N-tert-octylmethacrylamide, N-cyclohexylacrylamide, N-phenylacrylamide, N-(2-acetoacetoxyethyl)acrylamide, N-acryloylmorpholine, diacetone acrylamide, itaconic acid diamide, N-methylmaleimide, 2-acrylamido-methylpropanesulfonic acid, methylenebisacrylamide, dimethacryloylpiperazine, etc.

(f) Unsaturated Nitriles:

Acrylonitrile, methacrylonitrile, etc.

(g) Styrene and Derivatives thereof:

Styrene, vinyl toluene, p-tert-butylstyrene, vinylbenzoic acid, methyl vinylbenzoate, α-methylstyrene, p-chloromethylstyrene, vinyl naphthalene, β-hydroxymethylstyrene, sodium p-styrenesulfonate, potassium p-styrenesulfinate, β-aminomethylstyrene, 1,4-divinylbenzene, etc.

(h) Vinyl Ethers:

Methyl vinyl ether, butyl vinyl ether, methoxyethyl vinyl ether, etc.

(i) Vinyl Esters:

Vinyl acetate, vinyl propionate, vinyl benzoate, vinyl salicylate, vinyl chloroacetate, etc.

(j) Other Polymerizable Monomers:

N-Vinylimidazole, 4-vinylpyridine, N-vinylpyrrolidone, 2-vinyloxazoline, 2-isopropenyloxazoline, divinylsulfone, etc.

Preferred examples of the polymer obtained by the copolymerization of at least a conjugated diene include styrene-butadiene copolymers (e.g., butadiene-styrene block copolymer, styrene-butadiene-styrene block copolymer), styrene-isoprene copolymers (e.g., styrene-isoprene random copolymer, styrene-isoprene block copolymer), ethylene-propylene-diene copolymers (examples of the diene monomer includes 1,4-hexadiene, dicyclopentadiene and ethylidene norbornene), acrylonitrile-butadiene copolymers, isobutylene-isoprene copolymers, butadiene-acrylic acid ester copolymers (examples of the acrylic acid ester include ethyl acrylate and butyl acrylate) and butadiene-acrylic acid ester-acrylonitrile copolymers (examples of the acrylic acid ester which can be used are the same as above). Among these, styrene-butadiene copolymers are most preferred.

Specific examples (Compounds (P1-1) to (P1-24)) of the polymer for use in the first embodiment of the present invention are set forth below. The molecular weight is a mass average molecular weight and in the case of a polyfunctional monomer, since the concept of the molecular weight cannot be applied, the molecular weight is not shown. In the chemical formulae, x, y, z and z′ attached to the parentheses in the polymer main chain portion represent a mass ratio of the polymer composition and the sum total of x, y, z and z′ is 100%. Also in the chemical formulae, the numerical value attached on the right side of parentheses in the polymer side chain portion represents a polymerization degree. Tg represents a glass transition temperature of a dry film obtained from the polymer. The present invention is not limited to the following specific examples.

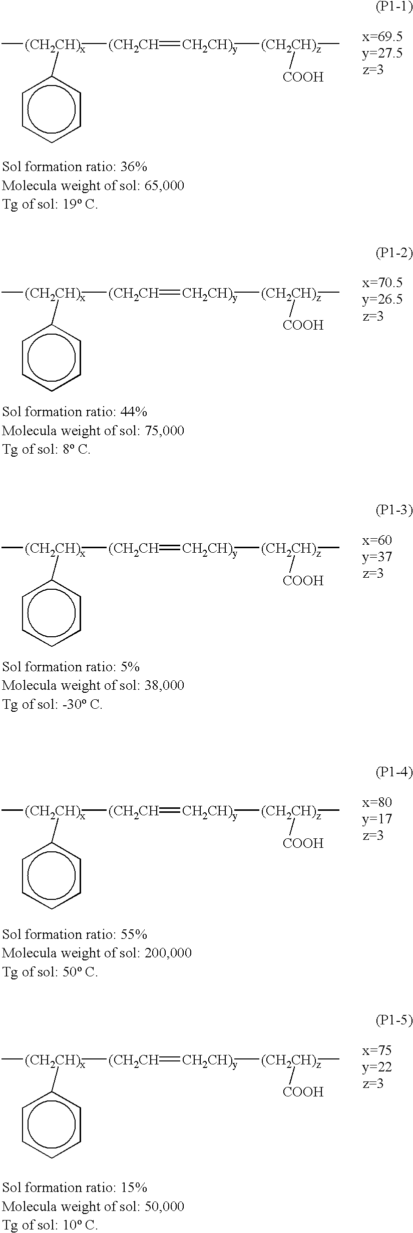

The polymer for use in the present invention can be easily obtained, for example, by an emulsion polymerization method. In performing the emulsion polymerization, for example, water or a mixed solvent of water and an organic solvent miscible with water (e.g., methanol, ethanol, acetone) is used as a dispersion medium and a monomer mixture in an amount of from 5 to 40 mass % based on the dispersion medium, a polymerization initiator in an amount of 0.05 to 5 mass % based on the monomer(s) and an emulsifier in an amount of 0.1 to 20 mass % based on the monomer(s) are polymerized under stirring at a temperature of approximately from 30 to 100° C., preferably from 60 to 90° C., for 3 to 8 hours. Various conditions such as dispersion medium, concentration of monomer, amount of polymerization initiator, amount of emulsifier, amount of dispersant, reaction temperature and method for addition of monomer are appropriately selected by taking account of the kind of monomer used. If desired, a dispersant is preferably used.

The chain transfer agent for use in the present invention is preferably selected from the compounds described in Polymer Handbook, 3rd Ed., Wiley-Interscience (1989). A sulfur compound is more preferred because it has high chain transfer function and can serve by the addition in a small amount. A hydrophobic mercaptan-type chain transfer agent such as tert-dodecylmercaptan and n-dodecylmercaptan is still more preferred.

The initiator used in the emulsion polymerization may be sufficient if it is water-soluble and has a radical generating ability, but preferred examples thereof include persulfates and water-soluble azo compounds. Preferred examples of the persulfate include ammonium persulfate, sodium persulfate and potassium persulfate and preferred examples of the water-soluble azo compound include azobiscyanovaleric acid.

The dispersant for use in the emulsion polymerization may be any of an anionic surface active agent, a nonionic surface active agent, a cationic surface active agent and an amphoteric surface active agent, however, in view of the dispersibility, an anionic surface active agent is preferred.

In addition to the compounds described above, additives described, for example, in Gosei Gomu Handbook (Handbook of Synthetic Rubber) may also be used in the emulsion polymerization, such as electrolyte, stabilizer, thickener, defoaming agent, antioxidant, vulcanizing agent, chelating agent, antifreezing agent, gelling agent and vulcanization accelerator.

In general, the emulsion polymerization can be performed according to the methods described in the following publications: Taira Okuda and Hiroshi Inagaki (compilers), Gosei Jushi Emulsion (Synthetic Resin Emulsion), Kobunshi Kankokai (1978), Takaaki Sugimura, Yasuo Kataoka, Souichi Suzuki and Keiji Kasahara (compilers), Gosei Latex no Oyo (Application of Synthetic Latex), Kobunshi Kankokai (1993), and Soichi Muroi, Gosei Latex no Kagaku (Chemistry of Synthetic Latex), Kobunshi Kankokai (1993).

Synthesis examples of the polymer for use in the present invention are set forth below, but the present invention should not be construed as being limited thereto. Other compounds can also be similarly synthesized and reduced in the halogen ion content.

### SYNTHESIS EXAMPLE 1-1

Synthesis of Compound P1-1

Into the polymerization furnace of a gas monomer reaction apparatus (Model TAS-2J, manufactured by Taiatsu Techno Corp.), 296.8 g of distilled water, 9.9 g of a surface active agent (prepared by purifying Sandet BL (produced by Sanyo Chemical Industries, Ltd.) using Micro Acilyzer G3 (membrane: AC110-800) produced by Asahi Chemical Industry Co., Ltd. until change in the electric conductivity did not occur; solid content: 30.4%), 15 ml of 1 mol/liter NaOH, 208.5 g of styrene, 9.0 g of acrylic acid and 2.4 g of tert-dodecylmercaptan were charged. The reactor was closed and stirred at a stirring rate of 200 rpm. After an operation of degassing the reactor by a vacuum pump and purging it with nitrogen gas was repeated several times, 82.5 g of 1,3-butadiene was charged under pressure and the inner temperature was elevated to 60° C. Thereto, a solution prepared by dissolving 1.5 g of sodium persulfate in 40 ml of water was added and the mixture was stirred for 5 hours. The temperature was further elevated to 90° C. and the mixture was stirred for 3 hours. After the completion of reaction, the inner temperature was lowered to room temperature and the resulting polymer was filtered through a paper towel to obtain 620 g of Compound P1-1 (solid content: 45%, particle size: 110 nm, sol formation ratio: 36%, gelling ratio: 64%, mass molecular weight of sol: 65,000, Tg of sol: 19° C.).

### SYNTHESIS EXAMPLE 1-2

Synthesis of Compound P1-2

Into the polymerization furnace of a gas monomer reaction apparatus (Model TAS-2J, manufactured by Taiatsu Techno Corp.), 287 g of distilled water, 19.7 g of a surface active agent (prepared by purifying Sandet BL (produced by Sanyo Chemical Industries, Ltd.) using Micro Acilyzer G3 (membrane: AC110-800) produced by Asahi Chemical Industry Co., Ltd. until change in the electric conductivity did not occur; solid content: 30.4%), 15 ml of 1 mol/liter NaOH, 0.06 g of tetrasodium ethylenediaminetetraacetate, 211.5 g of styrene, 9.0 g of acrylic acid and 2.4 g of tert-dodecylmercaptan were charged. The reactor was closed and stirred at a stirring rate of 200 rpm. After an operation of degassing the reactor by a vacuum pump and purging it with nitrogen gas was repeated several times, 79.5 g of 1,3-butadiene was charged under pressure and the inner temperature was elevated to 60° C. Thereto, a solution prepared by dissolving 0.6 g of ammonium persulfate in 40 ml of water was added and the mixture was stirred for 5 hours. The temperature was further elevated to 90° C. and the mixture was stirred for 3 hours. After the completion of reaction, the inner temperature was lowered to room temperature and the resulting polymer was filtered through a paper towel to obtain 615 g of Compound P1-2 (solid content: 45%, particle size: 76 nm, sol formation ratio: 44%, gelling ratio: 56%, mass average molecular weight of sol: 75,000, Tg of sol: 8° C.).

### SYNTHESIS EXAMPLE 1-3

Synthesis of Compound P1-20

Into a glass-made three-neck flask equipped with a stirrer and a condenser, 297 g of distilled water, 9.9 g of a surface active agent (prepared by purifying Sandet BL (produced by Sanyo Chemical Industries, Ltd.) using Micro Acilyzer G3 (membrane: AC110-800) produced by Asahi Chemical Industry Co., Ltd. until change in the electric conductivity did not occur; solid content: 30.4%), 15 ml of 1 mol/liter NaOH, 135 g of methyl methacrylate, 150 g of butyl acrylate, 12 g of sodium styrenesulfonate, 3 g of methylbisacrylamide and 2.4 g of tert-dodecylmercaptan were charged. The mixture was stirred at a stirring rate of 200 rpm in a nitrogen stream and the inner temperature was elevated to 60° C. Thereto, a solution prepared by dissolving 0.6 g of sodium persulfate in 40 ml of water was added and the mixture was stirred for 5 hours. The temperature was further elevated to 90° C. and the mixture was stirred for 3 hours. After the completion of reaction, the inner temperature was lowered to room temperature and the resulting polymer was filtered through a paper towel to obtain 610 g of Compound P1-20 (solid content: 45%, particle size: 93 nm, sol formation ratio: 30%, gelling ratio: 70%, mass average molecular weight of sol: 41,000, Tg of sol: 16° C.).

Specific examples (Compounds (P2-1) to (P2-24)) of the polymer for use in the second embodiment of the present invention are set forth below. The molecular weight is a mass average molecular weight and in the case of a polyfunctional monomer, since the concept of the molecular weight cannot be applied, the molecular weight is not shown.

In the chemical formulae, x, y, z and z′ attached to the parentheses in the polymer main chain portion represent a mass ratio of the polymer composition and the sum total of x, y, z and z′ is 100%. Also in the chemical formulae, the numerical value attached on the right side of parentheses in the polymer side chain portion represents a polymerization degree.

Tg represents a glass transition temperature of a dry film obtained from the polymer. The chelate compound is one used in the polymerization and the concentration in the parentheses following the name of the chelate compound is a concentration of chelate compound contained in the polymer latex, which is determined by high-performance liquid chromatography. The present invention is not limited to the following specific examples.

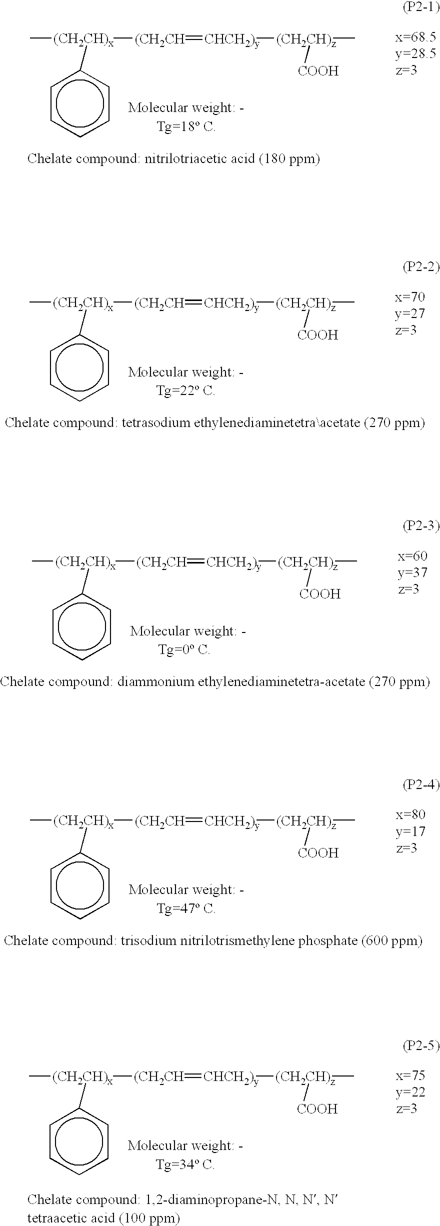

Chelate compound: iminodiacetic acid (900 ppm)

The polymer for use in the present invention can be easily obtained, for example, by an emulsion polymerization method. In performing the emulsion polymerization, for example, water or a mixed solvent of water and an organic solvent miscible with water (e.g., methanol, ethanol, acetone) is used as a dispersion medium and a monomer mixture in an amount of from 5 to 40 mass % based on the dispersion medium, a polymerization initiator in an amount of 0.05 to 5 mass % based on the monomer(s) and an emulsifier in an amount of 0.1 to 20 mass % based on the monomer(s) are polymerized under stirring at a temperature of approximately from 30 to 100° C., preferably from 60 to 90° C., for 3 to 8 hours.

Various conditions such as dispersion medium, concentration of monomer, amount of polymerization initiator, amount of emulsifier, amount of dispersant, reaction temperature and method for addition of monomer are appropriately selected by taking account of the kind of monomer used.

If desired, a dispersant is preferably used.

The chain transfer agent which can be used in the present invention is preferably selected from the compounds described in Polymer Handbook, 3rd Ed., Wiley-Interscience (1989). A sulfur compound is more preferred because it has high chain transfer function and can serve by the addition in a small amount. A hydrophobic mercaptan-type chain transfer agent such as tert-dodecylmeraptan and n-dodecylmercaptan is still more preferred.

The initiator used in the emulsion polymerization may be sufficient if it is water-soluble and has a radical generating ability, but preferred examples thereof include persulfates and water-soluble azo compounds. Among these, more preferred are ammonium persulfate, sodium persulfate, potassium persulfate and azobiscyanovaleric acid.

The dispersant for use in the emulsion polymerization may be any of an anionic surface active agent, a nonionic surface active agent, a cationic surface active agent and an amphoteric surface active agent, however, in view of the dispersibility, an anionic surface active agent is preferred.

In addition to the compounds described above, additives described, for example, in Gosei Gomu Handbook (Handbook of Synthetic Rubber) may also be used in the emulsion polymerization, such as electrolyte, stabilizer, thickener, defoaming agent, antioxidant, vulcanizing agent, antifreezing agent, gelling agent and vulcanization accelerator.

In general, the emulsion polymerization can be performed according to the methods described in the following publications: Taira Okuda and Hiroshi Inagaki (compilers), Gosei Jushi Emulsion (Synthetic Resin Emulsion), Kobunshi Kankokai (1978), Takaaki Sugimura, Yasuo Kataoka, Souichi Suzuki and Keiji Kasahara (compilers), Gosei Latex no Oyo (Application of Synthetic Latex), Kobunshi Kankokai (1993), and Soichi Muroi, Gosei Latex no Kagaku (Chemistry of Synthetic Latex), Kobunshi Kankokai (1993).

Synthesis examples of the polymer for use in the present invention are set forth below, but the present invention should not be construed as being limited thereto. Other compounds can also be similarly synthesized.

### SYNTHESIS EXAMPLE 2-1

Synthesis of Compound P2-1

Into the polymerization furnace of a gas monomer reaction apparatus (Model TAS-2J, manufactured by Taiatsu Techno Corp.), 296.8 g of distilled water, 9.9 g of a surface active agent (prepared by purifying Sandet BL (produced by Sanyo Chemical Industries, Ltd.) using Micro Acilyzer G3 (membrane: AC110-800) produced by Asahi Chemical Industry Co., Ltd. until change in the electric conductivity did not occur; solid content: 30.4%), 20 ml of 1 mol/liter NaOH, 0.12 g of nitrilotriacetic acid, 205.5 g of styrene, 9.0 g of acrylic acid and 2.4 g of tert-dodecylmercaptan were charged. The reactor was closed and stirred at a stirring rate of 200 rpm. After an operation of degassing the reactor by a vacuum pump and purging it with nitrogen gas was repeated several times, 85.5 g of 1,3-butadiene was charged under pressure and the inner temperature was elevated to 60° C. Thereto, a solution prepared by dissolving 1.5 g of sodium persulfate in 40 ml of water was added and the mixture was stirred for 5 hours. The temperature was further elevated to 90° C. and the mixture was stirred for 3 hours. After the completion of reaction, the inner temperature was lowered to room temperature and the resulting polymer was filtered through a paper towel to obtain 625 g of Compound P2-1 (solid content: 45%, particle size: 105 nm, Tg: 18° C.). The concentration of the chelating agent was measured by high-performance liquid chromatography and found to be 180 ppm.

### SYNTHESIS EXAMPLE 2-2

Synthesis of Compound P2-2

Into the polymerization furnace of a gas monomer reaction apparatus (Model TAS-2J, manufactured by Taiatsu Techno Corp.), 287 g of distilled water, 19.7 g of a surface active agent (prepared by purifying Sandet BL (produced by Sanyo Chemical Industries, Ltd.) using Micro Acilyzer G3 (membrane: AC110-800) produced by Asahi Chemical Industry Co., Ltd. until change in the electric conductivity did not occur; solid content: 30.4%), 15 ml of 1 mol/liter NaOH, 0.18 g of tetrasodium ethylenediaminetetraacetate, 210 g of styrene, 9.0 g of acrylic acid and 2.4 g of tert-dodecylmercaptan were charged. The reactor was closed and stirred at a stirring rate of 200 rpm. After an operation of degassing the reactor by a vacuum pump and purging it with nitrogen gas was repeated several times, 81 g of 1,3-butadiene was charged under pressure and the inner temperature was elevated to 60° C. Thereto, a solution prepared by dissolving 0.6 g of ammonium persulfate in 40 ml of water was added and the mixture was stirred for 5 hours. The temperature was further elevated to 90° C. and the mixture was stirred for 3 hours. After the completion of reaction, the inner temperature was lowered to room temperature and the resulting polymer was filtered through a paper towel to obtain 618 g of Compound P2-2 (solid content: 45%, particle size: 95 nm, Tg: 22° C.). The concentration of the chelating agent was measured by high-performance liquid chromatography and found to be 270 ppm.

### SYNTHESIS EXAMPLE 2-3

Synthesis of Compound P1-20

Into a glass-made three-neck flask equipped with a stirrer and a condenser, 297 g of distilled water, 9.9 g of a surface active agent (prepared by purifying Sandet BL (produced by Sanyo Chemical Industries, Ltd.) using Micro Acilyzer G3 (membrane: AC110-800) produced by Asahi Chemical Industry Co., Ltd. until change in the electric conductivity did not occur; solid content: 30.4%), 15 ml of 1 mol/liter NaOH, 0.3 g of triethylenetetraminehexaacetic acid, 135 g of methyl methacrylate, 150 g of butyl acrylate, 12 g of sodium styrenesulfonate, 3 g of methylbisacrylamide and 2.4 g of tert-dodecylmercaptan were charged. The mixture was stirred at a stirring rate of 200 rpm in a nitrogen stream and the inner temperature was elevated to 60° C. Thereto, a solution prepared by dissolving 0.6 g of sodium persulfate in 40 ml of water was added and the mixture was stirred for 5 hours. The temperature was further elevated to 90° C. and the mixture was stirred for 3 hours. After the completion of reaction, the inner temperature was lowered to room temperature and the resulting polymer was filtered through a paper towel to obtain 622 g of Compound P2-20 (solid content: 45%, particle size: 98 nm, mass average molecular weight: 100,000, Tg: 5° C.). The concentration of the chelating agent was measured by high-performance liquid chromatography and found to be 450 ppm.

Specific examples (Compounds (P3-1) to (P3-21)) of the polymer for use in the third embodiment of the present invention are set forth below. The molecular weight is a mass average molecular weight and in the case of a polyfunctional monomer, since the concept of the molecular weight cannot be applied, the molecular weight is not shown. In the chemical formulae, x, y, z and z′ attached to the parentheses in the polymer main chain portion represent a mass ratio of the polymer composition and the sum total of x, y, z and z′ is 100%. Tg represents a glass transition temperature of a dry film obtained from the polymer. The present invention is not limited to the following specific examples.

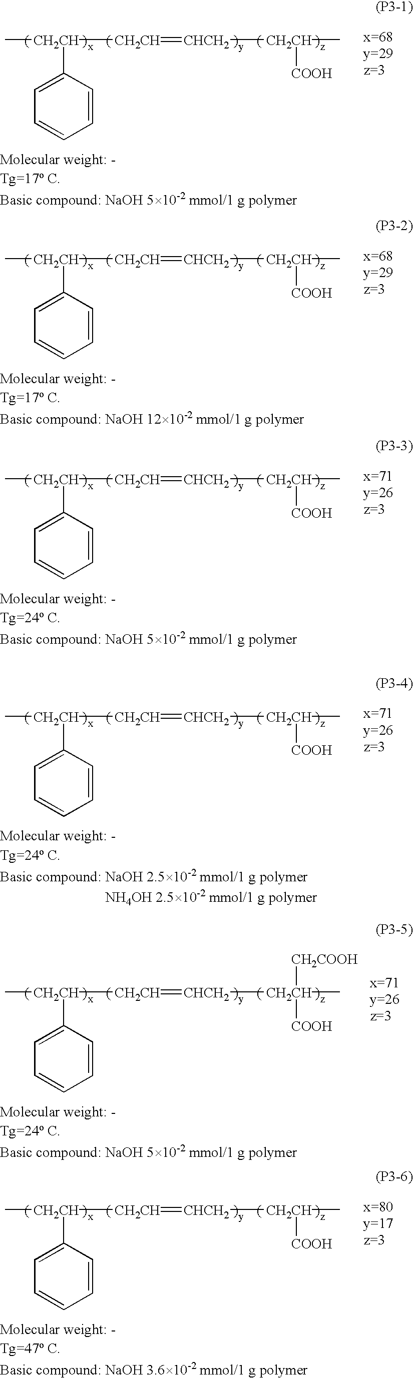

The polymer for use in the present invention is preferably reduced in the kind and amount of additives used for synthesis as much as possible so as to reduce the halogen content. In particular, additives containing halogen ion are preferably used by reducing the amount used or after the purification. Examples of the additive containing halogen ion include a polymerization emulsifier. In particular, these additives are preferably desalted by the electrodialysis using an ion exchange membrane before use for the polymerization.

The polymer for use in the present invention can be easily obtained, for example, by an emulsion polymerization method. In performing the emulsion polymerization, for example, water or a mixed solvent of water and an organic solvent miscible with water (e.g., methanol, ethanol, acetone) is used as a dispersion medium and a monomer mixture in an amount of from 5 to 40 mass % based on the dispersion medium, a polymerization initiator in an amount of 0.05 to 5 mass % based on the monomer(s) and an emulsifier in an amount of 0.1 to 20 mass % based on the monomer(s) are polymerized under stirring at a temperature of approximately from 30 to 100° C., preferably from 60 to 90° C., for 3 to 8 hours. Various conditions such as dispersion medium, concentration of monomer, amount of polymerization initiator, amount of emulsifier, amount of dispersant, reaction temperature and method for addition of monomer are appropriately selected by taking account of the kind of monomer used. If desired, a dispersant or a chain transfer agent for controlling the gelation rate is preferably used.

In the present invention, the chain transfer agent used in the emulsion polymerization is preferably selected from the compounds described in Polymer Handbook, 3rd Ed., Wiley-Interscience (1989). A sulfur compound is more preferred because it has high chain transfer function and can serve by the addition in a small amount. A hydrophobic mercaptan-type chain transfer agent such as tert-dodecylmeraptan and n-dodecylmercaptan is still more preferred.

The initiator used in the emulsion polymerization method is preferably a persulfate or an azo compound which are free of halogen ion, so as to reduce the halogen ion content of the polymer latex. The initiator is more preferably an ammonium persulfate, a sodium persulfate, a potassium persulfate, an azonitrile compound (e.g., azobiscyanovaleric acid) or an azoamide compound (e.g., 2,2-azobis(2-methyl-N-(1,1′-bis(hydroxymethyl)-2-hydroxy-ethyl)propionamide). Among these, ammonium persulfate, sodium persulfate and potassium persulfate are particularly preferred.

The dispersant for use in the emulsion polymerization may be any of an anionic surface active agent, a nonionic surface active agent, a cationic surface active agent and an amphoteric surface active agent, however, in view of the dispersibility, an anionic surface active agent is preferred. In the case of performing the emulsion polymerization by adding a surface active agent, the amount of the surface active agent added is preferably from 0.01 to 10 mass %, more preferably from 0.01 to 8 mass %, still more preferably 5 mass % or less, based on the solid components.

In addition to the compounds described above, additives described, for example, in Gosei Gomu Handbook (Handbook of Synthetic Rubber) may also be used in the emulsion polymerization, such as electrolyte, stabilizer, thickener, defoaming agent, antioxidant, vulcanizing agent, antifreezing agent, gelling agent and vulcanization accelerator.

In general, the emulsion polymerization can be performed according to the methods described in the following publications: Taira Okuda and Hiroshi Inagaki (compilers), Gosei Jushi Emulsion (Synthetic Resin Emulsion), Kobunshi Kankokai (1978), Takaaki Sugimura, Yasuo Kataoka, Souichi Suzuki and Keiji Kasahara (compilers), Gosei Latex no Oyo (Application of Synthetic Latex), Kobunshi Kankokai (1993), and Soichi Muroi, Gosei Latex no Kagaku (Chemistry of Synthetic Latex), Kobunshi Kankokai (1993).

Synthesis examples of the polymer for use in the present invention are set forth below, but the present invention should not be construed as being limited thereto. Compounds shown above but not described in the following Synthesis Examples can also be synthesized in accordance with the synthesis methods described below.

### SYNTHESIS EXAMPLE 3-1

Synthesis of Compound P3-1: latex Using Sodium Hydroxide

Into the polymerization furnace of a gas monomer reaction apparatus (Model TAS-2J, manufactured by Taiatsu Techno Corp.), 371.9 g of distilled water, 12.319 g of a surface active agent (prepared by purifying Sandet BL (produced by Sanyo Chemical Industries, Ltd.) using Micro Acilyzer G3 (membrane: AC110-800) produced by Asahi Chemical Industry Co., Ltd. until change in the electric conductivity did not occur; solid content: 30.4%), 18.75 ml of 1 mol/liter NaOH, 255 g of styrene, 11.25 g of acrylic acid and 3.0 g of tert-dodecylmercaptan were charged. The reactor was closed and stirred at a stirring rate of 200 rpm. After an operation of degassing the reactor by a vacuum pump and purging it with nitrogen gas was repeated several times, 108.75 g of 1,3-butadiene was charged under pressure and the inner temperature was elevated to 60° C. At this time, the water medium of the reaction system had a pH of 3.1. Thereto, a solution prepared by dissolving 1.875 g of ammonium persulfate in 50 g of water was added and the mixture was stirred for 5 hours. The temperature was further elevated to 90° C. and the mixture was stirred for 3 hours. After the completion of reaction, the inner temperature was lowered to room temperature and the resulting polymer was filtered through a paper towel to obtain 776 g of Compound P3-1 (solid content: 45%, particle size: 109 nm, gel partial ratio: 60%).

### SYNTHESIS EXAMPLE 3-2

Synthesis of Compound P3-2: Latex Using Sodium Hydroxide

Into the polymerization furnace of a gas monomer reaction apparatus (Model TAS-2J, manufactured by Taiatsu Techno Corp.), 343.7 g of distilled water, 12.319 g of a surface active agent (prepared by purifying Sandet BL (produced by Sanyo Chemical Industries, Ltd.) using Micro Acilyzer G3 (membrane: AC110-800) produced by Asahi Chemical Industry Co., Ltd. until change in the electric conductivity did not occur; solid content: 30.4%), 46.87 ml of 1 mol/liter NaOH, 255 g of styrene, 11.25 g of acrylic acid and 3.0 g of tert-dodecylmercaptan were charged. The reactor was closed and stirred at a stirring rate of 200 rpm. After an operation of degassing the reactor by a vacuum pump and purging it with nitrogen gas was repeated several times, 108.75 g of 1,3-butadiene was charged under pressure and the inner temperature was elevated to 60° C. At this time, the water medium of the reaction system had a pH of 3.2. Thereto, a solution prepared by dissolving 1.875 g of ammonium persulfate in 50 g of water was added and the mixture was stirred for 5 hours. The temperature was further elevated to 90° C. and the mixture was stirred for 3 hours. After the completion of reaction, the inner temperature was lowered to room temperature and the resulting polymer was filtered through a paper towel to obtain 776 g of Compound P3-2 (solid content: 45%, particle size: 109 nm, gel partial ratio: 60%).

### SYNTHESIS EXAMPLE 3-3

Synthesis of Compound P3-3: Latex Using Sodium Hydroxide

Into the polymerization furnace of a gas monomer reaction apparatus (Model TAS-2J, manufactured by Taiatsu Techno Corp.), 371.9 g of distilled water, 12.319 g of a surface active agent (prepared by purifying Sandet BL (produced by Sanyo Chemical Industries, Ltd.) using Micro Acilyzer G3 (membrane: AC110-800) produced by Asahi Chemical Industry Co., Ltd. until change in the electric conductivity did not occur; solid content: 30.4%), 18.75 ml of 1 mol/liter NaOH, 0.075 g of tetrasodium ethylene-diaminetetraacetate, 266.25 g of styrene, 11.25 g of acrylic acid and 3.0 g of tert-dodecylmercaptan were charged. The reactor was closed and stirred at a stirring rate of 200 rpm. After an operation of degassing the reactor by a vacuum pump and purging it with nitrogen gas was repeated several times, 97.5 g of 1,3-butadiene was charged under pressure and the inner temperature was elevated to 60° C. At this time, the water medium of the reaction system had a pH of 3.1. Thereto, a solution prepared by dissolving 1.875 g of ammonium persulfate in 50 g of water was added and the mixture was stirred for 5 hours. The temperature was further elevated to 90° C. and the mixture was stirred for 3 hours. After the completion of reaction, the inner temperature was lowered to room temperature and the resulting polymer was filtered through a paper towel to obtain 776 g of Compound P3-3 (solid content: 45%, particle size: 105 nm, gel partial ratio: 64%).

### SYNTHESIS EXAMPLE 3-4

Synthesis of Compound P3-4: Latex Using Sodium Hydroxide and Ammonia in Combination

Into the polymerization furnace of a gas monomer reaction apparatus (Model TAS-2J, manufactured by Taiatsu Techno Corp.), 371.9 g of distilled water, 12.319 g of a surface active agent (prepared by purifying Sandet BL (produced by Sanyo Chemical Industries, Ltd.) using Micro Acilyzer G3 (membrane: AC110-800) produced by Asahi Chemical Industry Co., Ltd. until change in the electric conductivity did not occur; solid content: 30.4%), 9.38 ml of 1 mol/liter NaOH, 9.38 ml of 1 mol/liter NH₄OH, 0.075 g of tetrasodium ethylenediaminetetraacetate, 266.25 g of styrene, 11.25 g of acrylic acid and 3.0 g of tert-dodecylmercaptan were charged. The reactor was closed and stirred at a stirring rate of 200 rpm. After an operation of degassing the reactor by a vacuum pump and purging it with nitrogen gas was repeated several times, 97.5 g of 1,3-butadiene was charged under pressure and the inner temperature was elevated to 60° C. At this time, the water medium of the reaction system had a pH of 3.1. Thereto, a solution prepared by dissolving 1.875 g of ammonium persulfate in 50 g of water was added and the mixture was stirred for 5 hours. The temperature was further elevated to 90° C. and the mixture was stirred for 3 hours. After the completion of reaction, the inner temperature was lowered to room temperature and the resulting polymer was filtered through a paper towel to obtain 776 g of Compound P3-4 (solid content: 45%, particle size: 105 nm, gel partial ratio: 64%).

### SYNTHESIS EXAMPLE 3-5

Synthesis of Compound P3-14: Latex Using Sodium Hydroxide

Into a glass-made three-neck flask equipped with a stirrer and a condenser, 297 g of distilled water, 9.9 g of a surface active agent (prepared by purifying Sandet BL (produced by Sanyo Chemical Industries, Ltd.) using Micro Acilyzer G3 (membrane: AC110-800) produced by Asahi Chemical Industry Co., Ltd. until change in the electric conductivity did not occur; solid content: 30.4%), 15 ml of 1 mol/liter NaOH, 165 g of methyl acrylate, 123 g of ethyl acrylate, 12 g of acrylic acid and 2.4 g of tert-dodecylmercaptan were charged. The mixture was stirred at a stirring rate of 200 rpm in a nitrogen stream and the inner temperature was elevated to 60° C. At this time, the water medium of the reaction system had a pH of 3.1. Thereto, a solution prepared by dissolving 0.6 g of ammonium persulfate in 40 g of water was added and the mixture was stirred for 5 hours. The temperature was further elevated to 90° C. and the mixture was stirred for 3 hours. After the completion of reaction, the inner temperature was lowered to room temperature and the resulting polymer was filtered through a paper towel to obtain 610 g of Compound P3-14 (solid content: 45%, particle size: 90 nm, gel partial ratio: 0%).

In the above-described synthesis examples, the gel partial ratio as a property of each synthetic latex is a value calculated as follows. In an aluminum foil Petri dish, 25 g of a latex sample is weighed and dried at 60° C. for 2 hours using a blast drier. The obtained dry film is further dried at 120° C. for 0.5 hours and cut into a size of about 2×2 cm. This film was placed in a 300-mesh wire gauze cage and left standing while dipping it in 60 ml of toluene for 60 hours or more. The wire cage is taken out from the toluene bath and dried at 110° C. for 1 hour, the amount of sample remained in the cage is weighed, and therefrom, a gel partial ratio is calculated.

Specific examples (Compounds (P4-1) to (P4-24)) of the polymer for use in the fourth embodiment of the present invention are set forth below. The molecular weight is a mass average molecular weight and in the case of a polyfunctional monomer, since the concept of the molecular weight cannot be applied, the molecular weight is not shown.

In the chemical formulae, x, y, z and z′ attached to the parentheses in the polymer main chain portion represent a mass ratio of the polymer composition and the sum total of x, y, z and z′ is 100%. Also in the chemical formulae, the numerical value attached on the right side of parentheses in the polymer side chain portion represents a polymerization degree.

Tg represents a glass transition temperature of a dry film obtained from the polymer. The present invention is not limited to the following specific examples.

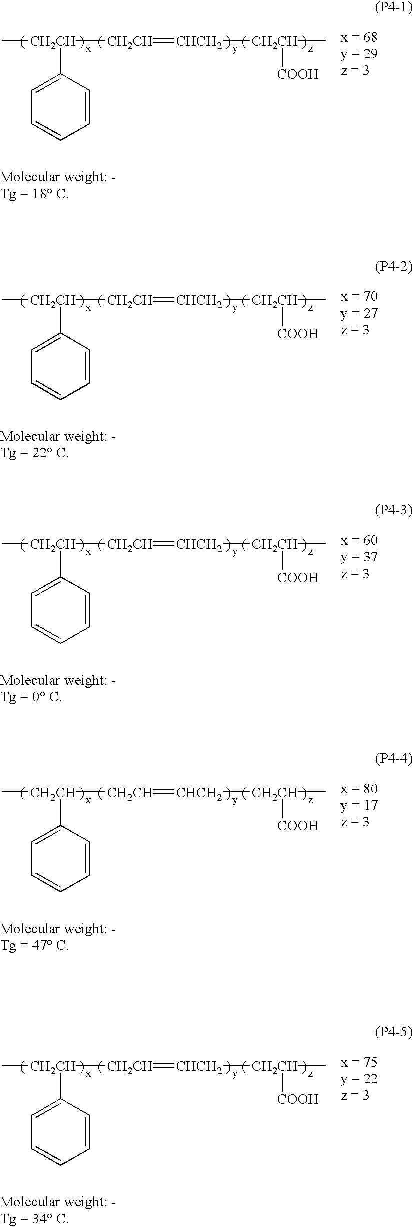

The polymer for use in the present invention can be easily obtained, for example, by an emulsion polymerization method. In performing the emulsion polymerization, for example, water or a mixed solvent of water and an organic solvent miscible with water (e.g., methanol, ethanol, acetone) is used as a dispersion medium and a monomer mixture in an amount of from 5 to 150 mass % based on the dispersion medium, a polymerization initiator in an amount of 0.05 to 5 mass % based on the monomer(s) and an emulsifier in an amount of 0.1 to 20 mass % based on the monomer(s) are polymerized under stirring at a temperature of approximately from 30 to 100° C., preferably from 60 to 90° C., for 3 to 8 hours.

Various conditions such as dispersion medium, concentration of monomer, amount of polymerization initiator, amount of emulsifier, amount of dispersant, reaction temperature and method for addition of monomer are appropriately selected by taking account of the kind of monomer used.

If desired, a dispersant is preferably used.

The chain transfer agent for use in the present invention is preferably selected from the compounds described in Polymer Handbook, 3rd Ed., Wiley-Interscience (1989). A sulfur compound is more preferred because it has high chain transfer function and can serve by the addition in a small amount. A hydrophobic mercaptan-type chain transfer agent such as tert-dodecylmeraptan and n-dodecylmercaptan is still more preferred.

The initiator used in the emulsion polymerization may be sufficient if it is water-soluble and has a radical generating ability, but preferred examples thereof include persulfates and water-soluble azo compounds. Among these, more preferred are ammonium persulfate, sodium persulfate, potassium persulfate and azobiscyanovaleric acid.

The dispersant for use in the emulsion polymerization may be any of an anionic surface active agent, a nonionic surface active agent, a cationic surface active agent and an amphoteric surface active agent, however, in view of the dispersibility, an anionic surface active agent is preferred.

In addition to the compounds described above, additives described, for example, in Gosei Gomu Handbook (Handbook of Synthetic Rubber) may also be used in the emulsion polymerization, such as electrolyte, chelating agent, stabilizer, thickener, defoaming agent, antioxidant, vulcanizing agent, antifreezing agent, gelling agent and vulcanization accelerator.

In general, the emulsion polymerization can be performed according to the methods described in the following publications: Taira Okuda and Hiroshi Inagaki (compilers), Gosei Jushi Emulsion (Synthetic Resin Emulsion), Kobunshi Kankokai (1978), Takaaki Sugimura, Yasuo Kataoka, Souichi Suzuki and Keiji Kasahara (compilers), Gosei Latex no Oyo (Application of Synthetic Latex), Kobunshi Kankokai (1993), and Soichi Muroi, Gosei Latex no Kagaku (Chemistry of Synthetic Latex), Kobunshi Kankokai (1993).

Synthesis examples of the polymer for use in the present invention are set forth below, but the present invention should not be construed as being limited thereto. Other compounds can also be similarly synthesized.

### SYNTHESIS EXAMPLE 4-1

Synthesis of Compound P4-1

Into the polymerization furnace of a gas monomer reaction apparatus (Model TAS-2J, manufactured by Taiatsu Techno Corp.), 1,500 g of distilled water was added and heated at 90° C. for 3 hours to form a passive state film on the stainless steel surface of the polymerization furnace or on the members of the stainless steel-made stirrer. Into the thus-treated polymerization furnace, 584.86 g of distilled water, 9.45 g of a surface active agent (PIONIN A-43-S, produced by Takemoto Yushi), 20.25 g of 1 mol/liter NaOH, 0.216 g of tetrasodium ethylenediaminetetraacetate, 372.6 g of styrene, 16.2 g of acrylic acid and 4.32 g of tert-dodecylmercaptan were charged. The reactor was closed and stirred at a stirring rate of 225 rpm. After an operation of degassing the reactor by a vacuum pump and purging it with nitrogen gas was repeated several times, 151.2 g of 1,3-butadiene was charged under pressure and the inner temperature was elevated to 60° C. Thereto, a solution prepared by dissolving 2.7 g of ammonium persulfate in 50 ml of water was added and the mixture was stirred for 5 hours. The temperature was further elevated to 90° C. and the mixture was stirred for 3 hours. After the completion of reaction, the inner temperature was lowered to room temperature and the resulting polymer was filtered through a filter cloth (mesh: 225) to obtain 1,145 g of Compound P4-1 (solid content: 45%, particle size: 100 nm). The concentration of iron was measured by an atomic absorption method and found to be 0.06 ppm.

### SYNTHESIS EXAMPLE 4-2

Synthesis of Compound P4-2

Into a gas monomer reaction apparatus (Model TAS-2J, manufactured by Taiatsu Techno Corp.) where a passive state film was formed in the same manner as in Synthesis Example 4-1, 584.86 g of distilled water, 9.45 g of a surface active agent (PIONIN A-43-S, produced by Takemoto Yushi), 20.25 g of 1 mol/liter NaOH, 0.216 g of tetrasodium ethylenediaminetetraacetate, 378.0 g of styrene, 16.2 g of acrylic acid and 4.32 g of tert-dodecylmercaptan were charged. The reactor was closed and stirred at a stirring rate of 225 rpm. After an operation of degassing the reactor by a vacuum pump and purging it with nitrogen gas was repeated several times, 145.8 g of 1,3-butadiene was charged under pressure and the inner temperature was elevated to 60° C. Thereto, a solution prepared by dissolving 2.7 g of ammonium persulfate in 50 ml of water was added and the mixture was stirred for 5 hours. The temperature was further elevated to 90° C. and the mixture was stirred for 3 hours. After the completion of reaction, the inner temperature was lowered to room temperature and the resulting polymer was filtered through a filter cloth (mesh: 225) to obtain 1,147 g of Compound P4-2 (solid content: 45%, particle size: 101 nm). The concentration of iron was measured by an atomic absorption method and found to be 0.05 ppm.

### SYNTHESIS EXAMPLE 4-3

Synthesis of Compound P4-20

Into a glass-made three-neck flask equipped with a stirrer and a condenser, 584.86 g of distilled water, 9.45 g of a surface active agent (PIONIN A-43-S, produced by Takemoto Yushi), 20.25 g of 1 mol/liter NaOH, 0.216 g of tetrasodium ethylenediaminetetraacetate, 243 g of methyl methacrylate, 270 g of butyl acrylate, 27.0 g of sodium styrenesulfonate and 4.32 g of tert-dodecylmercaptan were charged. The mixture was stirred at a stirring rate of 225 rpm and the inner temperature was elevated to 60° C. Thereto, a solution prepared by dissolving 2.7 g of ammonium persulfate in 50 ml of water was added and the mixture was stirred for 5 hours. The temperature was further elevated to 90° C. and the mixture was stirred for 3 hours. After the completion of reaction, the inner temperature was lowered to room temperature and the resulting polymer was filtered through a filter cloth (mesh: 225) to obtain 1,140 g of Compound P4-20 (solid content: 45%, particle size: 98 nm, mass average molecular weight: 100,000, Tg: 5° C.). The concentration of iron was measured by an atomic absorption method and found to be 0.04 ppm.

Specific examples (Compounds (P5-1) to (P5-24)) of the polymer for use in the fifth embodiment of the present invention are set forth below. The molecular weight is a mass average molecular weight and in the case of a polyfunctional monomer, since the concept of the molecular weight cannot be applied, the molecular weight is not shown. In the chemical formulae, x, y, z and z′ attached to the parentheses in the polymer main chain portion represent a mass ratio of the polymer composition and the sum total of x, y, z and z′ is 100%. Also in the chemical formulae, the numerical value attached on the right side of parentheses in the polymer side chain portion represents a polymerization degree. Tg represents a glass transition temperature of a dry film obtained from the polymer. The present invention is not limited to the following specific examples.

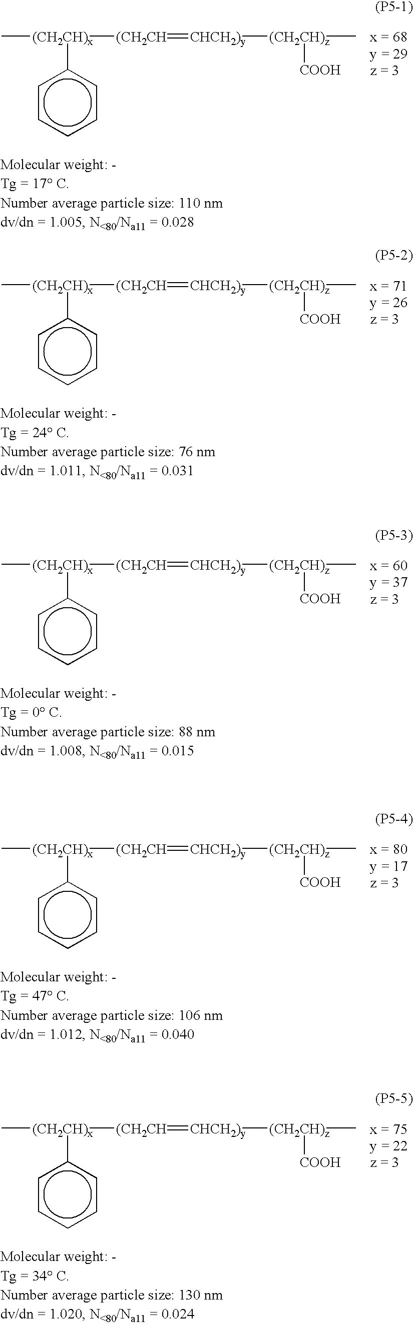

The polymer for use in the present invention can be easily obtained, for example, by an emulsion polymerization method. In performing the emulsion polymerization, for example, water or a mixed solvent of water and an organic solvent miscible with water (e.g., methanol, ethanol, acetone) is used as a dispersion medium and a monomer mixture in an amount of from 5 to 40 mass % based on the dispersion medium, a polymerization initiator in an amount of 0.05 to 5 mass % based on the monomer(s) and an emulsifier in an amount of 0.05 to 10 mass % based on the monomer(s) are polymerized under stirring at a temperature of approximately from 30 to 100° C., preferably from 60 to 90° C., for 3 to 8 hours. Various conditions such as dispersion medium, concentration of monomer, amount of polymerization initiator, amount of emulsifier, amount of dispersant, reaction temperature and method for addition of monomer are appropriately selected by taking account of the kind of monomer used. If desired, a dispersant is preferably used.

The chain transfer agent for use in the present invention is preferably selected from the compounds described in Polymer Handbook, 3rd Ed., Wiley-Interscience (1989). A sulfur compound is more preferred because it has high chain transfer function and can serve by the addition in a small amount. A hydrophobic mercaptan-type chain transfer agent such as tert-dodecylmeraptan and n-dodecylmercaptan is still more preferred.

The initiator used in the emulsion polymerization may be sufficient if it is water-soluble and has a radical generating ability, but preferred examples thereof include persulfates and water-soluble azo compounds. Among these, more preferred are ammonium persulfate, sodium persulfate, potassium persulfate and sodium azobiscyanovalerate.

The dispersant for use in the emulsion polymerization may be any of an anionic surface active agent, a nonionic surface active agent, a cationic surface active agent and an amphoteric surface active agent, however, in view of the dispersibility, an anionic surface active agent is preferred.

In addition to the compounds described above, additives described, for example, in Gosei Gomu Handbook (Handbook of Synthetic Rubber) may also be used in the emulsion polymerization, such as electrolyte, stabilizer, thickener, defoaming agent, antioxidant, vulcanizing agent, chelating agent, antifreezing agent, gelling agent and vulcanization accelerator.

In general, the emulsion polymerization can be performed according to the methods described in the following publications: Taira Okuda and Hiroshi Inagaki (compilers), Gosei Jushi Emulsion (Synthetic Resin Emulsion), Kobunshi Kankokai (1978), Takaaki Sugimura, Yasuo Kataoka, Souichi Suzuki and Keiji Kasahara (compilers), Gosei Latex no Oyo (Application of Synthetic Latex), Kobunshi Kankokai (1993), and Soichi Muroi, Gosei Latex no Kagaku (Chemistry of Synthetic Latex), Kobunshi Kankokai (1993).

Synthesis examples of the polymer for use in the present invention are set forth below, but the present invention should not be construed as being limited thereto.

### SYNTHESIS EXAMPLE 5-1

Synthesis of Compound P5-1

Into the polymerization furnace of a gas monomer reaction apparatus (Model TAS-2J, manufactured by Taiatsu Techno Corp.), 296.8 g of distilled water, 9.9 g of a surface active agent (prepared by purifying Sandet BL (produced by Sanyo Chemical Industries, Ltd.) using Micro Acilyzer G3 (membrane: AC110-800) produced by Asahi Chemical Industry Co., Ltd. until change in the electric conductivity did not occur; solid content: 30.4%), 15 ml of 1 mol/liter NaOH, 207 g of styrene, 9.0 g of acrylic acid and 2.4 g of tert-dodecylmercaptan were charged. The reactor was closed and stirred at a stirring rate of 200 rpm. After an operation of degassing the reactor by a vacuum pump and purging it with nitrogen gas was repeated several times, 84 g of 1,3-butadiene was charged under pressure and the inner temperature was elevated to 60° C. Thereto, a solution prepared by dissolving 1.5 g of sodium persulfate in 40 ml of water was added and the mixture was stirred for 5 hours. The temperature was further elevated to 90° C. and the mixture was stirred for 3 hours. After the completion of reaction, the inner temperature was lowered to room temperature and the resulting polymer was filtered through a paper towel to obtain 619 g of Compound P5-1 (solid content: 45%, number average particle size: 110 nm, dv/dn=1.005, N_{U80}/Nₐₗₗ=0.028).

### SYNTHESIS EXAMPLE 5-2

Synthesis of Compound P5-2

Into the polymerization furnace of a gas monomer reaction apparatus (Model TAS-2J, manufactured by Taiatsu Techno Corp.), 287 g of distilled water, 19.7 g of a surface active agent (prepared by purifying Sandet BL (produced by Sanyo Chemical Industries, Ltd.) using Micro Acilyzer G3 (membrane: AC110-800) produced by Asahi Chemical Industry Co., Ltd. until change in the electric conductivity did not occur; solid content: 30.4%), 15 ml of 1 mol/liter NaOH, 0.06 g of tetrasodium ethylenediaminetetraacetate, 213 g of styrene, 9.0 g of acrylic acid and 2.4 g of tert-dodecylmercaptan were charged. The reactor was closed and stirred at a stirring rate of 200 rpm. After an operation of degassing the reactor by a vacuum pump and purging it with nitrogen gas was repeated several times, 78 g of 1,3-butadiene was charged under pressure and the inner temperature was elevated to 60° C. Thereto, a solution prepared by dissolving 0.6 g of ammonium persulfate in 40 ml of water was added and the mixture was stirred for 5 hours. The temperature was further elevated to 90° C. and the mixture was stirred for 3 hours. After the completion of reaction, the inner temperature was lowered to room temperature and the resulting polymer was filtered through a paper towel to obtain 613 g of Compound P5-2 (solid content: 45%, particle size: 76 nm, dv/dn=1.011, N_{U80}/Nₐₗₗ=0.031).

### SYNTHESIS EXAMPLE 5-3

Synthesis of Compound P5-20

Into a glass-made three-neck flask equipped with a stirrer and a condenser, 297 g of distilled water, 9.9 g of a surface active agent (prepared by purifying Sandet BL (produced by Sanyo Chemical Industries, Ltd.) using Micro Acilyzer G3 (membrane: AC110-800) produced by Asahi Chemical Industry Co., Ltd. until change in the electric conductivity did not occur; solid content: 30.4%), 15 ml of 1 mol/liter NaOH, 135 g of methyl methacrylate, 150 g of butyl acrylate, 15 g of sodium styrenesulfonate and 2.4 g of tert-dodecylmercaptan were charged. The mixture was stirred at a stirring rate of 200 rpm in a nitrogen stream and the inner temperature was elevated to 60° C. Thereto, a solution prepared by dissolving 0.6 g of sodium persulfate in 40 ml of water was added and the mixture was stirred for 5 hours. The temperature was further elevated to 90° C. and the mixture was stirred for 3 hours. After the completion of reaction, the inner temperature was lowered to room temperature and the resulting polymer was filtered through a paper towel to obtain 608 g of Compound P5-20 (solid content: 45%, particle size: 104 nm, dv/dn=1.010, N_{U}₈₀/Nₐₗₗ=0.011).

In a coating solution of the polymer for use in the first to fifth embodiments of the present invention, an aqueous solvent may be used as a solvent and may also be used in combination with a water-miscible organic solvent.

Examples of the water-miscible organic solvent include an alcohol solvent such as methyl alcohol, ethyl alcohol and propyl alcohol, a cellosolve solvent such as methyl cellosolve, ethyl cellosolve and butyl cellosolve, an ethyl acetate and a dimethylformamide. The amount of the organic solvent added is preferably 50% or less, more preferably 30% or less.

The polymer (binder) for use in the first to fifth embodiments of the present invention is preferably added to an organic silver salt-containing layer in an amount such that the mass ratio of total binder/organic silver salt is from 1/10 to 10/1 , more preferably from ⅕ to 4/1.

The organic silver salt-containing layer is usually a photosensitive layer (emulsion layer) containing photo-sensitive silver halide which is a photosensitive silver salt. In this case, the mass ratio of total binder/silver halide is preferably from 400 to 5, more preferably from 200 to 10.

The total amount of binder in an image-forming layer is preferably from 0.2 to 30 g/m², more preferably from 1 to 15 g/m². To the image-forming layer, for example, a crosslinking agent for forming crosslinkage or a surface active agent for improving the work brittleness may be added.

The components used in each of the first, second, third, forth and fifth embodiments, are described in detail below.

<Non-Photosensitive Organic Silver Salt>

The photo-insensitive organic silver salt is described in detail below.

The organic silver salt for use in the present invention is preferably a silver salt which is relatively stable to light but capable of forming a silver image when heated at 80° C. or more in the presence of a photo-catalyst (e.g., a latent image of exposed photosensitive silver halide) and a heat developing agent. The organic silver salt may be an appropriate organic substance capable of becoming a source of supplying silver ion which is reduced to silver.

This photo-insensitive organic silver salt is described in JP-A-10-62899, paragraph Nos. 0048 to 0049, EP-A-803763, from page 18, line 24 to page 19, line 37, and EP-A-962812.

Among those, preferred is a silver salt of an organic acid, particularly a silver salt of a long-chain aliphatic carboxylic acid (having from 10 to 30 carbon atoms, preferably from 15 to 28 carbon atoms). Preferred examples of the silver salt of organic acid include silver behenate, silver arachidate, silver stearate, silver oleate, silver laurate, silver caprate, silver myristate, silver palmitate and a mixture thereof.

The shape of the organic silver salt for use in the present invention is not particularly limited, but the organic silver salt preferably has a scaly shape. The scaly organic silver salt is defined in the following manner. An organic silver salt particle is observed through an electron microscope and the shape of the organic silver salt particle is approximated to a rectangular parallelepiped. Assuming that the sides of the rectangular parallelepiped are a, b and c from the shortest side (c may be equal to b), x is calculated from the shorter numerical values a and b as follows:

x=b/a

Thus, x is determined on about 200 particles and assuming that an average value is x (average), particles satisfying the relationship of x (average)≧1.5 are defined as scaly particles. Particles satisfying the relationship of 30≧x (average)≧1.5 are preferred and particles satisfying the relationship of 20≧x (average)≧2.0 are more preferred. Incidentally, particles satisfying the relationship of 1.5≧x (average)≧1 are acicular particles.

In the scaly particle, a can be regarded as a thickness of a tabular particle (organic silver salt particle) having a plane with the sides of b and c as the main plane. The average of a is preferably from 0.01 to 0.23 μm, more preferably from 0.1 to 0.20 μm. The average of c/b is preferably from 1 to 6, more preferably from 1.05 to 4, still more preferably from 1.1 to 3, and particularly preferably from 1.1 to 2.

The particle size distribution of organic silver salt for use in the present invention is preferably mono-dispersed. The term “monodispersed” as used herein means that a percentage of values obtained by dividing the standard deviation of short axis length and the standard deviation of long axis length by the short axis length and the long axis length, respectively, is preferably 100% or less, more preferably 80% or less, still more preferably 50% or less.

The shape of the organic silver salt can be determined from a transmission electron microscope image of a dispersion of the organic silver salt. Another method for measuring the monodispersity is a method of determining a standard deviation of volume weighted average diameter of the organic silver salt. The percentage of value (variation coefficient) obtained by dividing the standard deviation by the volume weighted average diameter is preferably 100% or less, more preferably not 80% or less, still more preferably 50% or less.

The particle size (volume weighted average diameter) can be obtained, for example, by irradiating the organic silver salt dispersed in a liquid with a laser beam and determining an autocorrelation function of fluctuation of the scattered light to the time variation.

For the preparation and dispersion of the organic silver salt for use in the present invention, known methods may be used. For example, the methods described in JP-A-10-62899, EP-A-803763 and EP-A-962812 may be used.

In the present invention, an aqueous dispersion of the organic silver salt can be mixed with an aqueous dispersion of the photosensitive silver salt to prepare an image recording material. The mixing ratio of the photosensitive silver salt to the organic silver salt may be appropriately selected according to the purpose, but the ratio of the photosensitive silver salt to the organic silver salt is preferably from 1 to 30 mol %, more preferably from 3 to 20 mol %, still more preferably from 5 to 15 mol %. A method of mixing two or more aqueous dispersions of organic silver salts with two or more aqueous dispersions of photosensitive silver salts is preferably used in order to control the photographic properties.

The organic silver salt can be used in an appropriate amount, but the amount thereof is preferably from 0.1 to 5 g/m², more preferably from 1 to 3 g/m², in terms of silver.

<Photosensitive Silver Halide>

The photosensitive silver halide is described in detail below.

The photosensitive silver halide for use in the present invention is not particularly limited on its halogen composition and, for example, silver chloride, silver chlorobromide, silver bromide, silver iodobromide or silver iodochlorobromide is used. In the silver halide grain, the distribution of halide composition may be uniform or may vary stepwise or continuously. Also, a silver halide grain having a core/shell structure is preferably used. The core/shell grain preferably has a structure of 2 to 5 layers, more preferably from 2 to 4 layers. Furthermore, a technique of localizing silver bromide on the surface of a silver chloride or silver chlorobromide grain may also be preferably used.

The photosensitive silver halide for use in the present invention may be produced by a method well known in the art, for example, the methods described in Research Disclosure, Item 17029 (June, 1978) and U.S. Pat. No. 3,700,458. Specifically, a silver-supplying compound and a halogen-supplying compound are added to a gelatin or other polymer solution to prepare a photosensitive silver halide and then the photosensitive silver halide is mixed with the organic silver salt.

The grain size of the photosensitive silver halide for use in the present invention is preferably small for the purpose of restraining white turbidity after the image formation. Specifically, the grain size is preferably 0.20 μm or less, more preferably from 0.01 to 0.15 μm, still more preferably from 0.02 to 0.12 μm.

The term “grain size” as used herein means a diameter of a sphere having a volume equal to the silver halide grain, when the silver halide grain has a regular crystal form, e.g., cubic grain or octahedral grain, or an irregular crystal form, e.g., spherical grain or bar grain, or means a diameter of a circle having an area equal to the projected area of the main surface of a silver halide grain, when the silver halide grain is a tabular grain.

Examples of the shape of silver halide grain for use in the present invention include cubic form, octahedral form, tabular form, spherical form, bar form and pebble form. In the present invention, cubic grain is preferred. A silver halide grain having rounded corners is also preferably used.

The plane index (Miller index) of the outer surface of a photosensitive silver halide grain is not particularly limited, but since {100} plane exhibits a high spectral sensitization efficiency when a spectral sensitizing dye is adsorbed thereon, the {100} plane preferably occupies a higher proportion. The proportion is preferably 50% or more, more preferably 65% or more, still more preferably 80% or more. The ratio of the Miller index of {100} plane on the surface of a grain can be determined by the method described in T. Tani, J. Imaging Soc., Vol. 29, page 165 (1985), which utilizes adsorption dependence of spectral sensitizing dye on {111} plane and {100} plane.

The photosensitive silver halide for use in the present invention preferably contains a metal belonging to Groups 8 to 10 of the Periodic Table (showing Groups 1 to 18) or a complex thereof. Preferred examples of the metal or central metal of the metal complex belonging to Groups 8 to 10 include rhodium, rhenium, ruthenium, osmium and iridium. The metal complexes may be used individually or in combination of two or more complexes of the same metal or different metals.

The content of the metal complex is preferably from 1×10⁻⁹ to 1×10⁻³ mol per mol of silver. These metal complexes are described in JP-A-11-65021, paragraph Nos. 0018 to 0024.

The silver halide for use in the present invention preferably contains an iridium compound. Examples of the iridium compound include hexachloroiridium, hexammineiridium, trioxalatoiridium, hexacyanoiridium and pentachloronitrosyliridium. The iridium compound is used by dissolving it in water or an appropriate solvent. A method generally used for stabilizing the solution of iridium compound may be used, more specifically, a method of adding an aqueous hydrogen halide solution (e.g., hydrochloric acid, hydrobromic acid, hydrofluoric acid) or an alkali halide (e.g., KCl, NaCl, KBr, NaBr). In place of using water-soluble iridium, it is possible to add silver halide grains previously doped with iridium and dissolve the iridium at the preparation of silver halide.

The amount of the iridium compound added is preferably from 1×10⁻⁸ to 1×10⁻³ mol, more preferably from 1×10⁻⁷ to 5×10⁻⁴ mol, per mol of silver halide.

The metal atom (e.g., [Fe(CN)₆]⁴−) which can be incorporated into the silver halide for use in the present invention, the desalting method and the chemical sensitization method are described in JP-A-11-84574, paragraph Nos. 0046 to 0050, and JP-A-11-65021, paragraph Nos. 0025 to 0031.

In the heat-developable image recording material of the present invention, a phenol derivative represented by formula (A) described in Japanese Patent Application No. 11-73951 is preferably used as a development accelerator.

As for the sensitizing dye which can be applied to the silver halide for use in the present invention, a sensitizing dye capable of spectrally sensitizing a silver halide grain in the desired wavelength region when the dye is adsorbed on the silver halide grain, and having spectral sensitivity suitable for spectral characteristics of the light source for exposure can be advantageously selected.

Examples of the spectral sensitizing dye and the method for addition thereof include those described in JP-A-11-65021, paragraph Nos. 0103 to 0109, compounds represented by formula (II) described in JP-A-10-186572, and those described in EP-A-803764, from page 19, line 38 to page 20, line 35. The timing of adding the spectral sensitizing dye to a silver halide emulsion is preferably in the period between after desalting and before coating, more preferably in the period between after desalting and before the initiation of chemical ripening.

The amount of the spectral sensitizing dye added can be appropriately selected in accordance with sensitivity and fog, but is preferably from 10⁻⁶ to 1 mol, more preferably from 10⁻⁴ to 10⁻¹ mol, per mol of silver halide in the photosensitive layer.

A supersensitizing agent may also be used. Examples of the supersensitizing agent include compounds described in EP-A-587338, U.S. Pat. Nos. 3,877,943 and 4,873,184, JP-A-5-341432, JP-A-11-109547 and JP-A-10-111543.

The photosensitive silver halide for use in the present invention is preferably subjected to chemical sensitization by a sulfur sensitizing method, a selenium sensitizing method or a tellurium sensitizing method. As for the compounds preferably used in the sulfur sensitizing method, selenium sensitizing method and tellurium sensitizing method, known compounds, for example, compounds described in JP-A-7-128768 may be used.

In the present invention, tellurium sensitization is particularly preferred and examples of the tellurium sensitizer include diacyltellurides, bis(oxycarbonyl)-tellurides, bis(carbamoyl)tellurides, diacylditellurides, bis(oxycarbonyl)ditellurides, bis(carbamoyl)ditellurides, compounds containing a P═Te bond, tellurocarboxylates, tellurosulfonates, compounds containing a P—Te bond and tellurocarbonyl compounds. Specific examples of the tellurium sensitizer include the compounds described in the literatures cited in JP-A-11-65021, paragraph No. 0030.

Particularly, the compounds represented by formulae (II), (III) and (IV) of JP-A-5-313284 are preferred.

The chemical sensitization of photosensitive silver halide for use in the present invention can be performed at any stage between after grain formation and before coating and may be performed, for example, after desalting, (1) before spectral sensitization, (2) simultaneously with spectral sensitization, (3) after spectral sensitization or (4) immediately before coating. In particular, the chemical sensitization is preferably performed after spectral sensitization.

The amount of the sulfur, selenium or tellurium sensitizer used may vary depending on the silver halide grain, the conditions of chemical ripening or the like, but is from 10⁻⁸ to 10⁻² mol, preferably from 10⁻⁷ to 10⁻³ mol, per mol of silver halide. The conditions of chemical sensitization are not particularly limited, but the pH is from 5 to 8, the pAg is from 6 to 11, preferably from 7 to 10, and the temperature is from 40 to 95° C., preferably from 44 to 70° C.

As for the photosensitive silver halide (emulsion) for use in the present invention, one kind may be used or two or more kinds (for example, different in the average grain size, different in the halide composition, different in the crystal habit or different in the conditions of chemical sensitization) may be used in combination. The gradation can be controlled by using a plurality of photosensitive silver halides different in the sensitivity.

The technique thereon is described, for example, in JP-A-57-119341, JP-A-53-106125, JP-A-47-3929, JP-A-48-55730, JP-A-46-5187, JP-A-50-73627 and JP-A-57-150841. With respect to the difference in sensitivity, a difference of 0.2 or more in terms of logarithmic sensitivity is preferably present among respective emulsions.

The amount of the photosensitive silver halide for use in the present invention is preferably from 0.03 to 0.6 g/m², more preferably from 0.05 to 0.4 g/m², still more preferably from 0.1 to 0.4 g/m², in terms of silver per m² of the image recording material. The amount of photosensitive silver halide is preferably from 0.01 to 0.5 mol, more preferably from 0.02 to 0.3 mol, still more preferably from 0.03 to 0.25 mol, per mol of the organic silver salt.

With respect to the mixing method and the mixing conditions of the photosensitive silver halide and organic silver salt prepared separately, a method where the silver halide grain and the organic silver salt separately prepared are mixed by means of a high-speed stirrer, a ball mill, a sand mill, a colloid mill, a vibration mill or a homogenizer, or a method where the photosensitive silver halide prepared is mixed at an appropriate stage during the preparation of organic silver salt to prepare the organic silver salt may be used. However, the mixing method and mixing conditions are not particularly limited insofar as the effects of the present invention can be fully brought out.

The timing of adding the photosensitive silver halide for use in the present invention to a coating solution for the image forming layer is preferably from 180 minutes before coating to immediately before coating, preferably from 60 minutes to 10 seconds before coating. The mixing method and the mixing conditions are not particularly limited insofar as the effects of the present invention can fully brought out. Specifically, a method of mixing photosensitive silver halide with coating solution in a tank for a desired mean residence time which is calculated from the addition flow rate and the supply flow rate to a coater is controlled, or a method using a static mixer described in N. Harnby, M. F. Edwards and A. W. Nienow, Ekitai Kongou Gijutsu (Liquid Mixing Technology), Chapter 8, translated by Kouji Takahashi, The Nikkan Kogyo Shimbun, Ltd. (1989), may be used.

<Reducing Agent>

The reducing agent is described in detail below.

Although a conventionally known reducing agent may be used as the reducing agent for use in the present invention, it is preferred in the present invention to employ, as the reducing agent, a combination of (1) at least one phenol compound and (2) at least one compound satisfying at least one of Condition A (the hydrogen bond-forming rate constant (Kf) is from 20 to 4,000) and Condition B (the compound has a phosphoryl group within the molecule or has a structure represented by formula (II), (III), (IV) or (V)).

The use of the specific phenol compound and the specific compound in combination is preferred in view of the effect that the image preservability is greatly improved while substantially maintaining good heat-developability.

As for the reducing agent for use in the present invention, at least one phenol compound is suitably used. Use of a phenol compound as the reducing agent is known in EP-A-803764, JP-A-51-51933 and JP-A-6-3793 and those known phenol compounds may be are suitably used. Among these compounds, an o-polyphenol compound is preferred because of its high heat developability.

The term “o-polyphenol compound” as used herein may be any compound insofar as it contains the following structure within the molecule:

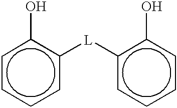

wherein L represents —S— or —CHR⁹—, and R⁹ represents a hydrogen atom or an alkyl group.

Particularly, the compound represented by formula (I) is preferred because of its higher heat developability.

The compound represented by formula (I) is described in detail below.

In formula (I), R¹ to R⁸ each independently represents a hydrogen atom or a group capable of being substituted on the benzene ring. Examples of the group capable of being substituted on the benzene ring include a halogen atom, an alkyl group, an aryl group, an aralkyl group, an alkoxy group, an acylamino group, a sulfonamido group, an acyl group, a carbamoyl group, a sulfamoyl group, an alkoxycarbonyl group, a sulfonyl group, an alkoxyalkyl group and an acylaminoalkyl group.

Examples of the alkyl group include a methyl group, an ethyl group, a propyl group, a butyl group, an isopropyl group, a tert-butyl group, a tert-amyl group, a cyclohexyl group and a 1-methylcyclohexyl group. Examples of the aralkyl group include a benzyl group.

R¹, R³, R⁶ and R⁸ each independently represents preferably an alkyl group, more preferably a primary alkyl group having from 1 to 20 carbon atoms, a secondary alkyl group having from 3 to 20 carbon atoms or a tertiary alkyl group having from 4 to 20 carbon atoms.

These groups each may further have an appropriate substituent. Examples of the substituent include a halogen atom, an aryl group, a heterocyclic group, an alkoxy group, an aryloxy group, an alkylthio group, an arylthio group, a hydroxy group, an acyloxy group, an amino group, an alkoxycarbonyl group, an acyl group, an acylamino group, an oxycarbonyl group, a carbamoyl group, a sulfonyl group, a sulfamoyl group, a sulfonamido group, a phosphoryl group and a carboxy group.

Examples of the primary alkyl group include a methyl group, an ethyl group, a propyl group, a butyl group, a pentyl group, a hexyl group, a heptyl group, an octyl group, a nonyl group, a decyl group, a dodecyl group, a benzyl group, a methoxymethyl group, a 2-methoxyethyl group, a phenethyl group and a hexyloxycarbonylmethyl group. Among these, preferred are a methyl group and an ethyl group.

Examples of the secondary alkyl group include an isopropyl group, a cyclohexyl group, a cyclopentyl group, a 1-methoxymethylethyl group and a 1-butoxyethylethyl group. Among these, preferred are an unsubstituted secondary alkyl group, more preferred are an isopropyl group and a cyclohexyl group.

Examples of the tertiary alkyl group include a tert-butyl group, a tert-amyl group, a tert-octyl group, a 1-methylcyclohexyl group, a 1-methylcyclopentyl group, a 1-methylcyclopropyl group, a 1-methyl-1-phenylethyl group and a 1,1-dimethyl-4-hexyloxycarbonylbutyl group. Among these, preferred are an unsubstituted tertiary alkyl group, more preferred are a tert-butyl and a 1-methylcyclohexyl group, and most preferred is a tert-butyl group.

R¹ and R⁸ each independently represents preferably a secondary alkyl group or a tertiary alkyl group. By selecting a secondary alkyl group or a tertiary alkyl group, the amount coated can be greatly reduced and therefore, costs and labors for the production of heat-developable image recording material can be significantly saved. If a secondary alkyl group or a tertiary alkyl group is selected, the image stability severely degrades unless a compound having a phosphoryl group is used in combination, however, when used in combination according to the present invention, the image stability is greatly improved. In view of development activity, R¹ and R⁸ are preferably a tertiary alkyl group. R¹ and R⁸, which may be the same or different, are preferably the same.

R³ and R⁶ each is preferably an unsubstituted alkyl group, specifically, a methyl group, an ethyl group, a propyl group, a butyl group, an isopropyl group, a tert-butyl group, a tert-amyl group, a cyclohexyl group or a 1-methylcyclohexyl group, more preferably a methyl group, an ethyl group, an isopropyl group or a tert-butyl group, and most preferably a methyl group or an ethyl group.

L represents —S— or —CHR⁹—, and R⁹ represents a hydrogen atom or an alkyl group. The alkyl group has preferably from 1 to 20 carbon atoms and may be unsubstituted or substituted with another group. Examples of the unsubstituted alkyl group include a methyl group, an ethyl group, a propyl group, a butyl group, a heptyl group, an undecyl group, an isopropyl group, a 1-ethylpentyl group and a 2,4,4-trimethylpentyl group. Examples of the substituent for the alkyl group are the same as those for R¹, R³, R⁶ and R⁸.

R⁹ is preferably a hydrogen atom or an unsubstituted alkyl group having from 1 to 12 carbon atoms, more preferably a hydrogen atom or an alkyl group having from 1 to 7 carbon atoms, still more preferably a hydrogen atom, a methyl group or a n-propyl group.

Specific examples (Compounds (I-1) to (I-34)) of the compound represented by formula (I) are set forth below, but the present invention should not be construed as being limited thereto.

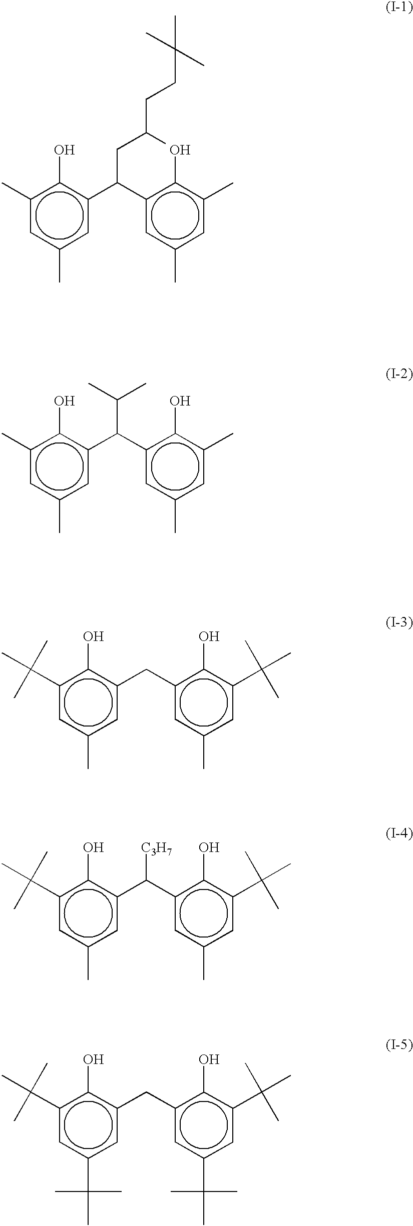

In addition to those specific examples of the compound represented by formula (I), specific examples of the phenol compound include those described in EP-A-803764, JP-A-51-51933 and JP-A-6-3793.

The phenol compound is preferably added in an amount of 0.01 to 4.0 g/m², more preferably from 0.1 to 2.0 g/m², or preferably contained in an amount of 2 to 40% by mol, more preferably from 5 to 30% by mol, per mol of silver present on the side having an image-forming layer.

The compound having a hydrogen bond-forming rate constant (Kf) of 20 to 4,000 is described in detail below.

The hydrogen bond-forming rate constant (Kf), which is used as a standard for the formation of hydrogen bond, is a constant studied by R. W. Taft et al., in J. Am. Chem. Soc., 91, 4794 (1969), etc. This is a reaction rate constant when hydrogen bonding takes place between p-FC₆H₄OH and a compound, and measured by F—NMR, IR or thermodynamic means. The hydrogen bond-forming rate constants (Kf) of various compounds are described in J. Am. Chem. Soc., 91, 4794 (1969), supra.

In the present invention, the Kf is preferably from 20 to 4,000, more preferably from 70 to 4,000, still more preferably from 100 to 4,000, particularly preferably from 250 to 2,000.

Representative examples of the compound having a hydrogen bond-forming rate constant (Kf) of 20 to 4,000 are set forth below.

| | Kf |
|---|---|
| Hexamethylphosphamide | 3,600 |
| Triphenylphosphinoxide | 1,456 ± 80 |
| 4-Dimethylaminopyridine | 650 ± 90 |
| Dimethylsulfoxide | 388 ± 7 |
| 2,6-Dimethyl-γ-pyrone | 318 ± 18 |
| Tetramethylurea | 261 ± 5 |
| Trimethyl phosphate | 250 ± 8 |
| N,N-Dimethylacetoamide | 242 ± 6 |
| N,N-Dimethylbenzamide | 167 ± 16 |
| Phenylmethylsulfoxide | 141 ± 4 |
| 4-Methoxypyridine | 139 ± 2 |
| 4-Methylpyridine | 107 ± 2 |
| N,N-Dimethylcyclohexylamine | 118 ± 2 |
| N,N-Dimethylformamide | 115 ± 2 |
| Diphenylsulfoxide | 106 ± 2 |
| Flavone | 98 ± 6 |
| N,N-Dimethyl-n-propylamine | 95 ± 1 |
| Trimethylamine | 85 ± 2 |
| 2-n-Butylpyridine | 76 ± 2 |
| Pyridine | 76 ± 1 |
| Quinoline | 71 ± 3 |
| Tri-n-butylamine | 37 ± 3 |
| N,N-Dimethylbenzylamine | 38 ± 3 |
| Pyrimidine | 22.5 ± 0.5 |

The compound represented by formula (II) is described in detail below.

In formula (II), R²¹ and R²² each independently represents an alkyl group, and R²³ represents an alkyl group, an aryl group or a heterocyclic group. These groups each may be unsubstituted or substituted by a substituent. Examples of the substituent include those described below as the substituent for R⁵¹.

Specific examples of the alkyl group represented by R²¹ and R²² include a methyl group, an ethyl group, a propyl group, a butyl group, an isopropyl group, a tert-butyl group, a tert-amyl group, a cyclohexyl group, a 1-methylcyclohexyl group and a benzyl group. Specific examples of the aryl group include a phenyl group, a p-tolyl group and a p-methoxyphenyl group. Specific examples of the heterocyclic group include a 2-tetrahydrofuryl group and a 4-pyridyl group. These substituents each may be unsubstituted or may be substituted by another group. The alkyl group described herein does not include an alkenyl group and an alkynyl group. Two or more of R²¹, R²² and R²³ may combine with each other to form a ring.

The compound represented by formula (III) is described in detail below.

In formula (III), R³¹ and R³² each independently represents an alkyl group, an aryl group or a heterocyclic group. These groups each may be unsubstituted or substituted by a substituent. Examples of the substituent include those described below as the substituent for R⁵¹.

Specific examples of the alkyl group represented by R³¹ and R³² include a methyl group, an ethyl group, a propyl group, a butyl group, an isopropyl group, a tert-butyl group, a tert-amyl group, a cyclohexyl group, a 1-methylcyclohexyl group and benzyl group. Specific examples of the aryl group include a phenyl group, a p-tolyl group and a p-methoxyphenyl group. Specific examples of the heterocyclic group include a 2-tetrahydrofuryl group and a 4-pyridyl group. These substituents each may be unsubstituted or may be substituted by another group. R³¹ and R³² may combine with each other to form a ring.

The compound represented by formula (IV) is described in detail below.

In formula (IV), R⁴¹ and R⁴² each independently represents an alkyl group, an aryl group or a heterocyclic group, R⁴³ represents an alkyl group, an aryl group, a heterocyclic group or —N(R⁴⁴) (R⁴⁵), and R⁴⁴ and R⁴⁵ each independently represents an alkyl group, an aryl group or a heterocyclic group. These groups each may be unsubstituted or substituted by a substituent. Examples of the substituent include those described below as the substituent for R⁵¹.

Specific examples of the alkyl group represented by R⁴¹, R⁴² and R⁴³ include a methyl group, an ethyl group, a propyl group, a butyl group, an isopropyl group, a tert-butyl group, a tert-amyl group, a cyclohexyl group, a 1-methylcyclohexyl group and a benzyl group. Specific examples of the aryl group include a phenyl group, a p-tolyl group and a p-methoxyphenyl group. Specific examples of the heterocyclic group include a 2-tetrahydrofuryl group and a 4-pyridyl group. These substituents each may be unsubstituted or may be substituted by another group. Two or more of R⁴¹, R⁴² , R⁴³, R⁴⁴ and R⁴⁵ may combine with each other to form a ring.

The compound represented by formula (V) is described in detail below.

In formula (V), R⁵¹, R⁵² , R⁵³, R⁵⁴ and R⁵⁵ each independently represents a hydrogen atom or a substituent.

Examples of the substituent include a straight-chain, branched or cyclic alkyl group, a straight-chain, branched or cyclic alkenyl group, an alkynyl group, an aryl group, an acyloxy group, an alkoxycarbonyloxy group, an aryloxycarbonyloxy group, a carbamoyloxy group, a carbonamido group, a sulfonamido group, a carbamoyl group, a sulfamoyl group, an alkoxy group, an aryloxy group, an aryloxycarbonyl group, an alkoxycarbonyl group, an N-acylsulfamoyl group, an N-sulfamoylcarbamoyl group, an alkylsulfonyl group, an arylsulfonyl group, an alkoxycarbonylamino group, an aryloxycarbonylamino group, an amino group, an ammonio group, a cyano group, a nitro group, a carboxy group, a hydroxy group, a sulfo group, a mercapto group, an alkylsulfinyl group, an arylsulfinyl group, an alkylthio group, an arylthio group, a ureido group, a heterocyclic group (e.g., a 3- to 12-membered single ring or condensed ring containing at least one of nitrogen, oxygen and sulfur), a heterocyclicoxy group, a heterocyclicthio group, an acyl group, a sulfamoylamino group, a silyl group and a halogen atom.

Specifically, the substituent is a hydrogen atom, a straight-chain, branched or cyclic alkyl group having from 1 to 10 carbon atoms (e.g., trifluoromethyl, methyl, ethyl, propyl, heptafluoropropyl, isopropyl, butyl, tert-butyl, tert-pentyl, cyclopentyl, cyclohexyl, octyl, 2-ethylhexyl), a straight-chain, branched or cyclic alkenyl group having from 2 to 10 carbon atoms (e.g., vinyl, 1-methylvinyl, cyclohexen-1-yl), an alkynyl group having from 2 to 10 carbon atoms (e.g., ethynyl, 1-propynyl), an aryl group having from 6 to 14 carbon atoms (e.g., phenyl, naphthyl), an acyloxy group having from 1 to 10 carbon atoms (e.g., acetoxy, benzoyloxy), an alkoxycarbonyloxy group having from 2 to 10 carbon atoms (e.g., methoxycarbonyloxy, 2-methoxyethoxycarbonyloxy), an aryloxycarbonyloxy group having from 7 to 14 carbon atoms (e.g., phenoxycarbonyloxy), a carbamoyloxy group having from 1 to 12 carbon atoms (e.g., N,N-dimetylcarbamoyloxy), a carbonamido group having from 1 to 12 carbon atoms (e.g., formamido, N-methylacetamido, acetamido, N-methylformamido, benzamido), a sulfonamido group having from 1 to 10 carbon atoms (e.g., methanesulfonamido, benzenesulfonamido, p-toluenesulfonamido), a carbamoyl group having from 1 to 10 carbon atoms (e.g., N-methylcarbamoyl, N,N-diethylcarbamoyl, N-mesylcarbamoyl), a sulfamoyl group having from 0 to 10 carbon atoms (e.g., N-butylsulfamoyl, N,N-diethylsulfamoyl, N-methyl-N-(4-methoxyphenyl)sulfamoyl), an alkoxy group having from 1 to 10 carbon atoms (e.g., methoxy, propoxy, isopropoxy, octyloxy, tert-octyloxy), an aryloxy group having from 6 to 14 carbon atoms (e.g., phenoxy, 4-methoxyphenoxy, naphthoxy), an aryloxycarbonyl group having from 7 to 14 carbon atoms (e.g., phenoxycarbonyl, naphthoxycarbonyl), an alkoxycarbonyl group having from 2 to 10 carbon atoms (e.g., methoxycarbonyl, tert-butoxycarbonyl), an N-acylsulfamoyl group having from 1 to 12 carbon atoms (e.g., N-acetylsulfamoyl, N-benzoylsulfamoyl), an N-sulfamoyl-carbamoyl group having from 1 to 12 carbon atoms (e.g., N-methanesulfonylcarbamoyl), an alkylsulfonyl group having from 1 to 10 carbon atoms (e.g., methanesulfonyl, octyl-sulfonyl, 2-methoxyethylsulfonyl), an arylsulfonyl group having from 6 to 14 carbon atoms (e.g., benzenesulfonyl, p-toluenesulfonyl, 4-phenylsulfonylphenylsulfonyl), an alkoxycarbonylamino group having from 2 to 10 carbon atoms (e.g., ethoxycarbonylamino), an aryloxycarbonylamino group having from 7 to 14 carbon atoms (e.g., phenoxy-carbonylamino, naphthoxycarbonylamino), an amino group having from 0 to 10 carbon atoms (e.g., amino, methylamino, diethylamino, diisopropylamino, anilino, morpholino), an ammonio group having from 3 to 12 carbon atoms (e.g., trimethylammonio, dimethylbenzylammonio), a cyano group, a nitro group, a carboxy group, a hydroxy group, a sulfo group, a mercapto group, an alkylsulfinyl group having from 1 to 10 carbon atoms (e.g., methanesulfinyl, octane-sulfinyl), an arylsulfinyl group having from 6 to 14 carbon atoms (e.g., benzenesulfinyl, 4-chlorophenylsulfinyl, p-toluenesulfinyl), an alkylthio group having from 1 to 10 carbon atoms (e.g., methylthio, octylthio, cyclohexylthio), an arylthio group having from 6 to 14 carbon atoms (e.g., phenylthio, naphthylthio), a ureido group having from 1 to 13 carbon atoms (e.g., 3-methylureido, 3,3-dimethylureido, 1,3-diphenylureido), a heterocyclic group having from 2 to 15 carbon atoms (for example, a 3- to 12-membered single ring or condensed ring containing at least one of nitrogen, oxygen and sulfur as the heteroatom, e.g., 2-furyl, 2-pyranyl, 2-pyridyl, 2-thienyl, 2-imidazolyl, morpholino, 2-quinolyl, 2-benzimidazolyl, 2-benzothiazolyl, 2-benzoxazolyl), a heterocyclicoxy group (e.g., pyridyloxy, pyrazolyloxy), a heterocyclicthio group (e.g., tetrazolylthio, 1,3,4-thiadiazolylthio, 1,3,4-oxadiazolylthio, benzimidazolylthio), an acyl group having from 1 to 12 carbon atoms (e.g., acetyl, benzoyl, trifluoroacetyl), a sulfamoylamino group having from 0 to 10 carbon atoms (e.g., N-butylsulfamoylamino, N-phenylsulfamoylamino), a silyl group having from 3 to 12 carbon atoms (e.g., trimethyl-silyl, dimethyl-tert-butylsilyl) or a halogen atom (e.g., fluorine, chlorine, bromine).

These substituents each may further have a substituent and examples of the substituent include those described above. Two or more of R⁵¹, R⁵², R⁵³, R⁵⁴ and R⁵⁵ may combine with each other to form a ring.

Specific examples (Compounds (1) to (32)) of the compounds represented by formulae (II), (III), (IV) and (V), which are electron-donating compounds, are set forth below, however, the present invention should not be construed as being limited thereto.

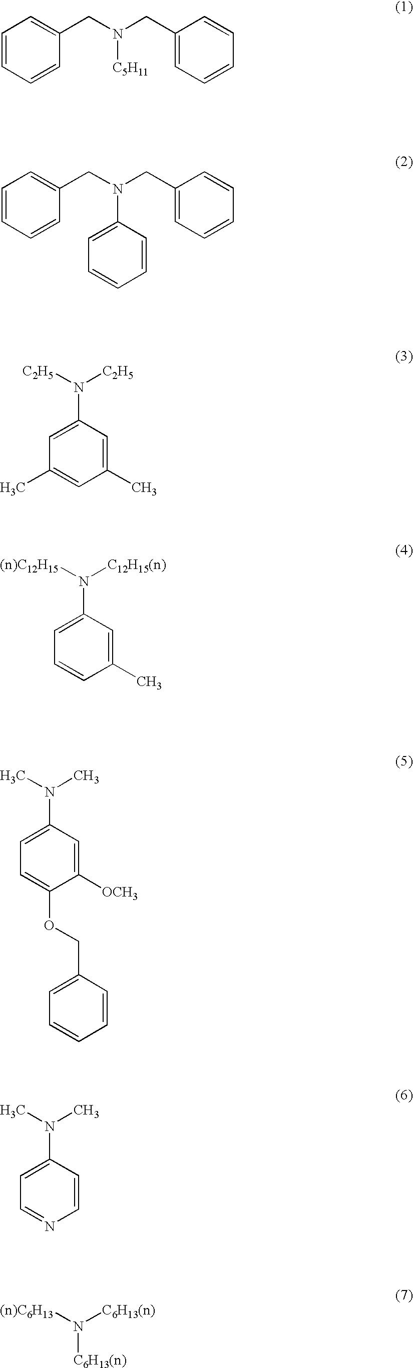

The compound having a phosphoryl group is described in detail below.

The “compound having a phosphoryl group” for use in the present invention (hereinafter sometimes referred to as a phosphoryl compound) may be any compound insofar as it has one or more phosphoryl group within its molecule. Particularly, a compound represented by formula (VI) is preferred.

In formula (VI), R⁶¹, R⁶² and R⁶³ each independently represents an alkyl group, an aryl group, an aralkyl group, an alkoxy group, an aryloxy group, an amino group or a heterocyclic group. These groups each may be unsubstituted or may have a substituent.

Examples of the alkyl group include a methyl group, an ethyl group, a butyl group, an octyl group, a dodecyl group, an isopropyl group, a tert-butyl group, a tert-amyl group, a tert-octyl group, a cyclohexyl group and a 1-methylcyclohexyl group.

Examples of the aryl group include a phenyl group, a cresyl group, a xylyl group, a naphthyl group, a 4-tert-butylphenyl group, a 4-tert-octylphenyl group, a 4-anisidyl group and a 3,5-dichlorophenyl group.

Examples of the aralkyl group include a benzyl group, a phenethyl and a 2-phenoxypropyl group.

Examples of the alkoxy group include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group and a benzyloxy group.

Examples of the aryloxy group include a phenoxy group, a cresyloxy group, an isopropylphenoxy group, a 4-tert-butylphenoxy group, a naphthoxy group and a biphenyloxy group. Examples of the amino group include a dimethylamino group, a diethylamino group, a dibutylamino group, a dioctylamino group, an N-methyl-N-hexylamino group, a dicyclohexylamino group, a diphenylamino group and an N-methyl-N-phenylamino group.

Preferably, R⁶¹ , R⁶² and R⁶³ are an alkyl group, an aryl group, an alkoxy group or an aryloxy group. More preferably, at least one of R⁶¹, R⁶² and R⁶³ is an alkyl group or an aryl group. Still more preferably, two or more of R⁶¹, R⁶² and R⁶³ are an alkyl group or an aryl group. In view of availability at a low price, R⁶¹, R⁶² and R⁶³ are preferably the same group.

When the group represented by R⁶¹, R⁶² or R⁶³ has a substituent, examples of the substituent include a halogen atom, an alkyl group, an aryl group, an alkoxy group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group and a phosphoryl group.

The substituent is preferably a substituted or unsubstituted alkyl, aryl, alkoxy or aryloxy group and examples thereof include a methyl group, an ethyl group, an isopropyl group, a tert-butyl group, a tert-octyl group, a phenyl group, a 4-alkoxyphenyl group, a 4-acyloxyphenyl group, a methoxy group and a phenoxy group.

R⁶³ is preferably a phenyl group, more preferably a phenyl group with at least one ortho position being substituted. Examples of the substituent at the ortho position include a straight-chain, branched or cyclic alkyl group, a straight-chain, branched or cyclic alkenyl group, an alkynyl group, an aryl group, an acyloxy group, an alkoxycarbonyloxy group, an aryloxycarbonyloxy group, a carbamoyloxy group, a carbonamido group, a sulfonamido group, a carbamoyl group, a sulfamoyl group, an alkoxy group, an aryloxy group, an aryloxycarbonyl group, an alkoxycarbonyl group, an N-acylsulfamoyl group, an N-sulfamoylcarbamoyl group, an alkylsulfonyl group, an arylsulfonyl group, an alkoxycarbonylamino group, an aryloxycarbonylamino group, an amino group, an ammonio group, a cyano group, a nitro group, a carboxy group, a hydroxy group, a sulfo group, a mercapto group, an alkylsulfinyl group, an arylsulfinyl group, an alkylthio group, an arylthio group, a ureido group, a heterocyclic group (for example, a 3- to 12-membered single ring or condensed ring containing at least one of nitrogen, oxygen and sulfur), a heterocyclicoxy group, a heterocyclicthio group, an acyl group, a sulfamoylamino group, a silyl group and a halogen atom.

Specifically, the substituent is a straight-chain, branched or cyclic alkyl group having from 1 to 10 carbon atoms (e.g., trifluoromethyl, methyl, ethyl, propyl, heptafluoropropyl, isopropyl, butyl, tert-butyl, tert-pentyl, cyclopentyl, cyclohexyl, octyl, 2-ethylhexyl), a straight-chain, branched or cyclic alkenyl group having from 2 to 10 carbon atoms (e.g., vinyl, 1-methylvinyl, cyclohexen-1-yl), an alkynyl group having from 2 to 10 carbon atoms (e.g., ethynyl, 1-propynyl), an aryl group having from 6 to 14 carbon atoms (e.g., phenyl, naphthyl), an acyloxy group having from 1 to 10 carbon atoms (e.g., acetoxy, benzoyloxy), an alkoxycarbonyloxy group having from 2 to 10 carbon atoms (e.g., methoxycarbonyloxy, 2-methoxyethoxycarbonyloxy), an aryloxycarbonyloxy group having from 7 to 14 carbon atoms (e.g., phenoxycarbonyloxy), a carbamoyloxy group having from 1 to 12 carbon atoms (e.g., N,N-dimethylcarbamoyloxy), a carbonamido group having from 1 to 12 carbon atoms (e.g., formamido, N-methylacetamido, acetamido, N-methylformamido, benzamido), a sulfonamido group having from 1 to 10 carbon atoms (e.g., methanesulfonamido, benzenesulfonamido, p-toluenesulfonamido), a carbamoyl group having from 1 to 10 carbon atoms (e.g., N-methylcarbamoyl, N,N-diethylcarbamoyl, N-mesylcarbamoyl), a sulfamoyl group having from 0 to 10 carbon atoms (e.g., N-butylsulfamoyl, N,N-diethylsulfamoyl, N-methyl-N-(4-methoxyphenyl)sulfamoyl), an alkoxy group having from 1 to 10 carbon atoms (e.g., methoxy, propoxy, isopropoxy, octyloxy, tert-octyloxy), an aryloxy group having from 6 to 14 carbon atoms (e.g., phenoxy, 4-methoxyphenoxy, naphthoxy), an aryloxycarbonyl group having from 7 to 14 carbon atoms (e.g., phenoxycarbonyl, naphthoxycarbonyl), an alkoxycarbonyl group having from 2 to 10 carbon atoms (e.g., methoxycarbonyl, tert-butoxycarbonyl), an N-acylsulfamoyl group having from 1 to 12 carbon atoms (e.g., N-ethylsulfamoyl, N-benzoylsulfamoyl), an N-sulfamoyl-carbamoyl group having from 1 to 12 carbon atoms (e.g., N-methanesulfonylcarbamoyl), an alkylsulfonyl group having from 1 to 10 carbon atoms (e.g., methanesulfonyl, octylsulfonyl, 2-methoxyethylsulfonyl), an arylsulfonyl group having from 6 to 14 carbon atoms (e.g., benzenesulfonyl, p-toluenesulfonyl, 4-phenylsulfonyl-phenylsulfonyl), an alkoxycarbonylamino group having from 2 to 10 carbon atoms (e.g., ethoxycarbonylamino), an aryloxycarbonylamino group having from 7 to 14 carbon atoms (e.g., phenoxycarbonylamino, naphthoxycarbonylamino), an amino group having from 0 to 10 carbon atoms (e.g., amino, methylamino, diethylamino, diisopropylamino, anilino, morpholino), an ammonio group having from 3 to 12 carbon atoms (e.g., trimethylammonio, dimethylbenzylammonio), a cyano group, a nitro group, a carboxy group, a hydroxy group, a sulfo group, a mercapto group, an alkylsulfinyl group having from 1 to 10 carbon atoms (e.g., methanesulfinyl, octanesulfinyl), an arylsulfinyl group having from 6 to 14 carbon atoms (e.g., benzenesulfinyl, 4-chlorophenylsulfinyl, p-toluenesulfinyl), an alkylthio group having from 1 to 10 carbon atoms (e.g., methylthio, octylthio, cyclohexylthio), an arylthio group having from 6 to 14 carbon atoms (e.g., phenylthio, naphthylthio), a ureido group having from 1 to 13 carbon atoms (e.g., 3-methylureido, 3,3-dimethylureido, 1,3-diphenylureido), a heterocyclic group having from 2 to 15 carbon atoms (for example, a 3- to 12-membered single ring or condensed ring containing at least one of nitrogen, oxygen and sulfur as a heteroatom, e.g., 2-furyl, 2-pyranyl, 2-pyridyl, 2-thienyl, 2-imidazolyl, morpholino, 2-quinolyl, 2-benzimidazolyl, 2-benzothiazolyl, 2-benzoxazolyl), a heterocyclicoxy group (e.g., pyridyloxy, pyrazolyloxy), a heterocyclicthio group (e.g., tetrazolylthio, 1,3,4-thiadiazolylthio, 1,3,4-oxadiazolylthio, benzimidazolylthio), an acyl group having from 1 to 12 carbon atoms (e.g., acetyl, benzoyl, trifluoroacetyl), a sulfamoylamino group having from 0 to 10 carbon atoms (e.g., N-butylsulfamoylamino, N-phenylsulfamoylamino), a silyl group having from 3 to 12 carbon atoms (e.g., trimethylsilyl, dimethyl-tert-butylsilyl) or a halogen atom (e.g., fluorine, chlorine, bromine).

Such a substituent may be present at the position other than the ortho position of the phenyl group represented by R⁶³.

When R⁶³ is a phenyl group having a substituent at the ortho position, R⁶¹ and R⁶² each is preferably an alkyl group or an aryl group.

Specific examples (Compounds (II-1) to (II-90)) of the compound having a phosphoryl group are set forth below, however, the present invention should not be construed as being limited thereto.

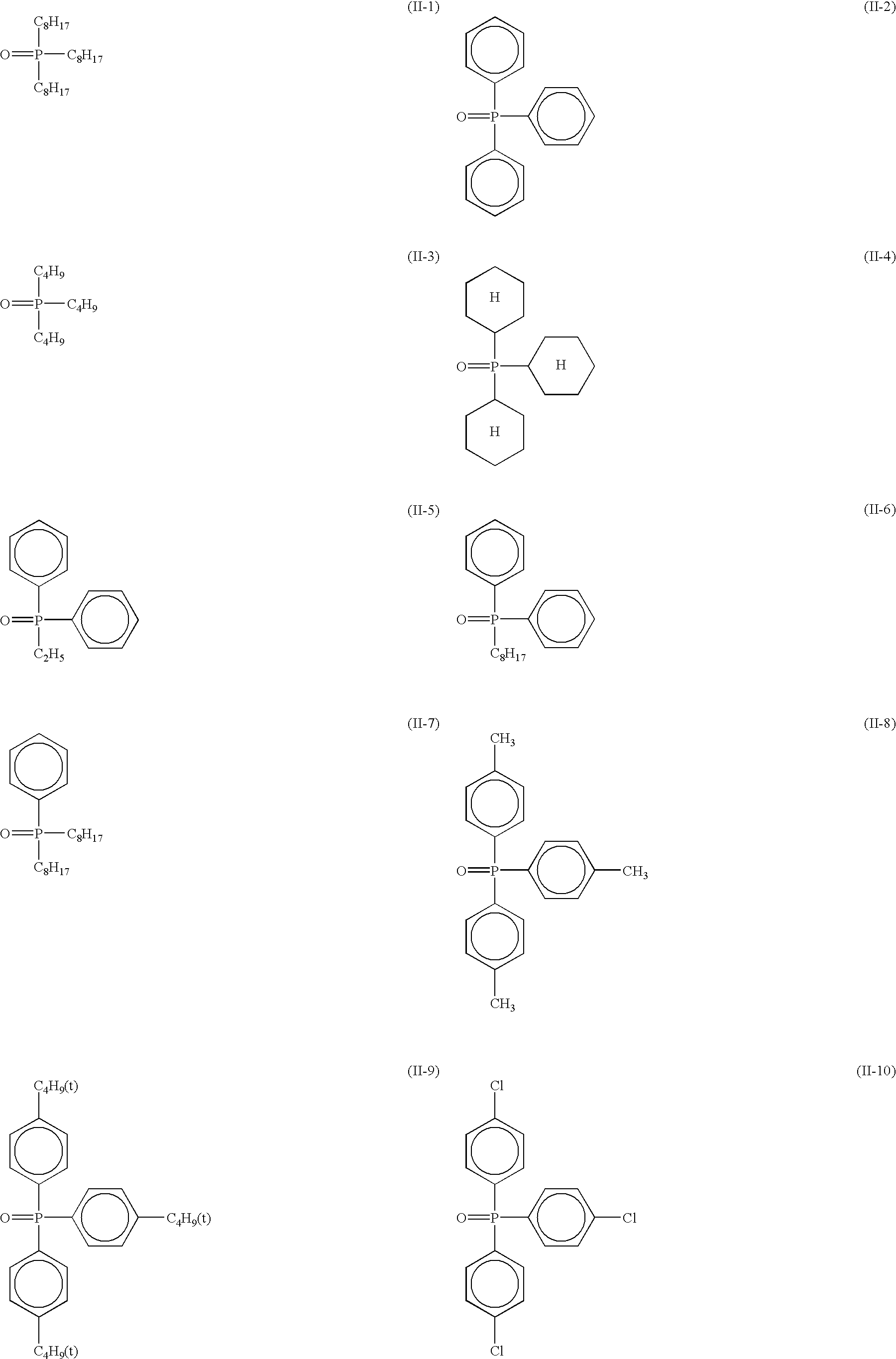

The amount added of the compound which satisfies at least one of Conditions (A) and (B) is preferably from 0.01 to 4.0 g/m², more preferably from 0.1 to 2.0 g/m². The compound is preferably contained in an amount of 2 to 40% by mol, more preferably from 5 to 30% by mol, per mol of silver present on the surface having an image-forming layer.

The ratio ((1)/(2)) in the amount added of the phenol compound (compound represented by formula (I)) (compound of (1)) to the compound (compound (2)) which satisfies at least one of Conditions (A) and (B) is preferably from 0.1 to 10, more preferably from 0.1 to 2.0, still more preferably from 0.5 to 1.5.

The phenol compound (compound represented by formula (I)) and the compound which satisfies at least one of Conditions (A) and (B) are preferably incorporated into the image-forming layer containing the organic silver salt. However, it is also possible to incorporate one of these compounds into the image-forming layer and the other into a non-image-forming layer adjacent to the image-forming layer or to incorporate both of these compounds into the non-image-forming layer. Furthermore, when the image-forming layer is composed of a plurality of layers, those compounds may be incorporated into different layers.

The phenol compound (compound represented by formula (I)) and the compound which satisfies at least one of Conditions (A) and (B) may be incorporated into the image recording material by incorporating these compounds into a coating solution in any form, for example, in the form of a solution, an emulsified dispersion or a solid fine particle dispersion.

Examples of the well-known emulsification dispersion method include a method of dissolving the compound using an oil such as dibutyl phthalate, tricresyl phosphate, glycerol triacetate or diethyl phthalate, and an auxiliary solvent such as ethyl acetate or cyclohexanone, and mechanically preparing an emulsified dispersion from the solution.

Examples of the solid fine particle dispersion method include a method where the phenol compound (compound represented by formula (I)) and the compound which satisfies at least one of Conditions (A) and (B) each in a powder form are dispersed in an appropriate solvent such as water using a ball mill, a colloid mill, a vibrating ball mill, a sand mill, a jet mill, a roller mill or ultrasonic wave, thereby preparing a solid dispersion. In this case, a protective colloid (e.g., polyinyl alcohol) or a surface active agent (for example, an anionic surface active agent such as sodium triisopropyl-naphthalenesulfonate (a mixture of those where the substitution positions of three isopropyl groups are different) may be used. Into an aqueous dispersion, an antiseptic (e.g., benzisothiazolinone sodium salt) may be incorporated.

<Support>

The support for use in the present invention is preferably a polyester film, particularly a polyethylene terephthalate film, which is subjected to a heat treatment in a temperature range from 130 to 185° C. so as to relax the residual internal strain generated at the biaxial stretching of the film and eliminate the strain of heat shrinkage generated during the heat development processing. In the case of a heat-developable image recording material for medical use, a transparent support may be colored with a blue dye (for example, Dye-1 described in Example of JP-A-8-240877) or may not be colored.

To the support, a technique relating to an undercoat layer using, for example, a water-soluble polyester described in JP-A-11-84574, a styrene-butadiene copolymer described in JP-A-10-186565 and a vinylidene chloride copolymer described in Japanese Patent Application No. 11-106881, paragraph Nos. 0063 to 0080 is preferably applied. Also, techniques relating to an antistatic layer or an undercoat layer described in JP-A-56-143430, JP-A-56-143431, JP-A-58-62646, JP-A-56-120519, JP-A-11-84573, paragraph Nos. 0040 to 0051, U.S. Pat. No. 5,575,957 and JP-A-11-223898, paragraph Nos. 0078 to 0084 may be applied.

The heat-developable image recording material of the present invention is preferably a mono-sheet type (a type where an image can be formed on the heat-developable image recording material without using a sheet for receiving the image separately from the image-recording material sheet).

<Others>

To the organic silver salt-containing layer of the heat-developable image recording material of the present invention, a hydrophilic polymer such as gelatin, polyinyl alcohol, methyl cellulose or hydroxypropyl cellulose may be added, if desired. The amount of the hydrophilic polymer added is 30 mass % or less, preferably 20 mass % or less, based on the total amount of binder in the organic silver salt-containing layer.

In the heat-developable image recording material of the present invention, the solvent (for convenience sake, both the solvent and the dispersion medium are hereinafter collectively denoted as a solvent) for a coating solution of the organic silver salt-containing layer is an aqueous solvent containing 30 mass % or more of water. The component other than water may be an arbitrary water-miscible organic solvent such as methyl alcohol, ethyl alcohol, isopropyl alcohol, methyl cellosolve, ethyl cellosolve, dimethylformamide or ethyl acetate. The water content in the solvent for the coating solution is preferably 50 mass % or more, more preferably 70 mass % or more.

Preferred examples of the solvent composition include water, water/methyl alcohol (=90/10), water/methyl alcohol (=70/30), water/methyl alcohol/dimethylformamide (=80/15/5), water/methyl alcohol/ethyl cellosolve (=85/10/5) and water/methyl alcohol/isopropyl alcohol (=85/10/5) (the numerical values are mass %).

The heat-developable image recording material of the present invention may contain an antifoggant, a stabilizer and a stabilizer precursor. Examples of the antifoggant, stabilizer and stabilizer precursor include those described in JP-A-10-62899, paragraph No. 0070, and the patents cited in EP-A-803764, from page 20 line 57 to page 21, line 7. As the antifoggant, an organic halogen compound can be suitably used and examples thereof include those described in the patents cited in JP-A-11-65021, paragraph Nos. 0111 to 0112. Particularly, an organic polyhalogen compound represented by formula (II) described in JP-A-10-33934 (specifically, tribromomethylnaphthylsulfone, tribromomethylphenylsulfone, tribromomethyl(4-(2,4,6-trimethylphenylsulfonyl)phenyl)sulfone, etc.) is preferred.

For incorporating the antifoggant into the heat-developable image recording material, the methods described above in regard to the method for incorporating the heat developing agent can be employed. The polyhalogen compound is also preferably added in the form of a solid fine particle dispersion.

Other examples of the antifoggant include a mercury (II) salt described in JP-A-11-65021, paragraph No. 0113, a benzoic acid described in JP-A-11-65021, paragraph No. 0114, a salicylic acid derivative represented by formula (Z) described in Japanese Patent Application No. 11-87297, and a formalin scavenger compound represented by formula (S) described in Japanese Patent Application No. 11-23995.

The heat-developable image recording material of the present invention may contain an azolium salt for the purpose of inhibiting fog. Examples of the azolium salt include compounds represented by formula (XI) described in JP-A-59-193447, compounds described in JP-B-55-12581, and compounds represented by formula (II) described in JP-A-60-153039.

The azolium salt may be added to any site of the image recording material, however, preferably added to a layer on the surface having the photosensitive layer, more preferably to the organic silver salt-containing layer. The azolium salt may be added at any stage during the preparation of a coating solution. For example, in the case of adding to the organic silver salt-containing layer, the azolium salt may be added at any stage during the preparation of organic silver salt and the preparation of coating solution for the organic silver salt-containing layer, but is preferably added at a stage after the preparation of organic silver salt and immediately before coating. The azolium salt may be added in any form, for example, in the form of powder, a solution or a fine particle dispersion, and also may be added as a solution mixed with other additive(s) such as sensitizing dye, heat developing agent or toning agent.

The amount of the azolium salt added may be any amount but is preferably from 1×10⁻⁶ to 2 mol, more preferably from 1×10⁻³ to 0.5 mol, per mol of silver.

The heat-developable image recording material of the present invention may contain a mercapto compound, a disulfide compound or a thione compound, for example, to control the development by inhibiting or accelerating development, to increase the spectral sensitization efficiency or to improve preservability before and after development.

Examples of the mercapto compound, disulfide compound and thione compound include compounds described in JP-A-10-62899, paragraph Nos. 0067 to 0069, compounds represented by formula (I) described in JP-A-10-186572 and specific examples thereof described in paragraph Nos. 0033 to 0052, compounds described in EP-A-803764, page 20, lines 36 to 56. Among these, mercapto-substituted heteroaromatic compounds are preferred.

The heat-developable image recording material of the present invention preferably contains a toning agent. Examples of the toning agent include those described in JP-A-10-62899, paragraph Nos. 0054 to 0055, and EP-A-803764, page 21, lines 23 to 48. Particularly, preferred are phthalazinone, a phthalazine derivative or metal salt, or derivatives such as 4-(1-naphthyl)phthalazinone, 6-chlorophthalazinone, 5,7-dimethoxyphthalazinone and 2,3-dihydro-1,4-phthalazinedione; a combination of a phthalazinone with a phthalic acid derivative (e.g., phthalic acid, 4-methylphthalic acid, 4-nitrophthalic acid, tetrachlorophthalic anhydride); phthalazines (e.g., phthalazine, phthalazine derivative or metal salt, derivatives such as 4-(1-naphthyl)phthalazine, 6-isopropylphthalazine, 6-tert-butylphthalazine, 6-chlorophthalazine, 5,7-dimethoxyphthalazine and 2,3-dihydrophthalazine); and a combination of a phthalazine with a phthalic acid derivative (e.g., phthalic acid, 4-methylphthalic acid, 4-nitrophthalic acid, tetrachlorophthalic anhydride), with a combination of a phthalazine with a phthalic acid derivative being more preferred.

The heat-developable image recording material of the present invention may contain a plasticizer or a lubricant. Suitable examples of the plasticizer and lubricant include those described in JP-A-11-65021, paragraph No. 0117.

The heat-developable image recording material of the present invention may contain a super high contrast imparting agent for the purpose of forming a super high contrast image. Suitable examples of the super high contrast imparting agent which can be used include compounds described in JP-A-11-65021, paragraph No. 0118, and compounds represented by formulae (III) to (V) (specific compounds in Chemical Formulae 21 to 24) described in Japanese Patent Application No. 11-91652. Also, acrylonitriles and specifically, compounds CN-1 to CN-13 described in U.S. Pat. No. 5,545,515 may be used.

The super high contrast imparting agent is preferably selected from the group consisting of a substituted alkene derivative, a substituted isoxazole derivative and an acetal compound represented by the following formulae (VII), (VIII) and (IX), respectively:

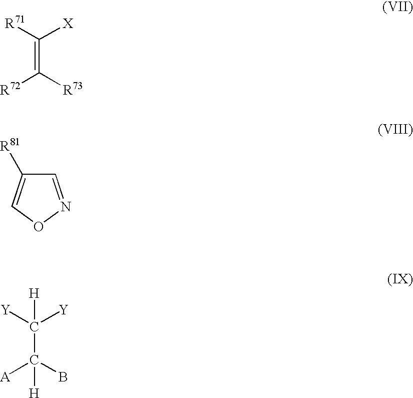

The compound represented by formula (VII) is described in detail below.

In formula (VII), R⁷¹, R⁷² and R⁷³ each independently represents a hydrogen atom or a substituent.

When R⁷¹, R⁷² and R⁷³ each represents a substituent, examples of the substituent include a halogen atom (e.g., fluorine, chlorine, bromine, iodine), an alkyl group (including a cycloalkyl group and an active methine group), an aralkyl group, an alkenyl group, an alkynyl group, an aryl group, a heterocyclic group (including an N-substituted nitrogen-containing heterocyclic group), a heterocyclic group containing a quaternized nitrogen atom (e.g., pyridinio), an acyl group, an alkoxycarbonyl group, an aryloxycarbonyl group, a carbamoyl group, a carboxy group or a salt thereof, an imino group, an imino group substituted by N atom, a thiocarbonyl group, a sulfonyl-carbamoyl group, an acylcarbamoyl group, a sulfamoyl-carbamoyl group, a carbazoyl group, an oxalyl group, an oxamoyl group, a cyano group, a thiocarbamoyl group, a hydroxy group or a salt thereof, an alkoxy group (including a group containing as a repeating unit an ethyleneoxy group or a propyleneoxy group), an aryloxy group, a heterocyclicoxy group, an acyloxy group, an alkoxycarbonyloxy group, aryloxycarbonyloxy group, a carbamoyloxy group, a sulfonyloxy group, an amino group, an alkylamino group, an arylamino group, a heterocyclic amino group, an acylamino group, a sulfonamido group, a ureido group, a thioureido group, an imido group, an alkoxycarbonylamino group, an aryloxycarbonylamino group, a sulfamoylamino group, a semicarbazido group, a thiosemicarbazido group, a hydrazino group, a quaternary ammonio group, an oxamoylamino group, an alkylsulfonylureido group, an arylsulfonylureido group, an acylureido group, an acylsulfamoylamino group, a nitro group, a mercapto group, an alkylthio group, an arylthio group, a heterocyclicthio group, an acylthio group, an alkylsulfonyl group, an arylsulfonyl group, an alkylsulfinyl group, an arylsulfinyl group, a sulfo group or a salt thereof, a sulfamoyl group, an acylsulfamoyl group, a sulfonylsulfamoyl group or a salt thereof, a phosphoryl group, a group containing a phosphoric amide or phosphoric ester structure, a silyl group and a stannyl group. These substituents each may be further substituted by the substituent described here.

Among the substituents represented by R⁷¹, R⁷² and R⁷³, a group having a total carbon atom number of 0 to 30 is preferred. Specifically, a group having the same meaning as the electron attractive group represented by Z in formula (VII) which is described later, an alkyl group, a hydroxy group or a salt thereof, a mercapto group or a salt thereof, an alkoxy group, an aryloxy group, a heterocyclicoxy group, an alkylthio group, an arylthio group, a heterocyclicthio group, an amino group, an alkylamino group, an arylamino group, a heterocyclic amino group, a ureido group, an acylamino group, a sulfonamido group and a substituted or unsubstituted aryl group are preferred.

R⁷¹ is preferably a hydrogen atom, an electron attractive group, an aryl group, an alkylthio group, an alkoxy group, an acylamino group or a silyl group, more preferably an electron attractive group or an aryl group.

When R⁷¹ represents an electron attractive group, R⁷¹ is preferably a group having a total carbon atom number of 0 to 30, specifically, a cyano group, a nitro group, an acyl group, a formyl group, an alkoxycarbonyl group, an aryloxycarbonyl group, a thiocarbonyl group, an imino group, an imino group substituted by N atom, an alkylsulfonyl group, an arylsulfonyl group, a carbamoyl group, a sulfamoyl group, a trifluoromethyl group, a phosphoryl group, a carboxyl group or a salt thereof, or a saturated or unsaturated heterocyclic group, more preferably a cyano group, an acyl group, a formyl group, an alkoxycarbonyl group, a carbamoyl group, an imino group, an imino group substituted by N atom, a sulfamoyl group, a carboxyl group or a salt thereof, or a saturated or unsaturated heterocyclic group, still more preferably a cyano group, a formyl group, an acyl group, an alkoxycarbonyl group, a carbamoyl group or a saturated or unsaturated heterocyclic group.

When R⁷¹ represents an aryl group, R⁷¹ is preferably a substituted or unsubstituted phenyl group having a total carbon atom number of 6 to 30. The substituent may be any appropriate substituent but is preferably an electron attractive substituent.

In formula (VII), when R⁷² and R⁷³ each represents a substituent, R⁷² and R⁷³ each is preferably a group having the same meaning as the electron attractive group represented by Z in formula (VII) which is described later, an alkyl group, a hydroxyl group (or a salt thereof), a mercapto group or a salt thereof, an alkoxy group, an aryloxy group, a heterocyclicoxy group, an alkylthio group, an arylthio group, a heterocyclicthio group, an amino group, an alkylamino group, an anilino group, a heterocyclicamino group, an acylamino group, or a substituted or unsubstituted phenyl group.

More preferably, one of R⁷² and R⁷³ is a hydrogen atom and the other is a substituent. The substituent is preferably an alkyl group, a hydroxyl group or a salt thereof, a mercapto group or a salt thereof, an alkoxyl group, an aryloxy group, a heterocyclicoxy group, an alkylthio group, an arylthio group, a heterocyclicthio group, an amino group, an alkylamino group, an anilino group, a heterocyclicamino group, an acylamino group (particularly a perfluoroalkanamido group), a sulfonamido group, a substituted or unsubstituted phenyl group, or a heterocyclic group, more preferably a hydroxyl group or a salt thereof, a mercapto group or a salt thereof, an alkoxyl group, an aryloxy group, a heterocyclicoxy group, an alkylthio group, an arylthio group, a heterocyclicthio group or a heterocyclic group, still more preferably a hydroxyl group or a salt thereof, an alkoxyl group, or a heterocyclic group.

In formula (VII), Z represents an electron attractive group or a silyl group, preferably an electron attractive group.

The electron attractive group represented by Z is a substituent having a Hammett substituent constant σₚ of a positive value. Specific examples thereof include a cyano group, an alkoxycarbonyl group, an aryloxycarbonyl group, a carbamoyl group, an imino group, an imino group substituted by N atom, a thiocarbonyl group, a sulfamoyl group, an alkylsulfonyl group, an arylsulfonyl group, a nitro group, a halogen atom, a perfluoroalkyl group, a perfluoroalkanamido group, a sulfonamido group, an acyl group, a formyl group, a phosphoryl group, a carboxyl group or a salt thereof, a sulfo group or a salt thereof, a heterocyclic group, an alkenyl group, an alkynyl group, an acyloxy group, an acylthio group, a sulfonyloxy group and an aryl group substituted with such an electron attractive group. The heterocyclic group is a saturated or unsaturated heterocyclic group and examples thereof include a pyridyl group, a quinolyl group, a quinoxalinyl group, a pyrazinyl group, a benzotriazolyl group, an imidazolyl group, a benzimidazolyl group, a hydantoin-1-yl group, a succinimido group and a phthalimido group.

The electron attractive group represented by Z may further have a substituent. Examples of the substituent include the substituents represented by R⁷¹, R⁷² and R⁷³ in formula (VII).

When Z represents an electron attractive group, Z is preferably a group having a total carbon atom number of 0 to 30, specifically, a cyano group, an alkoxycarbonyl group, an aryloxycarbonyl group, a carbamoyl group, a thiocarbonyl group, an imino group, an imino group substituted by N atom, a sulfamoyl group, an alkylsulfonyl group, an arylsulfonyl group, a nitro group, a perfluoroalkyl group, an acyl group, a formyl group, a phosphoryl group, an acyloxy group, an acylthio group or a phenyl group substituted by an appropriate electron attractive group, more preferably a cyano group, an alkoxycarbonyl group, a carbamoyl group, an imino group, a sulfamoyl group, an alkylsulfonyl group, an arylsulfonyl group, an acyl group, a formyl group, a phosphoryl group, a trifluoromethyl group or a phenyl group substituted by an appropriate electron attractive group, still more preferably a cyano group, a formyl group, an acyl group, an alkoxycarbonyl group, an imino group or a carbamoyl group.

When Z represents a silyl group, Z is preferably a trimethylsilyl group, a tert-butyldimethylsilyl group, a phenyldimethylsilyl group, a triethylsilyl group, a triisopropylsilyl group or a trimethylsilyldimethylsilyl group.

In formula (VII), R⁷¹ and Z, R⁷² and R⁷³, R⁷¹ and R⁷², and R⁷³ and Z may combine with each other to form a ring structure. In particular, R⁷¹ and Z, or R⁷² and R⁷³ preferably form a ring structure.

The ring structure formed is a non-aromatic carbon ring or a non-aromatic heterocyclic ring. The ring structure is preferably a 5- to 7-membered ring having a total carbon atom number (including substituent(s)) of 1 to 40, more preferably from 3 to 30.

Among the compounds represented by formula (VII), preferred are the compounds where Z is a cyano group, a formyl group, an acyl group, an alkoxycarbonyl group, an imino group or a carbamoyl group, R⁷¹ is an electron attractive group or an aryl group, one of R⁷² and R⁷¹ is a hydrogen atom and the other is a hydroxyl group or a salt thereof, a mercapto group or a salt thereof, an alkoxyl group, an aryloxy group, a heterocyclicoxy group, an alkylthio group, an arylthio group, a heterocyclicthio group or a heterocyclic group.

Among the compounds represented by formula (VII), more preferred are the compounds where Z and R⁷¹ form a 5-to 7-membered non-aromatic ring structure, one of R⁷² and R⁷³ is a hydrogen atom and the other is a hydroxyl group or a salt thereof, a mercapto group or a salt thereof, an alkoxyl group, an aryloxy group, a heterocyclicoxy group, an alkylthio group, an arylthio group, a heterocyclicthio group or a heterocyclic group.

In this case, Z which forms a non-aromatic ring structure together with R⁷¹ is preferably an acyl group, a carbamoyl group, an oxycarbonyl group, a thiocarbonyl group or a sulfonyl group, and R⁷¹ is preferably an acyl group, a carbamoyl group, an oxycarbonyl group, a thiocarbonyl group, a sulfonyl group, an imino group, an imino group substituted by N atom, an acylamino group or a carbonylthio group.

The compound represented by formula (VIII) is described below.

In formula (VIII), the substituent represented by R⁸¹ is the same as the substituent for R⁷¹, R⁷² or R⁷³ in formula (VII). R⁸¹ is preferably an electron attractive group or an aryl group.

When R⁸¹ represents an electron attractive group, R⁸¹ is preferably a group having a total carbon atom number of 0 to 30, specifically, a cyano group, a nitro group, an acyl group, a formyl group, an alkoxycarbonyl group, an aryloxycarbonyl group, an alkylsulfonyl group, an aryl-sulfonyl group, a carbamoyl group, a sulfamoyl group, a trifluoromethyl group, a phosphoryl group, an imino group or a saturated or unsaturated heterocyclic group, more preferably a cyano group, an acyl group, a formyl group, an alkoxycarbonyl group, a carbamoyl group, a sulfamoyl group, an alkylsulfonyl group, an arylsulfonyl group or a heterocyclic group, still more preferably a cyano group, a formyl group, an acyl group, an alkoxycarbonyl group, a carbamoyl group or a heterocyclic group.

When R⁸¹ represents an aryl group, R⁸¹ is preferably a substituted or unsubstituted phenyl group having a total carbon atom number of 6 to 30. Examples of the substituent include the substituents represented by R⁷¹, R⁷² or R⁷³ in formula (VII).

R⁸¹ is more preferably a cyano group, an alkoxy-carbonyl group, a carbamoyl group, a heterocyclic group or a substituted or unsubstituted phenyl group, most preferably a cyano group, a heterocyclic group or an alkoxycarbonyl group.

The compound represented by formula (IX) is described in detail below.

In formula (IX), X and Y each independently represents a hydrogen atom or a substituent, or X and Y may combine with each other to form a ring structure.

Examples of the substituent represented by X or Y include the substituents represented by R⁷¹, R⁷² or R⁷³ in formula (VII).

Specific examples thereof include an alkyl group (including a perfluoroalkyl group, a trichloromethyl group, etc.), an aryl group, a heterocyclic group, a halogen atom, a cyano group, a nitro group, an alkenyl group, an alkynyl group, an acyl group, a formyl group, an alkoxycarbonyl group, an aryloxycarbonyl group, an imino group, an imino group substituted by N atom, a carbamoyl group, a thiocarbonyl group, an acyloxy group, an acylthio group, an acylamino group, an alkylsulfonyl group, an arylsulfonyl group, a sulfamoyl group, a phosphoryl group, a carboxy group or a salt thereof, a sulfo group or a salt thereof, a hydroxyl group or a salt thereof, a mercapto group or a salt thereof, an alkoxy group, an aryloxy group, a heterocyclicoxy group, an alkylthio group, an arylthio group, a heterocyclicthio group, an amino group, an alkylamino group, an anilino group, a heterocyclicamino group and a silyl group.

These substituents each may further have a substituent. X and Y may combine with each other to form a ring structure. The ring structure formed may be a non-aromatic carbon ring or a non-aromatic heterocyclic ring.

The substituent represented by X or Y preferably has a total carbon atom number of 1 to 40, more preferably from 1 to 30. Specific examples thereof include a cyano group, an alkoxycarbonyl group, an aryloxycarbonyl group, a carbamoyl group, an imino group, an imino group substituted by N atom, a thiocarbonyl group, a sulfamoyl group, an alkylsulfonyl group, an arylsulfonyl group, a nitro group, a perfluoroalkyl group, an acyl group, a formyl group, a phosphoryl group, an acylamino group, an acyloxy group, an acylthio group, a heterocyclic group, an alkylthio group, an alkoxy group and an aryl group.

X and Y each is more preferably a cyano group, a nitro group, an alkoxycarbonyl group, a carbamoyl group, an acyl group, a formyl group, an acylthio group, an acylamino group, a thiocarbonyl group, a sulfamoyl group, an alkylsulfonyl group, an arylsulfonyl group, an imino group, an imino group substituted by N atom, a phosphoryl group, a trifluoromethyl group, a heterocyclic group or a substituted phenyl group, still more preferably a cyano group, an alkoxycarbonyl group, a carbamoyl group, an alkylsulfonyl group, an arylsulfonyl group, an acyl group, an acylthio group, an acylamino group, a thiocarbonyl group, a formyl group, an imino group, an imino group substituted by N atom, a heterocyclic group or a phenyl group substituted by an arbitrary electron attractive group.

It is also preferred that X and Y are combined with each other to form a non-aromatic carbon ring or a non-aromatic heterocyclic ring. The ring structure formed is preferably a 5- to 7-membered ring having a total carbon atom number including substituent(s) of 1 to 40, more preferably from 3 to 30.

X and Y which form the ring structure each is preferably an acyl group, a carbamoyl group, an oxycarbonyl group, a thiocarbonyl group, a sulfonyl group, an imino group, an imino group substituted by N atom, an acylamino group or a carbonylthio group.

In formula (IX), A and B each independently represents an alkoxy group, an alkylthio group, an alkylamino group, an aryloxy group, an arylthio group, an anilino group, a heterocyclicoxy group, a heterocyclicthio group or a heterocyclicamino group, or A and B may combine with each other to form a ring structure.

The group represented by A or B preferably has a total carbon atom number of 1 to 40, more preferably from 1 to 30, and may further have a substituent.

A and B are more preferably combined with each other to form a ring structure. The ring structure formed is preferably a 5- to 7-membered non-aromatic heterocyclic ring having a total carbon atom number of 1 to 40, more preferably from 3 to 30.

Examples of the case where A and B are combined (—A—B—) include —O—(CH₂)₂—, —O—(CH₂)₃—O—, —S—(CH₂)₂—S—, —S—(CH₂)₃—S—, —S—Ph—S—, —N(CH₃)—(CH₂)₂—O—, —N(CH₃)—(CH₂)₂—S—, —O—(CH₂)₂—S—, —O—(CH₂)₃—S—, —N(CH₃)—Ph—O—, —N(CH₃)—Ph—S— and —N(Ph)—(CH₂)₂—S—.

The compound represented by formula (VII), (VIII) or (IX) may contain an adsorptive group which adsorbs to photosensitive silver halide. Examples of the adsorptive group include an alkylthio group, an arylthio group, a thiourea group, a thioamido group, a mercapto heterocyclic group and a triazole group described in U.S. Pat. Nos. 4,385,108 and 4,459,347, JP-A-59-195233, JP-A-59-200231, JP-A-59-201045, JP-A-59-201046, JP-A-59-201047, JP-A-59-201048, JP-A-59-201049, JP-A-61-170733, JP-A-61-270744, JP-A-62-948, JP-A-63-234244, JP-A-63-234245 and JP-A-63-234246. The adsorptive group to photosensitive silver halide may be in a form of precursor. Examples of the precursor include groups described in JP-A-2-285344.

The compound represented by formula (VII), (VIII) or (IX) may contain a ballast group or a polymer which is conventionally used in an immobile photographic additive such as a coupler. Particularly, the compound containing a ballast group is preferred in the present invention.

The ballast group is a group having 8 or more carbon atoms, which is relatively inert to photographic properties. The ballast group can be selected, for example, from an alkyl group, an aralkyl group, an alkoxy group, a phenyl group, an alkylphenyl group, a phenoxy group and an alkylphenoxy group. Examples of the polymer include those described in JP-A-1-100530.

The compound represented by formula (VII), (VIII) or (IX) may contain a cationic group (specifically, a group containing a quaternary ammonio group or a nitrogen-containing heterocyclic group having a quaternized nitrogen atom), a group having a repeating unit of ethyleneoxy group or propyleneoxy group, an alkylthio group, an arylthio group, a heterocyclicthio group, or a dissociative group capable of being dissociated by a base, such as carboxy group, sulfo group, acylsulfamoyl group or carbamoylsulfamoyl group. Particularly, the compound containing a group having a repeating unit of ethyleneoxy group or propyleneoxy group, an alkylthio group, an arylthio group or a heterocyclic-thio group is preferred in the present invention.

Specific examples of these groups include compounds described in JP-A-7-234471, JP-A-5-333466, JP-A-6-19032, JP-A-6-19031, JP-A-5-45761, U.S. Pat. Nos. 4,994,365 and 4,988,604, JP-A-3-259240, JP-A-7-5610, JP-A-7-244348 and U.S. Pat. No. 4,006,032.

The compounds represented by formulae (VII) to (IX) can be easily synthesized by a known method. For example, the compounds can be synthesized by referring to methods described in U.S. Pat. Nos. 5,545,515, 5,635,339 and 5,654,130, WO 97/34196 and Japanese Patent Application Nos. 9-354107, 9-309813 and 9-272002.

Specific examples (Compounds 1 to 72) of the compounds represented by formulae (VII) to (IX), which are used as the super high contrast imparting agent, are set forth below, however, the present invention should not be construed as being limited thereto.

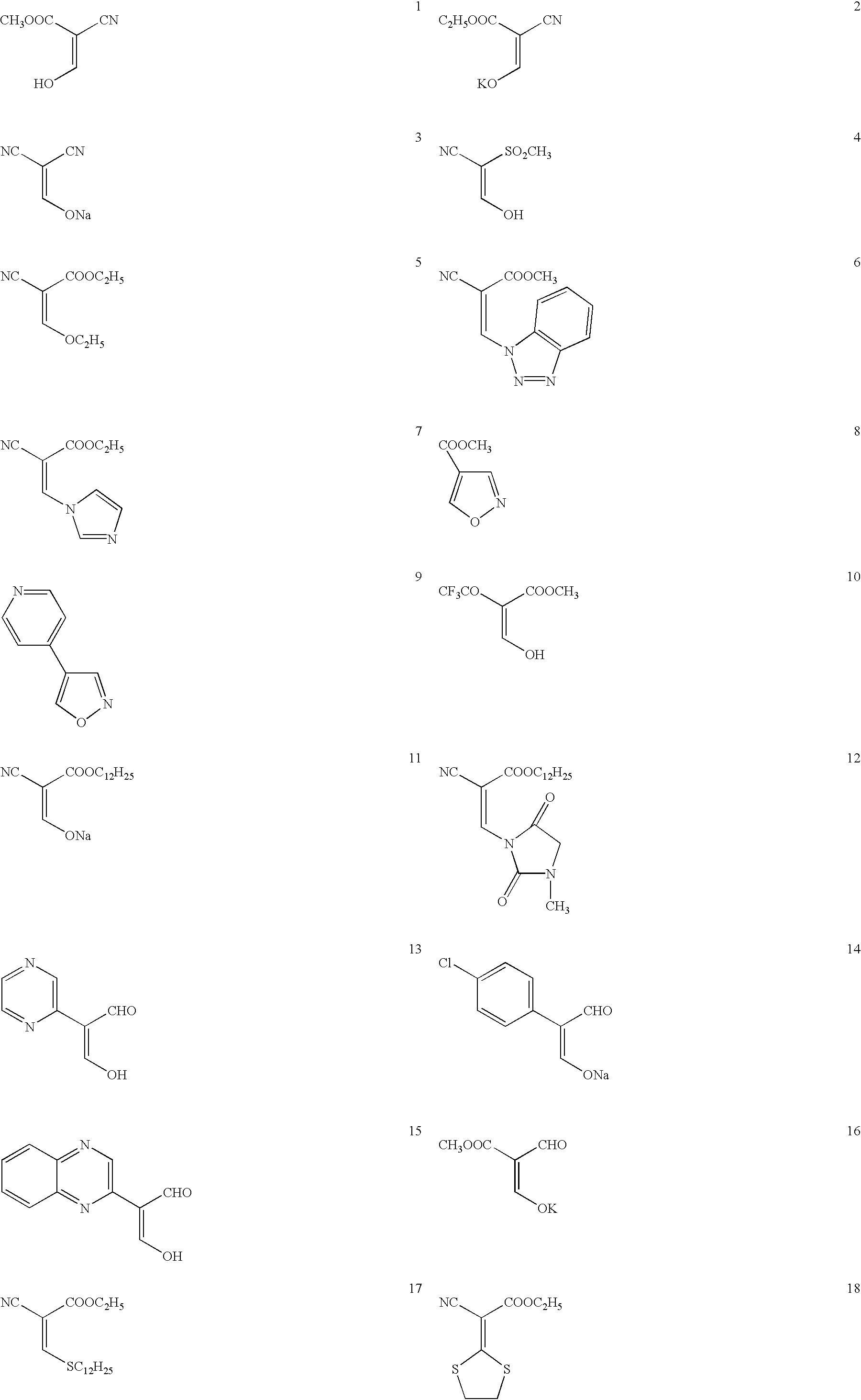

The amount of the compound represented by formula (VII), (VIII) or (IX) used is preferably from 1×10⁻⁶ to 1 mol, more preferably from 1×10⁻⁵ to 5×10⁻¹ mol. still more preferably from 2×10⁻⁵ to 2×10⁻¹ mol, per mol of silver.

The compound represented by formula (VII), (VIII) or (IX) may be used by dissolving it in water or an appropriate organic solvent such as an alcohol (e.g., methanol, ethanol, propanol, fluorinated alcohol), a ketone (e.g., acetone, methyl ethyl ketone), dimethylformamide, dimethylsulfoxide or methyl cellosolve. Also, the compound may be used by, according to a known emulsification dispersion method, dissolving it using an oil such as dibutyl phthalate, tricresyl phosphate, glycerol triacetate or diethyl phthalate, and an auxiliary solvent such as ethyl acetate or cyclohexanone, and mechanically preparing an emulsified dispersion. Furthermore, the compound represented by formula (VII), (VIII) or (IX) may be used by, according to a solid dispersion method, dispersing powder of the compound in an appropriate solvent such as water using a ball mill, a colloid mill or ultrasonic wave.

The compound represented by formula (VII), (VIII) or (IX) may be incorporated into any layer in the side having the image forming layer of the support, specifically, the image forming layer or any other layer in this side, but is preferably incorporated into the image forming layer or a layer adjacent thereto.

The compound represented by formula (VII), (VIII) or (IX) may be used individually or in combination of two or more thereof. Also, the compound may be used in combination with one or more compounds described in U.S. Pat. Nos. 5,545,515, 5,635,339 and 5,654,130, WO 97/34196, U.S. Pat. No. 5,686,228, JP-A-11-119372, Japanese Patent Application Nos. 9-228881, 9-273935, 9-354107, 9-309813, 9-296174 and 9-282564, JP-A-11-95365, JP-A-11-95366 and Japanese Patent Application No. 9-332388.

Furthermore, the compound represented by formula (VII), (VIII) or (IX) can also be used in combination with a hydrazine derivative described in JP-A-10-339932 and JP-A-10-161270. Also, the compound can be used in combination with following hydrazine derivatives: compounds represented by Chemical Formula I described in JP-B-6-77138 and specifically, compounds described on pages 3 to 4; compounds represented by formula (I) described in JP-B-6-93082 and specifically, Compounds 1 to 38 described on pages 8 to 18; compounds represented by formulae (4) to (6) described in JP-A-6-230497 and specifically, Compounds 4-1 to 4-10 described on pages 25 to 26, Compounds 5-1 to 5-42 described on pages 28 to 36, and Compounds 6-1 to 6-7 described on pages 39 to 40; compounds represented by formulae (1) to (2) described in JP-A-6-289520 and specifically, Compounds 1-1) to 1-17) and Compound 2-1) described on pages 5 to 7; compounds represented by Chemical Formulae 2 and 3 described in JP-A-6-313936 and specifically, compounds described on pages 6 to 19; compounds represented by Chemical Formula 1 described in JP-A-6-313951 and specifically, compounds described on pages 3 to 5; compounds represented by formula (I) described in JP-A-7-6510 and specifically, Compounds I-1 to I-38 described on pages 5 to 10; compounds represented by formula (II) described in JP-A-7-77783 and specifically, Compounds II-1 to II-102 described on pages 10 to 27; compounds represented by formulae (H) and (Ha) described in JP-A-7-104426 and specifically, Compounds H-1 to H-44 described on pages 8 to 15; compounds having an anionic group in the vicinity of a hydrazine group or a nonionic group capable of forming an intramolecular hydrogen bond with a hydrogen atom of the hydrazine described in EP-A-713131, particularly compounds represented by formulae (A) to (F) and specifically, Compounds N-1 to N-30; compounds represented by formula (1) described in EP-A-713131 and specifically, Compounds D-1 to D-55; various hydrazine derivatives described in Kochi Gijutsu (Known Techniques) (Pages 1 to 207), pages 25 to 34, Aztech Corp. (Mar. 22, 1991); and Compounds D-2 and D-39 described in JP-A-62-86354, on pages 6 to 7.

The amount of the hydrazine derivative used is preferably from 1×10⁻⁶ to 1 mol, more preferably from 1×10⁻5 to 5×10⁻¹ mol, still more preferably from 2×10⁵ to 2×10⁻¹ mol, per mol of silver.

The hydrazine derivative can be used by dispersing it in the same manner as described for the compound represented by formula (VII), (VIII) or (IX).

The hydrazine derivative may be incorporated into any layer in the side having the image-forming layer of the support, specifically, the image-forming layer or any other layer in this side, but is preferably incorporated into the image-forming layer or a layer adjacent thereto.

In the heat-developable image recording material according to the present invention, a high contrast accelerating agent may be used together with the super high contrast imparting agent described above in order to form a super high contrast image. Examples thereof include compounds described in JP-A-11-65021, paragraph No. 0102, amine compounds, specifically AM-1 to AM-5, described in U.S. Pat. No. 5,545,505, hydroxamic acids, specifically HA-1 to HA-11, described in U.S. Pat. No. 5,545,507, hydrazine compounds, specifically CA-1 to CA-6, described in U.S. Pat. No. 5,558,983, and onium salts, specifically A-1 to A-42, B-1 to B-27 and C-1 to C-14, described in JP-A-9-297368.

With respect to synthesis methods, addition methods and amounts added of the super high contrast imparting agent and high contrast accelerating agent, those described in the patents cited above can be utilized.

In the case of using a formic acid or a salt thereof as a strong fogging substance in the heat-developable image recording material of the present invention, the strong fogging substance is preferably incorporated into a layer in the side having the image-forming layer containing photosensitive silver halide in an amount of 5 mmol or less, more preferably 1 mmol or less.

In the case of using a nucleating agent in the heat-developable image recording material of the present invention, the nucleating agent is preferably used in combination with an acid formed by hydration of phosphorus pentoxide or a salt thereof. Examples of the acid formed by hydration of phosphorus pentoxide or a salt thereof include metaphosphoric acid (or a salt thereof), pyrophosphoric acid (or a salt thereof), orthophosphoric acid (or a salt thereof), triphosphoric acid (or a salt thereof), tetraphosphoric acid (or a salt thereof) and hexametaphosphoric acid (or a salt thereof) Among these acids formed by hydration of phosphorus pentoxide or salts thereof, preferred are orthophosphoric acid (or a salt thereof) and hexametaphosphoric acid (or a salt thereof) Specific examples of the salt include sodium orthophosphate, sodium dihydrogen orthophosphate, sodium hexametaphosphate and ammonium hexametaphosphate.

The amount of the acid formed by hydration of phosphorous pentaoxide or a salt thereof used (the coated amount per 1 m² of the image recording material) may be appropriately determined according to photographic performance such as sensitivity or fog, but is preferably from 0.1 to 500 mg/m², more preferably from 0.5 to 100 mg/m².

The heat-developable image recording material of the present invention may have a surface protective layer for the purpose of preventing adhesion of the image-forming layer. The surface protective layer is described in JP-A-11-65021, paragraph Nos. 0119 to 0120.

Although gelatin is preferred as a binder for the surface protective layer, polyinyl alcohol (PVA) is also preferably used. Specific example of PVA include completely saponified product PVA-105 (polyinyl alcohol (PVA) content: 94.0 mass % or more, saponification degree: 98.5±0.5% by mol, sodium acetate content: 1.5 mass % or less, volatile content: 5.0 mass % or less, viscosity (4 mass %, 20° C.): 5.6±0.4 CPS), partially saponified product PVA-205 (PVA content: 94.0 mass % weight, saponification degree: 88.0±1.5% by mol, sodium acetate content: 1.0 mass %, volatile content: 5.0 mass %, viscosity (4 mass %, 20° C.): 5.0±0.4 CPS), and modified polyinyl alcohols MP-102, MP-202, MP-203, R-1130 and R-2105 (trade name, all produced by Kuraray Co., Ltd.). The amount (per m² of the support) of polyinyl alcohol coated for the surface protective layer (per one layer) is preferably from 0.3 to 4.0 g/m², more preferably from 0.3 to 2.0 g/m².

In the case of using the heat-developable image recording material of the present invention in the field of printing where a dimensional change particularly causes a serious problem, a polymer is preferably used also in the surface protective layer and the back layer. Examples of the polymer include, in addition to the specific polymers described above, those described in Taira Okuda and Hiroshi Inagaki (compilers), Gosei Jushi Emulsion (Synthetic Resin Emulsion), Kobunshi-kankokai (1978), Takaaki Sugimura, Yasuo Kataoka, Souichi Suzuki and Keiji Kasahara (compilers), Gosei Latex no Oyo (Application of Synthetic Latex), Kobunshi-kankokai (1993), and Soichi Muroi, Gosei Latex no Kagaku (Science of Synthetic Latex), Kobunshi-kankokai (1979). Specific examples thereof include a latex of methyl methacrylate (33.5 mass %)/ethyl acrylate (50 mass %)/methacrylic acid (16.5 mass %) copolymer, a latex of methyl methacrylate (47.5 mass %)/butadiene (47.5 mass %)/itaconic acid (5 mass %) copolymer, a latex of ethyl acrylate/methacrylic acid copolymer, and a latex of methyl methacrylate (58.9 mass %)/2-ethylhexyl acrylate (25.4 mass %)/ethylene (8.6 mass %)/2-hydroxyethyl methacrylate (5.1 mass %)/acrylic acid (2.0 mass %) copolymer. Furthermore, with respect to the binder for the surface protective layer, combinations of polymers described in Japanese Patent Application No. 11-6872, techniques described in Japanese Patent Application No. 11-143058, paragraph Nos. 0021 to 0025, techniques described in Japanese Patent Application No. 11-6872, paragraph Nos. 0027 to 0028, and techniques described in Japanese Patent Application No. 10-199626, paragraph Nos. 0023 to 0041 may be applied.

In the heat-developable image recording material of the present invention, the temperature at the preparation of a coating solution for the image-forming layer is preferably from 30 to 65° C., more preferably from 35 to 60° C., still more preferably from 35 to 55° C. Also, the temperature of the coating solution for the image-forming layer immediately after the addition of polymer is preferably maintained in a range from 30 to 65° C. The heat developing agent and the organic silver salt are preferably mixed before the addition of polymer.

In the heat-developable image recording material of the present invention, the fluid containing the organic silver salt or the coating solution for the image-forming layer is preferably a so-called thixotropic fluid. The thixotropic property means a property such that the viscosity decreases as the shearing velocity increases. For the measurement of viscosity, any device may be employed, however, the measurement is preferably performed at 25° C. using FRS Fluid Spectrometer manufactured by Rheometrix Far East Ltd. The viscosity at the shearing velocity of 0.1 S⁻¹ in the fluid containing the organic silver salt or the coating solution for the image-forming layer is preferably from 400 to 100,000 mPa.s, more preferably from 500 to 20,000 mPa.s. Also, the viscosity at the shearing velocity of 1,000 S⁻¹ is preferably from 1 to 200 mPa.s, more preferably from 5 to 80 mPa.s.

Various systems exhibiting the thixotropic property are known and described, for example, in Kobunshi-kankokai (compiler) Koza Rheology (Lecture, Rheology), and Soichi Muroi and Ikuo Morino, Kobunshi Latex, Kobunshi-kankokai. In order to allow a fluid to exhibit the thixotropic property, the fluid must contain a large number of fine solid particles. For strengthening the thixotropic property, it is effective, for example, to incorporate a viscosity-increasing linear polymer, to use fine solid particles of anisotropy having a high aspect ratio or to employ an alkali thickener or a surface active agent.

In the heat-developable image recording material of the present invention, the image-forming layer (photo-sensitive layer) is composed of one or more layers on the support. In the case of one layer structure, the layer contains the organic silver salt, the silver halide, the reducing agent, the binder and if desired, additional materials such as toning agent, coating aid and other auxiliary agents. In the case of two layer structure, the first emulsion layer (usually a layer adjacent to the support) contains the organic silver salt and the silver halide, and the second layer or both layers contain some other components. Also, a two layer structure composed of a single image-forming layer containing all components and a protective top layer may be used.

In a multi-color photosensitive heat-developable photographic material, a combination of the above-described two layers may be used for each color. Also, all components may be contained in a single layer as described in U.S. Pat. No. 4,708,928. In the case of a multi-dye multi-color photosensitive heat-developable photographic material, respective emulsion layers are separated from each other by providing a functional or non-functional barrier layer between respective photosensitive layers as described in U.S. Pat. No. 4,460,681.

The specific polymer described above may be used in any layer described above but is preferably contained in a layer containing the organic silver salt and the silver halide (image-forming layer). In the case of third embodiment of the present invention, the specific polymer is contained in a layer containing the organic silver salt and the silver halide.

In the heat-developable image recording material of the present invention, various dyes and pigments may be incorporated into the photosensitive layer for improving tone, for preventing the occurrence of interference fringe at exposure with a laser beam, or for preventing irradiation. Such techniques are described in detail in WO 98/36322. Preferred examples of the dye and pigment for use in the photosensitive layer include an anthraquinone dye, an azomethine dye, an indoaniline dye, an azo dye, an indanthrone pigment of anthraquinone series (e.g., C.I. Pigment Blue 60), a phthalocyanine pigment (for example, copper phthalocyanine such as C.I. Pigment Blue 15, or non-metal phthalocyanine such as C.I. Pigment Blue 16), a triarylcarbonyl pigment of lake pigment series, indigo, and an inorganic pigment (e.g., ultramarine, cobalt blue).

The dye or pigment may be added in any manner, for example, as a solution, an emulsion or a solid fine particle dispersion or in a state mordanted to a polymer mordant. The amount of this compound used may be determined depending on the desired absorption but in general, the dye or pigment is preferably used in the range from 1 μg to 1 g per m² of the image recording material.

In the heat-developable image recording material of the present invention, an anti-halation layer may be provided in the farther side from a light source with respect to the photosensitive layer. The anti-halation layer is described in JP-A-11-65021, paragraph Nos. 6123 to 0124 and JP-A-11-223898.

The heat-developable image recording material of the present invention generally has a photo-insensitive layer in addition to the photosensitive layer. The photo-insensitive layer can be classified according to the position thereof as follows: (1) a protective layer provided on the photosensitive layer (in the farther side from the support), (2) an intermediate layer provided between a plurality of photosensitive layers or between the photosensitive layer and the protective layer; (3) an undercoat layer provided between the photosensitive layer and the support; and (4) a back layer provided on the support surface opposite the surface where the photosensitive layer is provided. A filter layer is provided in the image recording material as a layer classified in (1) or (2). The anti-halation layer is provided in the heat-developable image recording material as a layer classified in (3) or (4).

A decolorizable dye and a base precursor are preferably added to a photo-insensitive layer, so that the photo-insensitive layer can function as a filter layer or an anti-halation layer. The decolorizable dye and the base precursor are preferably added to the same photo-insensitive layer, but may be separately added to two adjacent photo-insensitive layers. Also, a barrier layer may be provided between two adjacent photo-insensitive layers.

In order to add the decolorizable dye to the photo-insensitive layer, a method of adding a solution, emulsion or solid fine particle dispersion of the decolorizable dye or a polymer impregnated with the decolorizable dye to a coating solution for the photo-insensitive layer can be adopted. Also, the decolorizable dye may be added to the photo-insensitive layer using a polymer mordant. These methods of addition are the same as those of adding a dye to a normal heat-developable image recording material.

The latex used for the polymer impregnated with the decolorizable dye is described in U.S. Pat. No. 4,199,363, West German Patents (OLS) 2,514,274 and 2,541,230, EP-A-029104 and JP-B-53-41091. The emulsifying method of adding a dye to a solution having dissolved therein a polymer is described in WO 88/00723.

The amount of the decolorizable dye added is determined according to the use of dye. Generally, the decolorizable dye is used in such an amount that an optical density (absorbance) measured at an objective wavelength exceeds 0.1. The optical density is preferably from 0.2 to 2. The amount of the decolorizable dye for obtaining such a level of the optical density is generally on the order of 0.001 to 1 g/m², preferably on the order of 0.01 to 0.2 g/m².

When the decolorizable dye is decolorized, the optical density can be reduced to 0.1 or less. Two or more decolorizable dyes may be used in combination in a heat-decolorizable type recording material or in the heat-developable image recording material. Similarly, two or more base precursors may be used in combination.

The heat-developable image recording material of the present invention is preferably a so-called one-sided image recording material having at least one photosensitive layer containing the above-described compounds such as photosensitive silver halide emulsion in one side of the support and a back layer in the other side of the support.

The heat-developable image recording material of the present invention preferably contains a matting agent for the purpose of improving the transportability. The matting agent is described in JP-A-11-65021, paragraph Nos. 0126 to 0127. The amount of the matting agent coated is preferably from 1 to 400 mg, more preferably from 5 to 300 mg, per m² of the image recording material.

The matting degree on the emulsion surface may be any degree insofar as no star dust-like defect occurs, however, the Bekk smoothness is preferably from 30 to 2,000 seconds, more preferably from 40 to 1,500 seconds.

As for the matting degree in the back layer side, the Bekk smoothness is preferably from 10 to 1,200 seconds, more preferably from 20 to 800 seconds, still more preferably from 40 to 500 seconds.

The matting agent is preferably added to the outermost surface layer, a layer which functions as the outermost surface layer, or a layer close to the outer surface, or also preferably added to a layer that functions as a so-called protective layer.

The back layer is described in JP-A-11-65021, paragraph Nos. 0128 to 0130.

In the heat-developable image recording material of the present invention, a hardening agent may be used in each layer such as photosensitive layer, protective layer and back layer. Examples of the hardening agent are described in T. H. James, The Theory of the Photographic Process, Fourth Edition, pages 77 to 87, Macmillan Publishing Co., Inc. (1977). Multi-valent metal ions described in ibid., page 78, polyisocyanates described in U.S. Pat. No. 4,281,060 and JP-A-6-208193, epoxy compounds described in U.S. Pat. No. 4,791,042 and vinyl sulfone compounds described in JP-A-62-89048 are preferably used.

The hardening agent is added in the form of a solution. The timing of adding the solution to a coating solution for the protective layer is from 180 minutes before coating to immediately before coating, preferably from 60 minutes before coating to 10 seconds before coating. The mixing method and the mixing conditions are not particularly limited as long as the effect of the present invention can be achieved.

Specific examples of the mixing method include a method of mixing in a tank where the mean residence time calculated from an addition flow rate and a supply flow rate to a coater is controlled to be the desired time, and a method using a static mixer described in N. Harnby, M. F. Edwards and A. W. Nienow, Ekitai Kongou Gijyutu, Chapter 8, translated by Kouji Takahashi, The Nikkan Kogyo Shimbun, Ltd. (1989).

The surface active agent which can be applied to the heat-developable image recording material is described in JP-A-11-65021, paragraph No. 0132, the solvent is described in ibid., paragraph No. 0133, the support is described in ibid., paragraph No. 0134, the antistatic or conductive layer is described in ibid., paragraph No. 0135, and the method for obtaining a color image is described in ibid., paragraph No. 0136.

In the heat-developable image recording material of the present invention, the pH on the film surface before heat development processing is preferably 6.0 or less, more preferably 5.5 or less. The lower limit is not particularly limited but is about 3. From the standpoint of decreasing the pH on the film surface, the pH on the film surface is preferably adjusted by using an organic acid such as phthalic acid derivative, a non-volatile acid such as sulfuric acid, or a volatile base such as ammonia. Particularly, ammonia is preferred for achieving a low pH on the film surface because it readily volatilizes and can be removed in the coating step or before the heat development. Measurement of the pH on the film surface is described in Japanese Patent Application No. 11-87297, paragraph No. 0123.

The heat-developable image recording material of the present invention may further contain an antioxidant, a stabilizer, a plasticizer, an ultraviolet absorbent or a coating aid. These additives are added to either the photosensitive layer or the photo-insensitive layer. Such additives are described in WO 98/36322, EP-A-803764, JP-A-10-186567 and JP-A-10-186568.

Each layer of the heat-developable image recording material of the present invention may be coated by any method. Specifically, various coating operations including extrusion coating, slide coating, curtain coating, dip coating, knife coating, flow coating and extrusion coating using a hopper described in U.S. Pat. No. 2,681,294 can be used. Extrusion coating or slide coating described in Stephan F. Kistler and Peter M. Schweizer, Liquid Film Coating, pages 399 to 536, Chapman & Hall (1997) is preferably employed. Particularly, the slide coating is preferably used. Examples of the shape of the slide coater used in the slide coating are described in ibid., page 427, FIG. 11b.1. If desired, two or more layers can be simultaneously coated by the method described in ibid., pages 399 to 536, U.S. Pat. No. 2,761,791 and British Patent 837,095.

Techniques which can be used for the heat-developable image recording material of the present invention include those described in EP-A-803764, EP-A-883022, WO 98/36322, JP-A-56-62648, JP-A-58-62644, JP-A-9-281637, JP-A-9-297367, JP-A-9-304869, JP-A-9-311405, JP-A-9-329865, JP-A-10-10669, JP-A-10-62899, JP-A-10-69023, JP-A-10-186568, JP-A-10-90823, JP-A-10-171063, JP-A-10-186565, JP-A-10-186567, JP-A-10-186569, JP-A-10-186570, JP-A-10-186571, JP-A-10-186572, JP-A-10-197974, JP-A-10-197982, JP-A-10-197983, JP-A-10-197985, JP-A-10-197986, JP-A-10-197987, JP-A-10-207001, JP-A-10-207004, JP-A-10-221807, JP-A-10-282601, JP-A-10-288823, JP-A-10-288824, JP-A-10-307365, JP-A-10-312038, JP-A-10-339934, JP-A-11-7100, JP-A-11-15105, JP-A-11-24200, JP-A-11-24201, JP-A-11-30832, JP-A-11-84574, JP-A-11-65021, JP-A-11-125880, JP-A-11-129629, JP-A-11-133536, JP-A-11-133537, JP-A-11-133538, JP-A-11-133539, JP-A-11-133542 and JP-A-11-133543.

The heat-developable image recording material of the present invention may be developed by any method but the heat-developable image recording material exposed imagewise is usually developed by heating. The developing temperature is preferably from 80 to 250° C., more preferably from 100 to 140° C. The developing time is preferably from 1 to 180 seconds, more preferably from 10 to 90 seconds, still more preferably from 10 to 40 seconds.

A plate heater system is preferably used for the heat development. As for the heat development using a plate heater system, the method described in JP-A-11-133572 is preferred, which is a heat development apparatus for obtaining a visible image by bringing a heat-developable image recording material having formed therein a latent image into contact with heating means in a heat development part, wherein the heating means comprises a plate heater and a plurality of press rollers are arranged along one side of the plate heater and wherein the heat-developable image recording material is passed between the press rollers and the plate heater to perform heat development. It is preferred to divide the plate heater into 2 to 6 stages and decrease the temperature at the leading end part by approximately from 1 to 10° C. This method is described also in JP-A-54-30032. According to this method, moisture and organic solvents contained in the heat-developable image recording material can be removed out of the system, and the support of the heat-developable image recording material can be suppressed from deformation due to abrupt heating of the heat-developable image recording material.

The heat-developable image recording material of the present invention may be exposed to light by any method but a laser beam is preferably used as a light source for exposure. The laser beam for use in the present invention is preferably a gas laser (e.g., Ar⁺, He—Ne), a YAG laser, a dye laser or a semiconductor laser. A semiconductor laser and a second harmonic generating element can also be used. A gas or semiconductor laser emitting red to infrared light is preferred.

A single-mode laser can be utilized for the laser beam and techniques described in JP-A-11-65021, paragraph No. 0140 can be used.

The laser output is preferably 1 mW or more, more preferably 10 mW or more, still more preferably 40 mW or more. A plurality of laser beams may be combined. The diameter of the laser beam may be set to approximately from 30 to 200 μm in terms of 1/e² spot size of Gaussian beam.

As a laser imager having an exposure part and a heat development part, Fuji Medical Dry Laser Imager FM-DP L is exemplified. The Fuji Medical Dry Laser Imager FM-DP L is described in Fuji Medical Review, No. 8, pages 39 to 55. Of course, the techniques described therein can be applied to the laser imager used for the heat-developable image recording material of the present invention.

The heat-developable image recording material of the present invention is a material of forming a black-and-white image based on a silver image and therefore, is preferably used as a heat-developable image recording material for medical diagnosis, a heat-developable image recording material for industrial photography, a heat-developable image recording material for printing and a heat-developable image recording material for COM. Based on the black-and-white image formed, a duplicated image is formed on a duplication film (MI-Dup produced by Fuji Photo Film Co., Ltd.) in use for medical diagnosis. Also, in use for printing, the black-and-white image formed is used as a mask for forming image on a contact film (DO-175 or PDO-100 produced by Fuji Photo Film Co., Ltd.) or an offset printing plate. Furthermore, the heat-developable image recording material of the present invention is used as a heat-developable image recording material for a laser imager in “AD network” proposed by Fuji Medical System as a network system adapted to the DICOM Standard.

The present invention is described in greater detail below by referring to Examples. The materials, reagents, ratios, operations and the like described in the following Examples can be appropriately changed without departing from the spirit of the present invention. Therefore, the present invention should not be construed as being limited thereto.

### EXAMPLE 1

The structures of compounds used in Example 1 are shown below.

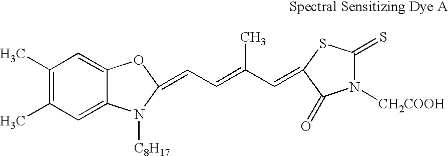

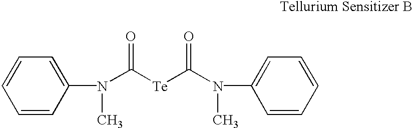

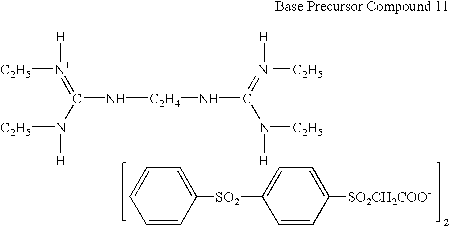

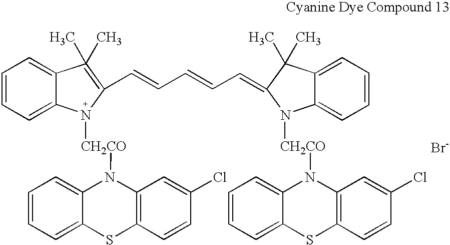

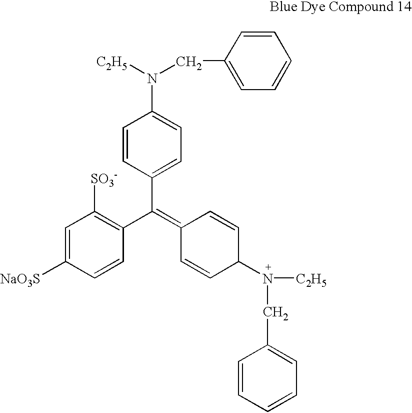

<Preparation of PET Support>

PET having an intrinsic viscosity IV=0.66 (measured in phenol/tetrachloroethane=6/4 (mass ratio) at 25° C.) was obtained using terephthalic acid and ethylene glycol in a conventional manner. The PET was palletized and the pellets were dried at 130° C. for 4 hours, melted at 300° C., extruded from a T-die and rapidly quenched to prepare an unstretched film having a thickness of giving a film thickness of 175 μm after heat setting.

The obtained film was stretched to 3.3 times in the longitudinal direction with rollers having different peripheral speeds, and then stretched to 4.5 times in the lateral direction using a tenter. The temperatures of the operations were 110° C. and 130° C., respectively. Subsequently, the film was subjected to heat setting at 240° C. for 20 seconds and then to relaxation by 4% in the lateral direction at the same temperature. The film was slit to remove its chucked parts by the tenter and both sides of the film were subjected to knurl processing. The film was rolled up at 4 kg/cm² to obtain a roll having a thickness of 175 μm.

<Surface Treatment with Corona Discharge>

Both surfaces of the support were treated by a solid-state corona discharge processor (6 KVA Model manufactured by Pillar Technologies, Inc.) at 20 m/min at room temperature. From the read values of electric current and voltage at this time, it was found that the support was treated in 0.375 kV.A.min/m². The treatment frequency at this time was 9.6 kHz and the gap clearance between an electrode and a dielectric roll was 1.6 mm.

<Preparation of Undercoated Support>

Preparation of coating solution for undercoat layer

Formulation 1 (for undercoat layer in the photosensitive layer side)

| | | |
|---|---|---|
| Besresin A-515GB (produced by | 234 | g |
| Takamatsu Oil and Fat Co., Ltd.) | | |
| (30 mass % solution) | | |
| Polyethylene glycol monononylphenyl ether | 21.5 | g |
| (average number of ethylene oxide: 8.5) | | |
| (10 mass % solution) | | |
| Fine polymer particles (average particle | 0.91 | g |
| size: 0.4 μm, MP-1000 produced by | | |
| Soken Chemical and Engineering Co., Ltd.) | | |
| Distilled water | 744 | ml |

Formulation 2 (for first layer on back surface)

| | | |
|---|---|---|
| Butadiene/styrene copolymer latex | 158 | g |
| (solid content: 40 mass %, | | |
| butadiene/styrene: 32/68 (by mass)) | | |
| Sodium salt of 2,4-dichloro-6-hydroxy- | 20 | g |
| S-triazine (8 mass % aqueous solution) | | |
| Sodium laurylbenzenesulfonate | 10 | ml |
| (1 mass % aqueous solution) | | |
| Distilled water | 854 | ml |

Formulation 3 (for second layer on back surface)

| | | |
|---|---|---|
| SnO₂/SbO (9/1 (by mass), average | 84 | g |
| particle size: 0.038 μm, 17 mass % | | |
| dispersion) | | |
| Gelatin (10% aqueous solution) | 89.2 | g |
| Metolose TC-5 (manufactured by Shin-Etsu | 8.6 | g |
| Chemical Co., Ltd.) (2% aqueous solution) | | |
| Fine polymer particles (MP-1000 produced | 0.01 | g |
| by Soken Chemical and Engineering Co., Ltd.) | | |
| Sodium dodecylbenzenesulfonate | 10 | ml |
| (1 mass % aqueous solution) | | |
| NaOH (1%) | 6 | ml |
| Proxel (produced by ICI Ltd.) | 1 | ml |
| Distilled water | 805 | ml |

<Preparation of Undercoated Support>

On one surface (photosensitive layer side) of the biaxially stretched polyethylene terephthalate support having a thickness of 175 μm, both surfaces of which was subjected to the corona discharge treatment, Formulation 1 for undercoat coating solution was coated by a wire bar to a wet coated amount of 6.6 ml/m² (per one side) and dried at 180° C. for 5 minutes. Then, Formulation 2 for undercoat coating solution was coated on the opposite surface (back surface) by a wire bar to a wet coated amount of 5.7 ml/m² and dried at 180° C. for 5 minutes. Furthermore, Formulation 3 for undercoat coating solution was coated on the back surface by a wire bar to a wet coated amount of 7.7 ml/m² and dried at 180° C. for 6 minutes to prepare an undercoated support.

<Preparation of Coating Solution for Back Surface>

(1) Preparation of Solid Fine Particle Dispersion (a) of Base Precursor

With 220 ml of distilled water were mixed 64 g of Base Precursor Compound 11, 28 g of diphenylsulfone and 10 g of a surface active agent (Demol N produced by Kao Corp.). The mixture solution was dispersed using beads by a sand mill (¼ Gallon Sand Grinder Mill manufactured by Imex Inc.) to obtain a solid fine particle dispersion (a) of base precursor compound having an average particle size of 0.2 μm.

(2) Preparation of Solid Fine Particle Dispersion of Dye

With 305 ml of distilled water were mixed 9.6 g of Cyanine Dye Compound 13 and 5.8 g of sodium p-dedecybenzenesulfonate. The mixture solution was dispersed using beads by a sand mill (¼ Gallon Sand Grinder Mill manufactured by Imex Inc.) to obtain a solid fine particle dispersion of dye having an average particle size of 0.2 μm.

(3) Preparation of Coating Solution for Anti-Halation Layer

With 844 ml of water were mixed 17 g of gelatin, 9.6 g of polyacrylamide, 70 g of the solid fine particle dispersion (a) of base precursor prepared above, 56 g of the solid fine particle dispersion of dye prepared above, 1.5 g of polymethyl methacrylate fine particles (average particle size: 6.5 μm), 0.03 g of benzisothiazolinone, 2.2 g of sodium polyethylenesulfonate and 0.2 g of Blue Dye Compound 14 to prepare a coating solution for anti-halation layer.

<Preparation of Coating Solution for Surface Protective Layer on Back Surface>

In a vessel maintained at 40° C., 50 g of gelatin, 0.2 g of sodium polystyrenesulfonate, 2.4 g of N,N-ethylenebis(vinylsulfonacetamide), 1 g of sodium tert-octylphenoxyethoxyethanesulfonate, 30 mg of benzisothiazolinone, 37 mg of potassium salt of N-perfluoro-octylsulfonyl-N-propylalanine, 0.15 g of polyethylene glycol mono(N-perfluorooctylsulfonyl-N-propyl-2-aminoethyl) ether (average polymerization degree of ethylene oxide: 15), 32 mg of C₈F₁7SO₃K, 64 mg of C₈F₁₇SO₂N(C₃H₇) (CH₂CH₂O)₄ (CH₂)₄SO₃Na, 8.8 g of acrylic acid/ethyl acrylate copolymer (mass ratio of copolymerization: 5/95), 0.6 g of Aerosol OT (produced by American Cyanamid Co.), 1.8 g of liquid paraffin (as a liquid paraffin emulsion) and 950 ml of water were mixed to prepare a coating solution for surface protective layer on back surface.

<Preparation of Silver Halide Emulsion 1>

To 1,421 ml of distilled water, 8.0 ml of a 1 mass % potassium bromide solution was added, and then 8.2 ml of 1N nitric acid and 20 q of phthalated gelatin were added thereto. The resulting solution was maintained with stirring at 37° C. in a stainless steel-made reaction vessel coated with titanium. Separately, 37.04 g of silver nitrate was diluted with distilled water to 159 ml to prepare Solution A, and 32.6 g of potassium bromide was diluted with distilled water to a volume of 200 ml to prepare Solution B. Solution A was entirely added at a constant flow rate over 1 minute to the above-described solution according to a controlled double jet method, while keeping pAg at 8.1. Solution B was added according to a controlled double jet method. Then, 30 ml of a 3.5 mass % aqueous hydrogen peroxide solution was added, and further 36 ml of a 3 mass % aqueous benzimidazole solution was added. Separately, Solution A was diluted with distilled water to 317.5 ml to prepare Solution A2, and tripotassium hexachloroiridate was dissolved in Solution B to make 1×10⁻⁴ mol per mol of silver in the final stage and then diluted with distilled water to a 2-fold volume of Solution B, i.e., 400 ml to prepare Solution B2. Solution A2 was entirely added at a constant flow rate over 10 minutes according to a controlled double jet method while keeping pAg at 8.1. Solution B was added according to a controlled double jet method. Then, 50 ml of a 0.5 mass % methanol solution of 5-methyl-2-mercaptobenzimidazole was added, the pAg was elevated to 7.5 with silver nitrate, the pH was then adjusted to 3.8 using 0.5 mol/liter sulfuric acid, and stirring was terminated. The mixture was subjected to precipitation, desalting and water washing steps, 3.5 g of deionized gelatin was added, and then 1 mol/liter sodium hydroxide was added to adjust the pH and the pAg to 6.0 and 8.2, respectively, thereby preparing a silver halide emulsion.

The grains in the thus-prepared silver halide emulsion were pure silver bromide grains having an average equivalent spherical diameter of 0.053 μm and a variation coefficient of equivalent spherical diameter of 18%. The grain size and the like were the average of 1,000 grains observed by an electron microscope. The proportion of {100} plane on the grain surface was 85% according to the Kubelka-Munk method.

The emulsion obtained above was maintained at 38° C. with stirring, 0.035 g of benzisothiazolinone (added as a 3.5 mass % methanol solution) was added thereto, and after 40 minutes, a solid dispersion (as an aqueous gelatin solution) of Spectral Sensitizing Dye A was added in an amount of 5×10⁻³ mol per mol of silver. After 1 minute, the temperature was raised to 47° C. and after 20 minutes, sodium benzenethiosulfonate was added in an amount of 3×10 ⁻⁵ mol per mol of silver. After 2 minutes, Tellurium Sensitizer B was added in an amount of 5×10 ⁵ mol per mol of silver, followed by ripening for 90 minutes. Immediately before the completion of ripening, 5 ml of a 0.5 mass % methanol solution of N,N-dihydroxy-N- to diethylmelamine was added and the temperature was lowered 31° C. Thereto, 5 ml of a 3.5 mass % methanol solution of phenoxyethanol, 5-methyl-2-mercaptobenzimidazole in an amount of 7×10 ⁻³ mol per mol of silver and 1-phenyl-2-heptyl-5-mercapto-1,3,4-triazole in an amount of 6.4×10⁻³ mol per mol of silver were added to prepare Silver Halide Emulsion 1.

<Preparation of Silver Halide Emulsion 2>

A pure silver bromide cubic grain emulsion having an average equivalent spherical diameter of 0.08 μm and a variation coefficient of equivalent spherical diameter of 15% was prepared in the same manner as in Preparation of Silver Halide Emulsion 1 except for changing the solution temperature from 37° C. to 50° C. at the grain formation. The precipitation, desalting and water washing steps were performed in the same manner as in Preparation of Silver Halide Emulsion 1. Then, the spectral sensitization, chemical sensitization and addition of 5-methyl-2-mercaptobenzimidazole and 1-phenyl-2-heptyl-5-mercapto-1,3,4-triazole were performed in the same manner as in Preparation of Silver Halide Emulsion 1 except for changing the amount added of Spectral Sensitizing Dye A to 4.5×10⁻³ mol per mol of silver, thereby preparing Silver Halide Emulsion 2.

<Preparation of Silver Halide Emulsion 3>

A pure silver bromide cubic grain emulsion having an average equivalent spherical diameter of 0.038 μm and a variation coefficient of equivalent spherical diameter of 20% was prepared in the same manner as in Preparation of Silver Halide Emulsion 1 except for changing the solution temperature from 37° C. to 27° C. at the grain formation. The precipitation, desalting and water washing steps were performed in the same manner as in Preparation of Silver Halide Emulsion 1. Then, the spectral sensitization, chemical sensitization and addition of 5-methyl-2-mercaptobenzimidazole and 1-phenyl-2-heptyl-5-mercapto-1,3,4-triazole were performed in the same manner as in Preparation of Silver Halide Emulsion 1 except for changing the amount of Spectral Sensitizing Dye A to 6×10⁻³ mol per mol of silver, thereby preparing Silver Halide Emulsion 3.

<Preparation of Mixed Silver Halide Emulsion A>

70 mass % of Silver Halide Emulsion 1, 15 mass % of Silver Halide Emulsion 2 and 15 mass % of Silver Halide Emulsion 3 were dissolved and thereto, a 1 mass % aqueous benzothiazolium iodide solution was added in an amount of 7×10⁻³ mol per mol of silver.

<Preparation of Scaly Fatty Acid Silver Salt>

87.6 g of behenic acid (Edenor C22-85R produced by Henkel Corp.), 423 ml of distilled water, 49.2 ml of an aqueous 5 mol/liter NaOH solution and 120 ml of tert-butanol were mixed and reacted at 75° C. for 1 hour with stirring to prepare a sodium behenate solution. Separately, 206.2 ml of an aqueous solution (pH: 4.0) containing 40.4 g of silver nitrate was prepared and maintained at 10° C. A reaction vessel containing 635 ml of distilled water and 30 ml of tert-butanol was maintained at 30° C. and thereto, the entire amount of the sodium behenate solution prepared above and the entire amount of the aqueous silver nitrate solution prepared above were added while stirring at a constant flow rate over 62 minutes and 10 seconds and over 60 minutes, respectively. At this time, only the aqueous silver nitrate solution was added for 7 minutes and 20 seconds after the start of the addition of the aqueous silver nitrate solution, the addition of the sodium behenate solution was then started, and only the sodium behenate solution was added for 9 minutes and 30 seconds after the completion of the addition of the aqueous silver nitrate solution. The temperature in the reaction vessel was set at 30° C. and the outer temperature was controlled to maintain the solution temperature constant. Furthermore, the piping of the addition system of the sodium behenate solution was warmed by a steam trace, and a steam aperture was adjusted such that the solution temperature at the outlet of the addition nozzle tip became 75° C. The piping of the addition system of the aqueous silver nitrate solution was also temperature-controlled by circulating cold water in the outer jacket of a double-walled tube. The positions where the sodium behenate solution and the aqueous silver nitrate solution were added were arranged symmetrically in relation to the stirring axle in the center, and the height of positions was adjusted not to come into contact with the reaction solution.

After the completion of the addition of the sodium behenate solution, the reaction solution was stirred at the same temperature for 20 minutes and allowed to stand to decrease the temperature to 25° C. The solid content was collected by suction filtration and then washed with water until the conductivity of the filtrate reached 30 μS/cm. Thus, a fatty acid silver salt was obtained. The solid content obtained was stored as a wet cake without drying.

The shape of the silver behenate particles thus-obtained was evaluated by electron microscopic photography. As a result, the silver behenate particles were scaly crystals having average values of a=0.14 μm, b=0.4 μm and c=0.6 μm, an average aspect ratio of 5.2, an average equivalent spherical diameter of 0.52 μm, and a variation coefficient of the equivalent spherical diameter of 15% (a, b and c are defined hereinbefore in this specification).

To the wet cake in an amount corresponding to 100 g of dried solid content were added 7.4 g of polyinyl alcohol (PVA-217, trade name, average polymerization degree: about 1,700) and water to make the entire amount of 385 g, and then the mixture was preliminarily dispersed by a homomixer.

The preliminarily dispersed stock solution was processed three times using a dispersing machine (Microfluidizer M-110S-EH equipped with a G01Z interaction chamber, manufactured by Microfluidex International Corp.) under a pressure adjusted to 175.0 MPa to prepare a silver behenate dispersion. The cooling operation was performed by using coil-type heat exchangers installed before and behind the interaction chamber respectively and by adjusting the temperature of coolant, thereby setting the dispersion temperature at 18° C.

<Preparation of 25 mass % Dispersion of Reducing Agent>

To a mixture of 10 kg of 1,1-bis(2-hydroxy-3,5-dimethylphenyl)-3,5,5-trimethylhexane (Compound (I-1)) as the reducing agent and 10 kg of a 20 mass % aqueous solution of modified polyinyl alcohol (Poval MP 203 manufacture by Kuraray Co., Ltd.) was added 16 kg of water. The resulting mixture was thoroughly mixed to make a slurry. This slurry was fed by means of a diaphragm pump into a horizontal type sand mill (UVM-2 manufactured by Imex Inc.) filled with zirconia beads having an average diameter of 0.5 mm, and dispersed for 3 hours and 30 minutes. Then, 0.2 g of benzisothiazolinone sodium salt and water were added to the dispersion such that the concentration of the reducing agent became 25 mass %, thereby preparing a reducing agent dispersion. The particles of the reducing agent contained in the thus-obtained dispersion of reducing agent had a median particle size of 0.40 μm and a maximum particle size of 1.8 μm or less.

This dispersion of reducing agent was filtered with a polypropylene-made filter having a pore size of 10.0 μm to remove foreign matters such as contaminant, and then stored.

<Preparation of 10 Mass % Dispersion of Mercapto Compound>

To a mixture of 5 kg of 1-phenyl-2-heptyl-5-mercapto-1,3,4-triazole and 5 kg of a 20 mass % aqueous solution of modified polyinyl alcohol (Poval MP 203 produced by Kuraray Co., Ltd.) was added 8.3 kg of water. The resulting mixture was thoroughly mixed to make a slurry. This slurry was fed by means of a diaphragm pump into a horizontal type sand mill (UVM-2 manufactured by Imex Inc.) filled with zirconia beads having an average diameter of 0.5 mm, and dispersed for 6 hours. Then, water was added to the dispersion such that the concentration of the mercapto compound became 10 mass %, thereby preparing a dispersion of mercapto compound. The particles of the mercapto compound contained in the thus-obtained dispersion of mercapto compound had a median particle size of 0.40 μm and a maximum particle size of 2.0 μm or less.

This dispersion of mercapto compound was filtered with a polypropylene-made filter having a pore size of 10.0 μm to remove foreign matters such as contaminant, and then stored. Immediately before the use, the dispersion of mercapto compound was again filtered with a polypropylene-made filter having a pore size of 10.0 μm.

<Preparation of 20 mass % Dispersion of Organic Polyhalogen Compound 1>

To a mixture of 5 kg of tribromomethylnaphthylsulfone, 2.5 kg of a 20 mass % aqueous solution of modified polyinyl alcohol (Poval MP 203 produced by Kuraray Co., Ltd.) and 213 g of a 20 mass % aqueous solution of sodium triisopropylnaphthalenesulfonate was added 10 kg of water. The resulting mixture was thoroughly mixed to make a slurry. This slurry was fed by means of a diaphragm pump into a horizontal type sand mill (UVM-2 manufactured by Imex Inc.) filled with zirconia beads having an average diameter of 0.5 mm, and dispersed for 5 hours. Then, 0.2 g of benzisothiazolinone sodium salt and water were added to the dispersion such that the concentration of the organic polyhalogen compound became 20 mass %, thereby preparing a dispersion of organic polyhalogen compound. The particles of the organic polyhalogen compound contained in the thus-obtained dispersion of organic polyhalogen compound 1 had a median particle size of 0.36 μm and a maximum particle size of 2.0 μm or less.

This dispersion of organic polyhalogen compound was filtered with a polypropylene-made filter having a pore size of 3.0 μm to remove foreign matters such as contaminant, and then stored.

<Preparation of 25 mass % Dispersion of Organic Polyhalogen Compound 2>

A dispersion was prepared in the same manner as in Preparation of 20 mass % Dispersion of Organic Polyhalogen Compound-1 except for using 5 kg of N-butyl-3-tribromomethanesulfonylbenzamide in place of 5 kg of tribromomethylnaphthylsulfone, dispersing a slurry thereof, diluting the dispersion such that the concentration of the organic polyhalogen compound became 25 mass %, and then filtering. The particles of the organic polyhalogen compound contained in the thus-obtained dispersion of organic polyhalogen compound 2 had a median particle size of 0.39 μm and a maximum particle size of 2.2 μm or less.

This dispersion of organic polyhalogen compound was filtered with a polypropylene-made filter having a pore size of 3.0 μm to remove foreign matters such as contaminant, and then stored.

<Preparation of 30 mass % Dispersion of Organic Polyhalogen Compound 3>

A dispersion was prepared in the same manner as in Preparation of 20 mass % Dispersion of Organic Polyhalogen Compound-1 except for using 5 kg of tribromomethylphenylsulfone in place of 5 kg of tribromomethylnaphthylsulfone, changing the amount of 20 mass % MP203 aqueous solution to 5 kg, dispersing the slurry, diluting the dispersion such that the concentration of the organic polyhalogen compound became 30 mass %, and filtering it. The particles of the organic polyhalogen compound contained in the thus-obtained dispersion of organic polyhalogen compound 3 had a median particle size of 0.41 μm and a maximum particle size of 2.0 μm or less.

This dispersion of organic polyhalogen compound was filtered with a polypropylene-made filter having a pore size of 3.0 μm to remove foreign matters such as contaminant, and then stored. During storage, the dispersion was kept at 10° C. or below until the use.

<Preparation of 5 mass % Solution of Phthalazine Compound>

In 174.57 kg of water was dissolved 8 kg of modified polyinyl alcohol (MP 203 produced by Kuraray Co., Ltd.). Thereto, 3.15 kg of a 20 mass % aqueous solution of sodium triisopropylnaphthalenesulfonate and 14.28 kg of a 70 mass % aqueous solution of 6-isopropylphthalazine were added to prepare a 5 mass % solution of 6-isopropylphthalazine.

<Preparation of 20 mass % Dispersion of Pigment>

To a mixture of 64 g of C.I. Pigment Blue 60 and 6.4 g of Demol N (produced by Kao Corp.) was added 250 ml of water. The mixture was thoroughly mixed to make a slurry and the slurry was put into a vessel together with 800 g of zirconia beads having an average diameter of 0.5 mm and dispersed by a dispersing machine (¼ Gallon Sand Grinder Mill manufactured by Imex Inc.) for 25 hours to prepare a pigment dispersion. The particles of the pigment contained in the thus-obtained pigment dispersion had an average particle size of 0.21 μm.

### EXAMPLE 1-1

<Preparation of Binder for Image-Forming Layer>

The binder for image-forming layer was prepared as follows. Compound (RP-1) obtained in Comparative Synthesis Example 1 shown below was treated by adding 1 mol/liter NaOH and 1 mol/liter NH₄OH such that the ratio of Na⁺ ion/NH₄⁺ ion was 1/2.3 (by mol), and adjusted to a pH of 8.4. At this time, the latex concentration was 40 mass %.

### COMPARATIVE SYNTHESIS EXAMPLE 1

Synthesis of Compound (RP-1)

RP-1 (solid content: 45, particle size: 105 nm, sol formation ratio: 0%, gelling ratio: 100%, molecular weight of sol: 8,000, Tg of sol: −40° C.) was synthesized in accordance with the synthesis formulation of Polymer Latex La-1 described in Example of JP-A-2000-10229.

<Preparation of Coating Solution for Image-Forming Layer>

A mixture of 1.1 g of the 20 mass % aqueous dispersion of pigment prepared above, 103 g of the organic acid silver salt dispersion prepared above, 5 g of a 20 mass % aqueous solution of polyinyl alcohol (PVA-205 produced by Kuraray Co., Ltd.), 25 g of the 25 mass % dispersion of reducing agent prepared above, 13.2 g in total of the organic polyhalogen compound dispersions 1, 2 and 3 (2/5/2 by mass), 6.2 g of the 10 mass % dispersion of mercapto compound prepared above, 106 g of the binder for image-forming layer (Compound (RP-1), latex concentration: 40 mass %) and 18 ml of the 5 mass % solution of phthalazine compound prepared above was thoroughly mixed with 10 g of Mixed Silver Halide Emulsion A to prepare a coating solution for image-forming layer (photosensitive layer, emulsion layer). The coating solution was fed to a coating die as it was and coated to give a coating amount of 70 ml/m².

The viscosity of the coating solution for image-forming layer was measured by a B-type viscometer (manufactured by Tokyo Keiki Co., Ltd.) at 40° C. (No. 1 rotor, at 60 rpm) and found to be 85 mPa.s.

The viscosity of the coating solution measured by RFS Fluid Spectrometer (manufactured by Rheometrix Far East Ltd.) at 25° C. were 1,500, 220, 70, 40 and 20 mPa.s at the shearing velocity of 0.1, 1, 10, 100 and 1,000 (1/sec), respectively.

<Preparation of Coating Solution for Intermediate Layer on Emulsion Surface>

To a mixture of 772 g of a 10 mass % aqueous solution of polyinyl alcohol (PVA-205 produced by Kuraray Co., Ltd.), 5.3 g of the 20 mass % dispersion of pigment prepared above, and 226 g of a 27.5 mass % solution of methyl methacrylate/styrene/butyl acrylate/hydroxyethyl methacrylate/acrylic acid copolymer (copolymerization ratio: 64/9/20/5/2 by mass) latex were added 2 ml of a 5 mass % aqueous solution of Aerosol OT (produced by American Cyanamid Co.) and 10.5 ml of a 20 mass % aqueous solution of diammonium phthalate. Thereto, water was added to make a total amount of 880 g, thereby preparing a coating solution for intermediate layer. The coating solution was fed to a coating die to give a coating amount of 10 ml/m².

The viscosity of the coating solution was measured by a B-type viscometer at 40° C. (No. 1 rotor, at 60 rpm) and found to be 21 mPa.s.

<Preparation of Coating Solution for First Protective Layer on Emulsion Surface>

To a solution prepared by dissolving 64 g of inert gelatin in water were added 80 g of a 27.5 mass % solution of methyl methacrylate/styrene/butyl acrylate/hydroxyethyl methacrylate/acrylic acid copolymer (copolymerization ratio: 64/9/20/5/2 by mass) latex, 23 ml of a 10 mass % methanol solution of phthalic acid, 23 ml of a 10 mass % aqueous solution of 4-methylphthalic acid, 28 ml of 0.5 mol/liter sulfuric acid, 5 ml of a 5 mass % aqueous solution of Aerosol OT (produced by American Cyanamid Co.), 0.5 g of phenoxyethanol and 0.1 g of benzisothiazolinone. Thereto, water was added to make a total amount of 750 g, thereby preparing a coating solution for first protective layer. Immediately before coating, 26 ml of 4 mass % chrome alum was mixed with the coating solution using a static mixer and then the coating solution was fed to a coating die to give a coating amount of 18.6 ml/m².

The viscosity of the coating solution was measured by a B-type viscometer at 40° C. (No. 1 rotor, at 60 rpm) and found to be 17 mPa.s.

<Preparation of Coating Solution for Second Protective Layer on Emulsion Surface>

To a solution prepared by dissolving 80 g of inert gelatin in water were added 102 g of a 27.5 mass % solution of methyl methacrylate/styrene/butyl acrylate/hydroxyethyl methacrylate/acrylic acid copolymer (copolymerization ratio: 64/9/20/5/2 by mass) latex, 3.2 ml of a 5 mass % solution of N-perfluorooctylsulfonyl-N-propylalanine potassium salt, 32 ml of a 2 mass % aqueous solution of polyethylene glycol mono(N-perfluorooctylsulfonyl-N-propyl-2-aminoethyl) ether (average polymerization degree of ethylene oxide: 15), 23 ml of a 5 mass % solution of Aerosol OT (produced by American Cyanamid Co.), 4 g of polymethyl methacrylate fine particles (average particle size: 0.7 μm), 21 g of polymethyl methacrylate fine particles (average particle size: 6.4 μm), 1.6 g of 4-methylphthalic acid, 4.8 g of phthalic acid, 44 ml of 0.5 mol/liter sulfuric acid and 10 mg of benzisothiazolinone. Thereto, water was added to make a total amount of 650 g and immediately before coating, 445 ml of an aqueous solution containing 4 mass % of chrome alum and 0.67 mass % of phthalic acid was mixed using a static mixer to prepare the coating solution for surface protective layer. Then, the coating solution was fed to a coating die to give a coating amount of 8.3 ml/m².

The viscosity of the coating solution was measured by a B-type viscometer at 40° C. (No. 1 rotor, at 60 rpm) and found to be 9 mPa.s.

<Manufacture of Heat-Developable Image Recording Material>

In the back surface side of the undercoated support prepared above, the coating solution for anti-halation layer and the coating solution for protective layer on back surface were simultaneously coated one on another such that the coated amount as a solid content of the solid fine particle dye in the anti-halation layer became 0.04 g/m² and the gelatin coated amount in the protective layer on back surface became 1.7 g/m². Then, the solutions were dried to form an anti-halation back layer.

On the undercoat layer provided in the opposite side to the back surface, the coating solutions for image-forming layer (coated amount of silver halide: 0.14 g/m² as silver), intermediate layer, first protective layer and second protective layer were simultaneously coated one on another in this order from the undercoat layer by a slide bead coating method to prepare heat-developable image recording material Sample 101.

The coating was performed at a coating speed of 160 m/min. The distance between the coating die tip and the support was adjusted to from 0.14 to 0.28 mm. The width of coating was controlled to increase 0.5 mm on each side to the discharge slit width for the coating solution. The pressure in a reduced pressure chamber was set lower than the atmospheric pressure by 392 Pa. The support was handled so as to prevent electrification while controlling temperature and humidity and electrically discharged with ionized air immediately before coating. In the subsequent chilling zone, the coating solution was chilled by blowing air of dry bulb temperature of 18° C. and wet bulb temperature of 12° C. for 30 seconds. The image recording material was transported in a helical floating type drying zone while blowing dry air of dry bulb temperature of 30° C. and wet bulb temperature of 18° C. for 200 seconds. Then, the material was passed through a drying zone of 70° C. for 20 seconds and a drying zone of 90° C. for 10 seconds, and thereafter cooled to 25° C., thereby volatilizing the solvent in the coating solution. In the chilling zone and drying zones, the average wind speed blown on the coating solution film surface was 7 m/sec.

The matting degree of the manufactured heat-developable image recording material was, in terms of the Bekk smoothness, 550 seconds in the image forming layer side and 130 seconds in the back surface side.

Samples 102 to 120 were prepared by appropriately selecting the phenol-base reducing agent (compound of formula (I)), the compound which satisfies at least one of the conditions (A) and (B) (compound used in combination with the compound of formula (I)), the coated amounts thereof (shown relatively by mol % taking the amount of compound as 100), and the binder for image-forming layer as shown in Table 1 below so as to give almost the same development density as that of Sample 101. These samples were evaluated on the work brittleness and the image preservability. The results obtained are shown in Table 1 below.

In Table 1 below, the reducing agent is selected from Compounds (I-1) to (I-34) which are specific examples of the compound of formula (I), the compound used in combination with the compound of formula (I) is selected from Compounds (1) to (32) which are specific examples of the compounds of formulae (II) to (V), and Compounds (II-1) to (II-90) which are specific examples of the compound having a phosphoryl group, and the binder for image-forming layer is selected from Compounds (P1-1) to (P1-24) which are specific examples of the specific polymer, and Compound (RP-1).

In the manufacture of Samples 102 to 120, when a reducing agent (compound of formula (I)) different from that of Sample 101 was used, a 25 mass % dispersion of the reducing agent was prepared in the same manner as in Preparation of 25 mass % Dispersion of Reducing Agent above except for using the reducing agent in place of 1,1-bis(2-hydroxy-3,5-dimethylphenyl)-3,5,5-trimethylhexane (Compound (I-1)).

In the manufacture of Samples 102 to 120, when the compound used in combination with the compound of formula (I) was used, the compound was incorporated as a dispersion into the coating solution for image-forming layer. The amount used was controlled to be equivalent in mol to the reducing agent. The preparation of dispersion of Compound (II-2) is described below and other compounds were also incorporated as a dispersion prepared in the same manner.

<Preparation of Dispersion of Compound (II-2)>

To a mixture of 1 kg of Compound (II-2) and 1 kg of a 20 mass % aqueous solution of modified polyinyl alcohol (Poval MP 203 produced by Kuraray Co., Ltd.) was added 1.6 kg of water. The mixture was thoroughly mixed to make a slurry. The slurry was fed by means of a diaphragm pump into a horizontal type sand mill (UVM-2 manufactured by Imex Inc.) filled with zirconia beads having an average diameter of 0.5 mm, and dispersed for 3 hours and 30 minutes. Thereto, 0.2 g of benzisothiazolinone sodium salt and water were added such that the concentration of the phosphoryl compound became 25 mass %, thereby obtaining a solid fine particle dispersion of phosphoryl compound. The particles of the phosphoryl compound contained in the thus-obtained dispersion had a median particle size of 0.45 μm and a maximum particle size of 2.0 μm or less. This dispersion was filtered with a polypropylene-made filter having a pore size of 10.0 μm to remove foreign matters such as contaminant, and then stored.

In the manufacture of Samples 102 to 120, even when the binder for image-forming layer used was different from that of Sample 101, the binder was prepared in the same manner as in Preparation of Binder for Image-Forming Layer above. In Table 1, the binder for image-forming layer and the halogen ion content thereof are shown.

<Evaluation of Working Brittleness>

A coated sample was cut into a rectangular shape having a width of 5 cm and a length of 20 cm. A pressure-sensitive adhesive tape (Cellotape, 2.5 cm width, produced by Nichiban) was adhered to the cut end and after allowing it to stand in an environment of 25° C. for 1 hour, the adhesive tape was peeled off. Then, the peeled part of the coating was observed with an eye through a microscope (practically acceptable are A and B).

A: No peeling.

B: Partially slight peeling.

C: Slight peeling.

D: Severe peeling.

<Evaluation of Image Preservability>

The evaluation of image preservability was performed by preserving each image recording material after heat development, under conditions of 60° C. and 55% RH for one day and determining the change in density (ΔDmin) in the white background portion before and after the preservation.

TABLE 1

| | | Reducing Agent | | Compound Combined | | | | |
|---|---|---|---|---|---|---|---|---|
| | Binder for | (formula (I)) | | with Reducing Agent | | | | |
| | Image-Forming | | Coated | | Coated | Working | | |
| Sample | Layer | | Amount | | Amount | Brittle- | Image | |
| No. | Kind | Kind | (relative mol %) | Kind | (relative mol %) | ness | Preservability | Remarks |
| 101 | RP-1 | (I-1) | 100 | — | — | C | 0.261 | Comparison |
| 102 | RP-1 | (I-1) | 100 | (II-2) | 100 | C | 0.120 | Comparison |
| 103 | P1-1 | (I-1) | 100 | (II-2) | 100 | A | 0.040 | Invention |
| 104 | P1-1 | (I-1) | 100 | | — | A | 0.111 | Invention |
| 105 | P1-1 | (I-1) | 80 | (II-2) | 80 | A | 0.050 | Invention |
| 106 | P1-1 | (I-1) | 50 | (II-2) | 50 | A | 0.038 | Invention |
| 107 | P1-1 | (I-1) | 65 | (II-2) | 65 | A | 0.053 | Invention |
| 108 | P1-1 | (I-1) | 90 | (II-2) | 90 | B | 0.069 | Invention |
| 109 | P1-2 | (I-1) | 100 | (2) | 100 | A | 0.060 | Invention |
| 110 | P1-3 | (I-1) | 100 | (6) | 100 | B | 0.048 | Invention |
| 111 | P1-4 | (I-1) | 100 | (8) | 100 | A | 0.041 | Invention |
| 112 | P1-5 | (I-1) | 100 | (11) | 100 | A | 0.040 | Invention |
| 113 | P1-7 | (I-1) | 100 | (13) | 100 | B | 0.073 | Invention |
| 114 | P1-8 | (I-1) | 100 | (15) | 100 | A | 0.080 | Invention |
| 115 | P1-10 | (I-1) | 100 | (16) | 100 | A | 0.083 | Invention |
| 116 | P1-12 | (I-1) | 100 | (17) | 100 | A | 0.077 | Invention |
| 117 | P1-15 | (I-1) | 100 | (II-51) | 100 | B | 0.099 | Invention |
| 118 | P1-18 | (I-1) | 100 | (II-26) | 100 | A | 0.065 | Invention |
| 119 | P1-20 | (I-1) | 100 | (23) | 100 | A | 0.064 | Invention |
| 120 | P1-21 | (I-1) | 100 | (24) | 100 | B | 0.059 | Invention |

As is apparent from Table 1, both the image preservability and the working brittleness were extremely improved by using the specific polymer as the binder for image-forming layer.

### EXAMPLE 1-2

<Preparation of Binder for Image-Forming Layer>

The binder for image-forming layer was prepared as follows. Compound (RP-2) obtained in Comparative Synthesis Example 2 shown below was treated by adding 1 mol/liter NaOH and 1 mol/liter NH₄OH such that the ratio of Na⁺ ion/NH₄⁺ ion was 1/2.3 (by mol), and adjusted to a pH of 8.4. At this time, the latex concentration was 40 mass %.

### COMPARATIVE SYNTHESIS EXAMPLE 2

Synthesis of Compound (RP-2)

RP-2 was synthesized in accordance with the synthesis formulation of Polymer Latex P2-1 in the above-described Synthesis Example of the present invention except for not using nitrilotriacetic acid (chelate compound) (solid content: 44%, particle size: 115 nm, Tg: 18° C.).

### COMPARATIVE SYNTHESIS EXAMPLE 3

Synthesis of Compound (RP-3)

RP-3 was synthesized in accordance with the synthesis formulation of Polymer Latex P2-2 in the above-described Synthesis Example of the present invention except for using 0.67 g of tetrasodium ethylenediaminetetraacetate (chelate compound) (solid content: 45%, particle size: 75 nm, Tg: 22° C., concentration of chelating agent: 1,000 ppm)

<Preparation of Coating Solution for Image-Forming Layer>

A mixture of 1.1 g of the 20 mass % aqueous dispersion of pigment prepared above, 103 g of the organic acid silver salt dispersion prepared above, 5 g of a 20 mass % aqueous solution of polyinyl alcohol (PVA-205 produced by Kuraray Co., Ltd.), 25 g of the 25 mass % dispersion of reducing agent prepared above, 13.2 g in total of the organic polyhalogen compound dispersions 1, 2 and 3 (2/5/2 by mass), 6.2 g of the 10 mass % dispersion of mercapto compound prepared above, 106 g of the binder for image-forming layer (Compound (RP-2), latex concentration: 40 mass %) and 18 ml of the 5 mass % solution of phthalazine compound prepared above was thoroughly mixed with 10 g of Mixed Silver Halide Emulsion A to prepare a coating solution for image-forming layer (photosensitive layer, emulsion layer). The coating solution was fed to a coating die as it was and coated to give a coating amount of 70 ml/m².

The viscosity of the coating solution for image-forming layer was measured by a B-type viscometer (manufactured by Tokyo Keiki Co., Ltd.) at 40° C. (No. 1 rotor, at 60 rpm) and found to be 85 mPa.s.

The viscosity of the coating solution measured by RFS Fluid Spectrometer (manufactured by Rheometrix Far East Ltd.) at 25° C. were 1,500, 220, 70, 40 and 20 mPa.s at the shearing velocity of 0.1, 1, 10, 100 and 1,000 (1/sec), respectively.

<Preparation of Coating Solution for Intermediate Layer on Emulsion Surface>

To a mixture of 772 g of a 10 mass % aqueous solution of polyinyl alcohol (PVA-205 produced by Kuraray Co., Ltd.), 5.3 g of the 20 mass % dispersion of pigment prepared above, and 226 g of a 27.5 mass % solution of methyl methacrylate/styrene/butyl acrylate/hydroxyethyl methacrylate/acrylic acid copolymer (copolymerization ratio: 64/9/20/5/2 by mass) latex were added 2 ml of a 5 mass % aqueous solution of Aerosol OT (produced by American Cyanamid Co.) and 10.5 ml of a 20 mass % aqueous solution of diammonium phthalate. Thereto, water was added to make a total amount of 880 g, thereby preparing a coating solution for intermediate layer. The coating solution was fed to a coating die to give a coating amount of 10 ml/m².

The viscosity of the coating solution was measured by a B-type viscometer at 40° C. (No. 1 rotor, at 60 rpm) and found to be 21 mPa.s.

<Preparation of Coating Solution for First Protective Layer on Emulsion Surface>

To a solution prepared by dissolving 64 g of inert gelatin in water were added 80 g of a 27.5 mass % solution of methyl methacrylate/styrene/butyl acrylate/hydroxyethyl methacrylate/acrylic acid copolymer (copolymerization ratio: 64/9/20/5/2 by mass) latex, 23 ml of a 10 mass % methanol solution of phthalic acid, 23 ml of a 10 mass % aqueous solution of 4-methylphthalic acid, 28 ml of 0.5 mol/liter sulfuric acid, 5 ml of a 5 mass % aqueous solution of Aerosol OT (produced by American Cyanamid Co.), 0.5 g of phenoxyethanol and 0.1 g of benzisothiazolinone. Thereto, water was added to make a total amount of 750 g, thereby preparing a coating solution for first protective layer. Immediately before coating, 26 ml of 4 mass % chrome alum was mixed with the coating solution using a static mixer and then the coating solution was fed to a coating die to give a coating amount of 18.6 ml/m².

The viscosity of the coating solution was measured by a B-type viscometer at 40° C. (No. 1 rotor, at 60 rpm) and found to be 17 mPa.s.

<Preparation of Coating Solution for Second Protective Layer on Emulsion Surface>

To a solution prepared by dissolving 80 g of inert gelatin in water were added 102 g of a 27.5 mass % solution of methyl methacrylate/styrene/butyl acrylate/hydroxyethyl methacrylate/acrylic acid copolymer (copolymerization ratio: 64/9/20/5/2 by mass) latex, 3.2 ml of a 5 mass % solution of N-perfluorooctylsulfonyl-N-propylalanine potassium salt, 32 ml of a 2 mass % aqueous solution of polyethylene glycol mono(N-perfluorooctylsulfonyl-N-propyl-2-aminoethyl) ether (average polymerization degree of ethylene oxide: 15), 23 ml of a 5 mass % solution of Aerosol OT (produced by American Cyanamid Co.), 4 g of polymethyl methacrylate fine particles (average particle size: 0.7 μm), 21 g of polymethyl methacrylate fine particles (average particle size: 6.4 μm), 1.6 g of 4-methylphthalic acid, 4.8 g of phthalic acid, 44 ml of 0.5 mol/liter sulfuric acid and 10 mg of benzisothiazolinone. Thereto, water was added to make a total amount of 650 g and immediately before coating, 445 ml of an aqueous solution containing 4 mass % of chrome alum and 0.67 mass % of phthalic acid was mixed using a static mixer to prepare the coating solution for surface protective layer. Then, the coating solution was fed to a coating die to give a coating amount of 8.3 ml/m².

The viscosity of the coating solution was measured by a B-type viscometer at 40° C. (No. 1 rotor, at 60 rpm) and found to be 9 mPa.s.

<Manufacture of Heat-Developable Image Recording Material>

In the back surface side of the undercoated support prepared above, the coating solution for anti-halation layer and the coating solution for protective layer on back surface were simultaneously coated one on another such that the coated amount as a solid content of the solid fine particle dye in the anti-halation layer became 0.04 g/m² and the gelatin coated amount in the protective layer on back surface became 1.7 g/m². Then, the solutions were dried to form an anti-halation back layer.

On the undercoat layer provided in the opposite side to the back surface, the coating solutions for image-forming layer (coated amount of silver halide: 0.14 g/m² as silver), intermediate layer, first protective layer and second protective layer were simultaneously coated one on another in this order from the undercoat layer by a slide bead coating method to prepare heat-developable image recording material Sample 101.

The coating was performed at a coating speed of 180 m/min. The distance between the coating die tip and the support was adjusted to from 0.14 to 0.28 mm. The width of coating was controlled to increase 0.5 mm on each side to the discharge slit width for the coating solution. The pressure in a reduced pressure chamber was set lower than the atmospheric pressure by 392 Pa. The support was handled so as to prevent electrification while controlling temperature and humidity and electrically discharged with ionized air immediately before coating. In the subsequent chilling zone, the coating solution was chilled by blowing air of dry bulb temperature of 18° C. and wet bulb temperature of 12° C. for 30 seconds. The image recording material was transported in a helical floating type drying zone while blowing dry air of dry bulb temperature of 30° C. and wet bulb temperature of 18° C. for 200 seconds. Then, the material was passed through a drying zone of 70° C. for 20 seconds and a drying zone of 90° C. for 10 seconds, and thereafter cooled to 25° C., thereby volatilizing the solvent in the coating solution. In the chilling zone and drying zones, the average wind speed blown on the coating solution film surface was 7 m/sec.

The matting degree of the manufactured heat-developable image recording material was, in terms of the Bekk smoothness, 550 seconds in the image-forming layer side and 130 seconds in the back surface side.

Samples 102 to 120 were prepared by appropriately selecting the phenol-base reducing agent (compound of formula (I)), the compound which satisfies at least one of the conditions (A) and (B) (compound used in combination with the compound of formula (I)), the coated amounts thereof (shown relatively by mol % taking the amount of Compound I-1 as 100), and the binder for image-forming layer as shown in Table 2 below so as to give almost the same development density as that of Sample 101. These samples were evaluated on the coating property and the image preservability.

The results obtained are shown in Table 1 below.

In Table 2 below, the reducing agent is selected from Compounds (I-1) to (I-34) which are specific examples of the compound of formula (I), the compound used in combination with the compound of formula (I) is selected from Compounds (1) to (32) which are specific examples of the compounds of formulae (II) to (V), and Compounds (II-1) to (II-90) which are specific examples of the compound having a phosphoryl group, and the binder for image-forming layer is selected from Compounds (P2-1) to (P2-24) which are specific examples of the specific polymer, and Compounds (RP-2) and (RP-3).

In the manufacture of Samples 102 to 120, when a reducing agent (compound of formula (I)) different from that of Sample 101 was used, a 25 mass % dispersion of the reducing agent was prepared in the same manner as in Preparation of 25 mass % Dispersion of Reducing Agent above except for using the reducing agent in place of 1,1-bis(2-hydroxy-3,5-dimethylphenyl)-3,5,5-trimethylhexane (Compound (I-1)).

In the manufacture of Samples 102 to 120, when the compound used in combination with the compound of formula (I) was used, the compound was incorporated as a dispersion into the coating solution for image-forming layer. The amount used was controlled to be equivalent in mol to the reducing agent. The preparation of dispersion of Compound (II-2) is described below and other compounds were also incorporated as a dispersion prepared in the same manner.

<Preparation of Dispersion of Compound (II-2)>

To a mixture of 1 kg of Compound (II-2) and 1 kg of a 20 mass % aqueous solution of modified polyinyl alcohol (Poval MP 203 produced by Kuraray Co., Ltd.) was added 1.6 kg of water. The mixture was thoroughly mixed to make a slurry. The slurry was fed by means of a diaphragm pump into a horizontal type sand mill (UVM-2 manufactured by Imex Inc.) filled with zirconia beads having an average diameter of 0.5 mm, and dispersed for 3 hours and 30 minutes. Thereto, 0.2 g of benzisothiazolinone sodium salt and water were added such that the concentration of the phosphoryl compound became 25 mass %, thereby obtaining a solid fine particle dispersion of phosphoryl compound. The particles of the phosphoryl compound contained in the thus-obtained dispersion had a median particle size of 0.45 μm and a maximum particle size of 2.0 μm or less. This dispersion was filtered with a polypropylene-made filter having a pore size of 10.0 μm to remove foreign matters such as contaminant, and then stored.

In the manufacture of Samples 102 to 120, even when the binder for image-forming layer used was different from that of Sample 101, the binder was prepared in the same manner as in Preparation of Binder for Image-Forming Layer above. In Table 2, the kind of the binder for image-forming layer is shown.

<Evaluation of Coating Property>

The evaluation of coating property was performed by observing with an eye the surface of each sample after coating and counting the number of streaks or repelling marks per 5 m². The criteria of evaluation are as follows (practically acceptable are A and B):

A: 0

B: 1

C: 2 to 4

D: 5 or more

<Evaluation of Image Preservability>

The evaluation of image preservability was performed by preserving each image recording material after heat development, under conditions of 60° C. and 55% RH for one day and determining the change in density (ΔDmin) in the white background portion before and after the preservation.

TABLE 2

| | | Reducing Agent | | Compound Combined | | | | |
|---|---|---|---|---|---|---|---|---|
| | Binder for | (formula (I)) | | with Reducing Agent | | | | |
| | Image-Forming | | Coated | | Coated | | | |
| Sample | Layer | | Amount | | Amount | Coating | Image | |
| No. | Kind | Kind | (relative mol %) | Kind | (relative mol %) | Property | Preservability | Remarks |
| 101 | RP-2 | (I-1) | 100 | — | — | D | 0.271 | Comparison |
| 102 | RP-2 | (I-1) | 100 | (II-2) | 100 | D | 0.115 | Comparison |
| 103 | P2-1 | (I-1) | 100 | (II-2) | 100 | A | 0.038 | Invention |
| 104 | P2-1 | (I-1) | 100 | | — | A | 0.120 | Invention |
| 105 | P2-1 | (I-2) | 80 | (II-2) | 80 | A | 0.070 | Invention |
| 106 | P2-1 | (I-3) | 50 | (II-2) | 50 | A | 0.028 | Invention |
| 107 | P2-1 | (I-4) | 65 | (II-2) | 65 | A | 0.063 | Invention |
| 108 | P2-1 | (I-7) | 90 | (II-2) | 90 | B | 0.079 | Invention |
| 109 | P2-2 | (I-1) | 100 | (2) | 100 | A | 0.065 | Invention |
| 110 | P2-3 | (I-1) | 100 | (6) | 100 | B | 0.049 | Invention |
| 111 | P2-4 | (I-1) | 100 | (8) | 100 | A | 0.051 | Invention |
| 112 | P2-5 | (I-1) | 100 | (11) | 100 | A | 0.047 | Invention |
| 113 | P2-7 | (I-1) | 100 | (13) | 100 | B | 0.077 | Invention |
| 114 | P2-8 | (I-1) | 100 | (15) | 100 | A | 0.074 | Invention |
| 115 | P2-10 | (I-1) | 100 | (16) | 100 | A | 0.085 | Invention |
| 116 | P2-12 | (I-1) | 100 | (17) | 100 | A | 0.067 | Invention |
| 117 | P2-15 | (I-1) | 100 | (II-51) | 100 | B | 0.101 | Invention |
| 118 | P2-18 | (I-1) | 100 | (II-26) | 100 | A | 0.069 | Invention |
| 119 | P2-20 | (I-1) | 100 | (23) | 100 | A | 0.054 | Invention |
| 120 | P2-3 | (I-1) | 100 | (24) | 100 | D | 0.255 | Comparison |

As is apparent from Table 2, both the image preservability and the coating property were extremely improved by using the specific polymer as the binder for image-forming layer.

### EXAMPLE 1-3

In Example 1-3, the suitability for emulsion polymerization of the polymer latexes (P3-1 to P3-19) obtained by the emulsion polymerization in the presence of a basic compound of the present invention are first shown in Table 3 below. The polymer latexes (P3-1 to P3-3 and P3-4) not described in Synthesis Examples above were prepared according to the synthesis method described in Synthesis Examples.

For the purpose of comparison with the synthesis method of polymer latex for use in the present invention, Comparative Polymer Latexes RP-4 and RP-5 were prepared by the method different from that of the present invention and these synthesis methods are described below.

### COMPARATIVE SYNTHESIS EXAMPLE 1

Synthesis of Compound (RP-4) (Change in Synthesis Formulation of Compound P3-1)

RP-4 was synthesized thoroughly in the same formulation as in Synthesis Example 1 except that 18.75 ml of 1 mol/liter NaOH was changed to 18.75 ml of distilled water in Synthesis Example 1 (solid content: 45%, particle size: 105 nm, gel partial ratio: 64%).

### COMPARATIVE SYNTHESIS EXAMPLE 1

Synthesis of Compound (RP-4) (Change in Synthesis Formulation of Compound P3-1)

A polymer latex was obtained thoroughly in the formulation as in Comparative Synthesis Example 1 above except that 371.9 g of distilled water was changed to 788 g of distilled water in Comparative Synthesis Example 1 (solid content: 30%, particle size: 102 nm, gel partial ratio: 60%). The obtained polymer latex was concentrated under reduced pressure and filtered through a paper towel to obtain 1,170 g of Compound RP-5 (solid content: 45%, particle size: 102 nm, gel partial ratio: 60%).

Each polymer latex obtained was evaluated as follows on the suitability for emulsion polymerization. The results obtained are shown in Table 3 below.

<Evaluation of Suitability for Emulsion Polymerization>

The evaluation of suitability for emulsion polymerization was performed by observing with an eye the state of the polymer latex at the completion of polymerization reaction. The criteria of evaluation are as follows (practically acceptable are ⊚ and ◯).

⊚: Very good suitability.

◯: Good suitability.

Δ: Aggregates are generated.

×: A seriously large number of aggregates.

TABLE 3

| Binder for | | | | |
|---|---|---|---|---|
| Image-Forming | Basic Compound | Amount Added of Basic | Suitability for | |
| Layer | Added At Emulsion | Compound per 1 g of Latex | Emulsion | |
| Kind | Polymerization | Solid Content | Polymerization | Remarks |
| RP-4 | — | — | × | Comparison |
| RP-4 | — | — | ◯ | Comparison |
| P3-1 | NaOH | 5.0 × 10⁻³ mmol | ⊚ | Invention |
| P3-2 | NaOH | 1.2 × 10⁻³ mmol | ⊚ | Invention |
| P3-3 | NaOH | 5.0 × 10⁻³ mmol | ⊚ | Invention |
| P3-4 | NaOH + NH₄OH | 2.5 × 10⁻² mmol + 2.5 × 10⁻² mmol | ⊚ | Invention |
| P3-5 | NaOH | 5.0 × 10⁻³ mmol | ⊚ | Invention |
| P3-6 | NaOH | 3.6 × 10⁻² mmol | ◯ | Invention |
| P3-7 | NaOH | 3.6 × 10⁻² mmol | ⊚ | Invention |
| P3-8 | NaOH | 3.6 × 10⁻² mmol | ⊚ | Invention |
| P3-9 | NaOH | 5.0 × 10⁻² mmol | ◯ | Invention |
| P3-10 | NaOH | 5.0 × 10⁻² mmol | ⊚ | Invention |
| P3-11 | NaOH | 5.0 × 10⁻² mmol | ⊚ | Invention |
| P3-12 | NaOH | 5.0 × 10⁻² mmol | ⊚ | Invention |
| P3-13 | NaOH | 5.0 × 10⁻² mmol | ⊚ | Invention |
| P3-14 | NaOH | 5.0 × 10⁻² mmol | ⊚ | Invention |
| P3-15 | NaOH | 5.0 × 10⁻² mmol | ⊚ | Invention |
| P3-16 | NaOH | 2.5 × 10⁻² mmol | ⊚ | Invention |
| P3-17 | triethylamine | 5.0 × 10⁻² mmol | ⊚ | Invention |
| P3-18 | LiOH | 5.0 × 10⁻² mmol | ⊚ | Invention |
| P3-19 | NaOH | 1.0 × 10⁻¹ mmol | ⊚ | Invention |

As seen from Table 3, Polymer Latexes P3-1 to P3-19 prepared by the method of the present invention exhibited very good suitability for emulsion polymerization. Comparative Compounds RP-4 and RP-5 which were prepared using the same starting material and synthesis method as those of P3-1 which was rated ⊚ but by performing the emulsion polymerization in the absence of a basic compound were rated ◯ and ×, respectively, revealing that the polymer latex prepared by the synthesis method for use in the present invention where a basic compound is allowed to be present, has excellent suitability for polymerization.

<Preparation of Binder for Image-Forming Layer>

The binder for image-forming layer was prepared as follows. Compound (RP-4) obtained in Comparative Synthesis Example 1 above was treated by adding 1 mol/liter NaOH and 1 mol/liter NH₄OH such that the ratio of Na⁺ ion/NH₄⁺ ion was 1/2.3 (by mol), and adjusted to a pH of 8.4. At this time, the latex concentration was 40 mass %.

From other polymer latexes (P3-1 to P3-19 and RP-5), the binder for image-forming layer was prepared in the same manner as above.

<Preparation of Coating Solution for Image-Forming Layer>

A mixture of 1.1 g of the 20 mass % aqueous dispersion of pigment prepared above, 103 g of the organic acid silver salt dispersion prepared above, 5 g of a 20 mass % aqueous solution of polyinyl alcohol (PVA-205 produced by Kuraray Co., Ltd.), 25 g of the 25 mass % dispersion of reducing agent prepared above, 13.2 g in total of the organic polyhalogen compound dispersions 1, 2 and 3 (2/5/2 by mass), 6.2 g of the 10 mass % dispersion of mercapto compound prepared above, 106 g of the binder for image-forming layer (Compound (RP-4), latex concentration: 40 mass %) and 18 ml of the 5 mass % solution of phthalazine compound prepared above was thoroughly mixed with 10 g of Mixed Silver Halide Emulsion A to prepare a coating solution for image-forming layer (photosensitive layer, emulsion layer) of Sample 201. The coating solution was fed to a coating die as it was and coated to give a coating amount of 70 ml/m².

The viscosity of the coating solution for image-forming layer was measured by a B-type viscometer (manufactured by Tokyo Keiki Co., Ltd.) at 40° C. (No. 1 rotor, at 60 rpm) and found to be 85 mPa.s.

The viscosity of the coating solution measured by RFS Fluid Spectrometer (manufactured by Rheometrix Far East Ltd.) at 25° C. were 1,500, 220, 70, 40 and 20 mPa.s at the shearing velocity of 0.1, 1, 10, 100 and 1,000 (1/sec), respectively.

The coating solutions for Samples 202 to 219 were prepared in the same manner as the coating solution for Sample 201 except for changing the composition as described later. Each coating solution was fed to a coating die and coated.

<Preparation of Coating Solution for Intermediate Layer on Emulsion Surface>

To a mixture of 772 g of a 10 mass % aqueous solution of polyinyl alcohol (PVA-205 produced by Kuraray Co., Ltd.), 5.3 g of the 20 mass % dispersion of pigment prepared above, and 226 g of a 27.5 mass % solution of methyl methacrylate/styrene/butyl acrylate/hydroxyethyl methacrylate/acrylic acid copolymer (copolymerization ratio: 64/9/20/5/2 by mass) latex were added 2 ml of a 5 mass % aqueous solution of Aerosol OT (produced by American Cyanamid Co.) and 10.5 ml of a 20 mass % aqueous solution of diammonium phthalate. Thereto, water was added to make a total amount of 880 g, thereby preparing a coating solution for intermediate layer. The coating solution was fed to a coating die to give a coating amount of 10 ml/m².

The viscosity of the coating solution was measured by a B-type viscometer at 40° C. (No. 1 rotor, at 60 rpm) and found to be 21 mPa.s.

<Preparation of Coating Solution for First Protective Layer on Emulsion Surface>

To a solution prepared by dissolving 64 g of inert gelatin in water were added 80 g of a 27.5 mass % solution of methyl methacrylate/styrene/butyl acrylate/hydroxyethyl methacrylate/acrylic acid copolymer (copolymerization ratio: 64/9/20/5/2 by mass) latex, 23 ml of a 10 mass % methanol solution of phthalic acid, 23 ml of a 10 mass % aqueous solution of 4-methylphthalic acid, 28 ml of 0.5 mol/liter sulfuric acid, 5 ml of a 5 mass % aqueous solution of Aerosol OT (produced by American Cyanamid Co.), 0.5 g of phenoxyethanol and 0.1 g of benzisothiazolinone. Thereto, water was added to make a total amount of 750 g, thereby preparing a coating solution for first protective layer. Immediately before coating, 26 ml of 4 mass % chrome alum was mixed with the coating solution using a static mixer and then the coating solution was fed to a coating die to give a coating amount of 18.6 ml/m².

The viscosity of the coating solution was measured by a B-type viscometer at 40° C. (No. 1 rotor, at 60 rpm) and found to be 17 mPa.s.

<Preparation of Coating Solution for Second Protective Layer on Emulsion Surface>

To a solution prepared by dissolving 80 g of inert gelatin in water were added 102 g of a 27.5 mass % solution of methyl methacrylate/styrene/butyl acrylate/hydroxyethyl methacrylate/acrylic acid copolymer (copolymerization ratio: 64/9/20/5/2 by mass) latex, 3.2 ml of a 5 mass % solution of N-perfluorooctylsulfonyl-N-propylalanine potassium salt, 32 ml of a 2 mass % aqueous solution of polyethylene glycol mono(N-perfluorooctylsulfonyl-N-propyl-2-aminoethyl) ether (average polymerization degree of ethylene oxide: 15), 23 ml of a 5 mass % solution of Aerosol OT (produced by American Cyanamid Co.), 4 g of polymethyl methacrylate fine particles (average particle size: 0.7 μm), 21 g of polymethyl methacrylate fine particles (average particle size: 6.4 μm), 1.6 g of 4-methylphthalic acid, 4.8 g of phthalic acid, 44 ml of 0.5 mol/liter sulfuric acid and 10 mg of benzisothiazolinone. Thereto, water was added to make a total amount of 650 g and immediately before coating, 445 ml of an aqueous solution containing 4 mass % of chrome alum and 0.67 mass % of phthalic acid was mixed using a static mixer to prepare the coating solution for surface protective layer. Then, the coating solution was fed to a coating die to give a coating amount of 8.3 ml/m².

The viscosity of the coating solution was measured by a B-type viscometer at 40° C. (No. 1 rotor, at 60 rpm) and found to be 9 mPa.s.

<Manufacture of Heat-Developable Image Recording Material>

In the back surface side of the undercoated support prepared above, the coating solution for anti-halation layer and the coating solution for protective layer on back surface were simultaneously coated one on another such that the coated amount as a solid content of the solid fine particle dye in the anti-halation layer became 0.04 g/m² and the gelatin coated amount in the protective layer on back surface became 1.7 g/m². Then, the solutions were dried to form an anti-halation back layer.

On the undercoat layer provided in the opposite side to the back surface, the coating solutions for image-forming layer (coated amount of silver halide: 0.14 g/m² as silver), intermediate layer, first protective layer and second protective layer were simultaneously coated one on another in this order from the undercoat layer by a slide bead coating method to prepare heat-developable image recording material Sample 201.

The coating was performed at a coating speed of 180 m/min. The distance between the coating die tip and the support was adjusted to from 0.14 to 0.28 mm. The width of coating was controlled to increase 0.5 mm on each side to the discharge slit width for the coating solution. The pressure in a reduced pressure chamber was set lower than the atmospheric pressure by 392 Pa. The support was handled so as to prevent electrification while controlling temperature and humidity and electrically discharged with ionized air immediately before coating. In the subsequent chilling zone, the coating solution was chilled by blowing air of dry bulb temperature of 18° C. and wet bulb temperature of 12° C. for 30 seconds. The image recording material was transported in a helical floating type drying zone while blowing dry air of dry bulb temperature of 30° C. and wet bulb temperature of 18° C. for 200 seconds. Then, the material was passed through a drying zone of 70° C. for 20 seconds and a drying zone of 90° C. for 10 seconds, and thereafter cooled to 25° C., thereby volatilizing the solvent in the coating solution. In the chilling zone and drying zones, the average wind speed blown on the coating solution film surface was 7 m/sec.

The matting degree of the manufactured heat-developable image recording material was, in terms of the Bekk smoothness, 550 seconds in the image-forming layer side and 130 seconds in the back surface side.

Samples 202 to 219 were prepared by appropriately selecting the phenol-base reducing agent (compound of formula (I)), the compound which satisfies at least one of the conditions (A) and (B) (compound used in combination with the compound of formula (I)), the coated amounts thereof (shown relatively by mol % taking the amount of compound as 100), and the binder for image-forming layer as shown in Table 4 below so as to give almost the same development density as that of Sample 201. These samples were evaluated on the coating property and the image preservability. The results obtained are shown in Table 4 below.

In Table 4 below, the reducing agent is selected from Compounds (I-1) to (I-34) which are specific examples of the compound of formula (I), the compound used in combination with the compound of formula (I) is selected from Compounds (1) to (32) which are specific examples of the compounds of formulae (II) to (V), and Compounds (II-1) to (II-90) which are specific examples of the compound having a phosphoryl group, and the binder for image-forming layer is selected from Compounds (P3-1) to (P3-19) which are specific examples of the specific polymer, and Compounds (RP-4) and (RP-5).

In the manufacture of Samples 202 to 219, when a reducing agent (compound of formula (I)) different from that of Sample 201 was used, a 25 mass % dispersion of the reducing agent was prepared in the same manner as in Preparation of 25 mass % Dispersion of Reducing Agent above except for using the reducing agent in place of 1,1-bis(2-hydroxy-3,5-dimethylphenyl)-3,5,5-trimethylhexane (Compound (I-1)).

In the manufacture of Samples 202 to 219, when the compound used in combination with the compound of formula (I) was used, the compound was incorporated as a dispersion into the coating solution for image-forming layer. The amount used was controlled to be equivalent in mol to the reducing agent. The preparation of dispersion of Compound (II-2) is described below and other compounds were also incorporated as a dispersion prepared in the same manner.

<Preparation of Dispersion of Compound (II-2)>

To a mixture of 1 kg of Compound (II-2) and 1 kg of a 20 mass % aqueous solution of modified polyinyl alcohol (Poval MP 203 produced by Kuraray Co., Ltd.) was added 1.6 kg of water. The mixture was thoroughly mixed to make a slurry. The slurry was fed by means of a diaphragm pump into a horizontal type sand mill (UVM-2 manufactured by Imex Inc.) filled with zirconia beads having an average diameter of 0.5 mm, and dispersed for 3 hours and 30 minutes. Thereto, 0.2 g of benzisothiazolinone sodium salt and water were added such that the concentration of the phosphoryl compound became 25 mass %, thereby obtaining a solid fine particle dispersion of phosphoryl compound. The particles of the phosphoryl compound contained in the thus-obtained dispersion had a median particle size of 0.45 μm and a maximum particle size of 2.0 μm or less. This dispersion was filtered with a polypropylene-made filter having a pore size of 10.0 μm to remove foreign matters such as contaminant, and then stored.

In the manufacture of Samples 202 to 219, even when the binder for image-forming layer used was different from that of Sample 201, the binder was prepared in the same manner as in Preparation of Binder for Image-Forming Layer above. In Table 4, the kind of the binder for image-forming layer is shown.

<Evaluation of Coating Property>

The evaluation of coating property was performed by observing with an eye the surface of each sample after coating and counting the number of streaks or repelling marks per 5 m². The criteria of evaluation are as follows (practically acceptable are A and B):

A: 0

B: 1

C: 2 to 4

D: 5 or more

<Evaluation of Image Preservability>

The evaluation of image preservability was performed by preserving each image recording material after heat development, under conditions of 60° C. and 55% RH for one day and determining the change in density (ΔDmin) in the white background portion before and after the preservation.

TABLE 4

| | | Basic | | | | | | | |
|---|---|---|---|---|---|---|---|---|---|
| | | Compound | | | | | | | |
| | | (amount | Reducing Agent | | Compound Combined | | | | |
| | Binder for | added: ×10⁻⁹ | (formula (I)) | | with Reducing Agent | | | | |
| | Image-Forming | mmol/g | | Coated | | Coated | | | |
| Sample | Layer | solid | | Amount | | Amount | Coating | Image | |
| No. | Kind | content) | Kind | (relative mol %) | Kind | (relative mol %) | Property | Preservability | Remarks |
| 201 | RP-4 | — | (I-1) | 100 | — | — | C | 0.161 | Comparison |
| 202 | RP-5 | — | (I-1) | 100 | (II-2) | — | C | 0.136 | Comparison |
| 203 | P3-1 | NaOH(5) | (I-1) | 100 | (II-2) | 100 | A | 0.055 | Invention |
| 204 | P3-2 | NaOH(12) | (I-1) | 100 | (II-2) | 100 | A | 0.040 | Invention |
| 205 | P3-3 | NaOH(5) | (I-1) | 100 | (II-2) | 100 | A | 0.062 | Invention |
| 206 | P3-4 | NaOH(2.5) + | (I-1) | 100 | (II-2) | 100 | A | 0.102 | Invention |
| | | NH₄OH(2.5) | | | | | | | |
| 207 | P3-1 | NaOH(5) | (I-1) | 100 | — | — | A | 0.144 | Invention |
| 208 | P3-1 | NaOH(5) | (I-2) | 80 | (II-2) | 100 | A | 0.102 | Invention |
| 209 | P3-1 | NaOH(5) | (I-3) | 50 | (II-2) | 80 | A | 0.044 | Invention |
| 210 | P3-1 | NaOH(5) | (I-4) | 65 | (II-2) | 50 | A | 0.038 | Invention |
| 211 | P3-1 | NaOH(5) | (I-7) | 90 | (II-2) | 65 | A | 0.047 | Invention |
| 212 | P3-9 | NaOH(5) | (I-1) | 100 | (2) | 100 | A | 0.047 | Invention |
| 213 | P3-10 | NaOH(5) | (I-1) | 100 | (6) | 100 | B | 0.069 | Invention |
| 214 | P3-11 | NaOH(5) | (I-1) | 100 | (8) | 100 | A | 0.055 | Invention |
| 215 | P3-14 | NaOH(5) | (I-1) | 100 | (15) | 100 | A | 0.042 | Invention |
| 216 | P3-15 | NaOH(5) | (I-1) | 100 | (16) | 100 | B | 0.062 | Invention |
| 217 | P3-16 | LiOH(5) | (I-1) | 100 | (17) | 100 | A | 0.077 | Invention |
| 218 | P3-17 | triethyl- | (I-1) | 100 | (II-51) | 100 | A | 0.081 | Invention |
| | | amine (5) | | | | | | | |
| 219 | P3-18 | LiOH(5) | (I-1) | 100 | (24) | 100 | B | 0.062 | Invention |

As is apparent from Table 4, both the image preservability and the coating property were extremely improved by using the specific polymer prepared according to the method of the present invention, as the binder for image-forming layer. In particular, when the phenol-type reducing agent of formula (I) was used in combination with the compound of formula (II), (III), (IV), (V) or (VI), the effect was more increased.

### EXAMPLE 1-4

<Preparation of Binder for Image-Forming Layer>

The binder for image-forming layer was prepared by treating a polymer latex using 25% NH₄OH to adjust the pH to 8.35 and the latex concentration to 44.6 mass %.

The binder for comparative Samples was prepared by treating Compound (RP-6) obtained in Comparative Synthesis Example 1 below similarly using 25% NH₄OH to adjust the pH to 8.35 and the latex concentration to 44.6 mass %.

### COMPARATIVE SYNTHESIS EXAMPLE 1

Synthesis of Compound (RP-6)

RP-6 was prepared thoroughly in the same synthesis formulation and operation procedure as Polymer Latex P4-1 above except that the treatment for forming a passive film was not performed (solid content: 44.9%, particle size: 115 nm, Tg: 19° C.). The iron content was measured by atomic absorption method and found to be 2.5 ppm.

<Preparation of Coating Solution for Image-Forming Layer>

A mixture of 1.1 g of the 20 mass % aqueous dispersion of pigment prepared above, 103 g of the organic acid silver salt dispersion prepared above, 5 g of a 20 mass % aqueous solution of polyinyl alcohol (PVA-205 produced by Kuraray Co., Ltd.), 25 g of the 25 mass % dispersion of reducing agent prepared above, 13.2 g in total of the organic polyhalogen compound dispersions 1, 2 and 3 (2/5/2 by mass), 6.2 g of the 10 mass % dispersion of mercapto compound prepared above, 106 g of the binder for image-forming layer (selected from Compounds (P4-1) to (P4-24) or Comparative Compound (RP-6), latex concentration: 44.6 mass % in each case) and 18 ml of the 5 mass % solution of phthalazine compound prepared above was thoroughly mixed with 10 g of Mixed Silver Halide Emulsion A to prepare a coating solution for image-forming layer (photosensitive layer, emulsion layer). The coating solution was fed to a coating die as it was and coated to give a coating amount of 70 ml/m².

The viscosity of the coating solution for image-forming layer was measured by a B-type viscometer (manufactured by Tokyo Keiki Co., Ltd.) at 40° C. (No. 1 rotor, at 60 rpm) and found to be 85 mPa.s.

The viscosity of the coating solution measured by RFS Fluid Spectrometer (manufactured by Rheometrix Far East Ltd.) at 25° C. were 1,500, 220, 70, 40 and 20 mPa.s at the shearing velocity of 0.1, 1, 10, 100 and 1,000 (1/sec), respectively.

<Preparation of Coating Solution for Intermediate Layer on Emulsion Surface>

To a mixture of 772 g of a 10 mass % aqueous solution of polyinyl alcohol (PVA-205 produced by Kuraray Co., Ltd.), 5.3 g of the 20 mass % dispersion of pigment prepared above, and 226 g of a 27.5 mass % solution of methyl methacrylate/styrene/butyl acrylate/hydroxyethyl methacrylate/acrylic acid copolymer (copolymerization ratio: 64/9/20/5/2 by mass) latex were added 2 ml of a 5 mass % aqueous solution of Aerosol OT (produced by American Cyanamid Co.) and 10.5 ml of a 20 mass % aqueous solution of diammonium phthalate. Thereto, water was added to make a total amount of 880 g, thereby preparing a coating solution for intermediate layer. The coating solution was fed to a coating die to give a coating amount of 10 ml/m².

The viscosity of the coating solution was measured by a B-type viscometer at 40° C. (No. 1 rotor, at 60 rpm) and found to be 21 mPa.s.

<Preparation of Coating Solution for First Protective Layer on Emulsion Surface>

To a solution prepared by dissolving 64 g of inert gelatin in water were added 80 g of a 27.5 mass % solution of methyl methacrylate/styrene/butyl acrylate/hydroxyethyl methacrylate/acrylic acid copolymer (copolymerization ratio: 64/9/20/5/2 by mass) latex, 23 ml of a 10 mass % methanol solution of phthalic acid, 23 ml of a 10 mass % aqueous solution of 4-methylphthalic acid, 28 ml of 0.5 mol/liter sulfuric acid, 5 ml of a 5 mass % aqueous solution of Aerosol OT (produced by American Cyanamid Co.), 0.5 g of phenoxyethanol and 0.1 g of benzisothiazolinone. Thereto, water was added to make a total amount of 750 g, thereby preparing a coating solution for first protective layer. Immediately before coating, 26 ml of 4 mass % chrome alum was mixed with the coating solution using a static mixer and then the coating solution was fed to a coating die to give a coating amount of 18.6 ml/m².

The viscosity of the coating solution was measured by a B-type viscometer at 40° C. (No. 1 rotor, at 60 rpm) and found to be 17 mPa.s.

<Preparation of Coating Solution for Second Protective Layer on Emulsion Surface>

To a solution prepared by dissolving 80 g of inert gelatin in water were added 102 g of a 27.5 mass % solution of methyl methacrylate/styrene/butyl acrylate/hydroxyethyl methacrylate/acrylic acid copolymer (copolymerization ratio: 64/9/20/5/2 by mass) latex, 3.2 ml of a 5 mass % solution of N-perfluorooctylsulfonyl-N-propylalanine potassium salt, 32 ml of a 2 mass % aqueous solution of polyethylene glycol mono(N-perfluorooctylsulfonyl-N-propyl-2-aminoethyl) ether (average polymerization degree of ethylene oxide: 15), 23 ml of a 5 mass % solution of Aerosol OT (produced by American Cyanamid Co.), 4 g of polymethyl methacrylate fine particles (average particle size: 0.7 μm), 21 g of polymethyl methacrylate fine particles (average particle size: 6.4 μm), 1.6 g of 4-methylphthalic acid, 4.8 g of phthalic acid, 44 ml of 0.5 mol/liter sulfuric acid and 10 mg of benzisothiazolinone. Thereto, water was added to make a total amount of 650 g and immediately before coating, 445 ml of an aqueous solution containing 4 mass % of chrome alum and 0.67 mass % of phthalic acid was mixed using a static mixer to prepare the coating solution for surface protective layer. Then, the coating solution was fed to a coating die to give a coating amount of 8.3 ml/m².

The viscosity of the coating solution was measured by a B-type viscometer at 40° C. (No. 1 rotor, at 60 rpm) and found to be 9 mPa.s.

<Manufacture of Heat-Developable Image Recording Material>

In the back surface side of the undercoated support prepared above, the coating solution for anti-halation layer and the coating solution for protective layer on back surface were simultaneously coated one on another such that the coated amount as a solid content of the solid fine particle dye in the anti-halation layer became 0.04 g/m² and the gelatin coated amount in the protective layer on back surface became 1.7 g/m². Then, the solutions were dried to form an anti-halation back layer.

On the undercoat layer provided in the opposite side to the back surface, the coating solutions for image-forming layer (coated amount of silver halide: 0.14 g/m² as silver), intermediate layer, first protective layer and second protective layer were simultaneously coated one on another in this order from the undercoat layer by a slide bead coating method to prepare heat-developable image recording material Sample 101.

The coating was performed at a coating speed of 160 m/min. The distance between the coating die tip and the support was adjusted to from 0.14 to 0.28 mm. The width of coating was controlled to increase 0.5 mm on each side to the discharge slit width for the coating solution. The pressure in a reduced pressure chamber was set lower than the atmospheric pressure by 392 Pa. The support was handled so as to prevent electrification while controlling temperature and humidity and electrically discharged with ionized air immediately before coating. In the subsequent chilling zone, the coating solution was chilled by blowing air of dry bulb temperature of 18° C. and wet bulb temperature of 12° C. for 30 seconds. The image recording material was transported in a helical floating type drying zone while blowing dry air of dry bulb temperature of 30° C. and wet bulb temperature of 18° C. for 200 seconds. Then, the material was passed through a drying zone of 70° C. for 20 seconds and a drying zone of 90° C. for 10 seconds, and thereafter cooled to 25° C., thereby volatilizing the solvent in the coating solution. In the chilling zone and drying zones, the average wind speed blown on the coating solution film surface was 7 m/sec.

The matting degree of the manufactured heat-developable image recording material was, in terms of the Bekk smoothness, 550 seconds in the image-forming layer side and 130 seconds in the back surface side.

Samples 102 to 119 were prepared by appropriately selecting the phenol-base reducing agent (compound of formula (I)), the compound which satisfies at least one of the conditions (A) and (B) (compound used in combination with the compound of formula (I)), the coated amounts thereof (shown relatively by mol % taking the amount of compound as 100), and the binder for image-forming layer as shown in Table 5 below so as to give almost the same development density as that of Sample 101. These samples were evaluated on the image preservability. The results obtained are shown in Table 5 below.

In Table 5 below, the reducing agent is selected from Compounds (I-1) to (I-34) which are specific examples of the compound of formula (I), the compound used in combination with the compound of formula (I) is selected from Compounds (1) to (32) which are specific examples of the compounds of formulae (II) to (V), and Compounds (II-1) to (II-90) which are specific examples of the compound having a phosphoryl group, and the binder for image-forming layer is selected from Compounds (P-1) to (P-24) which are specific examples of the specific polymer, and Compound (RP-6).

In the manufacture of Samples 102 to 119, when a reducing agent (compound of formula (I)) different from that of Sample 101 was used, a 25 mass % dispersion of the reducing agent was prepared in the same manner as in Preparation of 25 mass % Dispersion of Reducing Agent above except for using the reducing agent in place of 1,1-bis(2-hydroxy-3,5-dimethylphenyl)-3,5,5-trimethylhexane (Compound (I-1)).

In the manufacture of Samples 102 to 119, when the compound used in combination with the compound of formula (I) was used, the compound was incorporated as a dispersion into the coating solution for image-forming layer. The amount used was controlled to be equivalent in mol to the reducing agent. The preparation of dispersion of Compound (II-2) is described below and other compounds were also incorporated as a dispersion prepared in the same manner.

<Preparation of Dispersion of Compound (II-2)>

To a mixture of 1 kg of Compound (II-2) and 1 kg of a 20 mass % aqueous solution of modified polyinyl alcohol (Poval MP 203 produced by Kuraray Co., Ltd.) was added 1.6 kg of water. The mixture was thoroughly mixed to make a slurry. The slurry was fed by means of a diaphragm pump into a horizontal type sand mill (UVM-2 manufactured by Imex Inc.) filled with zirconia beads having an average diameter of 0.5 mm, and dispersed for 3 hours and 30 minutes. Thereto, 0.2 g of benzisothiazolinone sodium salt and water were added such that the concentration of the phosphoryl compound became 25 mass %, thereby obtaining a solid fine particle dispersion of phosphoryl compound. The particles of the phosphoryl compound contained in the thus-obtained dispersion had a median particle size of 0.45 μm and a maximum particle size of 2.0 μm or less. This dispersion was filtered with a polypropylene-made filter having a pore size of 10.0 μm to remove foreign matters such as contaminant, and then stored.

In the manufacture of Samples 102 to 119, even when the binder for image-forming layer used was different from that of Sample 101, the binder was prepared in the same manner as in Preparation of Binder for Image-Forming Layer above. In Table 5, the kind of the binder for image-forming layer is shown.

<Evaluation of Image Preservability>

The evaluation of image preservability was performed by preserving each image recording material after heat development, under conditions of 40° C. and 55% RH for one day while irradiating at 8,500 lux from NEOLINE RAPID MASTER FLR40SN-EDL/M manufactured by Toshiba and determining the change in density (ΔDmin) in the white background portion before and after the preservation.

TABLE 5

| | | | | | Compound Combined | | | |
|---|---|---|---|---|---|---|---|---|
| | Binder for Image- | | Reducing Agent | | with | | | |
| | Forming Layer | | (formula (I)) | | Reducing Agent | | | |
| Sample | | Heavy Metal | | Coated Amount | | Coated Amount | Image | |
| No. | Kind | Content (ppm) | Kind | (relative mol %) | Kind | (relative mol %) | Preservability | Remarks |
| 101 | RP-6 | 2.5 | (I-1) | 100 | — | — | 0.105 | Comparison |
| 102 | RP-6 | 2.5 | (I-1) | 100 | (II-2) | 100 | 0.098 | Comparison |
| 103 | P4-1 | 0.06 | (I-1) | 100 | (II-2) | 100 | 0.025 | Invention |
| 104 | P4-1 | 0.06 | (I-1) | 100 | | — | 0.037 | Invention |
| 105 | P4-1 | 0.06 | (I-2) | 80 | (II-2) | 80 | 0.040 | Invention |
| 106 | P4-1 | 0.06 | (I-3) | 50 | (II-2) | 50 | 0.028 | Invention |
| 107 | P4-1 | 0.06 | (I-4) | 65 | (II-2) | 65 | 0.053 | Invention |
| 108 | P4-1 | 0.06 | (I-7) | 90 | (II-2) | 90 | 0.029 | Invention |
| 109 | P4-2 | 0.05 | (I-1) | 100 | (2) | 100 | 0.025 | Invention |
| 110 | P4-3 | 0.04 | (I-1) | 100 | (6) | 100 | 0.029 | Invention |
| 111 | P4-4 | 0.15 | (I-1) | 100 | (8) | 100 | 0.031 | Invention |
| 112 | P4-5 | 0.92 | (I-1) | 100 | (11) | 100 | 0.037 | Invention |
| 113 | P4-7 | 0.55 | (I-1) | 100 | (13) | 100 | 0.027 | Invention |
| 114 | P4-8 | 0.73 | (I-1) | 100 | (15) | 100 | 0.034 | Invention |
| 115 | P4-10 | 0.69 | (I-1) | 100 | (16) | 100 | 0.035 | Invention |
| 116 | P4-12 | 0.49 | (I-1) | 100 | (17) | 100 | 0.037 | Invention |
| 117 | P4-15 | 0.22 | (I-1) | 100 | (II-51) | 100 | 0.031 | Invention |
| 118 | P4-18 | 0.72 | (I-1) | 100 | (II-26) | 100 | 0.039 | Invention |
| 119 | P4-20 | 0.58 | (I-1) | 100 | (23) | 100 | 0.034 | Invention |

As is apparent from Table 5, in Samples 103 to 119, namely, in Examples of the present invention employing a specific synthesis method where the iron content in the binder for image-forming layer is suppressed lower than the value prescribed in the present invention, the image preservability was extremely improved as compared with Comparative Examples 101 and 102 where such synthesis means was not employed.

### EXAMPLE 1-5

<Preparation of Binder for Image-Forming Layer>

The binder for image-forming layer was prepared as follows. Compound (RP-7) obtained in Comparative Synthesis Example 1 shown below was treated by adding 1 mol/liter NaOH and 1 mol/liter NH₄OH such that the ratio of Na⁺ ion/NH₄⁺ ion was 1/2.3 (by mol), and adjusted to a pH of 8.4. At this time, the latex concentration (concentration of polymer contained in latex) was 40 mass %.

### COMPARATIVE SYNTHESIS EXAMPLE 1

Synthesis of Compound (RP-7)

RP-7 was synthesized in accordance with the synthesis formulation of Polymer Latex La-1 described in Example of JP-A-2000-10229.

RP-7:

solid content: 45 wt %, number average particle size: 105 nm, dv/dn=1.162, N_{U80}/Nₐₗₗ=0.22

<Preparation of Coating Solution for Image-Forming Layer>

A mixture of 1.1 g of the 20 mass % aqueous dispersion of pigment prepared above, 103 g of the organic acid silver salt dispersion prepared above, 5 g of a 20 mass % aqueous solution of polyinyl alcohol (PVA-205 produced by Kuraray Co., Ltd.), 25 g of the 25 mass % dispersion of reducing agent prepared above, 13.2 g in total of the organic polyhalogen compound dispersions 1, 2 and 3 (2/5/2 by mass), 6.2 g of the 10 mass % dispersion of mercapto compound prepared above, 106 g of the binder for image-forming layer (Compound (RP-7), latex concentration: 40 mass %) and 18 ml of the 5 mass % solution of phthalazine compound prepared above was thoroughly mixed with 10 g of Mixed Silver Halide Emulsion A to prepare a coating solution for image-forming layer (photosensitive layer, emulsion layer). The coating solution was fed to a coating die as it was and coated to give a coating amount of 70 ml/m².

The viscosity of the coating solution for image-forming layer was measured by a B-type viscometer (manufactured by Tokyo Keiki Co., Ltd.) at 40° C. (No. 1 rotor, at 60 rpm) and found to be 85 mPa.s.

The viscosity of the coating solution measured by RFS Fluid Spectrometer (manufactured by Rheometrix Far East Ltd.) at 25° C. were 1,500, 220, 70, 40 and 20 mPa.s at the shearing velocity of 0.1, 1, 10, 100 and 1,000 (1/sec), respectively.

<Preparation of Coating Solution for Intermediate Layer on Emulsion Surface>

To a mixture of 772 g of a 10 mass % aqueous solution of polyinyl alcohol (PVA-205 produced by Kuraray Co., Ltd.), 5.3 g of the 20 mass % dispersion of pigment prepared above, and 226 g of a 27.5 mass % solution of methyl methacrylate/styrene/butyl acrylate/hydroxyethyl methacrylate/acrylic acid copolymer (copolymerization ratio: 64/9/20/5/2 by mass) latex were added 2 ml of a 5 mass % aqueous solution of Aerosol OT (produced by American Cyanamid Co.) and 10.5 ml of a 20 mass % aqueous solution of diammonium phthalate. Thereto, water was added to make a total amount of 880 g, thereby preparing a coating solution for intermediate layer. The coating solution was fed to a coating die to give a coating amount of 10 ml/m².

The viscosity of the coating solution was measured by a B-type viscometer at 40° C. (No. 1 rotor, at 60 rpm) and found to be 21 mPa.s.

<Preparation of Coating Solution for First Protective Layer on Emulsion Surface>

To a solution prepared by dissolving 64 g of inert gelatin in water were added 80 g of a 27.5 mass % solution of methyl methacrylate/styrene/butyl acrylate/hydroxyethyl methacrylate/acrylic acid copolymer (copolymerization ratio: 64/9/20/5/2 by mass) latex, 23 ml of a 10 mass % methanol solution of phthalic acid, 23 ml of a 10 mass % aqueous solution of 4-methylphthalic acid, 28 ml of 0.5 mol/liter sulfuric acid, 5 ml of a 5 mass % aqueous solution of Aerosol OT (produced by American Cyanamid Co.), 0.5 g of phenoxyethanol and 0.1 g of benzisothiazolinone. Thereto, water was added to make a total amount of 750 g, thereby preparing a coating solution for first protective layer. Immediately before coating, 26 ml of 4 mass % chrome alum was mixed with the coating solution using a static mixer and then the coating solution was fed to a coating die to give a coating amount of 18.6 ml/m².

The viscosity of the coating solution was measured by a B-type viscometer at 40° C. (No. 1 rotor, at 60 rpm) and found to be 17 mPa.s.

<Preparation of Coating Solution for Second Protective Layer on Emulsion Surface>

To a solution prepared by dissolving 80 g of inert gelatin in water were added 102 g of a 27.5 mass % solution of methyl methacrylate/styrene/butyl acrylate/hydroxyethyl methacrylate/acrylic acid copolymer (copolymerization ratio: 64/9/20/5/2 by mass) latex, 3.2 ml of a 5 mass % solution of N-perfluorooctylsulfonyl-N-propylalanine potassium salt, 32 ml of a 2 mass % aqueous solution of polyethylene glycol mono(N-perfluorooctylsulfonyl-N-propyl-2-aminoethyl) ether (average polymerization degree of ethylene oxide: 15), 23 ml of a 5 mass % solution of Aerosol OT (produced by American Cyanamid Co.), 4 g of polymethyl methacrylate fine particles (average particle size: 0.7 μm), 21 g of polymethyl methacrylate fine particles (average particle size: 6.4 μm), 1.6 g of 4-methylphthalic acid, 4.8 g of phthalic acid, 44 ml of 0.5 mol/liter sulfuric acid and 10 mg of benzisothiazolinone. Thereto, water was added to make a total amount of 650 g and immediately before coating, 445 ml of an aqueous solution containing 4 mass % of chrome alum and 0.67 mass % of phthalic acid was mixed using a static mixer to prepare the coating solution for surface protective layer. Then, the coating solution was fed to a coating die to give a coating amount of 8.3 ml/m².

The viscosity of the coating solution was measured by a B-type viscometer at 40° C. (No. 1 rotor, at 60 rpm) and found to be 9 mPa.s.

<Manufacture of Heat-Developable Image Recording Material>

In the back surface side of the undercoated support prepared above, the coating solution for anti-halation layer and the coating solution for protective layer on back surface were simultaneously coated one on another such that the coated amount as a solid content of the solid fine particle dye in the anti-halation layer became 0.04 g/m² and the gelatin coated amount in the protective layer on back surface became 1.7 g/m². Then, the solutions were dried to form an anti-halation back layer.

On the undercoat layer provided in the opposite side to the back surface, the coating solutions for image-forming layer (coated amount of silver halide: 0.14 g/m² as silver), intermediate layer, first protective layer and second protective layer were simultaneously coated one on another in this order from the undercoat layer by a slide bead coating method to prepare heat-developable image recording material Sample 101.

The coating was performed at a coating speed of 160 m/min. The distance between the coating die tip and the support was adjusted to from 0.14 to 0.28 mm. The width of coating was controlled to increase 0.5 mm on each side to the discharge slit width for the coating solution. The pressure in a reduced pressure chamber was set lower than the atmospheric pressure by 392 Pa. The support was handled so as to prevent electrification while controlling temperature and humidity and electrically discharged with ionized air immediately before coating. In the subsequent chilling zone, the coating solution was chilled by blowing air of dry bulb temperature of 18° C. and wet bulb temperature of 12° C. for 30 seconds. The image recording material was transported in a helical floating type drying zone while blowing dry air of dry bulb temperature of 30° C. and wet bulb temperature of 18° C. for 200 seconds. Then, the material was passed through a drying zone of 70° C. for 20 seconds and a drying zone of 90° C. for 10 seconds, and thereafter cooled to 25° C., thereby volatilizing the solvent in the coating solution. In the chilling zone and drying zones, the average wind speed blown on the coating solution film surface was 7 m/sec.

The matting degree of the manufactured heat-developable image recording material was, in terms of the Bekk smoothness, 550 seconds in the image-forming layer side and 130 seconds in the back surface side.

Samples 102 to 120 were prepared by appropriately selecting the phenol-base reducing agent (compound of formula (I)), the compound which satisfies at least one of the conditions (A) and (B) (compound used in combination with the compound of formula (I)), the coated amounts thereof (shown relatively by mol % taking the amount of compound (1-1) of Sample 101 as 100), and the binder for image-forming layer as shown in Table 6 below so as to give almost the same development density as that of Sample 101. These samples were evaluated on the coating property and the image preservability. The results obtained are shown in Table 6 below.

In Table 6 below, the reducing agent is selected from Compounds (I-1) to (I-34) which are specific examples of the compound of formula (I), the compound used in combination with the compound of formula (I) is selected from Compounds (1) to (32) which are specific examples of the compounds of formulae (II) to (V), and Compounds (II-1) to (II-90) which are specific examples of the compound having a phosphoryl group, and the binder for image-forming layer is selected from Compounds (P5-1) to (P5-24) which are specific examples of the specific polymer, and Compound (RP-7).

In the manufacture of Samples 102 to 120, when a reducing agent (compound of formula (I)) different from that of Sample 101 was used, a 25 mass % dispersion of the reducing agent was prepared in the same manner as in Preparation of 25 mass % Dispersion of Reducing Agent above except for using the reducing agent in place of 1,1-bis(2-hydroxy-3,5-dimethylphenyl)-3,5,5-trimethylhexane (Compound (I-1)).

In the manufacture of Samples 102 to 120, when the compound used in combination with the compound of formula (I) was used, the compound was incorporated as a dispersion into the coating solution for image-forming layer. The amount used was controlled to be equivalent in mol to the reducing agent. The preparation of dispersion of Compound (II-2) is described below and other compounds were also incorporated as a dispersion prepared in the same manner.

<Preparation of Dispersion of Compound (II-2)>

To a mixture of 1 kg of Compound (II-2) and 1 kg of a 20 mass % aqueous solution of modified polyinyl alcohol (Poval MP 203 produced by Kuraray Co., Ltd.) was added 1.6 kg of water. The mixture was thoroughly mixed to make a slurry. The slurry was fed by means of a diaphragm pump into a horizontal type sand mill (UVM-2 manufactured by Imex Inc.) filled with zirconia beads having an average diameter of 0.5 mm, and dispersed for 3 hours and 30 minutes. Thereto, 0.2 g of benzisothiazolinone sodium salt and water were added such that the concentration of the phosphoryl compound became 25 mass %, thereby obtaining a solid fine particle dispersion of phosphoryl compound. The particles of the phosphoryl compound contained in the thus-obtained dispersion had a median particle size of 0.45 μm and a maximum particle size of 2.0 μm or less. This dispersion was filtered with a polypropylene-made filter having a pore size of 10.0 μm to remove foreign matters such as contaminant, and then stored.

In the manufacture of Samples 102 to 120, even when the binder for image-forming layer used was different from that of Sample 101, the binder was prepared in the same manner as in Preparation of Binder for Image-Forming Layer above. In Table 6, the latex used as the binder for image-forming layer is shown together.

<Evaluation of Coating Property>

The evaluation of coating property was performed by observing with an eye the surface of each sample after coating and counting the number of streaks or repelling marks per 5 m². The criteria of evaluation are as follows (practically acceptable are A and B):

A: 0

B: 1

C: 2 to 4

D: 5 or more

<Evaluation of Image Preservability>

The evaluation of image preservability was performed by preserving each image recording material after heat development, under conditions of 60° C. and 55% RH for one day and determining the change in density (ΔDmin) in the white background portion before and after the preservation.

TABLE 6

| | Binder for | | | | | | | |
|---|---|---|---|---|---|---|---|---|
| | Image-Forming | Reducing Agent | | Compound Combined | | | | |
| | Layer | (formula (I)) | | with Reducing Agent | | Coated | | |
| Sample | Polymer in | | Coated Amount | | Coated Amount | Surface | Image | |
| No. | Latex | Kind | (relative mol %) | Kind | (relative mol %) | state | Preservability | Remarks |
| 101 | RP-7 | (I-1) | 100 | — | — | C | 0.261 | Comparison |
| 102 | RP-7 | (I-1) | 100 | (II-2) | 100 | D | 0.120 | Comparison |
| 103 | P5-1 | (I-1) | 100 | (II-2) | 100 | A | 0.040 | Invention |
| 104 | P5-1 | (I-1) | 100 | — | — | A | 0.111 | Invention |
| 105 | P5-1 | (I-2) | 80 | (II-2) | 80 | A | 0.050 | Invention |
| 106 | P5-1 | (I-3) | 50 | (II-2) | 50 | A | 0.038 | Invention |
| 107 | P5-1 | (I-4) | 65 | (II-2) | 65 | A | 0.053 | Invention |
| 108 | P5-1 | (I-7) | 90 | (II-2) | 90 | B | 0.069 | Invention |
| 109 | P5-2 | (I-1) | 100 | (2) | 100 | A | 0.060 | Invention |
| 110 | P5-3 | (I-1) | 100 | (6) | 100 | A | 0.048 | Invention |
| 111 | P5-4 | (I-1) | 100 | (8) | 100 | B | 0.041 | Invention |
| 112 | P5-5 | (I-1) | 100 | (11) | 100 | A | 0.040 | Invention |
| 113 | P5-7 | (I-1) | 100 | (13) | 100 | B | 0.073 | Invention |
| 114 | P5-8 | (I-1) | 100 | (15) | 100 | A | 0.080 | Invention |
| 115 | P5-10 | (I-1) | 100 | (16) | 100 | A | 0.083 | Invention |
| 116 | P5-12 | (I-1) | 100 | (17) | 100 | A | 0.077 | Invention |
| 117 | P5-15 | (I-1) | 100 | (II-51) | 100 | B | 0.099 | Invention |
| 118 | P5-18 | (I-1) | 100 | (II-26) | 100 | A | 0.065 | Invention |
| 119 | P5-20 | (I-1) | 100 | (23) | 100 | A | 0.064 | Invention |
| 120 | P5-21 | (I-1) | 100 | (24) | 100 | B | 0.059 | Invention |

As is apparent from Table 6, a heat-developable recording material having good coated surface state and excellent image preservability was obtained by using the specific latex as the binder for image-forming layer.

### EXAMPLE 2

A heat-developable image recording material was obtained according to the same procedures as in Example 1 except that Silver Halide Emulsions 1 to 3, Mixed Silver Halide Emulsion A, the 25 mass % dispersion of reducing agent, the 25 mass % dispersion of organic polyhalogen compound-2, the 30 mass % dispersion of organic polyhalogen compound-3 and the coating solution for image forming layer were changed to those prepared as follows, and a dispersion of phosphoryl compound was used.

<Preparation of Silver Halide Emulsion 1>

To 1,421 ml of distilled water was added 3.1 ml of a 1 mass % aqueous potassium bromide solution. Thereto, 3.5 ml of 0.5 mol/liter sulfuric acid and 31.7 g of phthalated gelatin were added. The solution was maintained at 34° C. while stirring in a stainless steel reaction vessel coated with titanium. Separately, 22.22 g of silver nitrate was diluted with distilled water to 95.4 ml to prepare Solution A, and 15.9 g of potassium bromide was diluted with distilled water to 97.4 ml in volume to prepare Solution B. Solution A and Solution B were entirely added at a constant flow rate over 45 seconds to the above-described solution. Then, 10 ml of a 3.5 mass % aqueous hydrogen peroxide solution was added, and further 10.8 ml of a 10 mass % aqueous benzimidazole solution was added. Separately, 51.86 g of silver nitrate was diluted with distilled water to 317.5 ml to prepare Solution C, and 45.8 g of potassium bromide was diluted with distilled water to 400 ml in volume to prepare Solution D. Solution C was entirely added at a constant flow rate over 20 minutes, and Solution D was added according to a controlled double jet method while keeping the pAg at 8.1. After 10 minutes since the start of addition of Solution C and Solution D, potassium hexachloroiridate(III) was added in an amount to make 1×10⁻⁴ mol per mol of silver. 5 Seconds after the completion of addition of Solution C, an aqueous solution of potassium hexacyanoferrate(II) was added in an amount to make 3×10⁻⁴ mol per mol of silver. The pH was adjusted to 3.8 using 0.5 mol/liter sulfuric acid, and stirring was terminated. The mixture was subjected to precipitation, desalting and water washing and using 1 mol/liter sodium hydroxide, the pH was adjusted to 5.9, thereby preparing a silver halide dispersion having a pAg to 8.0.

To the thus-obtained silver halide dispersion kept at 38° C. with stirring, 5 ml of a 0.34 mass % methanol solution of 1,2-benzisothiazolin-3-one was added. After 40 minutes, a methanol solution of Spectral Sensitizing Dye A which is described later was added in an amount of 1×10⁻³ mol per mol of silver and after 1 minute, the temperature was raised to 47° C. Furthermore, 20 minutes after the temperature elevation, a methanol solution of sodium benzenethiosulfonate was added in an amount of 7.6×10⁻⁵ mol per mol of silver and after 5 minutes, a methanol solution of Tellurium Sensitizer B which is described later was added in an amount of 1.9×10⁻⁴ mol per mol of silver, followed by ripening for 91 minutes. Then, 1.3 ml of a 0.8 mass % methanol solution of N,N′-dihydroxy-N″-diethylmelamine was added and after 4 minutes, a methanol solution of 5-methyl-2-mercaptobenzimidazole and a methanol solution of 1-phenyl-2-heptyl-5-mercapto-1,3,4-triazole were added in an amount of 3.7×10⁻³ mol per mol of silver and in an amount of 4.9×10⁻³ mol per mol of silver, respectively, to prepare Silver Halide Emulsion 1.

The grains in the thus-prepared silver halide emulsion were pure silver bromide grains having an average equivalent spherical diameter of 0.046 μm and a variation coefficient of equivalent spherical diameter of 20%. The grain size and the like were the average of 1,000 grains observed by an electron microscope. The proportion of {100} plane on the grain surface was 80% according to the Kubelka-Munk method.

<Preparation of Silver Halide Emulsion 2>

Silver Halide Emulsion 2 was prepared in the same manner as in Preparation of Silver Halide Emulsion 1 except for changing the solution temperature from 34° C. to 49° C. at the grain formation, changing the addition period of Solution C to 30 minutes and eliminating the addition of potassium hexacyanoferrate(II). The precipitation, desalting and water washing were performed in the same manner as in Preparation of Silver Halide Emulsion 1. Then, the spectral sensitization, chemical sensitization and addition of 5-methyl-2-mercaptobenzimidazole and 1-phenyl-2-heptyl-5-mercapto-1,3,4-triazole were performed in the same manner as in Preparation of Silver Halide Emulsion 1 except for changing the amount added of Spectral Sensitizing Dye A to 7.5×10⁻⁴ mol per mol of silver, the amount added of Tellurium Sensitizer B to 1×10⁻⁴ mol per mol of silver, and the amount added of 1-phenyl-2-heptyl-5-mercapto-1,3,4-triazole to 3.3×10⁻³ mol per mol of silver, thereby preparing Silver Halide Emulsion 2. The emulsion grains in Silver Halide Emulsion 2 were pure silver bromide cubic grains having an average equivalent spherical diameter of 0.080 μm and a variation coefficient of equivalent spherical diameter of 20%.

<Preparation of Silver Halide Emulsion 3>

Silver Halide Emulsion 3 was prepared in the same manner as in Preparation of Silver Halide Emulsion 1 except for changing the solution temperature from 34° C. to 27° C. at the grain formation. The precipitation, desalting and water washing were performed in the same manner as in Preparation of Silver Halide Emulsion 1. Then, Silver Halide Emulsion 3 was obtained in the same manner as in Preparation of Silver Halide Emulsion 1 except for changing the amount added of Spectral Sensitizing Dye A as a solid dispersion (aqueous gelatin solution) to 6×10⁻³ mol per mol of silver and changing the amount added of Tellurium Sensitizer B to 5.2×10⁻⁴ mol per mol of silver. The grains in Silver Halide Emulsion 3 were pure silver bromide cubic grains having an average equivalent spherical diameter of 0.038 μm and a variation coefficient of equivalent spherical diameter of 20%.

<Preparation of Mixed Silver Halide Emulsion A>

To a mixture of 70 mass % of Silver Halide Emulsion 1, 15 mass % of Silver Halide Emulsion 2 and 15 mass % of Silver Halide Emulsion 3 was added a 1 mass % aqueous solution of benzothiazolium iodide in an amount of 7×10⁻³ mol per mol of silver.

<Preparation of 25 mass % Dispersion of Reducing Agent>

To a mixture of 10 kg of 1,1-bis(2-hydroxy-3,5-dimethylphenyl)-3,5,5-trimethylhexane (Compound (I-1)) as the reducing agent and 10 kg of a 20 mass % aqueous solution of modified polyinyl alcohol (Poval MP 203 produced by Kuraray Co., Ltd.) was added 16 kg of water. The resulting mixture was thoroughly mixed to make a slurry. This slurry was fed by means of a diaphragm pump into a horizontal type sand mill (UVM-2 manufactured by Imex Inc.) filled with zirconia beads having an average diameter of 0.5 mm, and dispersed for 3 hours and 30 minutes. Thereto, 0.2 g of benzisothiazolinone sodium salt and water were added such that the concentration of the reducing agent became 25 mass %, thereby preparing a solid fine particle dispersion of reducing agent. The particles of the reducing agent contained in the thus-obtained dispersion had a median particle size of 0.42 μm and a maximum particle size of 2.0 μm. This dispersion of reducing agent was filtered with a polypropylene-made filter having a pore size of 10.0 μm to remove foreign matters such as contaminant, and then stored.

<Preparation of 25 mass % Dispersion of Phosphoryl Compound>

To a mixture of 1 kg of triphenylphosphine oxide as the phosphoryl compound and 1 kg of a 20 mass % aqueous solution of modified polyinyl alcohol (Poval MP 203 produced by Kuraray Co., Ltd.) was added 1.6 kg of water. The resulting mixture was thoroughly mixed to make a slurry. This slurry was fed by means of a diaphragm pump into a horizontal type sand mill (UVM-2 manufactured by Imex Inc.) filled with zirconia beads having an average diameter of 0.5 mm, and dispersed for 3 hours and 30 minutes. Thereto, 0.2 g of benzisothiazolinone sodium salt and water were added such that the concentration of the phosphoryl compound became 25 mass %, thereby preparing a solid fine particle dispersion of phosphoryl compound. The particles of the phosphoryl compound contained in the thus-obtained dispersion had a median particle size of 0.45 μm and a maximum particle size of 2.0 μm or less. This dispersion of phosphoryl compound was filtered with a polypropylene-made filter having a pore size of 10.0 μm to remove foreign matters such as contaminant, and then stored.

<Preparation of 25 mass % Dispersion of Organic Polyhalogen Compound 2>

A dispersion was prepared in the same manner as in Preparation of 20 mass % Dispersion of Organic Polyhalogen Compound 1 except for using 5 kg of tribromomethyl(4-(2,4,6-trimethylphenylsulfonyl)phenyl)sulfone in place of 5 kg of tribromomethylnaphthylsulfone, dispersing the slurry, diluting the dispersion such that the concentration of the organic polyhalogen compound became 25 mass %, and filtering it. The particles of the organic polyhalogen compound contained in the thus-obtained dispersion of organic polyhalogen compound had a median particle size of 0.38 μm and a maximum particle size of 2.0 μm or less. This dispersion of organic polyhalogen compound was filtered with a polypropylene-made filter having a pore size of 3.0 μm to remove foreign matters such as contaminant, and then stored.

<Preparation of 30 mass % Dispersion of Organic Polyhalogen Compound 3>

A dispersion was prepared in the same manner as in Preparation of 20 mass % Dispersion of Organic Polyhalogen Compound 1 except for using 5 kg of tribromomethylphenylsulfone in place of 5 kg of tribromomethylnaphthylsulfone, changing the amount of 20 mass % aqueous solution of modified polyinyl alcohol to 5 kg, dispersing the slurry, diluting the dispersion such that the concentration of the organic polyhalogen compound became 30 mass %, and filtering it. The particles of the organic polyhalogen compound contained in the thus-obtained dispersion of organic polyhalogen compound had a median particle size of 0.41 μm and a maximum particle size of 2.0 μm or less. This dispersion of organic polyhalogen compound was filtered with a polypropylene-made filter having a pore size of 3.0 μm to remove foreign matters such as contaminant, and then stored. During the storage, the dispersion was kept at 10° C. or less until the use.

### EXAMPLE 2-1

<Preparation of Coating Solution for Image-Forming Layer (Photosensitive layer)>

A mixture of 1.1 g of the 20 mass % aqueous dispersion of pigment prepared above, 103 g of the organic acid silver salt dispersion prepared above, 5 g of a 20 mass % aqueous solution of polyinyl alcohol (PVA-205 produced by Kuraray Co., Ltd.), 25 g of the 25 mass % dispersion of reducing agent prepared above, 9.4 g of the 25 mass % dispersion of phosphoryl compound prepared above, 16.3 g in total of the organic polyhalogen compound dispersions 1, 2 and 3 (5/1/3 by mass) prepared above, 6.2 g of the 10 mass % dispersion of mercapto compound prepared above, 106 g of the binder for image-forming layer (Compound (RP-1), latex concentration: 40 mass %) and 18 ml of the 5 mass % solution of phthalazine compound prepared above was thoroughly mixed with 10 g of Mixed Silver Halide Emulsion A to prepare a coating solution for image-forming layer. The coating solution was fed to a coating die as it was and coated to give a coating amount of 70 ml/m².

<Manufacture of Heat-Developable Image Recording Material>

A heat-developable image recording material, Sample 201, was manufactured in the same manner as Sample 101 in Example 1-1 except for using the materials described above.

Samples 202 to 216 and Samples 301 to 312 were manufactured in the same manner as in Example 1-1 by appropriately selecting the phenol-base reducing agent (compound of formula (I)), the compound which satisfies at least one of the conditions (A) and (B) (compound used in combination with the compound of formula (I)), the coating amounts thereof, and the binder for image-forming layer as shown in Tables 7 and 8 below so as to have almost the same development density as that of Sample 201. These samples were evaluated on the working brittleness and the image preservability. The results obtained are shown in Tables 7 and 8 below.

TABLE 7

| | | Reducing Agent | | Compound Combined | | | | |
|---|---|---|---|---|---|---|---|---|
| | Binder for | (formula (I)) | | with Reducing Agent | | | | |
| | Image-Forming | | Coated | | Coated | Working | | |
| Sample | Layer | | Amount | | Amount | Brittle- | Image | |
| No. | Kind | Kind | (relative mol %) | Kind | (relative mol %) | ness | Preservability | Remarks |
| 201 | RP-1 | (I-1) | 100 | — | — | C | 0.280 | Comparison |
| 202 | RP-1 | (I-1) | 100 | (II-2) | 100 | C | 0.130 | Comparison |
| 203 | P1-1 | (I-1) | 100 | (II-2) | 100 | A | 0.063 | Invention |
| 204 | P1-1 | (I-1) | 100 | | — | A | 0.110 | Invention |
| 205 | P1-2 | (I-1) | 80 | (II-2) | 100 | A | 0.069 | Invention |
| 206 | P1-3 | (I-1) | 100 | (II-2) | 50 | B | 0.089 | Invention |
| 207 | P1-4 | (I-1) | 100 | (II-2) | 100 | A | 0.063 | Invention |
| 208 | P1-5 | (I-1) | 100 | (II-2) | 100 | B | 0.075 | Invention |
| 209 | P1-7 | (I-1) | 100 | (II-2) | 100 | B | 0.083 | Invention |
| 210 | P1-8 | (I-1) | 100 | (II-2) | 100 | A | 0.085 | Invention |
| 211 | P1-10 | (I-1) | 100 | (II-2) | 100 | A | 0.062 | Invention |
| 212 | P1-12 | (I-1) | 100 | (II-2) | 100 | A | 0.071 | Invention |
| 213 | P1-15 | (I-1) | 100 | (II-2) | 100 | B | 0.081 | Invention |
| 214 | P1-18 | (I-1) | 100 | (II-2) | 100 | A | 0.083 | Invention |
| 215 | P1-20 | (I-2) | 80 | (II-2) | 80 | A | 0.090 | Invention |
| 216 | P1-21 | (I-3) | 50 | (II-2) | 75 | A | 0.079 | Invention |

TABLE 8

| | | Reducing Agent | | Compound Combined | | | | |
|---|---|---|---|---|---|---|---|---|
| | Binder for | (formula (I)) | | with Reducing Agent | | | | |
| | Image-Forming | | Coated | | Coated | Working | | |
| Sample | Layer | | Amount | | Amount | Brittle- | Image | |
| No. | Kind | Kind | (relative mol %) | Kind | (relative mol %) | ness | Preservability | Remarks |
| 301 | RP-1 | (I-7) | 90 | — | — | C | 0.289 | Comparison |
| 302 | RP-1 | (I-7) | 90 | (II-1) | 100 | C | 0.141 | Comparison |
| 303 | P1-1 | (I-7) | 90 | (II-1) | 100 | A | 0.070 | Invention |
| 304 | P1-1 | (I-7) | 90 | | — | A | 0.120 | Invention |
| 305 | P1-3 | (I-7) | 90 | (II-8) | 100 | B | 0.100 | Invention |
| 306 | P1-4 | (I-7) | 90 | (II-22) | 50 | A | 0.089 | Comparison |
| 307 | RP-1 | (I-9) | 50 | — | 100 | C | 0.298 | Comparison |
| 308 | RP-1 | (I-9) | 60 | (II-1) | 100 | C | 0.168 | Comparison |
| 309 | P1-1 | (I-9) | 60 | (II-1) | 100 | A | 0.074 | Invention |
| 310 | P1-2 | (I-9) | 80 | (II-6) | 100 | A | 0.069 | Invention |
| 311 | P1-3 | (I-9) | 60 | — | — | B | 0.133 | Invention |
| 312 | P1-4 | (I-9) | 60 | (II-22) | 100 | A | 0.072 | Invention |

As is apparent from Tables 7 and 8, the specific polymer as the binder for image-forming layer is effective in the improvement of image preservability and working brittleness.

### EXAMPLE 2-2

<Preparation of Coating Solution for Image-Forming Layer (Photosensitive layer)>

A mixture of 1.1 g of the 20 mass % aqueous dispersion of pigment prepared above, 103 g of the organic acid silver salt dispersion prepared above, 5 g of a 20 mass % aqueous solution of polyinyl alcohol (PVA-205 produced by Kuraray Co., Ltd.), 25 g of the 25 mass % dispersion of reducing agent prepared above, 9.4 g of the 25 mass % dispersion of phosphoryl compound prepared above, 16.3 g in total of the organic polyhalogen compound dispersions 1, 2 and 3 (5/1/3 by mass) prepared above, 6.2 g of the 10 mass % dispersion of mercapto compound prepared above, 106 g of the binder for image-forming layer (Compound (RP-1), latex concentration: 40 mass %) and 18 ml of the 5 mass % solution of phthalazine compound prepared above was thoroughly mixed with 10 g of Mixed Silver Halide Emulsion A to prepare a coating solution for image-forming layer. The coating solution was fed to a coating die as it was and coated to give a coating amount of 70 ml/m².

<Manufacture of Heat-Developable Image Recording Material>

A heat-developable image recording material, Sample 201, was manufactured in the same manner as Sample 101 in Example 1-2 except for using the materials described above.

Samples 202 to 216 and Samples 301 to 312 were manufactured in the same manner as in Example 2-1 by appropriately selecting the phenol-base reducing agent (compound of formula (I)), the compound which satisfies at least one of the conditions (A) and (B) (compound used in combination with the compound of formula (I)), the coating amounts thereof (shown relatively by mol % taking the amount of Compound I-1 as 100), and the binder for image-forming layer as shown in Tables 9 and 10 below so as to have almost the same development density as that of Sample 201. These samples were evaluated on the coating property and the image preservability. The results obtained are shown in Tables 9 and 10 below.

TABLE 9

| | | Reducing Agent | | Compound Combined | | | | |
|---|---|---|---|---|---|---|---|---|
| | Binder for | (formula (I)) | | with Reducing Agent | | | | |
| | Image-Forming | | Coated | | Coated | | | |
| Sample | Layer | | Amount | | Amount | Coating | Image | |
| No. | Kind | Kind | (relative mol %) | Kind | (relative mol %) | Property | Preservability | Remarks |
| 201 | RP-2 | (I-1) | 100 | — | — | D | 0.288 | Comparison |
| 202 | RP-2 | (I-1) | 100 | (II-2) | 100 | D | 0.137 | Comparison |
| 203 | P2-1 | (I-1) | 100 | (II-2) | 100 | A | 0.062 | Invention |
| 204 | P2-1 | (I-1) | 100 | — | — | A | 0.115 | Invention |
| 205 | P2-2 | (I-1) | 100 | (II-2) | 100 | A | 0.071 | Invention |
| 206 | P2-3 | (I-1) | 100 | (II-2) | 50 | B | 0.087 | Invention |
| 207 | P2-4 | (I-1) | 100 | (II-2) | 100 | A | 0.064 | Invention |
| 208 | P2-5 | (I-1) | 100 | (II-2) | 100 | B | 0.077 | Invention |
| 209 | P2-7 | (I-1) | 100 | (II-2) | 100 | B | 0.084 | Invention |
| 210 | P2-8 | (I-1) | 100 | (II-2) | 100 | A | 0.099 | Invention |
| 211 | P2-10 | (I-1) | 100 | (II-2) | 100 | A | 0.064 | Invention |
| 212 | P2-12 | (I-1) | 100 | (II-2) | 100 | A | 0.072 | Invention |
| 213 | P2-15 | (I-1) | 100 | (II-2) | 100 | B | 0.083 | Invention |
| 214 | P2-18 | (I-1) | 100 | (II-2) | 100 | A | 0.084 | Invention |
| 215 | P2-20 | (I-2) | 80 | (II-2) | 80 | A | 0.092 | Invention |
| 216 | RP-3 | (I-3) | 50 | (II-2) | 75 | D | 0.277 | Comparison |

TABLE 10

| | | Reducing Agent | | Compound Combined | | | | |
|---|---|---|---|---|---|---|---|---|
| | Binder for | (formula (I)) | | with Reducing Agent | | | | |
| | Image-Forming | | Coated | | Coated | | | |
| Sample | Layer | | Amount | | Amount | Coating | Image | |
| No. | Kind | Kind | (relative mol %) | Kind | (relative mol %) | Property | Preservability | Remarks |
| 301 | RP-2 | (I-7) | 90 | — | — | D | 0.285 | Comparison |
| 302 | RP-2 | (I-7) | 90 | (II-1) | 100 | D | 0.144 | Comparison |
| 303 | P2-1 | (I-7) | 90 | (II-1) | 100 | A | 0.077 | Invention |
| 304 | P2-1 | (I-7) | 90 | | — | A | 0.115 | Invention |
| 305 | P2-3 | (I-7) | 90 | (II-8) | 50 | B | 0.099 | Invention |
| 306 | P2-4 | (I-7) | 90 | (II-22) | 100 | A | 0.084 | Invention |
| 307 | RP-1 | (I-9) | 60 | — | 100 | D | 0.328 | Comparison |
| 308 | RP-3 | (I-9) | 60 | (II-1) | 150 | D | 0.186 | Comparison |
| 309 | P2-3 | (I-9) | 60 | (II-1) | 100 | A | 0.069 | Comparison |
| 310 | P2-2 | (I-9) | 60 | (II-6) | 100 | A | 0.065 | Invention |
| 311 | P2-3 | (I-9) | 60 | — | — | B | 0.134 | Invention |
| 312 | P2-4 | (I-9) | 60 | (II-22) | 100 | A | 0.071 | Invention |

As is apparent from Tables 9 and 10, the specific polymer as the binder for image-forming layer is effective in the improvement of image preservability and coating property.

### EXAMPLE 2-3

<Preparation of Coating Solution for Image-Forming Layer (Photosensitive layer)>

A mixture of 1.1 g of the 20 mass % aqueous dispersion of pigment prepared above, 103 g of the organic acid silver salt dispersion prepared above, 5 g of a 20 mass % aqueous solution of polyinyl alcohol (PVA-205 produced by Kuraray Co., Ltd.), 25 g of the 25 mass % dispersion of reducing agent prepared above, 9.4 g of the 25 mass % dispersion of phosphoryl compound prepared above, 16.3 g in total of the organic polyhalogen compound dispersions 1, 2 and 3 (5/1/3 by mass) prepared above, 6.2 g of the 10 mass % dispersion of mercapto compound prepared above, 106 g of the binder for image-forming layer (Compound (RP-4), latex concentration: 40 mass %) and 18 ml of the 5 mass % solution of phthalazine compound prepared above was thoroughly mixed with 10 g of Mixed Silver Halide Emulsion A to prepare a coating solution for image-forming layer. The coating solution was fed to a coating die as it was and coated to give a coating amount of 70 ml/m².

<Manufacture of Heat-Developable Image Recording Material>

A heat-developable image recording material, Sample 301, was manufactured in the same manner as Sample 201 in Example 1-3 except for using the materials described above.

Samples 302 to 318 were manufactured in the same manner as in Example 1-3 by appropriately selecting the phenol-base reducing agent (compound of formula (I)), the compound which satisfies at least one of the conditions (A) and (B) (compound used in combination with the compound of formula (I)), the coating amounts thereof, and the binder for image-forming layer as shown in Table 11 below so as to have almost the same development density as that of Sample 201. These samples were evaluated on the coating property and the image preservability in the same manner as in Example 1-3. The results obtained are shown in Table 11 below.

TABLE 11

| | | Basic | | | | | | | |
|---|---|---|---|---|---|---|---|---|---|
| | | Compound | | | | | | | |
| | | (amount | Reducing Agent | | Compound Combined | | | | |
| | Binder for | added: ×10⁻² | (formula (I)) | | with Reducing Agent | | | | |
| | Image-Forming | mmol/g | | Coated | | Coated | | | |
| Sample | Layer | solid | | Amount | | Amount | Coating | Image | |
| No. | Kind | content) | Kind | (relative mol %) | Kind | (relative mol %) | Property | Preservability | Remarks |
| 301 | RP-4 | — | (I-1) | 100 | — | — | C | 0.161 | Comparison |
| 302 | RP-4 | — | (I-1) | 100 | (II-2) | 100 | C | 0.136 | Comparison |
| 303 | RP-5 | | (I-1) | 100 | — | — | C | 0.133 | Comparison |
| 304 | P3-1 | NaOH(5) | (I-1) | 100 | (II-2) | 100 | A | 0.055 | Invention |
| 305 | P3-2 | NaOH(12) | (I-1) | 100 | (II-2) | 100 | A | 0.040 | Invention |
| 306 | P3-3 | NaOH(5) | (I-1) | 100 | (II-2) | 100 | A | 0.062 | Invention |
| 307 | P3-10 | NaOH(5) | (I-1) | 100 | (II-2) | 100 | A | 0.102 | Invention |
| 308 | P3-1 | NaOH(5) | (I-1) | 100 | — | — | A | 0.144 | Invention |
| 309 | P3-1 | NaOH(5) | (I-7) | 90 | (II-1) | 100 | A | 0.047 | Invention |
| 310 | P3-1 | NaOH(5) | (I-7) | 90 | — | — | A | 0.147 | Invention |
| 311 | P3-9 | NaOH(5) | (I-7) | 90 | (II-8) | 100 | A | 0.047 | Invention |
| 312 | P3-10 | NaOH(5) | (I-7) | 90 | (II-22) | 100 | B | 0.069 | Invention |
| 313 | P3-11 | NaOH(5) | (I-7) | 90 | (II-22) | 100 | Z | 0.055 | Invention |
| 314 | P3-14 | NaOH(5) | (I-9) | 60 | (II-1) | 100 | A | 0.042 | Invention |
| 315 | P3-15 | NaOH(5) | (I-9) | 60 | (II-1) | 100 | B | 0.062 | Invention |
| 316 | P3-16 | LiOH(5) | (I-9) | 60 | (II-1) | 100 | A | 0.077 | Invention |
| 317 | P3-17 | triethyl- | (I-9) | 60 | (II-6) | 100 | A | 0.081 | Invention |
| | | amine (5) | | | | | | | |
| 318 | P3-18 | LiOH(5) | (I-9) | 60 | — | — | A | 0.162 | Invention |

As is apparent from Table 11, both the image preservability and the coating property were extremely improved by using the specific polymer latex prepared according to the method of the present invention, as the binder for image-forming layer. In particular, when the phenol-type reducing agent of formula (I) was used in combination with the compound of formula (II), (III), (IV), (V) or (VI), the effect was more increased.

### EXAMPLE 2-4

<Preparation of Coating Solution for Image-Forming Layer (Photosensitive layer)>

A mixture of 1.1 g of the 20 mass % aqueous dispersion of pigment prepared above, 103 g of the organic acid silver salt dispersion prepared above, 5 g of a 20 mass % aqueous solution of polyinyl alcohol (PVA-205 produced by Kuraray Co., Ltd.), 25 g of the 25 mass % dispersion of reducing agent prepared above, 9.4 g of the 25 mass % dispersion of phosphoryl compound prepared above, 16.3 g in total of the organic polyhalogen compound dispersions 1, 2 and 3 (5/1/3 by mass) prepared above, 6.2 g of the 10 mass % dispersion of mercapto compound prepared above, 106 g of the binder for image-forming layer (compound selected from Compounds (P-1) to (P4-24) or Comparative Compound (RP-6), latex concentration: 44.6 mass % in any case) and 18 ml of the 5 mass % solution of phthalazine compound prepared above was thoroughly mixed with 10 g of Mixed Silver Halide Emulsion A to prepare a coating solution for image-forming layer. The coating solution was fed to a coating die as it was and coated to give a coating amount of 70 ml/M².

<Manufacture of Heat-Developable Image Recording Material>

A heat-developable image recording material, Sample 201, was manufactured in the same manner as Sample 101 in Example 1-4 except for using the materials described above.

Samples 202 to 215 and Samples 301 to 312 were manufactured in the same manner as in Example 1-4 by appropriately selecting the phenol-base reducing agent (compound of formula (I)), the compound which satisfies at least one of the conditions (A) and (B) (compound used in combination with the compound of formula (I)), the coating amounts thereof (shown relatively by mol % taking the amount of compound as 100), and the binder for image-forming layer as shown in Tables 12 and 13 below so as to have almost the same development density as that of Sample 201. These samples were evaluated on the image preservability. The results obtained are shown in Tables 12 and 13 below.

TABLE 12

| | Binder for Image- | | Reducing Agent | | Compound Combined with | | | |
|---|---|---|---|---|---|---|---|---|
| | Forming Layer | | (formula (I)) | | Reducing Agent | | | |
| Sample | | Heavy Metal | | Coated Amount | | Coated Amount | Image | |
| No. | Kind | Content (ppm) | Kind | (relative mol %) | Kind | (relative mol %) | Preservability | Remarks |
| 201 | RP-6 | 2.5 | (I-1) | 100 | — | — | 0.111 | Comparison |
| 202 | RP-6 | 2.5 | (I-1) | 100 | (II-2) | 100 | 0.101 | Comparison |
| 203 | P4-1 | 0.06 | (I-1) | 100 | (II-2) | 100 | 0.032 | Invention |
| 204 | P4-1 | 0.06 | (I-1) | 100 | — | — | 0.039 | Invention |
| 205 | P4-2 | 0.05 | (I-1) | 100 | (II-2) | 100 | 0.041 | Invention |
| 206 | P4-3 | 0.06 | (I-1) | 100 | (II-2) | 50 | 0.047 | Invention |
| 207 | P4-4 | 0.04 | (I-1) | 100 | (II-2) | 100 | 0.044 | Invention |
| 208 | P4-5 | 0.15 | (I-1) | 100 | (II-2) | 100 | 0.047 | Invention |
| 209 | P4-7 | 0.92 | (I-1) | 100 | (II-2) | 150 | 0.054 | Invention |
| 210 | P4-8 | 0.55 | (I-1) | 100 | (II-2) | 100 | 0.049 | Invention |
| 211 | P4-10 | 0.73 | (I-1) | 100 | (II-2) | 100 | 0.034 | Invention |
| 212 | P4-12 | 0.69 | (I-1) | 100 | (II-2) | 100 | 0.039 | Invention |
| 213 | P4-15 | 0.49 | (I-1) | 100 | (II-2) | 100 | 0.043 | Invention |
| 214 | P4-18 | 0.22 | (I-1) | 100 | (II-2) | 100 | 0.048 | Invention |
| 215 | P4-20 | 0.58 | (I-2) | 80 | (II-2) | 80 | 0.047 | Invention |

TABLE 13

| | Binder for Image- | | Reducing Agent | | Compound Combined with | | | |
|---|---|---|---|---|---|---|---|---|
| | Forming Layer | | (formula (I)) | | Reducing Agent | | | |
| Sample | | Heavy Metal | | Coated Amount | | Coated Amount | Image | |
| No. | Kind | Content (ppm) | Kind | (relative mol %) | Kind | (relative mol %) | Preservability | Remarks |
| 301 | RP-6 | 2.5 | (I-7) | 90 | — | — | 0.121 | Comparison |
| 302 | RP-6 | 2.5 | (I-7) | 90 | (II-1) | 100 | 0.115 | Comparison |
| 303 | P4-1 | 0.06 | (I-7) | 90 | (II-1) | 100 | 0.051 | Invention |
| 304 | P4-1 | 0.06 | (I-7) | 90 | — | — | 0.059 | Invention |
| 305 | P4-3 | 0.04 | (I-7) | 90 | (II-8) | 50 | 0.043 | Invention |
| 306 | P4-4 | 0.15 | (I-7) | 90 | (II-22) | 100 | 0.047 | Invention |
| 307 | RP-6 | 2.5 | (I-9) | 60 | — | 100 | 0.124 | Comparison |
| 308 | RP-6 | 2.5 | (I-9) | 60 | (II-1) | 150 | 0.119 | Comparison |
| 309 | P4-1 | 0.06 | (I-9) | 60 | (II-1) | 100 | 0.045 | Invention |
| 310 | P4-2 | 0.05 | (I-9) | 60 | (II-6) | 100 | 0.047 | Invention |
| 311 | P4-3 | 0.04 | (I-9) | 60 | — | — | 0.061 | Invention |
| 312 | P4-4 | 0.15 | (I-9) | 60 | (II-22) | 100 | 0.051 | Invention |

As is apparent from Tables 12 and 13, in Examples of the present invention using the specific polymer having a low iron content as the binder for image-forming layer, high image preservability was attained as compared with Comparative Samples 201, 202, 301 and 303, revealing that use of the specific polymer is effective in the improvement of image preservability.

### EXAMPLE 2-5

<Preparation of Coating Solution for Image-Forming Layer (Photosensitive layer)>

A mixture of 1.1 g of the 20 mass % aqueous dispersion of pigment prepared above, 103 g of the organic acid silver salt dispersion prepared above, 5 g of a 20 mass % aqueous solution of polyinyl alcohol (PVA-205 produced by Kuraray Co., Ltd.), 25 g of the 25 mass % dispersion of reducing agent prepared above, 9.4 g of the 25 mass % dispersion of phosphoryl compound prepared above, 16.3 g in total of the organic polyhalogen compound dispersions 1, 2 and 3 (5/1/3 by mass) prepared above, 6.2 g of the 10 mass % dispersion of mercapto compound prepared above, 106 g of the binder for image-forming layer (Compound (RP-7), latex concentration: 40 mass %) and 18 ml of the 5 mass % solution of phthalazine compound prepared above was thoroughly mixed with 10 g of Mixed Silver Halide Emulsion A to prepare a coating solution for image-forming layer. The coating solution was fed to a coating die as it was and coated to give a coating amount of 70 ml/m².

<Manufacture of Heat-Developable Image Recording Material>

A heat-developable image recording material, Sample 201, was manufactured in the same manner as Sample 101 in Example 1-5 except for using the materials described above.

Samples 202 to 216 and Samples 301 to 312 were manufactured in the same manner as in Example 1-5 by appropriately selecting the phenol-base reducing agent (compound of formula (I)), the compound which satisfies at least one of the conditions (A) and (B) (compound used in combination with the compound of formula (I)), the coating amounts thereof (shown relatively by mol % taking the amount of compound (1-1) of Sample 201 as 100), and the binder for image-forming layer as shown in Tables 14 and 15 below so as to have almost the same development density as that of Sample 201. These samples were evaluated on the coated surface state and the image preservability in the same manner as in Example 1-5. The results obtained are shown in Tables 14 and 15 below.

TABLE 14

| | Binder for | | | | | | | |
|---|---|---|---|---|---|---|---|---|
| | Image-Forming | Reducing Agent | | Compound Combined | | | | |
| | Layer | (formula (I)) | | with Reducing Agent | | Coated | | |
| Sample | Polymer in | | Coated Amount | | Coated Amount | Surface | Image | |
| No. | Latex | Kind | (relative mol %) | Kind | (relative mol %) | State | Preservability | Remarks |
| 201 | RP-7 | (I-1) | 100 | — | — | C | 0.280 | Comparison |
| 202 | RP-7 | (I-1) | 100 | (II-2) | 100 | D | 0.130 | Comparison |
| 203 | P5-1 | (I-1) | 100 | (II-2) | 100 | A | 0.063 | Invention |
| 204 | P5-1 | (I-1) | 100 | | — | A | 0.110 | Invention |
| 205 | P5-2 | (I-1) | 100 | (II-2) | 100 | A | 0.069 | Invention |
| 206 | P5-3 | (I-1) | 100 | (II-2) | 50 | B | 0.089 | Invention |
| 207 | P5-4 | (I-1) | 100 | (II-2) | 100 | A | 0.063 | Invention |
| 208 | P5-5 | (I-1) | 100 | (II-2) | 100 | B | 0.075 | Invention |
| 209 | P5-7 | (I-1) | 100 | (II-2) | 150 | B | 0.083 | Invention |
| 210 | P5-8 | (I-1) | 100 | (II-2) | 100 | A | 0.085 | Invention |
| 211 | P5-10 | (I-1) | 100 | (II-2) | 100 | A | 0.062 | Invention |
| 212 | P5-12 | (I-1) | 100 | (II-2) | 100 | A | 0.071 | Invention |
| 213 | P5-15 | (I-1) | 100 | (II-2) | 100 | B | 0.081 | Invention |
| 214 | P5-18 | (I-1) | 100 | (II-2) | 100 | A | 0.083 | Invention |
| 215 | P5-20 | (I-2) | 80 | (II-2) | 80 | A | 0.090 | Invention |
| 216 | P5-21 | (I-3) | 50 | (II-2) | 75 | A | 0.079 | Invention |

TABLE 15

| | Binder for | | | | | | | |
|---|---|---|---|---|---|---|---|---|
| | Image-Forming | Reducing Agent | | Compound Combined | | | | |
| | Layer | (formula (I)) | | with Reducing Agent | | Coated | | |
| Sample | Polymer in | | Coated Amount | | Coated Amount | Surface | Image | |
| No. | Latex | Kind | (relative mol %) | Kind | (relative mol %) | State | Preservability | Remarks |
| 301 | RP-7 | (I-7) | 90 | — | — | C | 0.289 | Comparison |
| 302 | RP-7 | (I-7) | 90 | (II-1) | 100 | C | 0.141 | Comparison |
| 303 | P5-1 | (I-7) | 90 | (II-1) | 100 | A | 0.070 | Invention |
| 304 | P5-1 | (I-7) | 90 | — | — | A | 0.120 | Invention |
| 305 | P5-3 | (I-7) | 90 | (II-8) | 50 | B | 0.100 | Invention |
| 306 | P5-4 | (I-7) | 90 | (II-22) | 100 | A | 0.089 | Invention |
| 307 | RP-7 | (I-9) | 60 | — | 100 | C | 0.298 | Comparison |
| 308 | RP-7 | (I-9) | 60 | (II-1) | 150 | C | 0.166 | Comparison |
| 309 | P5-1 | (I-9) | 60 | (II-1) | 100 | A | 0.074 | Comparison |
| 310 | P5-2 | (I-9) | 60 | (II-6) | 100 | A | 0.069 | Invention |
| 311 | P5-3 | (I-9) | 60 | — | — | B | 0.133 | Invention |
| 312 | P5-4 | (I-9) | 60 | (II-22) | 100 | A | 0.072 | Invention |

As is apparent from Tables 14 and 15, use of the specific latex as the binder for image-forming layer is effective in the improvement of coated surface state and image preservability.

### EXAMPLE 3

The structures of compounds used in Examples 3-1 are shown below.

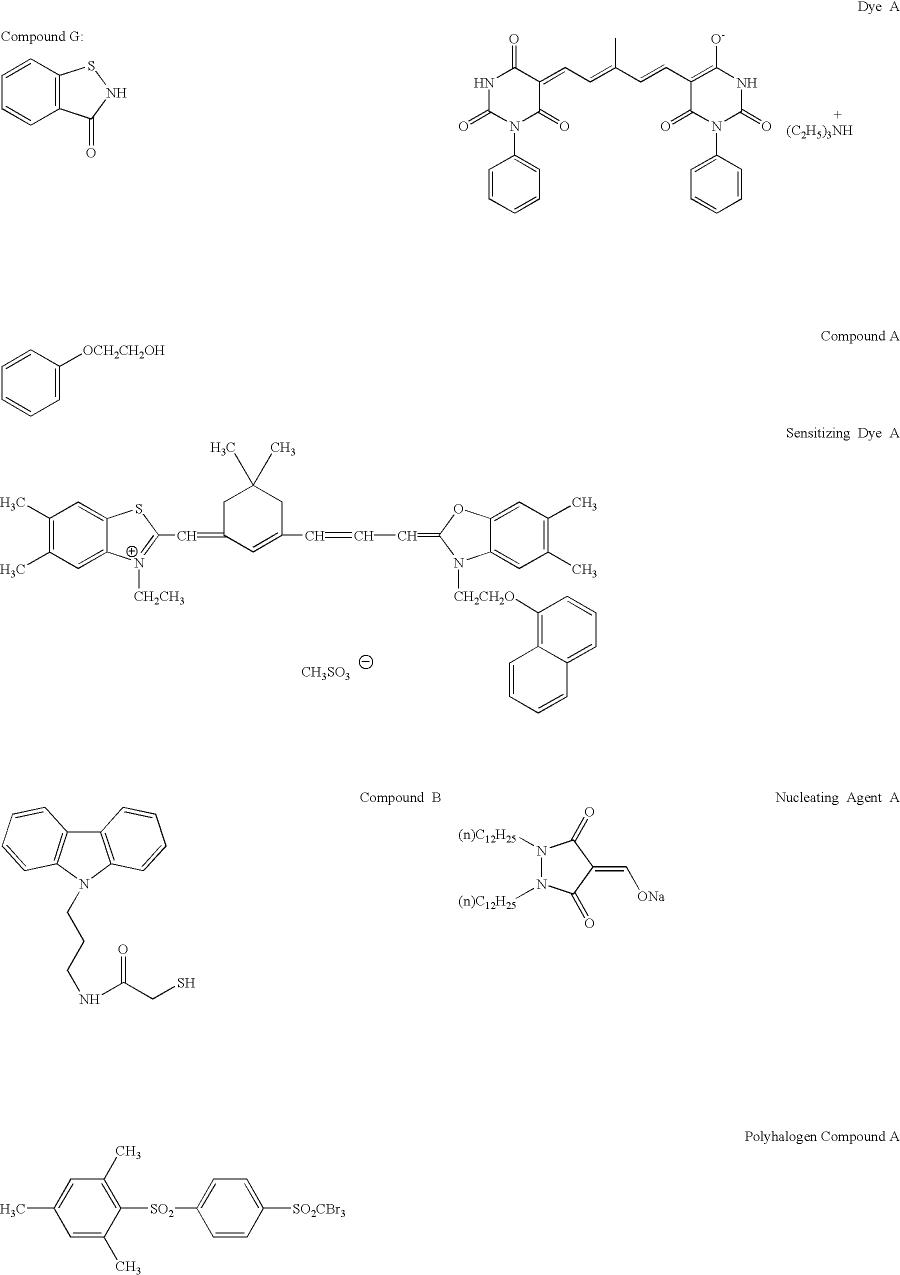

<Preparation of PET Support>

PET having an intrinsic viscosity IV=0.66 (measured in phenol/tetrachloroethane=6/4 (by mass) at 25° C.) was obtained using terephthalic acid and ethylene glycol in a conventional manner. The PET was palletized and the pellets were dried at 130° C. for 4 hours, melted at 300° C., extruded from a T-die, and rapidly quenched to prepare an unstretched film having a thickness of giving a film thickness of 120 μm after heat setting.

The film was stretched to 3.3 times in the longitudinal direction with rollers having different peripheral speeds, and then stretched to 4.5 times in the lateral direction by means of a tenter. The temperatures of the operations were 110° C. and 130° C., respectively. Subsequently, the film was subjected to heat setting at 240° C. for 20 seconds, and then relaxation by 4% in the lateral direction at the same temperature. The film was slit to remove its chucked parts by the tenter, and both sides of the film were subjected to knurl processing. The film was rolled up at 4.8 kg/cm² to obtain a roll of the PET support having a width of 2.4 m, a length of 3,500 m and a thickness of 120 μm.

<Undercoating>

On both surface of the PET support obtained above, the composition for undercoat layer (a) and the composition for undercoat layer (b) shown below were coated in this order and dried at 180° C. for 4 minutes. The thickness of the undercoat layer (a) after drying was 2.0 μm.

(1) Composition for Undercoat Layer (a)

| | |
|---|---|
| Polymer latex (a) as solid content | 3.0 g/m² |
| (core/shell type polymer composed of 90 mass % | |
| of core part and 10 mass % of shell part; | |
| core part: vinylidene chloride/methyl acrylate/methyl | |
| methacrylate/acrylonitrile/acrylic acid = | |
| 93/3/3/0.9/0.1 (mass %); | |
| shell portion: vinylidene chloride/methyl | |
| acrylate/methyl methacrylate/acrylonitrile/acrylic | |
| acid = 88/3/3/3/3 (mass %); | |
| weight average molecular weight: 38,000) | |
| 2,4-Dichloro-6-hydroxy-S-triazine | 23 mg/m² |
| Matting agent (polystyrene; average | 1.5 mg/m² |
| particle size: 2.4 μm) | |

(2) Composition for Undercoat Layer (b)

| | |
|---|---|
| Deionized gelatin (Ca²⁺ content: 0.6 ppm; | 50 mg/m² |
| gelly strength: 230 g) | |

<Formation of Back Layer>

On one surface of the thus-obtained PET support subjected to undercoating of two layers, the composition for electrically conducting layer and the composition for protective layer shown below were coated in this order and dried at 180° C. for 4 minutes to form the back layer.

(1) Composition for Electrically Conducting Layer

| | |
|---|---|
| Jurimer ET-410 (manufactured by Nippon | 96 mg/m² |
| Pure Chemicals Co., Ltd.) | |
| Alkali-treated gelatin (molecular weight: | 42 mg/m² |
| about 10,000; Ca²⁺ content: 30 ppm) | |
| Deionized gelatin (Ca²⁺ content: 0.6 ppm; | 8 mg/m² |
| Compound G | 0.2 mg/m² |
| Polyoxyethylene phenyl ether | 10 mg/m² |
| Sumitex resin M-3 (water-soluble melamine | 18 mg/m² |
| resin produced by Sumitomo Chemical | |
| Co., Ltd.) | |
| Dye A (coating amount for obtaining | |
| optical density of 1.2 at 783 nm) | |
| SnO₂/Sb (9/1 by mass; fine acicular | 160 mg/m² |
| particle; long axis/short axis = 20 to 30; | |
| produced by Ishihara Sangyo Kaisha, Ltd.) | |
| Matting agent (polymethyl methacrylate; | 7 mg/m² |
| average particle size: 5 μm) | |

(2) Composition for Protective Layer

| | |
|---|---|
| Polymer latex (b) as solid content | 1,000 mg/m² |
| (methyl methacrylate/styrene/2-ethylhexyl | |
| acrylate/2-hydroxyethyl methacrylate/acrylic | |
| acid (59/9/26/5/1 by mass) copolymer) | |
| Polystyrenesulfonate | 2.6 mg/m² |
| (molecular weight: 1,000 to 5,000) | |
| Celosol 524 (manufactured by Chukyo Yushi | 25 mg/m² |
| Co., Ltd.) | |
| Sumitex resin M-3 (water-soluble melamine | 218 mg/m² |
| resin produced by Sumitomo Chemical | |
| Co., Ltd.) | |

<Transportation Heat Treatment>

(1) Heat Treatment

The resulting PET support having the undercoat layer and the back layer was heat-treated by transporting it in a heat treatment zone having a total length of 200 m set at 160° C., under a tension of 3 kg/cm² at a transportation speed of 20 m/min.

(2) Post-Heat Treatment

In subsequent to the heat treatment, the PET support was subjected to a post-heat treatment by transporting it in a zone of 40° C. for 15 seconds and rolled up. At this time, the rolling up tension was 10 kg/cm².

<Preparation of Coating Solution for Image Forming Layer>

(1) Preparation of Dispersion of Organic Acid Silver Salt

A mixture of 87.6 g of behenic acid (Edenor C22-85R produced by Henkel Corp.), 423 ml of distilled water, 49.2 ml of an aqueous 5 mol/liter NaOH solution and 120 ml of tert-butyl alcohol was reacted at 75° C. for 1 hour with stirring to prepare a sodium behenate solution. Separately, 206.2 ml of an aqueous solution containing 40.4 g of silver nitrate was prepared and maintained at 10° C. A reaction vessel containing 635 ml of distilled water and 30 ml of tert-butyl alcohol was maintained at 30° C. and thereto, the sodium behenate solution prepared above and the aqueous silver nitrate solution prepared above were added with stirring at a constant flow rate over 62 minutes and 10 seconds and over 60 minutes, respectively. At this time, only the aqueous silver nitrate solution was added for 7 minutes and 20 seconds from the initiation of addition of the aqueous silver nitrate solution, the addition of the sodium behenate solution was started, and only the sodium behenate solution was added for 9 minutes and 30 seconds after the completion of the addition of the aqueous silver nitrate solution. The temperature in the reaction vessel was set to 30° C. and controlled not to elevate the solution temperature. Furthermore, the piping of the addition system of the sodium behenate solution was warmed by a steam trace, and the steam amount was adjusted such that the solution temperature at the outlet of the addition nozzle tip became 75° C. The piping of the addition system of the aqueous silver nitrate solution was also temperature-controlled by circulating cold water in the outer jacket of a double-walled tube. The positions where the sodium behenate solution and the aqueous silver nitrate solution were added were arranged symmetrically in relation to the stirring axle in the center, and the height of positions was adjusted not to come into contact with the reaction solution.

After the completion of addition of the sodium behenate solution, the reaction solution was stirred at the same temperature for 20 minutes and allowed to stand to lower the temperature to 25° C. The solid content was collected by suction filtration and then washed with water until the conductivity of the filtrate reached 30 μS/cm. The solid content obtained was stored as a wet cake without drying.

The shape of the thus-obtained silver behenate particles was evaluated by electron microscopic photography, as a result, the silver behenate particles were scaly crystals having an average projected area diameter of 0.52 μm, an average particle thickness of 0.14 μm, and a variation coefficient of equivalent spherical diameter of 15%.

To the wet cake in an amount corresponding to 100 g of dried solid content were added 7.4 g of polyinyl alcohol (PVA-217, trade name, produced by Kuraray Co., Ltd., average polymerization degree: about 1,700). Thereto, water was added to make a total amount of 385 g and then, the mixture was preliminarily dispersed by a homomixer. The preliminarily dispersed stock solution was processed three times using a dispersing machine (Microfluidizer M-110S-EH, trade name, manufactured by Microfluidex International Corp., using a G01Z interaction chamber) under a pressure adjusted to 1,750 Kg/cm² to prepare a silver behenate dispersion as the dispersion of organic acid silver salt. The cooling operation was performed by using coil type heat exchangers installed before and behind the interaction chamber and by adjusting the temperature of coolant, thereby setting the desired dispersion temperature.

The particles of silver behenate contained in the thus-obtained dispersion of silver behenate had a volume weighted average diameter of 0.52 μm and a variation coefficient of 15%. The measurement of particle size was performed using Master Sizer X (manufactured by Malvern Instruments Ltd.). As a result of electron microscopic evaluation, it was found that the ratio of long side to short side was 1.5, the particle thickness was 0.14 μm, and the average aspect ratio (a ratio of equivalent circular diameter of projected area to particle thickness) was 5.1.

(2) Preparation of Photosensitive Silver Halide Emulsion

In 700 ml of water were dissolved 11 g of alkali-treated gelatin (calcium content: 2,700 ppm or less), 30 mg of potassium bromide and 10- mg of sodium benzenethiosulfonate. After the temperature of the solution was adjusted to 40° C. and the pH thereof was adjusted to 5.0, 159 ml of an aqueous solution containing 18.6 g of silver nitrate and an aqueous solution containing 1 mol/liter of potassium bromide, 5×10⁻⁶ mol/liter of (NH₄)₂RhCl₅(H₂O) and 2×10⁻⁵ mol/liter of K₃IrCl₆ were added according to a controlled double jet method over 6 minutes and 30 seconds while keeping the pAg at 7.7. Subsequently, 476 ml of an aqueous solution containing 55.5 g of silver nitrate and an aqueous solution containing 1 mol/liter of potassium bromide and 2×10⁻⁵ mol/liter of K₃IrCl₆ were added according to a controlled double jet method over 28 minutes and 30 seconds while keeping the pAg at 7.7.

Thereafter, the mixture was subjected to a desalting treatment of decreasing the pH and thereby causing coagulation precipitation and thereto, 0.17 g of Compound A and 51.1 g of low molecular weight gelatin having an average molecular weight or 15,000 (calcium content: 20 ppm or less) were added to adjust the pH and the pAg to 5.9 and 8.0, respectively. The resulting particles were cubic grains having an average grain size of 0.08 μm, a variation coefficient of projected area of 9%, and a {100} plane proportion of 90%.

The temperature of the obtained photosensitive silver halide grains was elevated to 60° C. and thereto, sodium benzenethiosulfonate was added in an amount of 76 μmol per mol of silver. After 3 minutes, 71 μmol of triethyl-thiourea was added and the emulsion was ripened for 100 minutes. Then, 5×10⁻⁴ mol of 4-hydroxy-6-methyl-1,3,3a,7-tetrazaindene was added and the temperature was lowered to 40° C. While maintaining the temperature at 40° C., Sensitizing Dye A and Compound B were added in an amount of 12.8×10⁻⁴ mol per mol of photosensitive silver halide and in an amount of 6.4×10⁻³ mol per mol of photosensitive silver halide, respectively, with stirring and after 20 minutes, the temperature was rapidly lowered to 30° C., thereby preparing a photosensitive silver halide emulsion.

(3) Preparation of Solid Fine Particle Dispersion of Super High Contrast Imparting Agent

To 10 g of a super high contrast imparting agent (Nucleating Agent A) were added 2.5 g of polyinyl alcohol (PVA-217 produced by Kuraray Co., Ltd.) and 87.5 g of water. The resulting mixture was thoroughly stirred to make a slurry and then allowed to stand for 3 hours. This slurry was put into a vessel together with 240 g of zirconia beads of 0.5 mm and dispersed by a dispersing machine (¼ Gallon Sand Grinder Mill manufactured by Imex Inc.) for 10 hours to prepare a solid fine particle dispersion of super high contrast imparting agent. With respect to the particle size, 80 mass % of the particles had a particle size of 0.1 to 1.0 μm, and the average particle size was 0.5 μm.

(4) Preparation of Solid Fine Particle Dispersion of Reducing Agent

To 25 g of 1,1-bis(2-hydroxy-3,5-dimethylphenyl)-3,5,5-trimethylhexane were added 25 g of a 20 mass % aqueous solution of MP polymer (MP-203 produced by Kuraray Co., Ltd.), 0.1 g of Safinol 104E (produced by Nisshin Chemical Industry Co., Ltd.), 2 g of methanol and 48 ml of water. The resulting mixture was thoroughly stirred to make a slurry and then allowed to stand for 3 hours. The slurry was put into a vessel together with 360 g of zirconia beads of 1 mm and dispersed by a dispersing machine (¼ Gallon Sand Grinder Mill manufactured by Imex Inc.) for 3 hours to prepare a solid fine particle dispersion of reducing agent. With respect to the particle size, 80 mass % of the particles had a particle size of 0.3 to 1.0 μm.

(5) Preparation of Solid Fine Particle Dispersion of Polyhalogen Compound

To 30 g of Polyhalogen Compound A were added 4 g of MP polymer (MP-203 produced by Kuraray Co., Ltd.), 0.25 g of Compound C and 66 g of water. The resulting mixture was thoroughly stirred to make a slurry. This slurry was put into a vessel together with 200 g of zirconia silicate beads of 0.5 mm and dispersed by a dispersing machine (1/16 Gallon Sand Grinder Mill manufactured by Imex Inc.) for 5 hours to prepare a solid fine particle dispersion of Polyhalogen Compound A. With respect to the particle size, 80 mass % of the particles had a particle size of 0.3 to 1.0 μm.

A solid fine particle dispersion of Polyhalogen Compound B was also prepared in the same manner as the solid fine particle dispersion of Polyhalogen Compound A. The particle size was the same as that of the dispersion of Polyhalogen Compound A.

(6) Preparation of Solid Fine Particle Dispersion of Zinc Compound

To 30 g of Compound Z were added 3 g of MP polymer (MP-203 produced by Kuraray Co., Ltd.) and 87 ml of water. The resulting mixture was thoroughly stirred to make a slurry and then allowed to stand for 3 hours. Thereafter, a solid fine particle dispersion of zinc compound (Compound Z) was prepared by the same operation as in (4) Preparation of Solid Fine Particle Dispersion of Reducing Agent. With respect to the particle size, 80 mass % of the particles had a particle size of from 0.3 to 1.0 μm.

### EXAMPLE 3-1

Preparation of Coating Solution for Image-Forming Layer

To the dispersion of organic acid silver salt (silver behenate) prepared in (1) above were added the following components in amounts shown below per mol of silver in the dispersion. Thereto, water was added to prepare a coating solution for image-forming layer.

| | | |
|---|---|---|
| Photosensitive silver halide | 0.05 | mol as Ag |
| emulsion prepared in (2) | | |
| above | | |
| Solid fine particle | 17.1 | g as solid content |
| dispersion of nucleating | | |
| agent prepared in (3) above | | |
| Solid fine particle | 166 | g as solid content |
| dispersion of reducing agent | | |
| prepared in (4) above | | |
| Solid fine particle | 0.06 | mol as solid content |
| dispersion of polyhalogen | | |
| compound A prepared in (5) | | |
| above | | |
| Solid fine particle | 0.02 | mol as solid content |
| dispersion of polyhalogen | | |
| compound B prepared in (5) | | |
| above | | |
| Solid fine particle | 10.5 | g as solid content |
| dispersion of zinc compound | | |
| prepared in (6) above | | |
| Binder for image-forming | 470 | g as solid content |
| layer (Compound (RP-1)) | | |
| Sodium ethanethiosulfonate | 2.2 | mmol |
| 5-Methylbenzotriazole | 1.36 | g |
| Polyvinyl alcohol (PVA-235 | 12.1 | g |
| produced by Kuraray Co., | | |
| Ltd.) | | |
| 6-Isopropylphthalazine | 16.5 | g |
| Sodium dihydrogen- | 0.37 | g |
| orthophosphate dihydrate | | |

| | |
|---|---|
| Dye A | coating amount for giving |
| | optical density of 0.3 at |
| | 783 nm (0.50 g as a |
| | standard) |

<Preparation of Coating Solution for Protective Layer on Image Forming Surface>

(1) Preparation of Coating Solution for Protective Layer (a) on Image Forming Surface

To 956 g of a polymer solution of methyl methacrylate/styrene/2-ethylhexyl acrylate/2-hydroxyethyl methacrylate/acrylic acid (58.9/8.6/25.4/5.1/2 (mass %)) having a particle size of 120 nm (a copolymer having a glass transition temperature of 57° C. and a solid concentration of 21.5 mass % and containing Compound D as a film forming aid in an amount of 15 mass % based on the solid content of latex) was added water. Thereto, 1.62 g of Compound E, 3.15 g of Compound S, 1.98 g of a matting agent (polystyrene particles, average particle size: 7 μm, variation coefficient of average particle size: 8%) and 23.6 g of polyinyl alcohol (PVA-235 produced by Kuraray Co., Ltd.) were added and water was again added, thereby preparing a coating solution for protective layer (a) on the image forming surface.

(2) Preparation of Coating Solution for Protective Layer (b) on Image Forming Surface

To 630 g of a polymer solution of methyl methacrylate/styrene/2-ethylhexyl acrylate/2-hydroxyethyl methacrylate/acrylic acid (58.9/8.6/25.4/5.1/2 (mass %)) having a particle size of 70 nm (a copolymer having a glass transition temperature of 54° C. and a solid concentration of 21.5 mass % and containing Compound D shown in (6-1) as a film forming aid in an amount of 15 mass % based on the solid content of latex) was added water. Thereto, 6.30 g of a 30 mass % solution of carnauba wax (Celosol 524 produced by Chukyo Yushi Co., Ltd.) was added. Furthermore, 0.72 g of Compound E shown in (1) above, 7.95 g of Compound F shown above, 0.90 g of Compound S shown above, 1.18 g of a matting agent (polystyrene particles, average particle size: 7 μm) and 8.30 g of polyinyl alcohol (PVA-235 produced by Kuraray Co., Ltd.) were added thereto and water was again added, thereby preparing a coating solution for protective layer (b) on image forming surface.

<Manufacture of Heat-Developable Image Recording Material>

On the surface opposite the back layer, namely, on the undercoat layer (a) and the undercoat layer (b), of the PET support which was subjected to the transportation heat treatment, the coating solution for image-forming layer and the coating solution for protective layer (a) on image forming surface were simultaneously coated one on another in this order from the undercoat layer such that the coated silver amount became 1.6 g/m² and the coated amount as a solid content of the polymer became 1.31 g/m², respectively. Then, the coating solution for protective layer (b) on image forming surface was coated thereon such that the coated amount as a solid content of the polymer became 3.02 g/m², thereby manufacturing Sample 401. In the image forming side of Sample 401, the pH on the film surface was 4.9 and the Bekk smoothness was 660 seconds, and in the opposite side, the pH on the film surface was 5.9 and the Bekk smoothness was 560 seconds.

Samples 402 to 408 were manufactured in the same manner as in Example 1-1 except for changing the binder for image-forming layer of Sample 401 as shown in Table 16 below. These Samples were evaluated on the working brittleness and the image preservability. The results obtained are shown in Table 16 below.

The image preservability was evaluated after the heat-developable image recording material was exposed/developed ((1) exposure processing and (2) heat development processing) as follows.

(1) Exposure Processing

The heat-developable image recording material was exposed for 2×10⁻⁸ seconds using a laser exposure device of single channel cylindrical inner plane type equipped with a semiconductor laser having a beam diameter (FWHM of ½ beam intensity) of 12.56 μm, a laser output of 50 mW and an output wavelength of 783 nm, while controlling the exposure time by changing the rotation number of mirror and controlling the exposure amount by varying the output value. The overlap coefficient was 0.449.

(2) Heat Development Processing

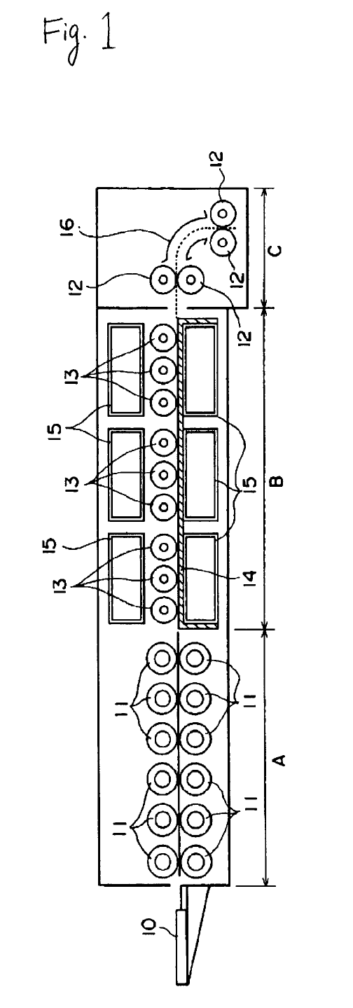

The exposed heat-developable image recording material obtained in (1) above was subjected to heat development processing using a heat developing machine shown in FIG. 1. The heat developing machine shown in FIG. 1 comprises a pre-heating part A, a heat development processing part B and a slow cooling part C. The pre-heating part A is equipped with pre-heating means (not shown) and a plurality of paired carrying-in rollers 11 for holding a heat-developable image recording material 10 therebetween and conveying it into the heat development processing part B. The heat development processing part B is equipped with a smooth surface 14 and rollers 13 for holding the heat-developable image recording material 10 therebetween and transporting it, and heaters 15 for heating the heat-developable image recording material 10. The slow cooling part C is equipped with paired carrying-out rollers 12 for holding the heat-developable image recording material 10 therebetween and conveying it out from the heat development processing part B, and a guide plate 16 for changing the carrying-out direction of the heat-developable image recording material 10 between the carrying-out rollers 12. In the heat developing machine shown in FIG. 1, the heat-developable image recording material 10 is passed through the pre-heating part A, the heat development processing part B and the slow cooling part C in order and subjected to pre-heating, heat development processing and slow cooling (air cooling) successively, thereby performing the heat development processing. In the heat development processing part B, silicone rubber was used as the construction material for the surface of rollers 13 and Teflon nonwoven fabric was used for the smooth surface 14. The transportation (i.e., carrying in and carrying out) was performed at a line speed of 20 mm/sec and the heat development was performed at 90 to 110° C. for 15 seconds in the pre-heating part A (the driving systems of the pre-heating part and the heat development processing part were independently operated and the difference in the speed from the heat development processing part B was set to a range from −0.5% to −1%), at 120° C. for 20 seconds in the heat development processing part B, and for 15 seconds (air cooling) in the slow cooling part C. The temperature accuracy on the transverse direction was ±1° C.

TABLE 16

| | Binder for | | | |
|---|---|---|---|---|
| | Image-Forming | | | |
| | Layer | Working | Image | |
| Sample No. | Kind | Brittleness | Preservability | Remarks |
| 401 | RP-1 | C | 0.129 | Comparison |
| 402 | P1-1 | A | 0.050 | Invention |
| 403 | P1-2 | A | 0.063 | Invention |
| 404 | P1-3 | B | 0.059 | Invention |
| 405 | P1-4 | A | 0.071 | Invention |
| 406 | P1-8 | A | 0.078 | Invention |
| 407 | P1-10 | A | 0.083 | Invention |

As is apparent from Table 16, similarly to Example 1-1 (construction of the present invention), the super high contrast heat-developable image recording material using the specific polymer as the binder for image-forming layer can have improved working brittleness and excellent image preservability as compared with Comparative Example.

According to the first embodiment of the present invention, a heat-developable image recording material having both excellent image preservability and improved working brittleness can be provided.

### EXAMPLE 3-2

Preparation of Coating Solution for Image-Forming Layer

To the dispersion of organic acid silver salt (silver behenate) prepared in (1) above were added the following components in amounts shown below per mol of silver in the dispersion. Thereto, water was added to prepare a coating solution for image-forming layer.

| | | |
|---|---|---|
| Photosensitive silver halide | 0.05 | mol as Ag |
| emulsion prepared in (2) | | |
| above | | |
| Solid fine particle | 17.1 | g as solid content |
| dispersion of nucleating | | |
| agent prepared in (3) above | | |
| Solid fine particle | 166 | g as solid content |
| dispersion of reducing agent | | |
| prepared in (4) above | | |
| Solid fine particle | 0.06 | mol as solid content |
| dispersion of polyhalogen | | |
| compound A prepared in (5) | | |
| above | | |
| Solid fine particle | 0.02 | mol as solid content |
| dispersion of polyhalogen | | |
| compound B prepared in (5) | | |
| above | | |
| Solid fine particle | 10.5 | g as solid content |
| dispersion of zinc compound | | |
| prepared in (6) above | | |
| Binder for image-forming | 470 | g as solid content |
| layer (Compound (RP-2)) | | |
| Sodium ethanethiosulfonate | 2.2 | mmol |
| 5-Methylbenzotriazole | 1.36 | g |
| Polyvinyl alcohol (PVA-235 | 12.1 | g |
| produced by Kuraray Co., | | |
| Ltd.) | | |
| 6-Isopropylphthalazine | 16.5 | g |
| Sodium dihydrogen- | 0.37 | g |
| orthophosphate dihydrate | | |

| | |
|---|---|
| Dye A | coating amount for giving |
| | optical density of 0.3 at |
| | 783 nm (0.50 g as a |
| | standard) |

<Preparation of Coating Solution for Protective Layer on Image Forming Surface>

(1) Preparation of Coating Solution for Protective layer (a) on Image Forming Surface

To 956 g of a polymer solution of methyl methacrylate/styrene/2-ethylhexyl acrylate/2-hydroxyethyl methacrylate/acrylic acid (58.9/8.6/25.4/5.1/2 (mass %)) having a particle size of 120 nm (a copolymer having a glass transition temperature of 57° C. and a solid concentration of 21.5 mass % and containing Compound D as a film forming aid in an amount of 15 mass % based on the solid content of latex) was added water. Thereto, 1.62 g of Compound E, 3.15 g of Compound S, 1.98 g of a matting agent (polystyrene particles, average particle size: 7 μm, variation coefficient of average particle size: 8%) and 23.6 g of polyinyl alcohol (PVA-235 produced by Kuraray Co., Ltd.) were added and water was again added, thereby preparing a coating solution for protective layer (a) on the image forming surface.

(2) Preparation of Coating Solution for Protective Layer (b) on Image Forming Surface

To 630 g of a polymer solution of methyl methacrylate/styrene/2-ethylhexyl acrylate/2-hydroxyethyl methacrylate/acrylic acid (58.9/8.6/25.4/5.1/2 (mass %)) having a particle size of 70 nm (a copolymer having a glass transition temperature of 54° C. and a solid concentration of 21.5 mass % and containing Compound D shown in (6-1) as a film forming aid in an amount of 15 mass % based on the solid content of latex) was added water. Thereto, 6.30 g of a 30 mass % solution of carnauba wax (Celosol 524 produced by Chukyo Yushi Co., Ltd.) was added. Furthermore, 0.72 g of Compound E shown in (1) above, 7.95 g of Compound F shown above, 0.90 g of Compound S shown above, 1.18 g of a matting agent (polystyrene particles, average particle size: 7 μm) and 8.30 g of polyinyl alcohol (PVA-235 produced by Kuraray Co., Ltd.) were added thereto and water was again added, thereby preparing a coating solution for protective layer (b) on image forming surface.

<Manufacture of Heat-Developable Image Recording Material>

On the surface opposite the back layer, namely, on the undercoat layer (a) and the undercoat layer (b), of the PET support which was subjected to the transportation heat treatment, the coating solution for image-forming layer and the coating solution for protective layer (a) on image forming surface were simultaneously coated one on another in this order from the undercoat layer such that the coated silver amount became 1.6 g/m² and the coated amount as a solid content of the polymer became 1.31 g/m², respectively. Then, the coating solution for protective layer (b) on image forming surface was coated thereon such that the coated amount as a solid content of the polymer became 3.02 g/m², thereby manufacturing Sample 401. In the image forming side of Sample 401, the pH on the film surface was 4.9 and the Bekk smoothness was 660 seconds, and in the opposite side, the pH on the film surface was 5.9 and the Bekk smoothness was 560 seconds.

Samples 402 to 408 were manufactured in the same manner as in Example 1-2 except for changing the binder for image-forming layer of Sample 401 as shown in Table 17 below. These Samples were evaluated on the coating property and the image preservability. The results obtained are shown in Table 17 below.

The image preservability was evaluated after the heat-developable image recording material was exposed/developed ((1) exposure processing and (2) heat development processing) as follows.

(1) Exposure Processing

The heat-developable image recording material was exposed for 2×10⁻⁸ seconds using a laser exposure device of single channel cylindrical inner plane type equipped with a semiconductor laser having a beam diameter (FWHM of ½ beam intensity) of 12.56 μm, a laser output of 50 mW and an output wavelength of 783 nm, while controlling the exposure time by changing the rotation number of mirror and controlling the exposure amount by varying the output value. The overlap coefficient was 0.449.

(2) Heat Development Processing

The exposed heat-developable image recording material obtained in (1) above was subjected to heat development processing using a heat developing machine shown in FIG. 1. The heat developing machine shown in FIG. 1 comprises a pre-heating part A, a heat development processing part B and a slow cooling part C. The pre-heating part A is equipped with pre-heating means (not shown) and a plurality of paired carrying-in rollers 11 for holding a heat-developable image recording material 10 therebetween and conveying it into the heat development processing part B. The heat development processing part B is equipped with a smooth surface 14 and rollers 13 for holding the heat-developable image recording material 10 therebetween and transporting it, and heaters 15 for heating the heat-developable image recording material 10. The slow cooling part C is equipped with paired carrying-out rollers 12 for holding the heat-developable image recording material 10 therebetween and conveying it out from the heat development processing part B, and a guide plate 16 for changing the carrying-out direction of the heat-developable image recording material 10 between the carrying-out rollers 12.

In the heat developing machine shown in FIG. 1, the heat-developable image recording material 10 is passed through the pre-heating part A, the heat development processing part B and the slow cooling part C in order and subjected to pre-heating, heat development processing and slow cooling (air cooling) successively, thereby performing the heat development processing. In the heat development processing part B, silicone rubber was used as the construction material for the surface of rollers 13 and Teflon nonwoven fabric was used for the smooth surface 14. The transportation (i.e., carrying in and carrying out) was performed at a line speed of 20 mm/sec and the heat development was performed at 90 to 110° C. for 15 seconds in the pre-heating part A (the driving systems of the pre-heating part and the heat development processing part were independently operated and the difference in the speed from the heat development processing part B was set to a range from −0.5% to −1%), at 120° C. for 20 seconds in the heat development processing part B, and for 15 seconds (air cooling) in the slow cooling part C. The temperature accuracy on the transverse direction was ±1° C.

TABLE 17

| | Binder for | | | |
|---|---|---|---|---|
| | Image-Forming | | | |
| | Layer | Coating | Image | |
| Sample No. | Kind | Property | Preservability | Remarks |
| 401 | RP-2 | D | 0.099 | Comparison |
| 402 | P2-1 | A | 0.051 | Invention |
| 403 | P2-2 | A | 0.060 | Invention |
| 404 | P2-3 | B | 0.055 | Invention |
| 405 | P2-4 | A | 0.070 | Invention |
| 406 | P2-8 | A | 0.069 | Invention |
| 407 | RP-3 | D | 0.144 | Comparison |

As is apparent from Table 17, similarly to Example 1-2 (construction of the present invention), the super high contrast heat-developable image recording material using the specific polymer as the binder for image-forming layer can have excellent coating property and excellent image preservability as compared with Comparative Examples.

According to the second embodiment of the present invention, a heat-developable image recording material excellent in both image preservability and coating property can be provided.

### EXAMPLE 3-3

Preparation of Coating Solution for Image-Forming Layer

To the dispersion of organic acid silver salt (silver behenate) prepared in (1) above were added the following components in amounts shown below per mol of silver in the dispersion. Thereto, water was added to prepare a coating solution for image-forming layer.

| | | |
|---|---|---|
| Photosensitive silver halide | 0.05 | mol as Ag |
| emulsion prepared in (2) | | |
| above | | |
| Solid fine particle | 17.1 | g as solid content |
| dispersion of nucleating | | |
| agent prepared in (3) above | | |
| Solid fine particle | 166 | g as solid content |
| dispersion of reducing agent | | |
| prepared in (4) above | | |
| Solid fine particle | 0.06 | mol as solid content |
| dispersion of polyhalogen | | |
| compound A prepared in (5) | | |
| above | | |
| Solid fine particle | 0.02 | mol as solid content |
| dispersion of polyhalogen | | |
| compound B prepared in (5) | | |
| above | | |
| Solid fine particle | 10.5 | g as solid content |
| dispersion of zinc compound | | |
| prepared in (6) above | | |
| Binder for image-forming | 470 | g as solid content |
| layer (Compound (RP-4)) | | |
| Sodium ethanethiosulfonate | 2.2 | mmol |
| 5-Methylbenzotriazole | 1.36 | g |
| Polyvinyl alcohol (PVA-235 | 12.1 | g |
| produced by Kuraray Co., | | |
| Ltd.) | | |
| 6-Isopropylphthalazine | 16.5 | g |
| Sodium dihydrogen- | 0.37 | g |
| orthophosphate dihydrate | | |

| | |
|---|---|
| Dye A | coating amount for giving |
| | optical density of 0.3 at |
| | 783 nm (0.50 g as a |
| | standard) |

<Preparation of Coating Solution for Protective Layer on Image Forming Surface>

(1) Preparation of Coating Solution for Protective Layer (a) on Image Forming Surface

To 956 g of a polymer solution of methyl methacrylate/styrene/2-ethylhexyl acrylate/2-hydroxyethyl methacrylate/acrylic acid (58.9/8.6/25.4/5.1/2 (mass %)) having a particle size of 120 nm (a copolymer having a glass transition temperature of 57° C. and a solid concentration of 21.5 mass % and containing Compound D as a film forming aid in an amount of 15 mass % based on the solid content of latex) was added water. Thereto, 1.62 g of Compound E, 3.15 g of Compound S, 1.98 g of a matting agent (polystyrene particles, average particle size: 7 μm, variation coefficient of average particle size: 8%) and 23.6 g of polyinyl alcohol (PVA-235 produced by Kuraray Co., Ltd.) were added and water was again added, thereby preparing a coating solution for protective layer (a) on the image forming surface.

(2) Preparation of Coating Solution for Protective layer (b) on Image Forming Surface

To 630 g of a polymer solution of methyl methacrylate/styrene/2-ethylhexyl acrylate/2-hydroxyethyl methacrylate/acrylic acid (58.9/8.6/25.4/5.1/2 (mass %)) having a particle size of 70 nm (a copolymer having a glass transition temperature of 54° C. and a solid concentration of 21.5 mass % and containing Compound D shown in (6-1) as a film forming aid in an amount of 15 mass % based on the solid content of latex) was added water. Thereto, 6.30 g of a 30 mass % solution of carnauba wax (Celosol 524 produced by Chukyo Yushi Co., Ltd.) was added. Furthermore, 0.72 g of Compound E shown in (1) above, 7.95 g of Compound F shown above, 0.90 g of Compound S shown above, 1.18 g of a matting agent (polystyrene particles, average particle size: 7 μm) and 8.30 g of polyinyl alcohol (PVA-235 produced by Kuraray Co., Ltd.) were added thereto and water was again added, thereby preparing a coating solution for protective layer (b) on image forming surface.

<Manufacture of Heat-Developable Image Recording Material>

On the surface opposite the back layer, namely, on the undercoat layer (a) and the undercoat layer (b), of the PET support which was subjected to the transportation heat treatment, the coating solution for image-forming layer and the coating solution for protective layer (a) on image forming surface were simultaneously coated one on another in this order from the undercoat layer such that the coated silver amount became 1.6 g/m² and the coated amount as a solid content of the polymer became 1.31 g/m², respectively. Then, the coating solution for protective layer (b) on image forming surface was coated thereon such that the coated amount as a solid content of the polymer became 3.02 g/m², thereby manufacturing Sample 401. In the image forming side of Sample 401, the pH on the film surface was 4.9 and the Bekk smoothness was 660 seconds, and in the opposite side, the pH on the film surface was 5.9 and the Bekk smoothness was 560 seconds.

Samples 402 to 408 were manufactured in the same manner as in Example 1-3 except for changing the binder for image-forming layer of Sample 401 as shown in Table 18 below. These Samples were evaluated on the coating property and the image preservability. The results obtained are shown in Table 18 below.

The image preservability was evaluated after the heat-developable image recording material was exposed/developed ((1) exposure processing and (2) heat development processing) as follows.

(1) Exposure Processing

The heat-developable image recording material was exposed for 2×10⁻⁸ seconds (irradiation energy: 4×10⁻¹⁰ J) using a laser exposure device of single channel cylindrical inner plane type equipped with a semiconductor laser having a beam diameter (FWHM of ½ beam intensity) of 12.56 μm, a laser output of 50 mW and an output wavelength of 783 nm, while controlling the exposure time by changing the rotation number of mirror and controlling the exposure amount by varying the output value. The overlap coefficient was 0.449.

(2) Heat Development Processing

The exposed heat-developable image recording material obtained in (1) above was subjected to heat development processing using a heat developing machine shown in FIG. 1. The heat developing machine shown in FIG. 1 comprises a pre-heating part A, a heat development processing part B and a slow cooling part C. The pre-heating part A is equipped with pre-heating means (not shown) and a plurality of paired carrying-in rollers 11 for holding a heat-developable image recording material 10 therebetween and conveying it into the heat development processing part B. The heat development processing part B is equipped with a smooth surface 14 and rollers 13 for holding the heat-developable image recording material 10 therebetween and transporting it, and heaters 15 for heating the heat-developable image recording material 10. The slow cooling part C is equipped with paired carrying-out rollers 12 for holding the heat-developable image recording material 10 therebetween and conveying it out from the heat development processing part B, and a guide plate 16 for changing the carrying-out direction of the heat-developable image recording material 10 between the carrying-out rollers 12. In the heat developing machine shown in FIG. 1, the heat-developable image recording material 10 is passed through the pre-heating part A, the heat development processing part B and the slow cooling part C in order and subjected to pre-heating, heat development processing and slow cooling (air cooling) successively, thereby performing the heat development processing. In the heat development processing part B, silicone rubber was used as the construction material for the surface of rollers 13 and Teflon^{R} nonwoven fabric was used for the smooth surface 14. The transportation (i.e., carrying in and carrying out) was performed at a line speed of 20 mm/sec and the heat development was performed at 90 to 110° C. for 15 seconds in the pre-heating part A (the driving systems of the pre-heating part and the heat development processing part were independently operated and the difference in the speed from the heat development processing part B was set to a range from −0.5% to −1%), at 120° C. for 20 seconds in the heat development processing part B, and for 15 seconds (air cooling) in the slow cooling part C. The temperature accuracy on the transverse direction was ±1° C.

TABLE 18

| | Binder for Image- | Basic Compound | | | |
|---|---|---|---|---|---|
| Sample | Forming Layer | (amount added: 10⁻² | Coating | Image | |
| No. | Kind | mmol/g solid content | Property | Preservability | Remarks |
| 401 | RP-4 | — | C | 0.109 | Comparison |
| 402 | RP-4 | — | C | 0.110 | Comparison |
| 403 | P3-1 | NaOH(5) | A | 0.050 | Invention |
| 404 | P3-2 | NaOH(12) | A | 0.050 | Invention |
| 405 | P3-3 | NaOH(5) | A | 0.053 | Invention |
| 406 | P3-5 | NaOH(5) | A | 0.051 | Invention |
| 407 | P3-6 | NaOH(3.6) | A | 0.063 | Invention |
| 408 | P3-8 | NaOH(3.6) | B | 0.059 | Invention |
| 409 | P3-9 | NaOH(5) | A | 0.071 | Invention |
| 410 | P3-11 | NaOH(5) | A | 0.078 | Invention |
| 411 | P3-18 | LiOH(5) | A | 0.060 | Invention |

As is apparent from Table 18, similarly to the heat-developable image recording material of the present invention in Example 2, the super high contrast heat-developable image recording material using the specific polymer latex as the binder for image-forming layer can have excellent coating property and excellent image preservability as compared with Comparative Examples.

According to the third embodiment of the present invention, a polymer latex having excellent suitability for polymerization and good dispersibility and free of precipitation can be produced and by using the polymer latex, a heat-developable image recording material excellent in both image preservability and coating property can be provided.

### EXAMPLE 3-4

Preparation of Coating Solution for Image-Forming Layer

To the dispersion of organic acid silver salt (silver behenate) prepared in (1) above were added the following components in amounts shown below per mol of silver in the dispersion. Thereto, water was added to prepare a coating solution for image-forming layer.

| | | |
|---|---|---|
| Photosensitive silver halide | 0.05 | mol as Ag |
| emulsion prepared in (2) | | |
| above | | |
| Solid fine particle | 17.1 | g as solid content |
| dispersion of nucleating | | |
| agent prepared in (3) above | | |
| Solid fine particle | 166 | g as solid content |
| dispersion of reducing agent | | |
| prepared in (4) above | | |
| Solid fine particle | 0.06 | mol as solid content |
| dispersion of polyhalogen | | |
| compound A prepared in (5) | | |
| above | | |
| Solid fine particle | 0.02 | mol as solid content |
| dispersion of polyhalogen | | |
| compound B prepared in (5) | | |
| above | | |
| Solid fine particle | 10.5 | g as solid content |
| dispersion of zinc compound | | |
| prepared in (6) above | | |
| Binder for image-forming | 470 | g as solid content |
| layer (Compound (RP-6)) | | |
| Sodium ethanethiosulfonate | 2.2 | mmol |
| 5-Methylbenzotriazole | 1.36 | g |
| Polyvinyl alcohol (PVA-235 | 12.1 | g |
| produced by Kuraray Co., | | |
| Ltd.) | | |
| 6-Isopropylphthalazine | 16.5 | g |
| Sodium dihydrogen- | 0.37 | g |
| orthophosphate dihydrate | | |

| | |
|---|---|
| Dye A | coating amount for giving |
| | optical density of 0.3 at |
| | 783 nm (0.50 g as a |
| | standard) |

<Preparation of Coating Solution for Protective Layer on Image Forming Surface>

(1) Preparation of Coating Solution for Protective layer (a) on Image Forming Surface

To 956 g of a polymer solution of methyl methacrylate/styrene/2-ethylhexyl acrylate/2-hydroxyethyl methacrylate/acrylic acid (58.9/8.6/25.4/5.1/2 (mass %)) having a particle size of 120 nm (a copolymer having a glass transition temperature of 57° C. and a solid concentration of 21.5 mass % and containing Compound D as a film forming aid in an amount of 15 mass % based on the solid content of latex) was added water. Thereto, 1.62 g of Compound E, 3.15 g of Compound S, 1.98 g of a matting agent (polystyrene particles, average particle size: 7 μm, variation coefficient of average particle size: 8%) and 23.6 g of polyinyl alcohol (PVA-235 produced by Kuraray Co., Ltd.) were added and water was again added, thereby preparing a coating solution for protective layer (a) on the image forming surface.

(2) Preparation of Coating Solution for Protective Layer (b) on Image Forming Surface

To 630 g of a polymer solution of methyl methacrylate/styrene/2-ethylhexyl acrylate/2-hydroxyethyl methacrylate/acrylic acid (58.9/8.6/25.4/5.1/2 (mass %)) having a particle size of 70 nm (a copolymer having a glass transition temperature of 54° C. and a solid concentration of 21.5 mass % and containing Compound D shown in (6-1) as a film forming aid in an amount of 15 mass % based on the solid content of latex) was added water. Thereto, 6.30 g of a 30 mass % solution of carnauba wax (Celosol 524 produced by Chukyo Yushi Co., Ltd.) was added. Furthermore, 0.72 g of Compound E shown in (1) above, 7.95 g of Compound F shown above, 0.90 g of Compound S shown above, 1.18 g of a matting agent (polystyrene particles, average particle size: 7 μm) and 8.30 g of polyinyl alcohol (PVA-235 produced by Kuraray Co., Ltd.) were added thereto and water was again added, thereby preparing a coating solution for protective layer (b) on image forming surface.

<Manufacture of Heat-Developable Image Recording Material>

On the surface opposite the back layer, namely, on the undercoat layer (a) and the undercoat layer (b), of the PET support which was subjected to the transportation heat treatment, the coating solution for image-forming layer and the coating solution for protective layer (a) on image forming surface were simultaneously coated one on another in this order from the undercoat layer such that the coated silver amount became 1.6 g/m² and the coated amount as a solid content of the polymer became 1.31 g/m², respectively. Then, the coating solution for protective layer (b) on image forming surface was coated thereon such that the coated amount as a solid content of the polymer became 3.02 g/m², thereby manufacturing Sample 401. In the image forming side of Sample 401, the pH on the film surface was 4.9 and the Bekk smoothness was 660 seconds, and in the opposite side, the pH on the film surface was 5.9 and the Bekk smoothness was 560 seconds.

Samples 402 to 406 were manufactured in the same manner as in Example 1-4 except for changing the binder for image-forming layer of Sample 401 as shown in Table 19 below. These Samples were evaluated on the coating property and the image preservability. The results obtained are shown in Table 19 below.

The image preservability was evaluated after the heat-developable image recording material was exposed/developed ((1) exposure processing and (2) heat development processing) as follows.

(1) Exposure Processing

The heat-developable image recording material was exposed for 2×10⁻⁸ seconds using a laser exposure device of single channel cylindrical inner plane type equipped with a semiconductor laser having a beam diameter (FWHM of ½ beam intensity) of 12.56 μm, a laser output of 50 mW and an output wavelength of 783 nm, while controlling the exposure time by changing the rotation number of mirror and controlling the exposure amount by varying the output value. The overlap coefficient was 0.449.

(2) Heat Development Processing

The exposed heat-developable image recording material obtained in (1) above was subjected to heat development processing using a heat developing machine shown in FIG. 1. The heat developing machine shown in FIG. 1 comprises a pre-heating part A, a heat development processing part B and a slow cooling part C. The pre-heating part A is equipped with pre-heating means (not shown) and a plurality of paired carrying-in rollers 11 for holding a heat-developable image recording material 10 therebetween and conveying it into the heat development processing part B. The heat development processing part B is equipped with a smooth surface 14 and rollers 13 for holding the heat-developable image recording material 10 therebetween and transporting it, and heaters 15 for heating the heat-developable image recording material 10. The slow cooling part C is equipped with paired carrying-out rollers 12 for holding the heat-developable image recording material 10 therebetween and conveying it out from the heat development processing part B, and a guide plate 16 for changing the carrying-out direction of the heat-developable image recording material 10 between the carrying-out rollers 12.

In the heat developing machine shown in FIG. 1, the heat-developable image recording material 10 is passed through the pre-heating part A, the heat development processing part B and the slow cooling part C in order and subjected to pre-heating, heat development processing and slow cooling (air cooling) successively, thereby performing the heat development processing. In the heat development processing part B, silicone rubber was used as the construction material for the surface of rollers 13 and Teflon nonwoven fabric was used for the smooth surface 14. The transportation (i.e., carrying in and carrying out) was performed at a line speed of 20 mm/sec and the heat development was performed at 90 to 110° C. for 15 seconds in the pre-heating part A (the driving systems of the pre-heating part and the heat development processing part were independently operated and the difference in the speed from the heat development processing part B was set to a range from −0.5% to −1%), at 120° C. for 20 seconds in the heat development processing part B, and for 15 seconds (air cooling) in the slow cooling part C. The temperature accuracy on the transverse direction was ±1° C.

TABLE 19

| | Binder for Image-Forming | | | |
|---|---|---|---|---|
| | Layer | | | |
| | | Heavy Metal | Image | |
| Sample No. | Kind | Content (ppm) | Preservability | Remarks |
| 401 | RP-6 | 2.5 | 0.127 | Comparison |
| 402 | P4-1 | 0.06 | 0.046 | Invention |
| 403 | P4-2 | 0.05 | 0.057 | Invention |
| 404 | P4-3 | 0.04 | 0.066 | Invention |
| 405 | P4-4 | 0.15 | 0.064 | Invention |
| 406 | P4-8 | 0.73 | 0.081 | Invention |

As is apparent from Table 19, similarly to Example 1-4 (construction of the present invention), Samples 402 to 406 of the present invention, which are the super high contrast heat-developable image recording material using the specific polymer reduced in the iron content as the binder for image-forming layer, can have excellent image preservability as compared with Comparative Examples.

According to the fourth embodiment of the present invention, a heat-developable image recording material extremely improved in the image preservability can be provided by using a polymer latex reduced in the iron content as the binder.

### EXAMPLE 3-5

Preparation of Coating Solution for Image-Forming Layer

To the dispersion of organic acid silver salt (silver behenate) prepared in (1) above were added the following components in amounts shown below per mol of silver in the dispersion. Thereto, water was added to prepare a coating solution for image-forming layer.

| | | |
|---|---|---|
| Photosensitive silver halide | 0.05 | mol as Ag |
| emulsion prepared in (2) | | |
| above | | |
| Solid fine particle | 17.1 | g as solid content |
| dispersion of nucleating | | |
| agent prepared in (3) above | | |
| Solid fine particle | 166 | g as solid content |
| dispersion of reducing agent | | |
| prepared in (4) above | | |
| Solid fine particle | 0.06 | mol as solid content |
| dispersion of polyhalogen | | |
| compound A prepared in (5) | | |
| above | | |
| Solid fine particle | 0.02 | mol as solid content |
| dispersion of polyhalogen | | |
| compound B prepared in (5) | | |
| above | | |
| Solid fine particle | 10.5 | g as solid content |
| dispersion of zinc compound | | |
| prepared in (6) above | | |
| Binder for image-forming | 470 | g as solid content |
| layer (Compound (RP-7)) | | |
| Sodium ethanethiosulfonate | 2.2 | mmol |
| 5-Methylbenzotriazole | 1.36 | g |
| Polyvinyl alcohol (PVA-235 | 12.1 | g |
| produced by Kuraray Co., | | |
| Ltd.) | | |
| 6-Isopropylphthalazine | 16.5 | g |
| Sodium dihydrogen- | 0.37 | g |
| orthophosphate dihydrate | | |

| | |
|---|---|
| Dye A | coating amount for giving |
| | optical density of 0.3 at |
| | 783 nm (0.50 g as a |
| | standard) |

<Preparation of Coating Solution for Protective Layer on Image Forming Surface>

(1) Preparation of Coating Solution for Protective Layer (a) on Image Forming Surface

To 956 g of a polymer solution of methyl methacrylate/styrene/2-ethylhexyl acrylate/2-hydroxyethyl methacrylate/acrylic acid (58.9/8.6/25.4/5.1/2 (mass %)) having a particle size of 120 nm (a copolymer having a glass transition temperature of 57° C. and a solid concentration of 21.5 mass % and containing Compound D as a film forming aid in an amount of 15 mass % based on the solid content of latex) was added water. Thereto, 1.62 g of Compound E, 3.15 g of Compound S, 1.98 g of a matting agent (polystyrene particles, average particle size: 7 μm, variation coefficient of average particle size: 8%) and 23.6 g of polyinyl alcohol (PVA-235 produced by Kuraray Co., Ltd.) were added and water was again added, thereby preparing a coating solution for protective layer (a) on the image forming surface.

(2) Preparation of Coating Solution for Protective Layer (b) on Image Forming Surface

To 630 g of a polymer solution of methyl methacrylate/styrene/2-ethylhexyl acrylate/2-hydroxyethyl methacrylate/acrylic acid (58.9/8.6/25.4/5.1/2 (mass %)) having a particle size of 70 nm (a copolymer having a glass transition temperature of 54° C. and a solid concentration of 21.5 mass % and containing Compound D shown in (6-1) as a film forming aid in an amount of 15 mass % based on the solid content of latex) was added water. Thereto, 6.30 g of a 30 mass % solution of carnauba wax (Celosol 524 produced by Chukyo Yushi Co., Ltd.) was added. Furthermore, 0.72 g of Compound E shown in (1) above, 7.95 g of Compound F shown above, 0.90 g of Compound S shown above, 1.18 g of a matting agent (polystyrene particles, average particle size: 7 μm) and 8.30 g of polyinyl alcohol (PVA-235 produced by Kuraray Co., Ltd.) were added thereto and water was again added, thereby preparing a coating solution for protective layer (b) on image forming surface.

<Manufacture of Heat-Developable Image Recording Material>

On the surface opposite the back layer, namely, on the undercoat layer (a) and the undercoat layer (b), of the PET support which was subjected to the transportation heat treatment, the coating solution for image-forming layer and the coating solution for protective layer (a) on image forming surface were simultaneously coated one on another in this order from the undercoat layer such that the coated silver amount became 1.6 g/m² and the coated amount as a solid content of the polymer became 1.31 g/m², respectively. Then, the coating solution for protective layer (b) on image forming surface was coated thereon such that the coated amount as a solid content of the polymer became 3.02 g/m², thereby manufacturing Sample 401. In the image forming side of Sample 401, the pH on the film surface was 4.9 and the Bekk smoothness was 660 seconds, and in the opposite side, the pH on the film surface was 5.9 and the Bekk smoothness was 560 seconds.

Samples 402 to 408 were manufactured in the same manner as in Example 1-5 except for changing the binder for image-forming layer of Sample 401 as shown in Table 20 below. These Samples were evaluated on the coating property and the image preservability. The results obtained are shown in Table 20 below.

The image preservability was evaluated after the heat-developable image recording material was exposed/developed ((1) exposure processing and (2) heat development processing) as follows.

(1) Exposure Processing

The heat-developable image recording material was exposed for 2×10⁻⁸ seconds using a laser exposure device of single channel cylindrical inner plane type equipped with a semiconductor laser having a beam diameter (FWHM of ½ beam intensity) of 12.56 μm, a laser output of 50 mW and an output wavelength of 783 nm, while controlling the exposure time by changing the rotation number of mirror and controlling the exposure amount by varying the output value. The overlap coefficient was 0.449.

(2) Heat Development Processing

The exposed heat-developable image recording material obtained in (1) above was subjected to heat development processing using a heat developing machine shown in FIG. 1. The heat developing machine shown in FIG. 1 comprises a pre-heating part A, a heat development processing part B and a slow cooling part C. The pre-heating part A is equipped with pre-heating means (not shown) and a plurality of paired carrying-in rollers 11 for holding a heat-developable image recording material 10 therebetween and conveying it into the heat development processing part B. The heat development processing part B is equipped with a smooth surface 14 and rollers 13 for holding the heat-developable image recording material 10 therebetween and transporting it, and heaters 15 for heating the heat-developable image recording material 10. The slow cooling part C is equipped with paired carrying-out rollers 12 for holding the heat-developable image recording material 10 therebetween and conveying it out from the heat development processing part B, and a guide plate 16 for changing the carrying-out direction of the heat-developable image recording material 10 between the carrying-out rollers 12. In the heat developing machine shown in FIG. 1, the heat-developable image recording material 10 is passed through the pre-heating part A, the heat development processing part B and the slow cooling part C in order and subjected to pre-heating, heat development processing and slow cooling (air cooling) successively, thereby performing the heat development processing. In the heat development processing part B, silicone rubber was used as the construction material for the surface of rollers 13 and Teflon(R) nonwoven fabric was used for the smooth surface 14. The transportation (i.e., carrying in and carrying out) was performed at a line speed of 20 mm/sec and the heat development was performed at 90 to 110° C. for 15 seconds in the pre-heating part A (the driving systems of the pre-heating part and the heat development processing part were independently operated and the difference in the speed from the heat development processing part B was set to a range from −0.5% to −1%), at 120° C. for 20 seconds in the heat development processing part B, and for 15 seconds (air cooling) in the slow cooling part C. The temperature accuracy on the transverse direction was ±1° C.

TABLE 20

| | Binder for | | | |
|---|---|---|---|---|
| | Image-Forming | Coated | | |
| | Layer | Surface | Image | |
| Sample No. | Polymer in Latex | State | Preservability | Remarks |
| 401 | RP-7 | D | 0.129 | Comparison |
| 402 | P5-1 | A | 0.050 | Invention |
| 403 | P5-2 | A | 0.063 | Invention |
| 404 | P5-3 | B | 0.059 | Invention |
| 405 | P5-4 | A | 0.071 | Invention |
| 406 | P5-8 | A | 0.078 | Invention |
| 407 | P5-10 | A | 0.083 | Invention |

As is apparent from Table 20, similarly to Example 1-5 (construction of the present invention), the super high contrast heat-developable image recording material using the specific latex as the binder for image-forming layer can have excellent coated surface state and excellent image preservability as compared with Comparative Example.

According to the fifth embodiment of the present invention, a heat-developable image recording material excellent in both image preservability and coated surface state can be provided.

While the invention has been described in detail and with reference to specific examples thereof, it will be apparent to one skilled in the art that various changes and modifications can be made therein without departing from the spirit and scope thereof.

The entire disclosure of each and every foreign patent application from which the benefit of foreign priority has been claimed in the present application is incorporated herein by reference, as if fully set forth.

What is claimed is:

1. A heat-developable image recording material comprising:
a support;
a photosensitive silver halide;
a non-photosensitive organic silver salt;
a reducing agent for silver ion; and
a binder including a polymer,
wherein said polymer has:
a sol formation ratio of 5 to 55 wt %; and
the sol moiety having a weight average molecular weight of 10,000 to 200,000 and having a glass transition temperature of −30 to 50° C.

2. The heat-developable image recording material as claimed in claim 1, wherein said binder contains a polymer having:
a sol formation ratio of 15 to 45 wt %; and
the sol moiety having a weight average molecular weight of 30,000 to 150,000 and having a glass transition temperature of 0 to 30° C.

3. The heat-developable image recording material as claimed in claim 1, wherein said polymer contains a repeating unit corresponding to a crosslinkable monomer.

4. The heat-developable image recording material as claimed in claim 1, wherein said polymer contains a repeating unit corresponding to a conjugated diene monomer.

5. The heat-developable image recording material as claimed in claim 4, wherein said polymer is a styrene-butadiene copolymer.

6. The heat-developable image recording material as claimed in claim 1, wherein the reducing agent contains:
a phenol compound; and
a compound that satisfies at least one of the conditions A and B:
A: the compound having a hydrogen bond-forming rate constant (Kf) of from 20 to 4,000,
B: the compound having one of a phosphoryl group in its molecule, and a structure represented by the following formula (II), (III), (IV) or (V): 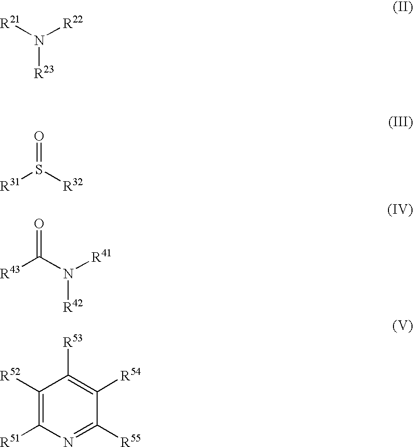
wherein R²¹ and R²² each independently represents an alkyl group; R²³ represents an alkyl group, an aryl group or a heterocyclic group; at least two of R²¹, R²² and R²³ may combine with each other to form a ring; R³¹ and R³² each independently represents an alkyl group, an aryl group or a heterocyclic group; R³¹ and R³² may combine with each other to form a ring; R⁴¹ and R⁴² each independently represents an alkyl group, an aryl group or a heterocyclic group; R⁴³ represents an alkyl group, an aryl group, a heterocyclic group or —N(R⁴⁴) (R⁴⁵); R⁴⁴ and R⁴⁵ each independently represents an alkyl group, an aryl group or a heterocyclic group; at least two of R⁴¹, R⁴², R⁴³, R⁴⁴ and R⁴⁵ may combine with each other to form a ring; R⁵¹, R⁵², R⁵³, R⁵⁴ and R⁵⁵ each independently represents a hydrogen atom or a substituent; at least two of R⁵¹, R⁵², R⁵³, R⁵⁴ and R⁵⁵ may combine with each other to form a ring.

7. The heat-developable image recording material as claimed in claim 6, wherein said phenol compound is an o-polyphenol compound.

8. The heat-developable image recording material as claimed in claim 7, wherein said o-polyphenol compound is a compound represented by the following formula (I): 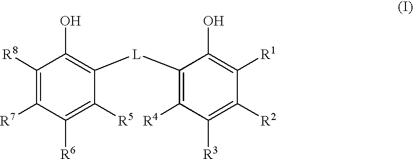
wherein R¹, R², R³, R⁴, R⁵, R⁶, R⁷ and R⁸ each independently represents a hydrogen atom or a group capable of being substituted on the benzene ring; L represents —S— or —CHR⁹—; R⁹ represents a hydrogen atom or an alkyl group.

9. The heat-developable image recording material as claimed in claim 8, wherein said compound represented by formula (I) is a compound where R², R⁴, R⁵ and R⁷ each is a hydrogen atom, R¹ and R⁸ each is independently an alkyl group, R³ and R⁶ each is independently an alkyl group, and L is —CHR⁹—.

10. The heat-developable image recording material as claimed in claim 9, wherein R¹ and R⁸ each is independently a secondary or tertiary alkyl group.

11. The heat-developable image recording material as claimed in claim 6, wherein said hydrogen bond-forming rate constant (Kf) is from 70 to 4,000.

12. The heat-developable image recording material as claimed in claim 6, wherein said phenol compound is an o-polyphenol compound, and the compound that satisfies at least one of the conditions A and B is the compound having a phosphoryl group in its molecule.

13. The heat-developable image recording material as claimed in claim 6, wherein said compound having a phosphoryl group in its molecule is a compound represented by the following formula (VI): 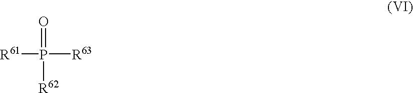
wherein R⁶¹, R⁶² and R⁶³ each independently represents an alkyl group, an aryl group, an aralkyl group, an alkoxy group, an aryloxy group, an amino group or a heterocyclic group.

14. A heat-developable image recording material comprising:
a support;
a photosensitive silver halide;
a non-photosensitive organic silver salt;
a reducing agent for silver ion; and
a binder including a polymer latex,
wherein the polymer latex contains a chelate compound in an amount of 20 to 900 ppm based on the polymer latex solution.

15. The heat-developable image recording material as claimed in claim 14, wherein said polymer latex contains the chelate compound in an amount of from 40 to 600 ppm based on the polymer latex solution.

16. The heat-developable image recording material as claimed in claim 14, wherein said chelate compound is an aminopolycarboxylic acid derivative.

17. The heat-developable image recording material as claimed in claim 14, wherein said binder has a glass transition temperature of −20 to 80° C.

18. The heat-developable image recording material as claimed in claim 14, wherein said binder contains a copolymer having a repeating unit corresponding to a conjugated diene monomer.

19. The heat-developable image recording material as claimed in claim 14, wherein the reducing agent contains:
a phenol compound; and
a compound that satisfies at least one of the conditions A and B:
A: the compound having a hydrogen bond-forming rate constant (Kf) of from 20 to 4,000,
B: the compound having one of a phosphoryl group in its molecule, and a structure represented by the following formula (II), (III), (IV) or (V): 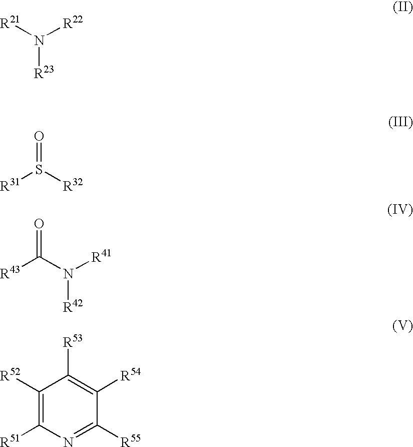
wherein R²¹ and R²² each independently represents an alkyl group; R²³ represents an alkyl group, an aryl group or a heterocyclic group; at least two of R²¹, R²² and R²³ may combine with each other to form a ring; R³¹ and R³² each independently represents an alkyl group, an aryl group or a heterocyclic group; R³¹ and R³² may combine with each other to form a ring; R⁴¹ and R⁴² each independently represents an alkyl group, an aryl group or a heterocyclic group; R⁴³ represents an alkyl group, an aryl group, a heterocyclic group or —N(R⁴⁴) (R⁴⁵); R⁴⁴ and R⁴⁵ each independently represents an alkyl group, an aryl group or a heterocyclic group; at least two of R⁴¹ , R⁴² , R⁴³ , R⁴⁴ and R⁴⁵ may combine with each other to form a ring; R⁵¹, R⁵², R⁵³, R⁵⁴ and R⁵⁵ each independently represents a hydrogen atom or a substituent; at least two of R⁵¹ , R⁵² , R⁵³ , R⁵⁴ and R⁵⁵ may combine with each other to form a ring.

20. The heat-developable image recording material as claimed in claim 19, wherein said phenol compound is an o-polyphenol compound.

21. The heat-developable image recording material as claimed in claim 20, wherein said o-polyphenol compound is a compound represented by the following formula (I): 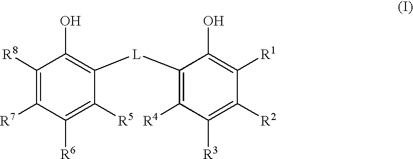
wherein R¹, R², R³, R⁴, R⁵, R⁶, R⁷ and R⁸ each independently represents a hydrogen atom or a group capable of being substituted on the benzene ring; L represents —S— or —CHR⁹—; R⁹ represents a hydrogen atom or an alkyl group.

22. The heat-developable image recording material as claimed in claim 21, wherein said compound represented by formula (I) is a compound where R², R⁴, R⁵ and R⁷ each is a hydrogen atom, R¹ and R⁸ each is independently an alkyl group, R³ and R⁶ each is independently an alkyl group, and L is —CHR⁹—.

23. The heat-developable image recording material as claimed in claim 22, wherein R¹ and R⁸ each is independently a secondary or tertiary alkyl group.

24. The heat-developable image recording material as claimed in claim 19, wherein said hydrogen bond-forming rate constant (Kf) is from 70 to 4,000.

25. The heat-developable image recording material as claimed in claim 19, wherein said phenol compound is an o-polyphenol compound, and the compound that satisfies at least one of the conditions A and B is the compound having a phosphoryl group in its molecule.

26. The heat-developable image recording material as claimed in claim 19, wherein said compound having a phosphoryl group in its molecule is a compound represented by the following formula (VI): 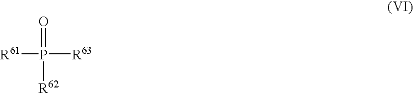
wherein R⁶¹, R⁶² and R⁶³ each independently represents an alkyl group, an aryl group, an aralkyl group, an alkoxy group, an aryloxy group, an amino group or a heterocyclic group.

27. A latex solution for an organic silver-containing heat-developable image recording material, which comprises:
a polymer latex; and
a chelate compound in an amount of from 20 to 900 ppm.

28. A heat-developable image recording material comprising:
a support;
a photosensitive silver halide;
a non-photosensitive organic silver salt;
a reducing agent capable of reducing silver ion; and
a binder,
wherein a layer containing the binder is provided by applying a coating solution containing:
the photosensitive silver halide;
the non-photosensitive organic silver salt; and
a polymer latex obtained by the emulsion polymerization in the presence of a basic compound.

29. The heat-developable image recording material as claimed in claim 28, wherein the basic compound is used in an amount of 1.0×10⁻⁵ mmol or more per g as a solid content of the polymer latex.

30. The heat-developable image recording material as claimed in claim 28, wherein said binder contains a polymer latex obtained by the copolymerization of a monomer having a carboxyl group.

31. The heat-developable image recording material as claimed in claim 28, wherein the polymer latex is obtained by the emulsion polymerization in the presence of a surface active agent in an amount of 10 wt % or less based on the solid content of the polymer latex.

32. The heat-developable image recording material as claimed in claim 28, wherein said binder has a glass transition temperature of −20 to 80° C.

33. The heat-developable image recording material as claimed in claim 28, wherein said polymer latex is a polymer latex obtained by the copolymerization of at least a conjugated diene monomer.

34. The heat-developable image recording material as claimed in claim 28, wherein the reducing agent contains:
a phenol compound; and
a compound that satisfies at least one of the conditions A and B:
A: the compound having a hydrogen bond-forming rate constant (Kf) of from 20 to 4,000,
B: the compound having one of a phosphoryl group in its molecule, and a structure represented by the following formula (II), (III), (IV) or (V): 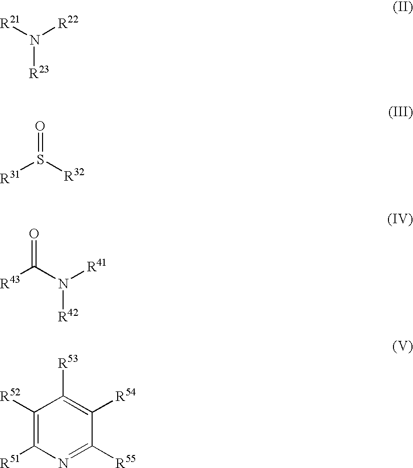
wherein R²¹ and R²² each independently represents an alkyl group; R²³ represents an alkyl group, an aryl group or a heterocyclic group; at least two of R²¹, R²² and R²³ may combine with each other to form a ring; R³¹ and R³² each independently represents an alkyl group, an aryl group or a heterocyclic group; R³¹ and R³² may combine with each other to form a ring; R⁴¹ and R⁴² each independently represents an alkyl group, an aryl group or a heterocyclic group; R⁴³ represents an alkyl group, an aryl group, a heterocyclic group or —N(R⁴⁴) (R⁴⁵); R⁴⁴ and R⁴⁵ each independently represents an alkyl group, an aryl group or a heterocyclic group; at least two of R⁴¹, R⁴², R⁴³, R⁴⁴ and R⁴⁵ may combine with each other to form a ring; R⁵¹, R⁵², R⁵³, R⁵⁴ and R⁵⁵ each independently represents a hydrogen atom or a substituent; at least two of R⁵¹, R⁵², R⁵³, R⁵⁴ and R⁵⁵ may combine with each other to form a ring.

35. The heat-developable image recording material as claimed in claim 34, wherein said phenol compound is an o-polyphenol compound.

36. The heat-developable image recording material as claimed in claim 35, wherein said o-polyphenol compound is a compound represented by the following formula (I): 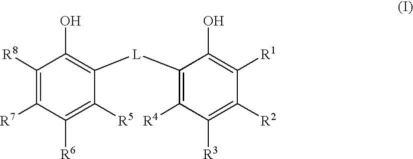
wherein R¹, R², R³ , R³ , R⁴ , R⁵ , R⁶, R⁷ and R⁸ each independently represents a hydrogen atom or a group capable of being substituted on the benzene ring; L represents —S— or —CHR⁹—; R⁹ represents a hydrogen atom or an alkyl group.

37. The heat-developable image recording material as claimed in claim 36, wherein said compound represented by formula (I) is a compound where R², R⁴, R⁵ and R⁷ each is a hydrogen atom, R¹ and R⁸ each is independently an alkyl group, R³ and R⁶ each is independently an alkyl group, and L is —CHR⁹—.

38. The heat-developable image recording material as claimed in claim 37, wherein R¹ and R⁸ each is independently a secondary or tertiary alkyl group.

39. The heat-developable image recording material as claimed in claim 34, wherein said hydrogen bond-forming rate constant (Kf) is from 70 to 4,000.

40. The heat-developable image recording material as claimed in claim 34, wherein said phenol compound is an o-polyphenol compound, and the compound that satisfies at least one of the conditions A and B is the compound having a phosphoryl group in its molecule.

41. The heat-developable image recording material as claimed in claim 34, wherein said compound having a phosphoryl group in its molecule is a compound represented by the following formula (VI): 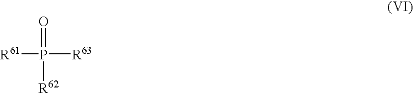
wherein R⁶¹, R⁶² and R⁶³ each independently represents an alkyl group, an aryl group, an aralkyl group, an alkoxy group, an aryloxy group, an amino group or a heterocyclic group.

42. A heat-developable image recording material comprising:
a support;
a photosensitive silver halide;
a non-photosensitive organic silver salt;
a reducing agent for silver ion; and
a binder including a polymer latex,
wherein said polymer latex has a heavy metal content of 1 ppm or less based on the polymer latex.

43. The heat-developable image recording material as claimed in claim 42, wherein said heavy metal content is 0.5 ppm or less based on the polymer latex.

44. The heat-developable image recording material as claimed in claim 42, wherein said heavy metal is at least one selected from the group consisting of iron, chromium, nickel, molybdenum or titanium.

45. The heat-developable image recording material as claimed in claim 42, wherein said binder has a glass transition temperature of −20 to 80° C.

46. The heat-developable image recording material as claimed in claim 42, wherein the polymer has a repeating unit corresponding to a conjugated diene monomer.

47. The heat-developable image recording material as claimed in claim 42, wherein the reducing agent contains:
a phenol compound; and
a compound that satisfies at least one of the conditions A and B:
A: the compound having a hydrogen bond-forming rate constant (Kf) of from 20 to 4,000,
B: the compound having one of a phosphoryl group in its molecule, and a structure represented by the following formula (II), (III), (IV) or (V): 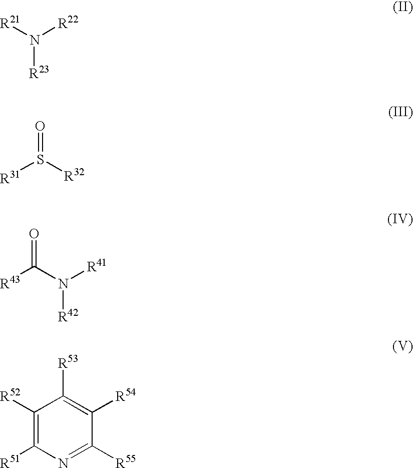
wherein R²¹ and R²² each independently represents an alkyl group; R²³ represents an alkyl group, an aryl group or a heterocyclic group; at least two of R²¹, R²² and R²³ may combine with each other to form a ring; R³¹ and R³² each independently represents an alkyl group, an aryl group or a heterocyclic group; R³¹ and R³² may combine with each other to form a ring; R⁴¹ and R⁴² each independently represents an alkyl group, an aryl group or a heterocyclic group; R⁴³ represents an alkyl group, an aryl group, a heterocyclic group or —N(R⁴⁴) (R⁴⁵); R⁴⁴ and R⁴⁵ each independently represents an alkyl group, an aryl group or a heterocyclic group; at least two of R⁴¹, R⁴², R⁴³, R⁴⁴ and R⁴⁵ may combine with each other to form a ring; R⁵¹, R⁵², R⁵³, R⁵⁴ and R⁵⁵ each independently represents a hydrogen atom or a substituent; at least two of R⁵¹, R⁵² , R⁵³ , R⁵⁴ and R⁵⁵ may combine with each other to form a ring.

48. The heat-developable image recording material as claimed in claim 47, wherein said phenol compound is an o-polyphenol compound.

49. The heat-developable image recording material as claimed in claim 48, wherein said o-polyphenol compound is a compound represented by the following formula (I): 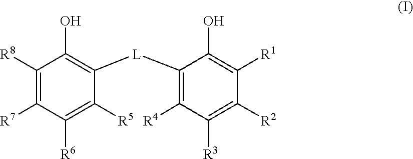
wherein R¹, R², R³ , R⁴, R⁵ , R⁶ , R⁷ and R⁸ each independently represents a hydrogen atom or a group capable of being substituted on the benzene ring; L represents —S— or —CHR⁹—; R⁹ represents a hydrogen atom or an alkyl group.

50. The heat-developable image recording material as claimed in claim 49, wherein said compound represented by formula (I) is a compound where R², R⁴, R⁵ and R⁷ each is a hydrogen atom, R¹ and R⁸ each is independently an alkyl group, R³ and R⁶ each is independently an alkyl group, and L is —CHR⁹—.

51. The heat-developable image recording material as claimed in claim 50, wherein R¹ and R⁸ each is independently a secondary or tertiary alkyl group.

52. The heat-developable image recording material as claimed in claim 47, wherein said hydrogen bond-forming rate constant (Kf) is from 70 to 4,000.

53. The heat-developable image recording material as claimed in claim 47, wherein said phenol compound is an o-polyphenol compound, and the compound that satisfies at least one of the conditions A and B is the compound having a phosphoryl group in its molecule.

54. The heat-developable image recording material as claimed in claim 47, wherein said compound having a phosphoryl group within the molecule is a compound represented by the following formula (VI): 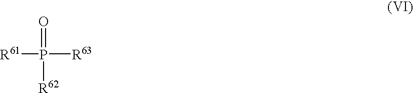
wherein R⁶¹, R⁶² and R⁶³ each independently represents an alkyl group, an aryl group, an aralkyl group, an alkoxy group, an aryloxy group, an amino group or a heterocyclic group.

55. A heat-developable image recording material comprising:
a support;
a photosensitive silver halide;
a non-photosensitive organic silver salt;
a reducing agent for silver ion; and
a binder including a latex,
wherein the latex contains dispersed particles, and the dispersed particles has the ratio (dv/dn) of the volume weighted mean diameter (dv) to the number average diameter (dn) of from 1.0 to 1.10.

56. The heat-developable image recording material as claimed in claim 55, wherein the number average diameter (dn) of the dispersed particles of the latex is from 30 to 300 nm.

57. The heat-developable image recording material as claimed in claim 55, wherein the latex is a dispersion of a polymer having a repeating unit corresponding to a conjugated diene monomer.

58. The heat-developable image recording material as claimed in claim 57, wherein said polymer is a styrene-butadiene copolymer.

59. The heat-developable image recording material as claimed in claim 55, wherein the reducing agent contains:
a phenol compound; and
a compound that satisfies at least one of the conditions A and B:
A: the compound having a hydrogen bond-forming rate constant (Kf) of from 20 to 4,000,
B: the compound having one of a phosphoryl group in its molecule, and a structure represented by the following formula (II), (III), (IV) or (V): 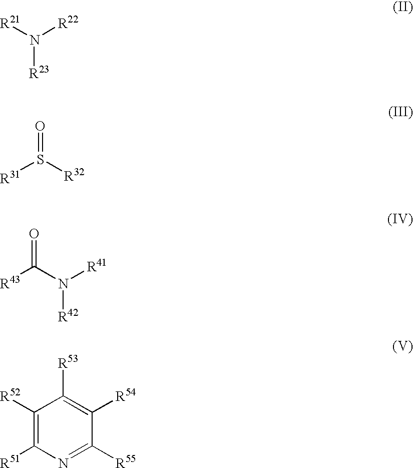
wherein R²¹ and R²² each independently represents an alkyl group; R²³ represents an alkyl group, an aryl group or a heterocyclic group; at least two of R²¹, R²² and R²³ may combine with each other to form a ring; R³¹ and R³² each independently represents an alkyl group, an aryl group or a heterocyclic group; R³¹ and R³² may combine with each other to form a ring; R⁴¹ and R⁴² each independently represents an alkyl group, an aryl group or a heterocyclic group; R⁴³ represents an alkyl group, an aryl group, a heterocyclic group or —N(R⁴⁴) (R⁴⁵); R⁴⁴ and R⁴⁵ each independently represents an alkyl group, an aryl group or a heterocyclic group; at least two of R⁴¹, R⁴², R⁴³, R⁴⁴ and R⁴⁵ may combine with each other to form a ring; R⁵¹, R⁵², R⁵³ R⁵⁴ and R⁵⁵ each independently represents a hydrogen atom or a substituent; at least two of R⁵¹, R⁵², R⁵³, R⁵⁴ and R⁵⁵ may combine with each other to form a ring.

60. The heat-developable image recording material as claimed in claim 59, wherein said phenol compound is an o-polyphenol compound.

61. The heat-developable image recording material as claimed in claim 60, wherein said o-polyphenol compound is a compound represented by the following formula (I): 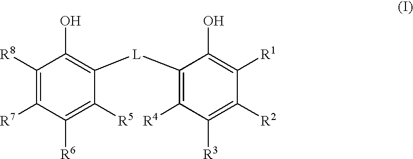
wherein R¹, R², R³, R⁴, R⁵, R⁶, R⁷ and R⁸ each independently represents a hydrogen atom or a group capable of being substituted on the benzene ring; L represents —S— or —CHR⁹—; R⁹ represents a hydrogen atom or an alkyl group.

62. The heat-developable image recording material as claimed in claim 61, wherein said compound represented by formula (I) is a compound where R², R⁴, R⁵ and R⁷ each is a hydrogen atom, R¹ , R³ , R⁶ and R⁸ each is independently an alkyl group, L is —CHR⁹—, and R⁹ is a hydrogen atom or an alkyl group.

63. The heat-developable image recording material as claimed in claim 62, wherein R¹ and R⁸ each is independently a secondary or tertiary alkyl group.

64. The heat-developable image recording material as claimed in claim 59, wherein said hydrogen bond-forming rate constant (Kf) is from 70 to 4,000.

65. The heat-developable image recording material as claimed in claim 59, wherein said phenol compound is an o-polyphenol compound, and the compound that satisfies at least one of the conditions A and B is the compound having a phosphoryl group in its molecule.

66. The heat-developable image recording material as claimed in claim 59, wherein said compound having a phosphoryl group within the molecule is a compound represented by the following formula (VI): 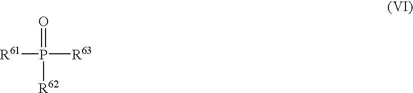
wherein R⁶¹, R⁶² and R⁵³ each independently represents an alkyl group, an aryl group, an aralkyl group, an alkoxy group, an aryloxy group, an amino group or a heterocyclic group.

67. A heat-developable image recording material comprising:
a support;
a photosensitive silver halide;
a non-photosensitive organic silver salt;
a reducing agent for silver ion; and
a binder including a latex,
wherein the latex has the ratio (N_{U80}/Nₐₗₗ) of 0.1 or less between the number (N_{U80}) of small-size particles having a diameter of less than 80% of the number average diameter (dn) and the number (Nₐₗₗ) of all particles.

68. The heat-developable image recording material as claimed in claim 67, wherein the number average diameter (dn) of said latex is from 30 to 300 nm.

69. The heat-developable image recording material as claimed in claim 67, wherein the latex is a dispersion of a polymer having a repeating unit corresponding to a conjugated diene monomer.

70. The heat-developable image recording material as claimed in claim 69, wherein said polymer is a styrene-butadiene copolymer.

71. The heat-developable image recording material as claimed in claim 67, wherein the reducing agent contains:
a phenol compound; and
a compound that satisfies at least one of the conditions A and B:
A: the compound having a hydrogen bond-forming rate constant (Kf) of from 20 to 4,000,
B: the compound having one of a phosphoryl group in its molecule, and a structure represented by the following formula (II), (III), (IV) or (V): 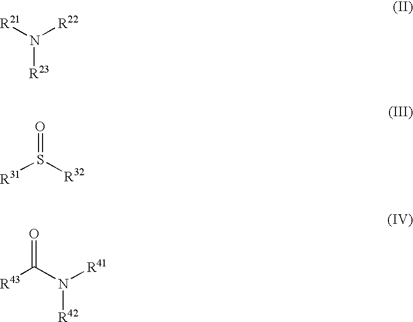 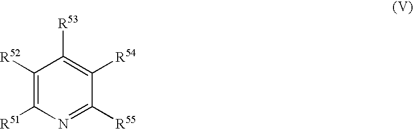
wherein R²¹ and R²² each independently represents an alkyl group; R²³ represents an alkyl group, an aryl group or a heterocyclic group; at least two of R²¹, R²² and R²³ may combine with each other to form a ring; R³¹ and R³² each independently represents an alkyl group, an aryl group or a heterocyclic group; R³¹ and R³² may combine with each other to form a ring; R⁴¹ and R⁴² each independently represents an alkyl group, an aryl group or a heterocyclic group; R⁴³ represents an alkyl group, an aryl group, a heterocyclic group or —N(R⁴⁴) (R⁴⁵); R⁴⁴ and R⁴⁵ each independently represents an alkyl group, an aryl group or a heterocyclic group; at least two of R⁴¹, R⁴², R⁴³, R⁴⁴ and R⁴⁵ may combine with each other to form a ring; R⁵¹, R⁵² , R⁵³, R⁵⁴ and R⁵⁵ each independently represents a hydrogen atom or a substituent; at least two of R⁵¹, R⁵², R⁵³, R⁵⁴ and R⁵⁵ may combine with each other to form a ring.

72. The heat-developable image recording material as claimed in claim 71, wherein said phenol compound is an o-polyphenol compound.

73. The heat-developable image recording material as claimed in claim 72, wherein said o-polyphenol compound is a compound represented by the following formula (I): 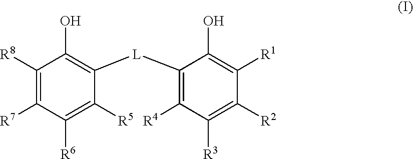
wherein R¹, R², R³, R⁴, R⁵, R⁶, R⁷ and R⁸ each independently represents a hydrogen atom or a group capable of being substituted on the benzene ring; L represents —S— or —CHR⁹—, and R⁹ represents a hydrogen atom or an alkyl group.

74. The heat-developable image recording material as claimed in claim 73, wherein said compound represented by formula (I) is a compound where R², R⁴, R⁵ and R⁷ each is a hydrogen atom, R¹ , R³, R⁶ and R⁸ each is independently an alkyl group, L is —CHR⁹—, and R⁹ is a hydrogen atom or an alkyl group.

75. The heat-developable image recording material as claimed in claim 74, wherein R¹ and R⁸ each is independently a secondary or tertiary alkyl group.

76. The heat-developable image recording material as claimed in claim 71, wherein said hydrogen bond-forming rate constant (Kf) is from 70 to 4,000.

77. The heat-developable image recording material as claimed in claim 71, wherein said phenol compound is an o-polyphenol compound, and the compound that satisfies at least one of the conditions A and B is the compound having a phosphoryl group in its molecule.

78. The heat-developable image recording material as claimed in claim 71, wherein said compound having a phosphoryl group in its molecule is a compound represented by the following formula (VI): 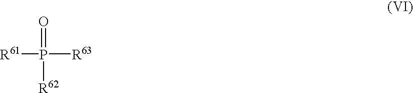
wherein R⁶¹, R⁶² and R⁶³ each independently represents an alkyl group, an aryl group, an aralkyl group, an alkoxy group, an aryloxy group, an amino group or a heterocyclic group.
